(19) United States
(12) Patent Application Publication
(10) Pub. No.: US 2007/0038516 A1
(43) Pub. Date: Feb. 15, 2007

(54) Systems, methods, and computer program products for enabling an advertiser to measure user viewing of and response to an advertisement

(76) Inventors: Jeff Apple, Malibu, CA (US); Lehmann Li, Studio City, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/509,054

(22) Filed: Aug. 24, 2006

Related U.S. Application Data
(63) Continuation-in-part of application No. 11/503,185, filed on Aug. 14, 2006.
(60) Provisional application No. 60/707,684, filed on Aug. 13, 2005.
(60) Provisional application No. 60/716,089, filed on Sep. 11, 2005.
(60) Provisional application No. 60/774,423, filed on Feb. 16, 2006.
(60) Provisional application No. 60/779,753, filed on Mar. 6, 2006.
(60) Provisional application No. 60/744,505, filed on Apr. 9, 2006.
(60) Provisional application No. 60/774,836, filed on Feb. 17, 2006.
(60) Provisional application No. 60/745,524, filed on Apr. 24, 2006.
(60) Provisional application No. 60/821,572, filed on Aug. 6, 2006.

(51) Int. Cl. G06Q 30/00

(52) U.S. Cl. 705/14

(57) ABSTRACT

Systems, methods, apparatus, and/or computer program products for measuring if, when, how, and/or to what degree an user responds to an advertisement to enable an advertiser to produce an unique advertisement for the user and measure the effectiveness of advertisements through wireless and other media channels. The system enables an advertiser to measure the effectiveness of advertisements transmitted to the user through multiple media channels, including, but not limited to: television, radio, personal computer, billboard, magazines, newspapers, product package, and/or other wireless devices, as well as a wireless network. The system also incorporates static and/or dynamic information about the user and/or feedback from the user to produce dynamically an unique advertisement that increases and/or maximizes the probability of the user and comparable users buying the advertised product.

### CROSS REFERENCE TO RELATED APPLICATIONS

The application is a continuation-in-part of U.S. patent application Ser. No. 11/503,185, filed on Aug. 14, 2006 entitled “Systems, Methods, and Computer Program Products for Enabling an Advertiser to Measure User Viewing Of and Response to an Advertisement,” which claims benefit under 35 U.S.C. §119(e) to U.S. Provisional Application No. 60/707,684, filed on Aug. 13, 2005, entitled “Systems, Methods, And Apparatus Enabling Whether, When, And How A Wireless User Responds To An Advertisement Transmitted Through Any Media Device To Produce A Customized Advertisement And Measure Advertisement Effectiveness,” U.S. Provisional Application No. 60/716,089, filed on Sep. 11, 2005, entitled “Systems, Methods, And Apparatus Measuring Whether, When, And How A Wireless User Responds To An Advertisement Transmitted Through Any Media Device To Produce A Customized Advertisement And Measure Advertisement Effectiveness,” U.S. Provisional Application No. 60/774,423, filed on Feb. 16, 2006, entitled “Systems, Methods, And Apparatus Enabling An Advertiser To Measure If A User Views An Advertisement Transmitted To Any Media Device And Purchases In Any Retail Channel The Product Promoted In Said Advertisement,” U.S. Provisional Application No. 60/779,753, filed on Mar. 6, 2006, entitled, “Systems, Methods, And Apparatus Enabling An Advertiser To Measure If A User Views An Advertisement Transmitted To Any Media Device And Purchases In Any Retail Channel The Product Promoted In Said Advertisement,” U.S. Provisional Application No. 60/744,505, filed on Apr. 9, 2006, entitled “Systems, Methods, And Apparatus Enabling An Advertiser To Measure If A User Views An Advertisement Transmitted To Any Media Device And Purchases In Any Retail Channel The Product Promoted In Said Advertisement,” U.S. Provisional Application No. 60/774,836, filed on Apr. 13, 2006, entitled “Systems, Methods, And Apparatus Enabling An Advertiser To Measure If A User Views An Advertisement Transmitted To Any Media Device And Purchases In Any Retail Channel The Product Promoted In Said Advertisement,” U.S. Provisional Application No. 60/745,524, filed on Apr. 24, 2006, entitled “Systems, Methods, And Apparatus Enabling An Advertiser To Measure If A User Views An Advertisement Transmitted To Any Media Device And Purchases In Any Retail Channel The Product Promoted In Said Advertisement,” and U.S. Provisional Application No. 60/821,572, filed on Aug. 6, 2006, entitled “Systems, Methods, And Computer Program Products Enabling The Measurement If An Advertisement Transmitted To Any Media Device Leads To A Sale In Any Retail Channel,” each of which is incorporated by reference herein in its entirety.

The application is also related to Disclosure Document, Ser. No. 593980, filed on Jan. 30, 2006, entitled “Systems, Methods, And Apparatus Enabling An Advertiser To Measure If A User Views An Advertisement Transmitted To Any Media Device And Purchases The Product Promoted In Any Retail Channel,” and Disclosure Document, Ser. No. 604024, filed on Jul. 27, 2006, entitled “System, Methods, And Computer Program Products Enabling The Measurement If An Advertisement Delivered To Any Media Device Leads To A Sale In Any Retail Channel,” each of which is incorporated by reference herein in its entirety.

### FIELD OF THE INVENTION

The present invention relates, in general, to measuring the effectiveness of advertising and, in particular, to systems, methods, apparatuses, and computer program products for producing advertisements for transmission to any media device and measuring how users respond in any retail channel to such advertisements.

### BACKGROUND OF THE INVENTION

Advertisers generally produce one advertisement—whether in the form of video, audio, and/or image—for their target audience. An advertiser might vary some elements of the advertisement, e.g., different price offers or different celebrity endorsers, depending on the target market. Current media channels such as television, radio, personal computer, outdoor, magazines, newspapers, and product packaging enable an advertiser to distribute a unique advertisement to some group of users, e.g., all users living within a zip code. However, these current media technologies generally do not allow an advertiser to distribute a unique advertisement to an individual user.

In addition, advertisers currently produce advertisements with limited feedback from actual users. Often advertisers review a given advertisement with a focus group of users in their target market. In some cases, advertisers show an advertisement in a test media market before showing the advertisement in a broader media market. In general, current media technologies enable advertisers to measure only the opinion of users regarding an advertisement or their intent to buy the product advertised.

Advertisers recognize the disadvantages of measuring what an user thinks by asking him/her what they think. In general, a system requiring active measurement of user activity will be less accurate and reliable than a system of passive measurement. That is, a system requiring users to give an opinion about their preferences introduces a variety of potential problems, including, inter alia, user lack of understanding of the question, user bias, and user unwillingness to provide publicly an unpopular answer.

In the case of measuring advertising effectiveness, a system requiring users to state explicitly their opinion about an advertisement or particular elements of an advertisement introduces a variety of problems that can cause the over- or underestimation of the real user responsiveness to an advertisement or an advertisement element. Therefore, advertisers generally prefer to measure—not what an user thinks about an advertisement, elements of an advertisement, or the product advertised—but how an user actually behaves after viewing the advertisement. However, current media technologies do not enable an advertiser to measure, inter alia, whether a given user buys the product advertised in response to the advertisement, whether the user takes certain steps short of buying the product advertised that still reflect interest in the product and/or intent to buy the product at a later time, or the ratio of the number of units purchased by an user viewing an advertisement to the number of times an user viewed an advertisement (“Return On Investment” or “ROI”).

A few selected media devices and retail channels in which an advertiser can measure if an user views an advertisement transmitted to the media device and purchases the product promoted in the advertisement in the retail channels. For example, an advertiser can measure the ROI of an online advertisement leading to an online purchase, because it can track an user viewing an advertisement on an online media program, e.g., a search engine, determine which online media program forwarded the user to the advertiser's web site, and record any purchase made by the user at the advertiser's web site. In another example, an advertiser can measure the ROI of an advertisement placed in a mail order catalog leading to a purchase through a telecommunications device or the mail if an user purchases the product in the catalog utilizing a specific phone number or by mailing a specific code provided in the catalog, respectively.

However, an advertiser cannot measure the ROI for online advertisements that lead to a purchase in any retail channel other than an online retailer such as a physical retailer, a purchase order made through a phone call, or physical delivery of a purchase order. Furthermore, an advertiser cannot measure the ROI for advertisements viewed on television, radio, print, outdoor, and product package leading to a purchase in any retail channel. Except for certain types of interactive television shopping, an advertiser cannot measure the specific ROI of a television advertisement leading to a purchase through a phone call. While an advertiser can measure the number of purchases made through a phone call, it cannot measure the specific advertisement or specific media program which led to the phone call unless the user manually identifies the advertisement or the program.

Without data measuring the ROI of advertisements across most major media programs, an advertiser cannot optimize the purchase of advertisements to maximize sales or profits. Techniques exist to enable an advertiser to optimize the purchase of advertisements to maximize the number of users viewing an advertisement or optimize the number of users viewing an advertisement most likely to purchase the product promoted based on demographics of a given media program.

Finally, advertisers currently have research data showing the response rates among different media channels. However, these response rates typically measure whether users as a class met some objective, e.g., recalling the advertisement, that may or may not be related to the primary advertiser objective of maximizing sales and/or profits. Moreover, advertisers typically obtain such data only in a survey of users after transmission of the advertisement. Without a measure of the ROI for each media channel, an advertiser cannot determine how to allocate an advertising budget efficiently among the different media channels.

Existing techniques enable the measurement of an user viewing an advertisement transmitted to certain media devices and the identification of the specific media program in which an user viewed the advertisement. For example, an advertiser placing an advertisement in an online media program can determine if the user viewed the advertisement and identify the specific media program in which an user viewed the advertisement.

Techniques also exist to enable an advertiser to pay for a media location based not on the number of potential or actual viewers of an advertisement, as measured by, e.g., cost-per-thousand (CPM) impressions, but on a measure that reflects some response by an user to an advertisement, as measured by, e.g., cost-per-click (CPC). However, even paying for a media location based on CPC still does not enable an advertiser to pay for a media location based on actual sales or profits. Existing techniques enable an advertiser to pay for an online media location based on cost-per-sale (CPS) for online advertisements leading to online sales. However, a vast majority of sales occur in retail channels other than online sales. Moreover, an advertiser should value the ability to pay for a media location in any media based on CPS.

Therefore, what is needed are systems and methods for providing the ability to generate unique advertisements for individuals.

What is further needed are systems and methods that passively measure user responses to advertisements by observing user behavior.

What is also needed are systems and methods to allow for the accurate measurement of user responses to advertisements.

What is also needed are systems and methods to allow advertisers to analyze consumption and response to advertisements based on numerous factors such as response per media channel carrying the advertisement.

What is further needed are systems and methods for automating the process of measuring an advertisement which an user views, the media program in which an user views the advertisement, the retail channel in which an user purchases product promoted in the advertisement, and the matching of code recording the advertisement viewed with data recording the product purchased.

What is also needed are systems and methods to enable an advertiser to pay for a media location based on estimated or actual sales or profits, as measured by, e.g., cost-per-sale (CPS), for online advertisements leading to any retail channel other than online retailers; and advertisements delivered to media devices other than a device that can receive an online advertisement.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts a high-level block diagram of a system enabling an advertiser to track user viewing of and response to an advertisement, according to embodiments of the present invention.

FIG. 2 depicts an exemplary ad data code, according to embodiments of the present invention.

FIG. 3 depicts a portion of the exemplary system of FIG. 1 including media devices and wireless devices, according to embodiments of the present invention.

FIG. 4 depicts one or more these exemplary media devices and their respective I-O devices which may be used in the system of FIG. 1, according to embodiments of the present invention.

FIG. 5 depicts a functional block diagram of an exemplary set top box, according to embodiments of the present invention.

FIG. 6 depicts a table listing the I-O devices of a wireless device and the I-O devices of the above described media devices with which such wireless device can exchange data through a wired and/or wireless signal, according to embodiments of the present invention.

FIG. 7 depicts a functional block diagram of an exemplary URMS, according to embodiments of the present invention.

FIG. 8 depicts a block diagram of an exemplary implementation of a URMS in a wireless device as a software application program operating on top of an operating system, such as the operating system depicted in FIG. 3, according to embodiments of the present invention.

FIG. 9 depicts a table listing a set of modules and how each module can generate values for particular variables reflecting an user viewing an advertisement and values for particular variables reflecting how an user responds to an advertisement, according to embodiments of the present invention.

FIG. 10 depicts an exemplary template for an ad data file associated with each ad data code, according to embodiments of the present invention.

FIG. 11 depicts an exemplary table listing the operators the present invention can utilize to calculate the number of specific types of advertisements transmitted by a given advertiser, according to embodiments of the present invention.

FIG. 12 depicts an exemplary table showing different variables measuring how an user can respond to a given advertisement, according to embodiments of the present invention.

FIG. 13 depicts a diagram of a specific embodiment of the MMCMS exchanging data in the case of a television advertisement, according to embodiment of the present invention.

FIG. 14 depicts a functional block diagram of a portion of a system measuring an user response to an advertisement by purchasing a product at a retailer, according to embodiments of the present invention.

FIG. 15 depicts an exemplary process for any contactless device to exchange data with a Payment Device, according to embodiments of the present invention.

FIG. 16A is a diagram illustrating an exemplary PLU database, according to embodiments of the present invention.

FIG. 16B is a diagram illustrating an exemplary transaction database, according to embodiments of the present invention.

FIG. 16C is a diagram illustrating an exemplary customer database, according to embodiments of the present invention.

FIG. 17 depicts a functional block diagram of an exemplary implementation of a wireless device which includes the capability of communicating with a payment device, according to embodiments of the present invention.

FIG. 18 depicts a flowchart of an exemplary method for measuring details related to user viewing of an advertisement and user response(s) to one or more viewed advertisements, according to embodiments of the present invention.

FIG. 19 depicts an exemplary Payment Receipt which a Retailer and/or wireless device can produce, according to embodiments of the present invention.

FIG. 20 depicts a flowchart of an exemplary method for comparing data stored in a wireless device and ad file table information, according to embodiments of the present invention.

FIG. 21 depicts exemplary ad data code and payment receipt, according to embodiments of the present invention.

FIG. 22 depicts a flowchart of an exemplary method for measuring if an user of a wireless device views an advertisement on a television, according to embodiments of the present invention.

FIG. 23 depicts a functional block diagram of an exemplary system for measuring the ROI of an advertisement transmitted to a television, according to embodiments of the present invention.

FIG. 24 depicts an exemplary system for measuring if an user of a wireless device views an advertisement transmitted to a television, according to embodiments of the present invention.

FIG. 25 depicts a flowchart of an exemplary method for measuring the ROI for an advertisement transmitted to a personal computer, according to embodiments of the present invention.

FIG. 26A depicts a functional block diagram of an exemplary system for measuring the ROI for an advertisement transmitted to a personal computer, according to embodiments of the present invention.

FIG. 26B depicts a functional block diagram of a specific embodiment of an exemplary system for measuring the ROI for an advertisement transmitted to a personal computer utilizing the payment functionality of a credit/debit card external to a wireless device, according to embodiments of the present invention.

FIG. 27 depicts an exemplary system for measuring if an user of a wireless device views an advertisement transmitted to a personal computer, according to embodiments of the present invention.

FIG. 28 depicts a flowchart of advertiser transmission of ad data code to a wireless device, according to embodiments of the present invention.

FIG. 29 depicts a flowchart of third party URL transmission of ad data code to a wireless device, according to embodiments of the present invention.

FIG. 30 depicts a flowchart of third party cookie method for transmission of ad data code to a wireless device, according to embodiments of the present invention.

FIG. 31 depicts a flowchart of a wireless device synchronization method for transmission of an ad data code to a wireless device, according to embodiments of the present invention.

FIG. 32 depicts a flowchart of a wireless device synchronization method for transmission of an ad data code to a wireless device, according to embodiments of the present invention.

FIG. 33 depicts a flowchart of a method for measuring whether a wireless device user views an advertisement at a search engine and determining if there is a match between an user response and an advertisement viewed by the user, according to embodiments of the present invention.

FIG. 34 depicts an exemplary system enabling an user of a wireless device equipped with one or more I-O Devices capable of recording an ad data code to record such code from an advertisement viewed in a print publication, e.g., a newspaper or magazine, according to embodiments of the present invention.

FIG. 35 depicts a flowchart of an exemplary method of how a payment module can measure and/or process data on any products purchased by a wireless device user, according to embodiments of the present invention.

FIG. 36 depicts a flowchart of a method for the generation and transmission of payment information by a retailer, according to embodiments of the present invention.

FIG. 37 depicts a flowchart of an exemplary method of enabling a retailer to transmit data measuring if the user of a wireless device purchased a product, according to embodiments of the present invention.

FIG. 38 depicts a flowchart of an exemplary method for transmitting a payment receipt to a wireless device in a HTML format for viewing by the web browser of wireless device, according to embodiments of the present invention.

FIG. 39 depicts a flowchart of an exemplary method of how an event handler module can measure the reception of a text message from a given media device, according to embodiments of the present invention.

FIG. 40 depicts a flowchart of an exemplary method of how a keypad module can measure user input data, according to embodiments of the present invention.

FIG. 41 depicts a flowchart of an exemplary method of how a mapping module can measure if a wireless device visits a physical retailer advertised, according to embodiments of the present invention.

FIG. 42 depicts an exemplary system for measuring if an user of a wireless device views an advertisement transmitted to and displayed on such wireless device, according to embodiments of present invention.

FIG. 43 depicts a flowchart of an exemplary method for processing the calculation of ROI for a television advertisement within URMA module, according to embodiments of the present invention.

FIG. 44 depicts a functional block diagram of an exemplary system for measuring user viewing of and response to advertisements using unique individual or device identifiers, according to embodiments of the present invention. FIG. 45 depicts a functional block diagram of a system enabling the exchange of Ad Data Codes, Payment Receipts, Ad Data Files, Payment Data Files, and/or Matching Event Files between an advertiser and one or more devices, according to embodiments of the present invention. FIG. 46 depicts a functional block diagram of a system enabling the exchange of Ad Data Codes, Payment Receipts, Ad Data Files, Payment Data Files, and/or Matching Event Files between an advertiser that is a financial institution with an ATM and one or more devices, according to embodiments of the present invention.

FIG. 47 depicts a functional block diagram of a system enabling the measurement of an user viewing of an advertisement and an user paying for a Product through a bill payment program on a Wireless Device 0120 or any Media Device 0110, according to embodiments of the present invention.

FIG. 48 depicts a flowchart of an exemplary method of enabling an advertiser to track if an advertisement delivered to any media device results in a sale in any retail channel using an unique wireless device code, according to embodiments of the present invention.

FIG. 49 depicts an exemplary system for enabling an advertiser to track if an advertisement delivered to a media device results in a sale in a retail channel using an unique wireless device code, according to embodiments of the present invention.

FIG. 50 depicts a flowchart of an exemplary method of enabling an advertiser to track if an advertisement delivered to any media device results in a sale in any retail channel using an existing unique ID code, according to embodiments of the present invention.

FIG. 51 depicts an exemplary system for enabling an advertiser to track if an advertisement delivered to any media device results in a sale in any retail channel using an existing unique ID code, according to embodiments of the present invention.

FIG. 52 depicts a flowchart of an exemplary method of enabling an advertiser to track if an advertisement delivered to any media device results in a sale at a retailer, where the retailer is the advertiser, according to embodiments of the present invention.

FIG. 53 depicts a flowchart of an exemplary method for a Wireless Device having a unique ID and/or existing unique ID code to transmit to a STB, wireless device Vicinity Data, according to embodiments of the present invention.

FIG. 54 depicts a flowchart of a method for associating a unique code with payment information, according to embodiments of the present invention.

FIG. 55 depicts a flowchart of a method for redeeming an electronic coupon to enable the ROI calculation for a given advertisement, according to embodiments of the invention.

FIG. 56 depicts a flowchart of a method for electronic receipt capture and/or retrieval, according to embodiments of the present invention.

FIG. 57 depicts a block diagram of an exemplary system for producing dynamic advertising, according to embodiments of the present invention.

FIG. 58 depicts a table of exemplary ad elements and element codes, according to embodiments of the present invention.

FIG. 59 depicts an exemplary table of user responses to different versions of a single element, according to embodiments of the present invention.

FIG. 60 depicts an exemplary process for converting a generic ad data code into an user specific ad data code, according to embodiments of the present invention.

FIG. 61 depicts a table of exemplary user reception of advertisements for a product over a specific time frame, according to embodiments of the present invention.

FIGS. 62A-D show examples of the generation of different User Response Scores based on characteristics of an advertisement, according to embodiments of the present invention.

FIG. 63 depicts a flowchart of an exemplary method for the dynamic production of advertisements, according to embodiments of the present invention.

FIG. 64 depicts a flowchart of an exemplary method of enabling an advertiser to measure the effect that one variable can have on the response of an user to an advertisement, according to embodiments of the present invention.

FIG. 65 depicts a flowchart of an exemplary method for enabling an advertiser to measure the effect of viewing an advertisement on different media devices, media programs, or media locations, according to embodiments of present invention.

FIG. 66 depicts a diagram comparing two advertisements which have the same features in every respect except for an independent variable, according to embodiments of the present invention.

FIG. 67 depicts an exemplary method of calculating the optimal price an Advertiser should be willing to pay for a given Media Location, according to embodiments of the present invention.

FIG. 68 depicts a diagram comparing the transmission of the same advertisement to Sample Group A and Sample Group B, each of which views the advertisement through different media devices, according to embodiment so the present invention.

FIG. 69 depicts an architecture of the DAPM in the case of producing one advertisement for transmission to a television or personal computer, according to embodiments of the present invention.

FIG. 70 depicts a block diagram of a data processing unit that can be used to implement the entities described herein.

FIG. 71 depicts a block diagram of an embodiment of a combination power charger and ad measurement apparatus for a television set-top box, according to embodiments of the present invention.

FIG. 72 depicts a functional block diagram of an exemplary system enabling the measurement if an advertisement transmitted to a personal computer or television leads to a sale in retail channel.

FIG. 73 depicts a flowchart of an exemplary method for measuring if an advertisement transmitted to a media device leads to a sale in any retailer, according to an embodiment of the present invention.

FIG. 74 depicts a functional block diagram of a system enabling an advertiser to measure if an user views an advertisement transmitted to any media device, e.g., a personal computer or television, according to an embodiment of the present invention.

FIG. 75 depicts a functional block diagram of a system enabling a retailer to measure if the user who viewed an advertisement purchases the product promoted in such advertisement, according to an embodiment of the present invention.

FIG. 76 depicts a functional block diagram of a system enabling the matching of a customer record with an advertisement record through ID) codes, according to an embodiment of the present invention.

FIG. 77 depicts a functional block diagram of a system enabling the testing of the effect of an independent variable on the ROI of a given advertisement, according to an embodiment of the present invention.

FIG. 78 depicts a diagram comparing the transmission of one advertisement to Sample Group A and another advertisement to Sample Group B, according to an embodiment of the present invention.

FIG. 79 depicts a flowchart of a method for testing the effect of an independent variable on the ROI of a given advertisement, according to an embodiment of the present invention.

The present application will now describe the present invention with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE INVENTION

### OUTLINE

1. Data Processing Unit

2. Measuring User Viewing of and Response to Advertisements
2.1 Architecture
   2.1.1 Advertisement Information
   2.1.2 Media Device & Wireless Device
      2.1.2.1 Media Devices
      2.1.2.2 Wireless Device
         2.1.2.2.1 I-O Devices
      2.1.2.3 User Response Measurement System (URMS)
         2.1.2.3.1 Ad Data Code Module & Payment Code Module
         2.1.2.3.2 Data Storage
         2.1.2.3.3 User Response Measurement Analysis
         2.1.2.3.4 Exemplary Implementation of URMS
      2.1.2.4 Multiple Media Channel Measurement System (MMCMS)
   2.1.3 Payment Architecture
2.2 Methods
   2.2.1 Examples
      2.2.1.1 Measurement of User Viewing Advertisement on Television Media Device
      2.2.1.2 Measurement of User Viewing Advertisement on Personal Computer Media Device
         2.2.1.2.1 Methods for Reception of Ad Data Code
2.2.1.2.1.1 Advertiser Transmission
2.2.1.2.1.2 Third Party URL Transmission
2.2.1.2.1.3 Third Party Cookie
2.2.1.2.1.4 Wireless Device Synchronization
2.2.1.2.1.5 Wireless Device Search
   2.2.1.2.2 Examples
   2.2.1.3 Measurement of User Viewing of and Response to Advertisement by Search Module
   2.2.1.4 Measurement of User Viewing Advertisement on Print Media Device
   2.2.1.5 Measurement of User Response to Advertisement by Payment Module
   2.2.1.6 Generation and Receipt of Payment Information
      2.2.1.6.1 Generation by Retailer
      2.2.1.6.2 Generation by Wireless Device
      2.2.1.6.3 Generation by Third Party Credit/Debit Card Vendor
      2.2.1.6.4 Electronic Ticket
   2.2.1.7 Measurement of User Response to Advertisement by Event Handler Module
   2.2.1.8 Measurement of User Response to Advertisement by Keyboard Module
   2.2.1.9 Measurement of User Response to Advertisement by Mapping Module
   2.2.1.10 General Measurement of Viewing
   2.2.2 Exemplary URMA processing
   2.2.3 Method for Analysis of Historical Database of Payment Information

3. Measuring User Consumption and/or Response to Advertising Using Individual or Device Identifiers
3.1 Architecture
   3.1.1 Exemplary Systems
3.2 Methods
   3.2.1 Unique Code
   3.2.2 Existing Unique ID Code
3.3 Examples
   3.3.1 Existing Unique ID
   3.3.2 Transmission of Vicinity Data to STB
   3.3.3 Association of Unique Code with Payment Information
   3.3.4 Electronic Coupon Redemption
   3.3.5 Electronic Receipt Capture and/or Retrieval
   3.3.6 Shopper Loyalty
3.4 Summary

4. Dynamic Production of Advertisements
4.1 Architecture
   4.1.1 Static Information
   4.1.2 Dynamic Information
   4.1.3 Feedback Information
4.2 Methods for Dynamic Production of Advertisements
   4.2.1 Overview
   4.2.2 Method for Dynamic Production of Advertisements
   4.2.3 Methods Testing Effect of Independent Variables
   4.2.4 Example
   4.2.5 Benefits

5. Example Implementations
5.1. Combination Power Charger and Ad Measurement Apparatus

6. Conclusion

A. Appendix A
A.1 Overview of Exemplary Implementation of Invention
A.2 Overall System of Exemplary Implementation
   A.2.1 Architecture
   A.2.2 Method
   A.2.3 Formats/Interfaces
A.3 Measurement of Advertisement Viewed
   A.3.1 PC Advertisement Measurement
      A.3.1.1 Local WD Program
      A.3.1.2 Local PC Program
   A.3.2 TV Advertisement Measurement
      A.3.2.1 Local WD Program
      A.3.2.2 Local STB Program
   A.3.3 Web Server Program
   A.3.4 Web DB Program
   A.3.5 Panel List Program
A.4 Measurement of Product Purchased
   A.4.1 Customer DB Program
A.5 Matching of Data
   A.5.1 Match Program
      A.5.1.1 Description
      A.5.1.2 Inputs
      A.5.1.3 Processing
         A.5.1.3.1 Algorithm
         A.5.1.3.2 Related Product Purchases
      A.5.1.4 Outputs
A.6 Analysis of Data
   A.6.1 Analysis Program
      A.6.1.1 Description
      A.6.1.2 Inputs
      A.6.1.3 Processing
         A.6.1.3.1 Algorithm
         A.6.1.3.2 Example
      A.6.1.4 Outputs

### 1. DATA PROCESSING UNIT

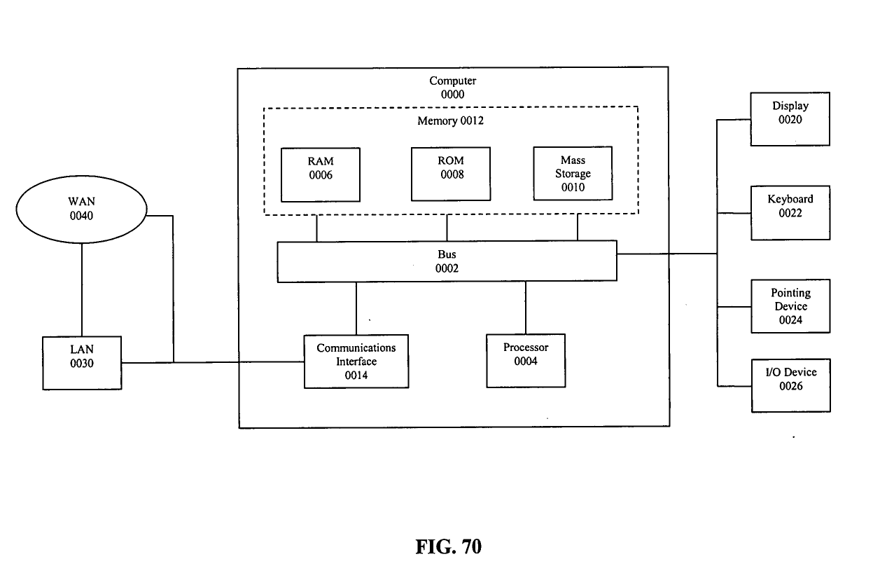

FIG. 70 depicts a block diagram of a Data Processing System 0000 that can be used to implement the entities described herein. It is noted that the entities described herein may be implemented using any number of data processing units and the configuration actually used is implementation specific.

A Data Processing System 0000 may represent any type of device which can process data, including, but not limited to: a personal computer, a portable computer, a hand-held computer, a personal digital assistant, a portable media device, a wireless device, a “smart card,” a server, a workstation, and/or a mainframe computer. The type of data processing device used to implement the entities described herein is implementation specific.

Any of these devices can communicate with each other utilizing any protocol over any network, including, but not limited to: HyperText Transport Protocol (HTTP), File Transport Protocol (FTP), Simple Mail Transport Protocol (SMTP), Post Office Protocol (POP), and/or Internet Mail Access Protocol (IMAP) over a network, e.g., the Internet.

Data Processing System 0000 can comprise one or more components, including, but not limited to: any communications medium, wired and/or wireless (e.g., a bus) 0002 or any other means of transmitting and/or receiving data among components; a general- or special-purpose Processor or any other means of processing data 0004; a Random Access Memory (RAM) Device 0006 coupled to Bus 0002 capable of storing data and instructions executed by Processor 0004 or temporary variables or other intermediate data during the execution of instructions by Processor 0004; a Read-Only Memory (ROM) Device 0008 coupled to Bus 0002 capable of storing data and instructions executed by Processor 0004; a Mass Storage Device 0010 (which can be a non-removable device, e.g., a hard disk drive, or a removable device, e.g., a floppy disk drive, a compact disc drive, a tape drive, a magneto-optical disc drive, or a chip, e.g., a chip as part of a subscriber identity module (SIM) card) coupled to Bus 0002 or Data Processing System 0000 capable of storing data and instructions executed by Processor 0004; a Display Device 0020 coupled to Bus 0002 or Data Processing System 0000 capable of displaying data to a computer user; a Keyboard Device 0022 coupled to Bus 0002 or Data Processing System 0000 capable of communicating data and/or enabling command selection to Processor 0004; a Pointing Device 0024 coupled to Bus 0002 or Data Processing System 0000 capable of communicating direction information and/or enabling command selection to Processor 0004; an I-O Device 0026 (which can enable any other type of input and/or output) coupled to Bus 0002 or Data Processing System 0000 capable of communicating direction information and/or enabling command selection to Processor 0004; and/or a Communications Interface 0014 coupled to Bus 0002 or Computer System 0000 capable of accessing other computers through a local area network (LAN) 0030 and/or a wide area network (WAN) 0032, e.g., the Internet. Processor 0004 can reside at a single physical location or be distributed across a multiple physical locations, e.g., on one client and one server. The present invention defines Memory 0012 to include any device coupled to Bus 0002 capable of storing data and/or instructions executed by Processor 0004, including, but not limited to: RAM Device 0006, ROM Device 0008, Mass Storage Device 0010, a data cache, a data object, and/or any other type of short-term or long-term storage device. While prior art typically refers to memory and storage separately, the present invention defines memory to include storage. Memory 0012 can reside at a single physical location or be distributed across multiple physical locations. The instructions can include code from any computer-programming language and/or scripts, including, but not limited to: C, C++, Basic, Java, JavaScript, Pascal, Perl, Smalltalk, Structured Query Language (SQL), VBScript, and/or Visual Basic. Communications Interface 0014 can include a modem, a network interface card, and/or any other device capable of coupling Data Processing System 0000 to any LAN 0030 and/or WAN 0032. Communications Interface 0014 can include an antenna enabling wireless communication utilizing any wireless protocol with LAN 0030 and/or WAN 0032. The present invention defines an Antenna to include any of the components necessary to transmit and/or receive an electromagnetic signal, e.g., a radio signal. Such components can include not only a physical material capable of conducting such a signal, but also any component which can perform any function needed to process such signal, including, but not limited to: modulation, demodulation, spreading, despreading, analog-to-digital (A/D) conversion, digital-to-analog (D/A) conversion, compression, decompression, upconversion, and/or downconversion. LAN 0030 and/or WAN 0032 can enable communication through a wired, wireless, or combination of wired and wireless signals. Keyboard 0022 can include any device enabling an user of Data Processing System 0000 to input any alphanumeric character, including, but not limited to a Keyboard connected to a Personal Computer, and/or a Keypad connected to or integrated with a Wireless Device. An I-O Device is any device attached to and/or integrated with a Data Processing System 0000 which can enable such system to communicate with another device.

Computer program product interfaces are devices that access objects (such as information and/or software) stored in computer program products. Examples of computer program product interfaces include, but are not limited to, floppy drives, CD drives, DVD drives, ZIP drives, JAZ drives, optical storage devices, etc.

Data Processing System 0000 can implement any or all of the steps of the methods described herein through programmable logic, hard-wired logic, any combination of programmable and hard-wired logic, or any other type of logic.

Control logic or software may be stored in Memory 0012 and/or computer program products. In one embodiment, Data Processing System 0000 can have Processor 0004 or multiple Processors 0004 execute one or more instructions stored in RAM 0006. RAM 0006 can retrieve the instructions from any other Computer/Machine Readable/Accessible Medium, e.g., Mass Storage 0010. In another embodiment, Data Processing System 0000 can have Processor 0004 or multiple Processors 0004 execute one or more instructions that are predefined or hard-wired. In another embodiment, Data Processing System 0000 can have Processor 0004 or multiple Processors 0004 execute one or more instructions utilizing a combination of programmable and hard-wired logic.

In one embodiment, the steps in any of the present methods are embodied in machine-executable instructions. The present invention can process instructions using one or more techniques, including, but not limited to: utilizing one or more general- or special-purpose processors programmed with the instructions to execute the steps in any of the present methods, equivalent or related steps, other or additional steps, or any subset thereof; utilizing one or more hardware components that contain hardwired logic to execute the steps in any of the present methods, equivalent or related steps, other or additional steps, or any subset thereof; or utilizing any combination of programmed processors and/or hardware components to execute the steps in any of the present methods, equivalent or related steps, other or additional steps, or any subset thereof. The software can execute on any type of hardware located at or distributed among any entity, including, but not limited to: an Advertiser, a Media Operator, a Media Device, a Wireless Device, a Retailer, or a Third Party.

In general, a “computer program product” comprises any of the functions enabling the execution of the methods described in the present invention. When loaded in a Data Processing System 0000, in general, or a Computer/Machine Readable/Accessible Medium, in particular, a computer program product can execute the functions of the present invention as described herein and cause a computer, general- or special-purpose processor, and/or other hardware to execute any of the steps described herein.

The computer- or machine-readable or -accessible medium can include, but is not limited to: floppy disks, magnetic disks, optical disks, magneto-optical disks, CD-ROMs, ROM, RAM, programmable read-only memory (PROM), erasable programmable read-only memory (EPROM), electrically erasable programmable read-only memory (EEPROM), magnetic or optical cards, or any other type of media or computer- or machine-readable or -accessible media capable of storing instructions (“Computer/Machine Readable/Accessible Medium”).

The functionality described herein can be distributed and/or downloaded as a computer program product. Methods described herein can be distributed from a remote computer, e.g., a server, to another computer, e.g., a client, through any wired and/or wireless channel over a network, e.g., the Internet.

### 2. MEASURING USER VIEWING OF AND RESPONSE TO ADVERTISEMENTS

At a high level, a system for measuring user viewing of and response to advertisements includes an user response measurement system (URMS) and multiple media channel measurement system (MMCMS). First, the URMS is a system for measuring if, through what media device, when, and/or where a wireless device user views an advertisement and/or if, when, how, and/or to what degree such user responds to the advertisement. As used herein, the present invention defines viewing as any activity where an user receives and/or transmits an advertisement and/or media program, including, but not limited to: reading, seeing, hearing, touching, smelling, interacting in any other manner, or any combination thereof, an advertisement and/or media program. The URMS can be a system that focuses on measuring if, through what media device, when, and/or where a wireless device user views an advertisement and interoperates with another system measuring if, when, how, and/or to what degree the user responds to such advertisement. Alternatively, the URMS can be a system that focuses on measuring if, when, how, and/or to what degree the user responds to an advertisement and interoperates with another system measuring if, through what media device, when, and/or where the user views an advertisement. Second, the MMCMS is a system and related methods for a wireless device to measure if, through what media device, when, and/or where a wireless user views an advertisement distributed through any media channel.

The URMS can incorporate data collected by the MMCMS to measure if, through what media device, when, and/or where a wireless user views an advertisement through any media channel. The present invention, in particular the URMS and MMCMS, addresses one of the main objectives of advertisers, i.e., measuring how an user actually responds to an advertisement, elements of an advertisement, and/or versions of an element, rather than trying to determine an user's preferences of the advertisement, elements, and/or versions by asking them to take some explicit action. By recording how an user responds to advertisements and/or aggregating the preferences of groups of users, the URMS and MMCMS can measure the advertising preferences of users.

### 2.1 ARCHITECTURE

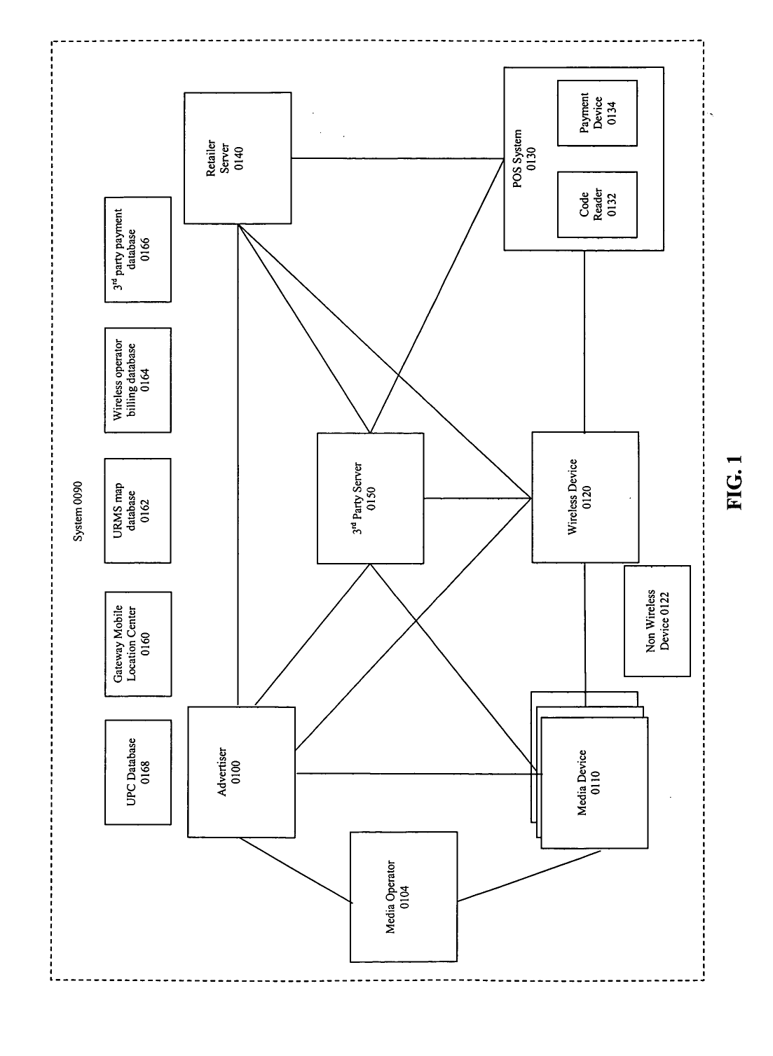

FIG. 1 depicts a high-level functional block diagram of a System 0090 enabling an advertiser to track user viewing of and/or response to an Advertisement, according to embodiments of the present invention. System 0090 may include one or more Advertiser Systems 0100, one or more Media Operators 0104, one or more Media Devices 0110, one or more Third Party Servers 0150, one or more Wireless Devices 0120, one or more Point-Of-Sale Systems 0130, and/or one or more Retailer Servers 0140.

In one embodiment, Advertiser System 0100 is one or more Data Processing Systems or servers that can transmit either directly or indirectly through a Media Operator 0104 an Advertisement and/or Ad Data Code 0200 to Media Device 0110 and/or receive data from such Media Device 0110. In another embodiment, Advertiser System 0100 is configured to provide Advertisements and/or associated Ad Data Codes 0200 directly to Wireless Device 0120 and/or Non-Wireless Device 0122 and/or receive data from such devices. Advertisements and Ad Data Codes 0200 are described in further detail in Section 2.1.1 below.

In one embodiment, Wireless Device 0120 transmits information (e.g., an user response score) to an Advertiser System 0100 through a variety of methods, including, but not limited to: transmitting the information through a wireless connection, e.g., Antenna 0322 or Antenna 0324 to Wireless Base Station 0302 for transmission through the Public Switched Telephone Network (PSTN) and/or a WAN, e.g., the Internet, to Advertiser System 0100; and/or transmitting the information through a wired connection, e.g., Synchronization Device 0326 to a Personal Computer 0308 or Television 0304 for transmission through the Internet and/or PSTN to Advertiser System 0100. Wireless Device 0120 can transmit the information to Advertiser System 0100 through the browser of Wireless Device 0120, the email application of Wireless Device 0120, the text messaging application of Wireless Device 0120, or any other means of transmitting information that will be readily apparent to any person with ordinary skill in the art.

Advertiser System 0100 is operated by or on behalf of one or more Advertisers. An Advertiser is any entity that produces, distributes, and/or sells an Advertisement and/or finances the production, distribution, and/or sale of an Advertisement. An Advertiser can include, but is not limited to: the vendor of the goods and/or services, including retailing services (collectively “Products”) advertised; an advertising agency and/or production company that produces an Advertisement on behalf of the Advertiser; a media planning and/or buying company that purchases and/or distributes advertising on behalf of the Advertiser; the media channel, e.g., a television network or web site that distributes an Advertisement; and/or a Third Party. While one or more servers that can constitute Advertiser System 0100 may be owned or operated by a Third Party, e.g., a Web hosting vendor, the present invention still defines Advertiser System 0100 as operated by or on behalf of one or more Advertisers as long as Advertiser System 0100 can transmit an Advertisement.

Media Device 0110 is any Data Processing System that can display an Advertisement and/or transmit Ad Data Code 0200 to Wireless Device 0120 and/or Non-Wireless Device 0122. Media Devices 0110 are described in further detail in Section 2.1.2 below.

Wireless Device 0120 is a Data Processing System that is configured to receive and/or transmit through a wireless connection, store, and/or process any type of data, including, but not limited to, text, voice, audio, music, image, animation, video, or any combination thereof. In another embodiment, a Wireless Device 0120 can receive from and/or transmit to a Media Device 0110 data through a wired connection, e.g., a universal serial bus (USB) cable.

Wireless Device 0120 is configured to measure if the user of the Wireless Device 0120 views an Advertisement on Media Device 0110 and/or purchases a Product promoted in the Advertisement (e.g., at Point-Of-Sale System 0130).

In one embodiment, the Wireless Device 0120 can include a Portable Media Device and non-Portable Media Devices. A Portable Media Device is a Data Processing System that can receive and/or transmit through a wired and/or wireless connection, store, process, and/or play any type of media, including, but not limited to, text, voice, audio, music, image, animation, video, or any combination thereof. Examples of the device can include, but are not limited to: a portable music player (e.g., MP3 player); a portable video player; a portable text player, a portable video game player; personal digital assistants and/or a portable player capable of receiving, transmitting, storing, processing, and/or playing any media.

The portion of the system illustrating Media Devices 0110 and Wireless Device 0120 is described in further detail in Section 2.1.2 below.

Non-Wireless Device 0122 is a Data Processing System configured to measure viewing of an Advertisement and/or response by an Advertisement by an user. Non-Wireless Device 0122 can include one or more I-O Devices and an URMS 0350. For example, Non-Wireless Device 0122 may include one or more of the I-O Devices described in Section 2.1.2.2.1 below. For example, Non-Wireless Device 0122 can be a Personal Computer which an user cannot take with him or her when the user changes geographical location with: (a) a wired connection to a network, e.g., the Internet, including, but not limited to: a cable modem, digital subscriber line modem, or a broadband power line modem; and/or (b) a wireless connection to a network, e.g., the Internet, including, but not limited to: any wireless protocols described herein.

Point-Of-Sale (POS) System 0130 is a Data Processing System configured to execute the sale of one or more Products. In one embodiment, POS System 0130 is operated by a Retailer. If the Retailer is a physical retailer, POS System 0130 may comprise an optional Code Reader 0132 and/or a Payment Device 0134.

Code Reader 0132 is a Data Processing System configured to read data from a Wireless Device 0120, an user of Wireless Device 0120, and/or the individual whose viewing of an Advertisement and responses, including, but not limited to, purchasing of Products promoted in the Advertisement and/or Intermediate Response to the Advertisement an Advertiser wishes to track (“Target Customer”). The Target Customer can include an individual who does not use a Wireless Device 0120. The present invention discusses in Section 3 systems, methods, apparatuses, and computer program products enabling an Advertiser to measure viewing of an Advertisement and/or the purchase of Products promoted in the Advertisement without using a Wireless Device 0120. Code Reader 0132 can be either fixed or mobile. Code Reader 0132 can read any data transmitted from Wireless Device 0120 as well as data from a barcode, a string of characters which can be converted into a barcode, or any other form of data. Code Reader 0132 can read data from any Data Processing System, including, but not limited to: a Smart Card, and/or Wireless Device 0120. In another embodiment, Code Reader 0132 can read data from any non-Data Processing System, including, but not limited to: Products; and/or codes embedded in a paper-based check, e.g., a check reader utilized by some Retailers.

Payment Device 0134 is a Data Processing System configured to exchange data with a device, (e.g., a Smart Card or Wireless Device 0120) utilizing any wired and/or wireless standard. In one embodiment, Payment Device 0134 can exchange data with any device (e.g., Wireless Device 0120) utilizing any contactless standard, which can include, but is not limited to, near field communications (NFC). In one embodiment, Payment Device 0134 includes a NFC Device 1400 that can exchange data between Payment Device 0134 and Wireless Device 0120. In another embodiment, Payment Device 0134 can exchange data with any device (e.g., Wireless Device 0120) utilizing any short-range wireless standard (described in Section 2.1.2.2.1), which can include, but is not limited to, Bluetooth, HomeRF, IEEE 802.11, IEEE 802.15.3a or ultra wideband (UWB), infrared, wireless IEEE 1394, or Wireless USB. In the present embodiment, Payment Device 0134 can exchange data between Payment Device 0134 and Wireless Device 0120 by utilizing any device, including, but not limited to, Infrared Device or Transceiver 0330, Bluetooth Antenna 0324, radio frequency identification (RFID) Antenna 0334, NFC Antenna 0338, and/or I-O Device 0339.

NFC Antenna 0338 is any device that can enable a device, e.g., a Wireless Device 0120, to exchange data wirelessly with another device utilizing standards including, but not limited to: the NFC standard (ISO 18092, ISO 21481, ECMA (340, 352, and 356), ETSI TS 102 190, and any equivalent or successor standards. In another embodiment, such device can include any other device able to exchange data wirelessly with another machine utilizing any other contactless standards, i.e., any standard enabling wireless data exchange over very short distances (or even in physical contact) and in an unregulated RF band, e.g., 13.56 MHz. These other standards can include, but are not limited to: ISO 14443 for contactless integrated circuit proximity cards, ISO 15693 for contactless integrated circuit vicinity cards, or any equivalent or successor standard to ISO 14443, ISO 14443A/B, ISO 15693, ISO 18092, ISO 21481, ECMA (340, 352, and 356), or ETSI TS 102 190.

In another embodiment, POS System 0130 can include the capability of reading any type of form, either electronic- or non-electronic-based, that can include data indicating the purchase of a Product. Exemplary forms include, but are not limited to: a paper-based check issued by a financial institution enabling the withdrawal of funds from an account at the financial institution; an electronic-based check issued by a financial institution enabling the withdrawal of funds from an account at the financial institution; and/or a form issued by an Advertiser and/or a Third Party financing the purchase of a Product offered by Advertiser, which is executed by an user of Wireless Device 0120 and/or the Target Customer, e.g., a loan document executed by the user and/or Target Customer. POS System 0130 can read the data on a form that is electronic-based, e.g., where an automobile dealer can input into a Personal Computer the name and/or other personally identifiable information about the user of Wireless Device 0120 and/or the Target Customer. POS System 0130 can read the data on a form that is non-electonic-based, e.g., by electronically scanning a check written by the user of Wireless Device 0120 and/or the Target Customer utilizing any method readily apparent to any person with ordinary skill in the art, or electronically scanning a paper-based form into a scanner for conversion into digital form that can be read by a Personal Computer.

In another embodiment, POS System 0130 can include the capability of enabling an user of Wireless Device 0120, the Target Customer, and/or an individual operating POS System 0130 to input into any I-O Device of such POS System 0130 the name and/or other personally identifiable information about the user of Wireless Device 0120 and/or the Target Customer. In the present embodiment, POS System 0130 can be a device that includes, but is not limited to: an automated teller machine (ATM); a Personal Computer with a Keyboard Device 0022 into which the user of Wireless Device 0120, the Target Customer, and/or an individual operating POS System 0130 can input such data; and/or a Personal Computer with a touch-sensitive Display on which the user of Wireless Device 0120, the Target Customer, and/or an individual operating POS System 0130 can input such data.

By enabling the reading of any type of form, either electronic- or non-electronic-based and/or inputting of any type of data, the present invention can expand the scope of Products whose purchases can be measured in response to an Advertisement to those Products which consumers typically purchase with means other than a credit/debit card. For example, most consumers purchase an automobile by making a down payment in the form of a check or executing a loan with a financial institution.

In an online retailer, POS System 0130 can comprise one or more components, including, but not limited to, Payment Device 0134, which can exchange payment data through any network, e.g., the Internet, with any device, e.g., Wireless Device 0120 through an Internet connection, or Personal Computer 0308 or STB 0500 through an Internet connection.

POS System 0130 can exchange data with Retailer Server 0140 through a wired and/or wireless connection.

Retailer Server 0140 is a Data Processing System configured to transmit to, receive from, and/or process information received from a POS System 0130. A Retailer and/or a Third Party can operate Retailer Server 0140. In general, a Retailer is an entity that can sell a Product to an user through any Retail Channel. A Retail Channel is any type of channel through which an user can purchase a Product, including, but not limited to: a physical retailer, which is any entity that can sell a Product at a physical location, examples of which can include, but is not limited to: a supermarket, a mass merchandiser, a drugstore, a dealer (e.g., an automobile dealer), a manufacturer (e.g., a company that owns and/or operates a store that sells Products it manufactures), an outlet store, a store which can sell services, a financial institution (e.g., a bank branch or ATM), and/or a movie theater; an online retailer; a purchase order made through a phone call, e.g., a toll-free telephone number; or physical delivery of a purchase order, e.g., mail-order.

In one embodiment, Retailer Server 0140 includes one or more databases. In one embodiment, Retailer Server 0140 includes one or more of the following databases: a Price Lookup (“PLU”) Database, a Transaction Database, and/or a Customer Database. As would be appreciated by persons of skill in the art, Retailer Server 0140 may include or access other databases, as required.

The portion of the system illustrating POS System 0130 and Retailer Server 0140 is described in further detail in Section 2.1.3 below.

Third Party Server 0150 is a Data Processing System configured to exchange data with any device in the present invention, including, but not limited to: Media Device 0110, Wireless Device 0120, POS System 0130, Retailer Server 0140, and/or Advertiser System 0100. The data can include, but is not limited to Ad Data Codes 0200, Payment Receipts 1900, Ad Data File 0734, Ad Reception File 0736, Ad Response File 0738, Payment Data File 0740, and/or Matching Event File 0742. Any device can initiate a transmission of the data to Third Party Server 0150 and/or Third Party Server 0150 can initiate a request for the data from any device. Third Party Server 0150 can exchange the data on any schedule, including, but not limited to: whenever Wireless Device 0120 records an user viewing of an Advertisement; whenever Wireless Device 0120 records an user purchase of a Product promoted in the Advertisement; and/or at a regular schedule.

In one embodiment, a Third Party can operate Third Party Server 0150. Unless otherwise noted, the present invention refers to a Third Party as an entity that is not an Advertiser, Media Operator 0104, or a Retailer which can receive, process, store, and/or transmit data recording the viewing by an user of an Advertisement transmitted to any Media Device 0110 and/or the purchasing by the user of the Product promoted in the Advertisement in any Retail Channel.

UPC Database 0168 includes descriptive data associated with Products. The descriptive data can be any format, including, but not limited to, Universal Product Code (UPC), European Article Numbering (EAN) system, Global Trade Identification Number (GTIN), or any other format. Wireless Device 0120 can access UPC Database 0168 when such Device requires additional descriptive information. A variety of parties can operate UPC Database 0168, which parties can include, but are not limited to, the vendor of the Product advertised, the Retailer of the Product advertised, the wireless operator providing wireless service to Wireless Device 0120, and/or an industry standards group.

The present invention can implement any of the databases described herein entirely in hardware, entirely in software, and/or any combination of software and/or hardware. An user at an Advertiser can access data stored in one or more of the databases described herein through any client, which can be any Data Processing System 0000. Advertiser System 0100, Third Party Server 0150, Retailer Server 0140, or any other server can serve on request any data from one or more of the databases to any user utilizing any method readily apparent to any person with ordinary skill in the art.

One or more of the databases described herein can support structured and/or unstructured data based on extensible Markup Language (XML) or any equivalent or successor language. The present invention can enable an Advertiser System 0100 and/or Third Party Server 0150 utilizing any method readily apparent to any person with ordinary skill in the art to extract, clean, transform, and/or summarize data from any database to load data into a data warehouse and/or integrate such data into an enterprise database system. For example, an Advertiser System 0100 can analyze data from one or more Retailer Servers 0140 and extract, clean, transform, and/or summarize data from any Transaction Database in such servers to load such data into a data warehouse, which an user at an Advertiser System 0100 can more easily access utilizing any online analytical processing (OLAP) and data mining tools readily apparent to any person with ordinary skill in the art.

A Media Operator 0104 is any entity that operates, distributes, and/or transmits a Media Program to any Media Device 0110, including, but not limited to: a Television 0304, whose means of receiving an Advertisement can include, but is not limited to, terrestrial broadcasting, satellite broadcasting, or any other means of wireless transmission, and/or wired transmission, e.g., cable, telephony, or utility; a Radio 0306, whose means of receiving an Advertisement can include, but is not limited to, terrestrial broadcasting, satellite broadcasting, or wired transmission; a Personal Computer 0308, whose means of receiving an Advertisement can include wired and/or wireless networks utilizing any type of protocol, e.g., Internet Protocol (IP); a Wireless Device 0120 or Wireless Device 0316; a Portable Media Player; an Outdoor Media Device 0310; a Print publication 0312; and/or Product Package 0314. A Media Operator 0104 can sell and/or lease a Media Location to any Advertiser. For example, the present invention defines a Media Operator 0104 which can operate a server that can transmit a Media Program and/or an Advertisement to a Personal Computer 0308 or any other Media Device 0110 utilizing any type of protocol, e.g., IP, as an Internet Operator.

Throughout the present application, the systems, methods, apparatuses, and/or computer program products typically teach how an Advertiser can transmit an Advertisement to a Media Operator 0104, which can then transmit the Advertisement to a Media Device 0110 for viewing by an user of Wireless Device 0120 and/or a Target Customer. The present application does not intend to limit the present invention or any of its systems, methods, apparatuses, and/or computer program products to the specific embodiment, but can include any embodiment which enables the transmission of an Advertisement to an user of Wireless Device 0120, an user of any Media Device 0110, and/or a Target Customer, including, but not limited to: an Advertiser transmitting the Advertisement directly to a Media Device 0110 for viewing by an user of Wireless Device 0120 and/or a Target Customer; an Advertiser transmitting the Advertisement directly to a Wireless Device 0120; an Advertiser transmitting the Advertisement to a Third Party, which can transmit the Advertisement to a Media Device 0110 for viewing by an user of Wireless Device 0120 and/or a Target Customer; an Advertiser transmitting the Advertisement to a Third Party, which can transmit the Advertisement directly to a Wireless Device 0120; an Advertiser transmitting the Advertisement to a Retailer, which can transmit the Advertisement directly to a Wireless Device 0120; and/or an user of any Media Device 0110 or Wireless Device 0120 transmitting the Advertisement to another user of any Media Device 0110 or Wireless Device 0120 (e.g., an user transmitting the Advertisement as an attachment to an email, instant message, or text message). The present invention can include any embodiment enabling the transmission of an Advertisement to an user of Wireless Device 0120, an user of any Media Device 0110, and/or a Target Customer regardless of whether the Advertiser initiates the transmission of such Advertisement (e.g., in an email to an user or in a broadcast to a Television 0304) or the user initiates the reception of such Advertisement (e.g., where an aggregator in a Wireless Device 0120 or Media Device 0110 initiates a web feed utilizing Really Simple Syndication (RSS), Atom, and/or any other equivalent or successor syndication specification.

A Media Program is any type of content provided by or property operated by a given Media Operator 0104 in which an user can view an Advertisement. The content or property can include, but is not limited to: (1) static content (which does not change over the time period viewed by an user) provided or distributed by a Media Operator 0104, e.g., a web page including information about diabetes provided by an Internet Operator, a web page including information associated with a given keyword generated by an Internet search engine, an email delivered by an Internet Operator, a text message delivered by a Wireless Operator, or a page in a newspaper or magazine about diabetes published by a Newspaper or Magazine Operator, respectively; (2) dynamic content (which can change over the time period viewed by an user) provided or distributed by a Media Operator 0104, e.g., a television program on baseball provided by a television network, a video program or podcast on baseball provided by an Internet Operator, or an audio program on baseball provided by a Radio Operator; or (3) any combination of static and dynamic content provided or distributed by a Media Operator 0104, e.g., a web page including both static and dynamic content.

A Media Location is any slot in which a Media Operator 0104 can place an Advertisement with any dimension, including, but not limited to: space, time, embedded, any other dimension, or any combination thereof. A space slot can include, but is not limited to: a Web page; a section of a Web page; a keyword utilized by a search engine; a word utilized in Internet content, e.g., a news story; a section of a screen in a Television Advertisement; a page in a Print publication; a section of a page in a Print publication; an insert in a Print publication; or a section of Product Package. A time slot can be any period of time in which a Media Operator 0104 can place an Advertisement. The time slot can be as short as a few seconds to as long as an entire Media Program, e.g., where a Media Operator 0104 can lease for an “infomercial” a block of time typically reserved for an entire Media Program. An embedded slot can include, but is not limited to: the display of a Product in a Media Program or what is commonly referred to as “product placement.” A combination space-time slot can include, but is not limited to: a space slot that is available for a certain period of time, e.g., a rotating Advertisement available to different Advertisers over time. An exemplary space-time slot can be a single Outdoor Media Device 0310 that displays one Advertisement for one time period and then displays another Advertisement for another time period.

### 2.1.1 ADVERTISEMENT INFORMATION

Advertisement information includes an Advertisement and/or its associated Ad Data Code 0200. An Advertisement is any type of content aimed at persuading an user to buy Products and/or any means of promoting a Product utilizing any data type, including, but not limited to, text, audio, music, image, video, animation, or any combination thereof. The Advertisement can be in electronic or non-electronic form. An Advertisement can be a separate or discrete program or file or embedded in another program or file. For example, an Advertisement can be a separate 30-second Television Advertisement promoting a specific Product or the use and/or display of the Product in embedded in a television program, i.e., product placement. A product placement can be the use and/or display of a product in any form of content, including, but not limited to, an article that includes a reference to the Product, a radio program that includes a reference or describing the use of the Product, a television program in which the Product is used and/or displayed, a film in which the Product is used and/or displayed, or a video game in which the Product is used and/or displayed. An Advertisement can include, but is not limited to, a keyword, key phrase, text link, image link, audio link, video link, banner, button, audio file, animation file, video file, or any combination thereof.

An Advertisement can also be the use of the Product by an endorser. For example, an Advertisement can be an item of apparel worn by an athlete while performing featuring the trademark of a provider of a Product. An Advertisement can promote a Product, brand, and/or company. An Advertisement may provide incentives for an user to buy a Product, e.g., a coupon. The user may be a consumer or a business, i.e., the trade. The Product may be a good, including a digital good like music in the form of an electronic file or a non-digital good like an automobile, or a service, like a checking account or a restaurant.

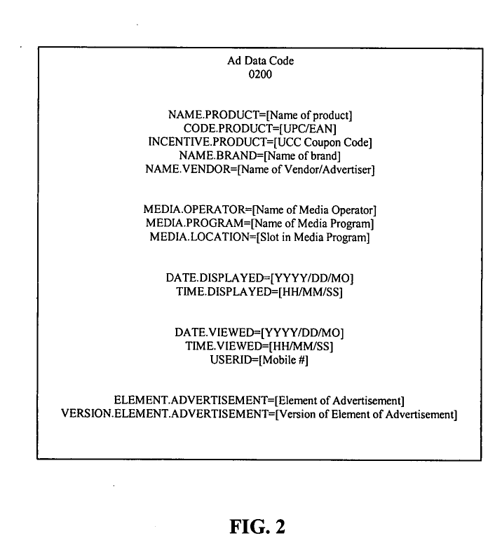

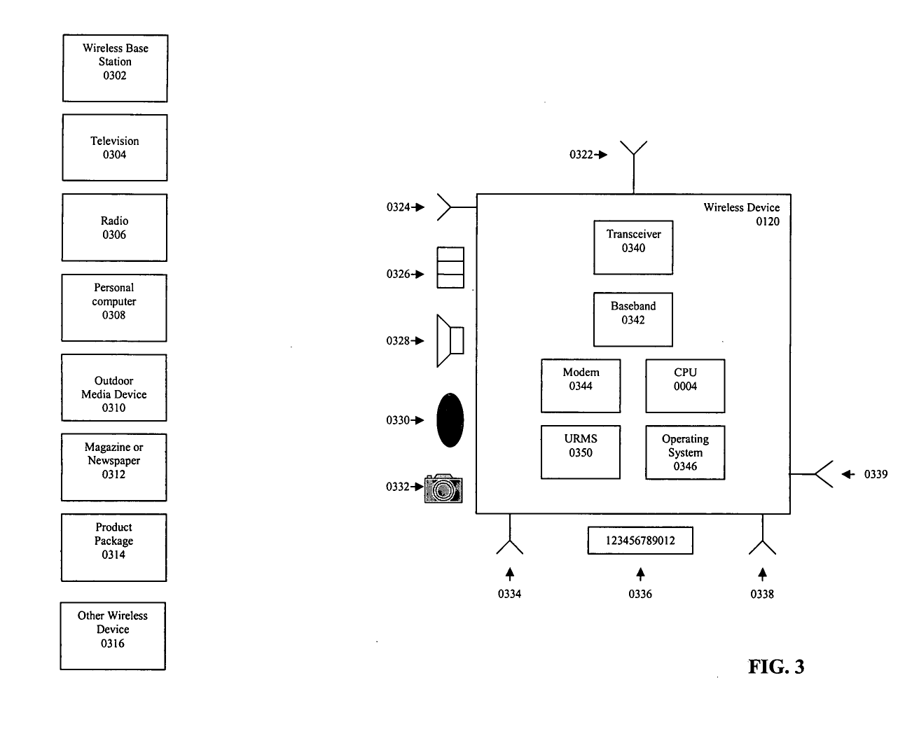

Ad Data Code 0200 is information provided by an Advertiser describing the characteristics of an Advertisement that would enable any system, method, apparatus, and/or computer program product, e.g., a Wireless Device 0120, to measure if, when, how, and/or to what degree an user responds to the Advertisement. FIG. 2 depicts exemplary Ad Data Code 0200. Ad Data Code 0200 can include other data not pictured in FIG. 2 like the category of the Product advertised. For example, the Advertiser field can describe not only the Product by its name, e.g., the title of a book, but also the category of the Product, book, or the sub-category of the Product, comedy book.

In one embodiment, a group of Advertisers through a formal group like an industry association, through an informal group, or through advertising agencies can determine the format of Ad Data Code 0200 (“Open Format Standard”). To enable the present invention to match a value in Ad Data Code 0200 with a value in any other type of data, e.g., a Payment Receipt 1900, a computer program product that is part of System 0090 can process such Ad Data Code 0200 in a manner consistent with the Open Format Standard.

In another embodiment, each Advertiser can determine the format of Ad Data Code 0200 in any manner it wishes (“Proprietary Format Standard”). To enable the present invention to match a value in Ad Data Code 0200 with a value in any other type of data, e.g., a Payment Receipt 1900, an Advertiser producing an Ad Data Code 0200 utilizing a Proprietary Format Standard can utilize any type of file that defines how a computer program product can process an Ad Data Code 0200. The present invention can support any type of such file, including, but not limited to:

In one embodiment, the present invention can utilize a file that can define the content of any file, e.g., Ad Data Code 0200, and how a computer program product can process such content (“Document Format Definition” or DFD). An Advertiser transmitting an Ad Data Code 0200 can transmit a DFD as part of the Ad Data Code 0200 or transmit a DFD separately from Ad Data Code 0200. Any computer program product that is part of System 0090 can read a DFD to determine how to process an Ad Data Code 0200 produced consistent with any Proprietary Format Standard. The DFD can have the capability to perform the same or similar functions as a Document Type Definition (DTD) in XML.

In another embodiment, the present invention can utilize a DTD to define the content of any file, e.g., Ad Data Code 0200, and how a computer program product can process such content if an Advertiser produces Ad Data Code 0200 utilizing XML.

In another embodiment, the present invention can utilize any file developed by an Advertiser to define the content of any other file, e.g., Ad Data Code 0200, and how a computer program product can process such content.

The format of Ad Data Code 0200 can include any type of attributes, e.g., name-value pairs where the code includes the name of each variable and a value for such variable. For example, the name of a variable can be the name of the Product, e.g., NAMEPRODUCT. An Advertiser can then assign to the variable the name of the Product promoted in a given Advertisement described by an Ad Data Code 0200. In another embodiment, an Advertiser can include the values without assigning each value to a variable. Advertiser can generate Ad Data Code 0200 in any format for transmission to any Media Device 0110 and/or Wireless Device 0120. The format can include, but is not limited to: rich text format (RTF), text ANSI (TXT ANSI), text Unicode (TXT Unicode), hypertext markup language (HTML), XML, portable document format (PDF), Microsoft Word (DOC), Microsoft Excel (XLS), and/or Word for Macintosh Document (MCW).

An Ad Data Code 0200 is a type of data which can be read by a machine, including, but not limited to, data: (1) at least similar to the data utilized by Advertisers and/or Retailers to identify the Product promoted in the Advertisement, which can include, but are not limited to: (a) the name of the Product; and/or (b) the unique code utilized by Advertisers and/or Retailers to identify the Product, which can include, but is not limited to: (i) the UPC, e.g., UPC-A, UPC-E, and/or any successor standard; (ii) the EAN, e.g., EAN-8, EAN-13, and/or any successor standard; (iii) Japanese Article Numbering (JAN); (iv) the Uniform Code Council (UCC) Coupon Code, EAN In-Store Coupon Code, other country/region corresponding version, and/or any successor standard; (v) Reduced Space Symbology (RSS), including, but not limited to: RSS-14, RSS-14 Stacked, RSS-14 Stacked Omnidirectional, RSS Expanded, RSS Expanded Stacked, RSS Truncated, and/or RSS Limited; (vi) Code 39; (vi) CodaBar; (viii) Interleaved 2 of 5; (vix) Discrete 2 of 5; (x) Code 93; (xi) Code 128; (xii) EAN/UCC 128; (xiii) POSTNET; (xiv) Facing Identification Mark (FIM); (xv) British Post Office 4 State Code (BPO 4 State Code); (xvi) Portable Data File 417 (PDF417); (xvii) QR Code; (xviii) Data Matrix; (xvix) MaxiCode; (xx) Aztec Code; (xxi) MSI/Plessey; (xxii) the GTIN and/or any successor standard; (xxiii) any stock keeping unit (SKU) or other number assigned to a Product by Advertiser and/or Retailer; and/or (xxiv) any Attribute for a given unique code, e.g., certain Products like apparel items typically use Attributes to distinguish different characteristics or styles of a given Product; and/or (2) data uniquely identifying the Advertisement promoting the Product.

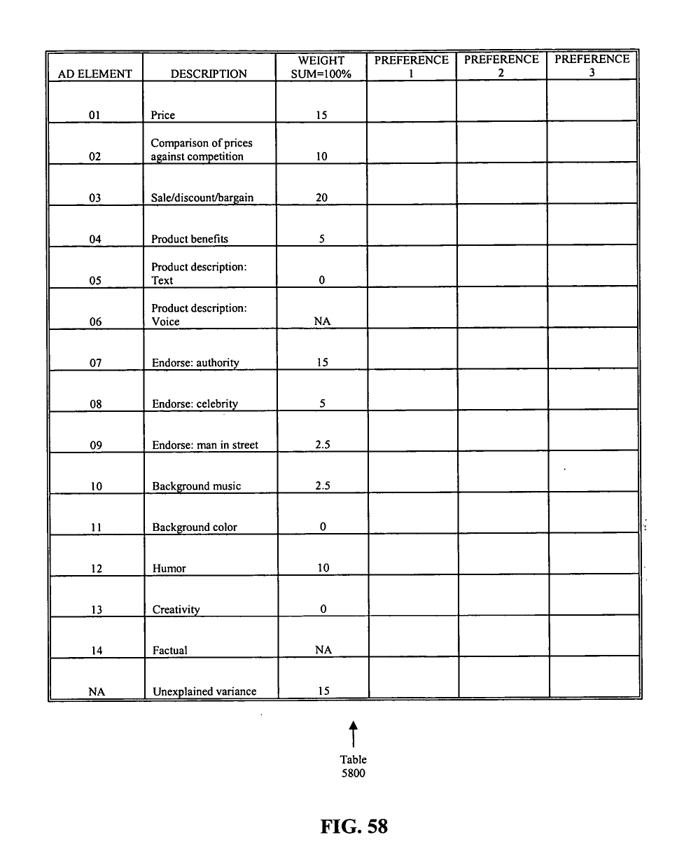

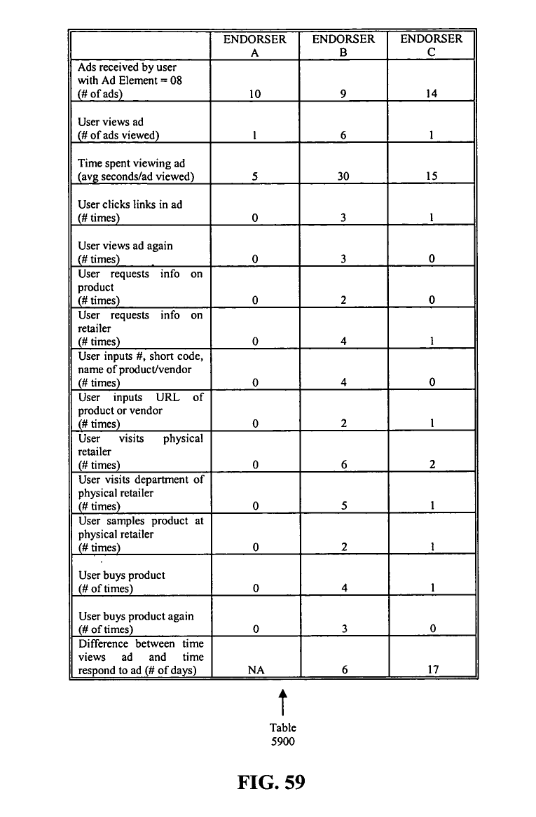

In another embodiment, Ad Data Code 0200 can be any additional type of data, including, but not limited to: data identifying the Media Program in which an Advertiser placed the Advertisement; data identifying the Media Location in which an Advertiser placed the Advertisement; data providing an user an incentive, including, but not limited to, a coupon, rebate, or other form of economic incentive (collectively, “Response Incentive”), to respond to the Advertisement, which responses can include, but are not limited to: (a) any Intermediate Response; and/or (b) any purchase of the Product; data describing any Element of an Advertisement, as described in FIG. 58; and/or data describing any Version of any Element of an Advertisement, as illustrated in FIG. 59.

An Intermediate Response is any action by an user in response to viewing an Advertisement short of buying the Product promoted in the Advertisement. These actions can include, but are not limited to: searching for the Product advertised, obtaining information about the Product, searching for a Retailer which sells the Product, visiting a Retailer which sells the Product, visiting a department within a Retailer which sells the Product, reading the package of the Product, and/or sampling the Product.

The unique code utilized by Advertiser and/or Retailers can be in any form or data type, including, but not limited to: a barcode; any string of characters which can be converted into a barcode by software in a Wireless Device 0120; or data which can be transmitted in a radio signal, e.g., RFID, and/or through a cable. Ad Data Code 0200 can include any additional data provided by an Advertiser to enable it to measure the effectiveness of the Advertisement. An Advertiser can transmit to a Media Device 0110 an Ad Data Code 0200 through a variety of means, including, but not limited to: transmitting it separately from the Advertisement that the Ad Data Code 0200 describes, and/or embedding or integrating the Ad Data Code 0200 in the Advertisement.

A vendor of an Advertisement, an electronic ticket, electronic coupon, content, or applications that can be transmitted to a Wireless Device 0120 (collectively, “Wireless Content”) can produce an Ad Data Code 0200 or any comparable file or document describing the characteristics of the Wireless Content in a variety of formats, including, but not limited to, a standard format to which most or all Advertisers can agree (as described in the prior paragraph), and/or XML.

For example, an Advertiser can produce an Ad Data Code 0200 utilizing XML to produce an Ad Data Code 0200 that communicates meta-information to a Wireless Device 0120 about its content. The process for producing XML documents is well known to those with ordinary skill in the art. The Advertiser can declare attributes that describe the Wireless Content. XML permits an author to identify the attributes of Wireless Content and the values the attributes can hold. For example, the Advertiser producing an Ad Data Code 0200 can declare an attribute of a Product name, which would have a name-value pair where the name could equal “Product” and the value could equal “NAMEPRODUCT.” By declaring the attributes, an Advertiser utilizing XML can enable the URMS 0350 to process XML data and convert the data into an Ad File. In one embodiment, the URMS 0350 and its Modules are configured to process XML data.

### 2.1.2 MEDIA DEVICES—WIRELESS DEVICE

FIG. 3 depicts a portion of exemplary System 0090 including Media Devices 0110 and Wireless Device 0120, according to embodiments of the present invention. FIG. 3 includes one or more Media Devices 0110 and Wireless Device 0120.

A Media Device 0110 is any Data Processing System that can perform one or more of the following functions: (1) receive and/or display an Advertisement; (2) receive and/or display Ad Data Code 0200; (3) transmit Ad Data Code 0200 to Wireless Device 0120 and/or Non-Wireless Device 0122; and/or (4) transmit any data to Advertiser System 0100 and/or Third Party Server 0150. Examples of Media Devices 0110 can include a Television 0304, a Radio 0306, a Personal Computer 0308, a portable media player, an Outdoor Media Device 0130, a Print publication 0312, Product Package 0314, Other Wireless Device 0316, or Wireless Device 0120. As would be appreciated by any person with ordinary skill in the art, an advertisement response measurement system can use other types of Media Devices. A Media Device 0110 can be in any location such as a home, an automobile, an office, a school, an elevator, an outdoor platform, a retailer, and/or carried by an user of a Wireless Device 0120. Media Devices 0110 are described in further detail in Section 2.1.2.1, below.

A Wireless Device such as Wireless Device 0120 and Other Wireless Device 0316 is a device that can transmit and/or receive information wirelessly to and/or from other devices and which an user can take with him or her when the user changes geographical location. Exemplary Wireless Devices include, but are not limited to, a wireless phone, portable computer, personal digital assistant, email device, camera, portable game player, watch, pager, or any device that combines any of these functions. Wireless Device 0120 includes devices attached to or integrated with it that can receive and/or transmit from and/or to other devices, respectively, an Advertisement, Ad Data Code 0200, a response to an Advertisement, Static Information, Dynamic Information, Feedback Information, and/or any other communication through either a wireless or wired connection. Wireless Device 0120 is described in further detail in Section 2.1.2.2, below.

2.1.2.1 Media Devices

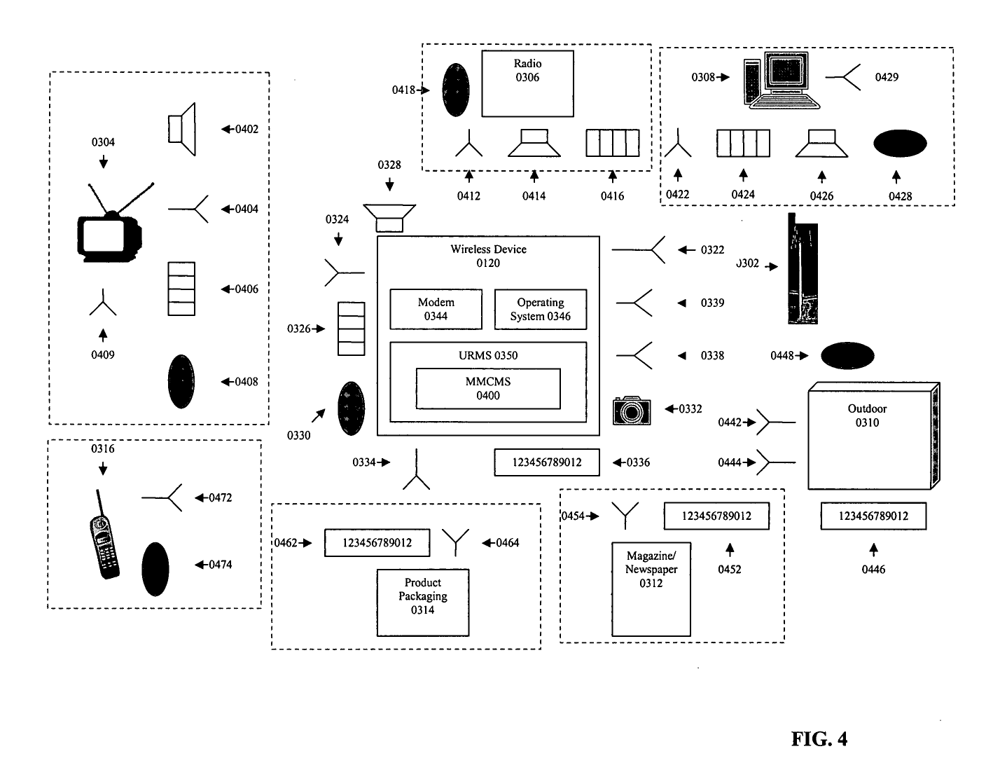

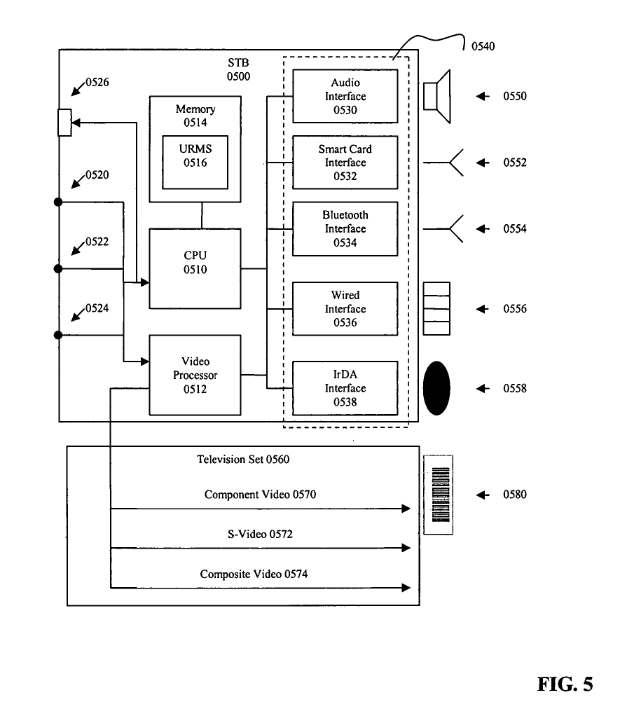

As described above, System 0090 can include one or more Media Devices 0110. The following section describes exemplary Media Devices 0110 which can be used in System 0090. FIG. 4 depicts one or more of these exemplary Media Devices 0110 and their respective I-O Devices which may be used in System 0090, according to embodiments of the present invention. As would be appreciated by persons with ordinary skill in the art, System 0090 can include other Media Devices 0110 as required.

A Television 0304 is any type of Data Processing System that can receive video programming via a wired or wireless connection to a provider of the programming. A Television 0304 can include any integrated or attached device that can enable other capabilities including, but not limited to, a video cassette recorder (VCR), a digital video recorder (DVR) and/or a digital video disc (DVD) player. Exemplary wired connections can include, but are not limited to, coaxial cable, fiber optic cable, utility, and/or a copper wire. Exemplary wireless connections can include, but are not limited to, a terrestrial system like a broadcast television network, a satellite system, and/or a wireless WAN, e.g., one based on 802.16. The video programming can be in analog or digital form. A content provider or content distributor can distribute video programming to a Television 0304 over a dedicated connection or divide the video programming into packets, distribute them over different routes to a Television 0304, and reassemble them at the Television 0304. Such packet-based video programming can be based on IP or any other kind of protocol that can route packets over a network, e.g., the Internet.

Television 0304 includes one or more I-O Devices. FIG. 4 depicts exemplary Television I-O Devices including, but not limited to a Speaker 0402, an Antenna 0404, a Synchronization Device/Port 0406, Infrared Device 0408, and/or an Antenna 0409. The Antenna I-O Device 0404 is configured to transmit and/or receive signals utilizing any wireless protocol such as Bluetooth or any other short-range wireless protocol, or any other wireless protocol. In one embodiment, the Synchronization I/O Device/Port 0406 is a USB host device. Alternate embodiments include a device communicating with another port through a wire using any cable standard, including, but not limited to, UART, USB, and RS-232. Antenna 0409 can transmit to and/or receive from another Antenna through a very short-range radio signal utilizing NFC and/or any other contactless standard.

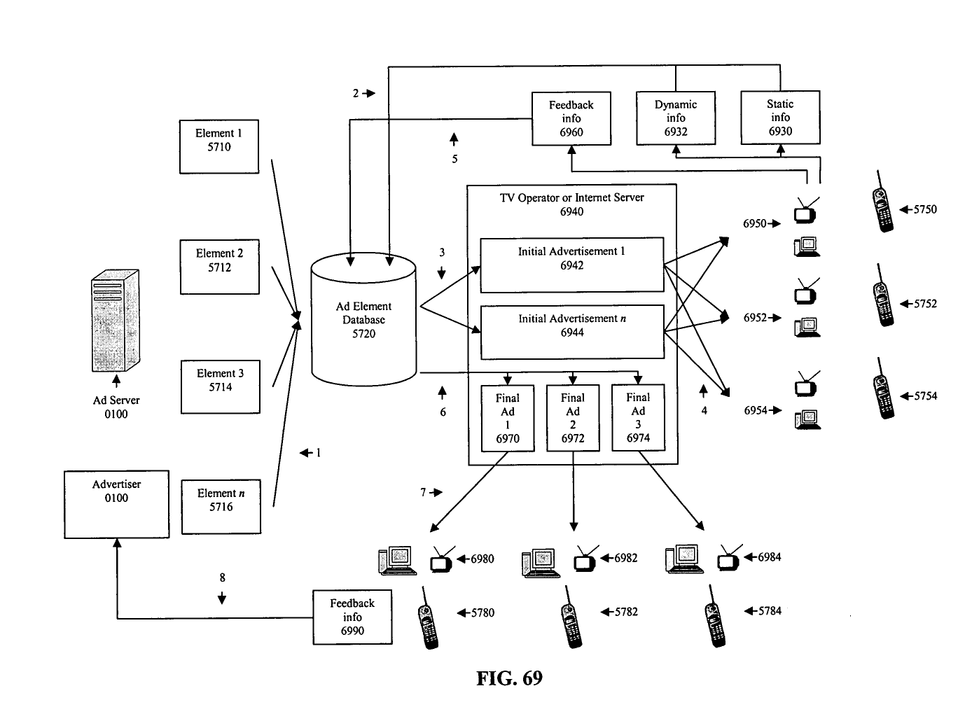

Television 0304 can transmit through its I-O Devices to Wireless Device 0120 and/or Non-Wireless Device 0122 an Advertisement and/or Ad Data Code 0200. Television 0304 may also receive, through its I-O Devices, from Wireless Device 0120 and/or Non-Wireless Device 0122 any communication, including, but not limited to, a response to an Advertisement, a message indicating Wireless Device 0120 user is viewing Television 0304 or Wireless Device 0120 I-O Devices utilizing any short-range and/or very short-range wireless protocols are within range of Television 0304, Static Information 6930 (described in FIG. 69), Dynamic Information 6932, and/or Feedback Information 6960.

The present system and methods can apply, in general, to any Media Device 0110 that can display an Advertisement, and specifically, to any device that can control the reception, storage, processing, and/or transmission of signals, including, but not limited to, a set-top box (STB) for a Television, or any corresponding device for other Media Devices 0110. In addition, the present system and methods can apply, in general, to any Media Device 0110 with one or more I-O Devices capable of exchanging data with a Wireless Device 0120.

A STB is another type of Media Device 0110 which can be used in System 0090. In one embodiment, the present invention considers a combination of the STB and a Television a Media Device 0110. In another embodiment, the present invention considers a STB by itself a Media Device 0110. FIG. 5 depicts a functional block diagram of an exemplary STB 0500, according to embodiments of the present invention.

STB 0500 is any type of Data Processing System configured to receive, store, process, and/or transmit Television signals. In one embodiment, STB 0500 is a digital STB capable of: (1) enabling Television Set 0560 to receive, decode, and/or display digital Television signals; and/or (2) enabling an user to transmit and/or receive data to and/or from a network, e.g., the Internet. In another embodiment, STB 0500 is an analog STB. STB 0500 include a CPU 0510, Video Processor 0512, URMS Module 0516, and one or more interfaces 0530-0538 enabling STB 0500 to exchange data with Wireless Device 0120 through the I-O Devices of STB 0500 and Wireless Device 0120.

CPU 0510 is a Processor capable of processing data and instructions, reading from and/or storing to Memory 0514; receiving data from any input, including, but not limited to, Television Antenna 0520, Cable Television I-O Device 0522, and/or Satellite Television I-O Device 0524; transmitting data to Video Processor 0512; and/or transmitting data to any output interface, including, but not limited to, Audio Interface 0530, Smart Card Interface 0532, Bluetooth Interface 0534, Wired Interface 0536, and/or IrDA Interface 0538

Video Processor 0512 is a Processor capable of receiving a signal from any input, including, but not limited to, Television Antenna 0520; Cable Television I-O Device 0522, which can receive a signal from any type of cable, including, but not limited to, coaxial cable, fiber optic cable, digital subscriber line (DSL) cable, and/or copper cable; and/or Satellite Television I-O Device 0524; decoding the signal; processing the signal; and/or transmitting any type of output signal directly to Television Set 0560, indirectly to Television Set 0560 through one or more video encoders (not shown), or to other devices, e.g., a VCR or DVR. The signal can be any type of signal, including, but not limited to: an analog video signal, and/or a digital audio and video signal. In another embodiment, one or more separate devices, e.g., one or more decoders (not shown), can receive, demodulate, decompress, and/or decode the signal before transmitting the signal to Video Processor 0512. The decoders, either separately or as part of Video Processor 0512, can include, but are not limited to: (1) a Motion Picture Experts Group (MPEG) decoder, which can implement any MPEG or non-MPEG compression standard; and/or (2) an analog decoder, which can implement any analog standard, including, but not limited to, the National Television System Committee (NTSC) standard, the Phase Alternate Line (PAL) standard, and/or NTSC/PAL standard. In another embodiment, any input device, including, but not limited to, Television Antenna 0520, Cable Television I-O Device 0522, Satellite Television I-O Device 0524, or Wireless Cable I-O Device (not shown), can transmit a return signal from STB 0500 to a Television Operator.

Memory 0514, which can store any data and instructions executed by Processor 0510, including, but not limited to, URMS 0516. Memory 0514 can have the same capabilities as Memory 0012.

URMS 0516 is configured to perform one or more of the functions performed by URMS 0350. In an embodiment, LRMS 0516 can receive, process, store, and/or transmit any data, including, but not limited to, data in: Ad Data Codes 0200, Payment Receipts 1900, Ad Data File 0734, Ad Response File 0738, Payment Data File 0740, and/or Matching Event File 0742.

Communication interfaces include an Audio Interface 0530, a Smart Card Interface 0532, a Bluetooth Interface 0534, a Wired Interface 0536, and an Infrared Interface 0538. As would be appreciated by any person with ordinary skill in the art, the present invention can use additional or alternative communication interfaces.

Audio Interface 0530 is configured to enable STB 0500 to exchange data with Wireless Device 0120 through Speaker 0550 and Microphone 0328. In one embodiment, STB 0500 can encode data into a sound wave transmitted from Speaker 0550 to Microphone 0328.

Smart Card Interface 0532 is configured to enable STB 0500 to exchange data with Wireless Device 0120 through Antenna 0552 and NFC Antenna 0338. In one embodiment, STB 0500 can encode data into a radio signal transmitted from Antenna 0552 to NFC Antenna 0338. STB 0500 can transmit the signal utilizing the NFC, any equivalent, and/or other contactless standard.

Bluetooth Interface 0534 is configured to enable STB 0500 to exchange data with Wireless Device 0120 through Antenna 0554 and Antenna 0324. In one embodiment, STB 0500 can encode data into a radio signal transmitted from Antenna 0554 to Antenna 0324. STB 0500 can transmit the signal utilizing the Bluetooth, any equivalent, and/or other short-range wireless standard.

Wired Interface 0536 is configured to enable STB 0500 to exchange data with Wireless Device 0120 through Port 0556 and Port 0326. In one embodiment, STB 0500 can encode data into a carrier signal transmitted through a cable attached to Port 0556 and Port 0326. The Interface can support one or more standards, including, but not limited to: RS-232, serial universal asynchronous receiver-transmitter (UART), USB, IEEE 1394, Inter-Integrated Circuit (“I2C”) bus, or any other cable standard.

Infrared (IRDA) Interface 0538 is configured to enable STB 0500 to exchange data with Wireless Device 0120 through IrDA Transceiver 0538 and IrDA Transceiver 0330. In one embodiment, STB 0500 can encode data into a radio signal operating in the infrared frequency spectrum from IrDA Transceiver 0538 to IrDA Transceiver 0330. STB 0500 can transmit the signal utilizing the IrDA or any equivalent standard.

STB 0500 is coupled to Television Set 0560, which can receive any type of video input, including, but not limited to: Component Video Signal 0570, S-Video Signal 0572, Composite Video Signal 0574, and/or Digital Video Signal (not pictured) (collectively, “Video Signal”). Television Set 0560 can display in any video programming an Ad Data Code 0200. Television Set 0560 can include any type of display device, including, but not limited to: cathode ray tube (CRT), liquid crystal display (LCD), or plasma panel (collectively, “TV Display Device”). In one embodiment, the present invention can embed Ad Data Code 0200 in a Video Signal in the form of a barcode 0580 displayed on the screen of Television Set 0560.

In another embodiment, the STB 0500 or similar Media Device 0110 can include additional components to enable an user of Wireless Device 0120 to respond to an Advertisement viewed on Television Set 0560. These additional components can include, but are not limited to, DSL or Cable Modem 0526, which can transmit and/or receive data to and/or from, respectively, a Television Operator utilizing any standard, including, but not limited to, Digital Video Broadcasting Return Channel for Cable (DVB-RCC); Antenna 0520, which can transmit and/or receive data to and/or from, respectively, a Television Operator utilizing any standard, including, but not limited to, Digital Video Broadcasting Return Channel for Terrestrial Broadcasting (DVB-RCT); Cable Television I-O Device 0522, which can transmit and/or receive data to and/or from, respectively, a Television Operator utilizing any standard, including, but not limited to, DVB-RCC; Satellite Television I-O Device 0524, which can transmit and/or receive data to and/or from, respectively, a Television Operator utilizing any standard; and/or Wireless Cable I-O Device (not shown), which can transmit and/or receive data to and/or from, respectively, a Television Operator utilizing a microwave distribution system, e.g., a multipoint microwave distribution system (MMDS).

A Radio 0306 can receive an Advertisement and/or Ad Data Code 0200 via terrestrial broadcasting, satellite broadcasting, or a wired transmission. Radio 0306 includes one or more I-O Devices. FIG. 4 depicts exemplary Radio I-O Devices including, but not limited to, an Antenna 0412, Speaker 0414, Infrared Device 0418, Synchronization Device/Port 0416, and/or RFID Antenna (not shown). Antenna 0412 is configured to transmit and/or receive signals utilizing any wireless protocol with the preferred embodiment being Bluetooth, an alternative embodiment being 802.11, and alternative embodiments being any other wireless protocol. In one embodiment, the Synchronization I-O Device 0416 is a USB host device. Alternate embodiments include a device communicating with another device through any other port, including, but not limited to, UART, USB, and RS-232. The RFID I-O Device (not shown) can support NFC or any comparable standard enabling very short-range communication.

Radio 0306 can transmit through its I-O Devices to Wireless Device 0120 and/or Non-Wireless Device 0122 an Advertisement and/or Ad Data Code 0200. Radio 0306 can receive through its I-O Devices from Wireless Device 0120 and/or Non-Wireless Device 0122 any communication, including, but not limited to: a response to an Advertisement, a message indicating Wireless Device 0120 user is listening to Radio 0306 or Wireless Device 0120 I-O Devices utilizing any short-range and/or very short-range wireless protocols are within range of Radio 0306, Static Information 6930 (described in FIG. 69), Dynamic Information 6932, and/or Feedback Information 6960.

Personal Computer 0308 is any Data Processing System that can process data, and transmit and/or receive information to and from other devices. In addition, a Personal Computer 0308 can transmit and/or receive information through either a wired connection and/or a wireless connection. When using a wireless connection, Personal Computer 0308 is referred to herein as a Wireless Device.

A Personal Computer 0308 can receive an Advertisement and/or Ad Data Code 0200 via a wired and/or wireless network utilizing any type of protocol (e.g, IP). Personal Computer 0308 includes one or more I-O Devices. FIG. 4 depicts exemplary Personal Computer 0308 I-O Devices including, but not limited to, Antenna 0422, Synchronization Device/Port 0424, Speaker 0426, Infrared Device 0428, and/or Antenna 0429, which can transmit to and/or receive from another Antenna through a very short range radio signal utilizing NFC and/or another contactless standard. Antenna 0422 can transmit and/or receive signals utilizing any wireless protocol with the preferred embodiment being Bluetooth, an alternative embodiment being 802.11, and alternative embodiments being any other wireless protocol. Synchronization Device/Port 0424 can, for example, communicate with another device through a USB port and alternative embodiments communicating with another device through any other port, including, but not limited to: UART and RS-232.

Personal Computer 0308 can transmit through its I-O Devices to Wireless Device 0120 and/or Non-Wireless Device 0122 an Advertisement and/or Ad Data Code 0200. Personal Computer 0308 can receive through its I-O Devices from Wireless Device 0120 any communication, including, but not limited to: a response to an Advertisement, a message indicating Wireless Device 0120 user is viewing Personal Computer 0308 or Wireless Device 0120 I-O Devices utilizing any short-range and/or very short-range wireless protocols are within range of Personal Computer 0308, Static Information 6930 (described in FIG. 69), Dynamic Information 6932, and/or Feedback Information 6960. Personal Computer 0308 can broadcast through Antenna 1522 to any Wireless Device within its immediate area a RF signal containing an Advertisement and/or Ad Data Code 0200.

Personal Computer 0308 can record the activity of an user of Personal Computer 0308 viewing an Advertisement in a variety of ways, including, but not limited to: storing a data file containing state information or what is commonly referred to as “cookie” in Memory 0012 of Personal Computer 0308; recording data about the user on the web server serving the Advertisement if the user provides information about the user to the server; recording the static IP address of the user if the user requests a web page containing an Advertisement; or other means of recording an Advertisement viewed by the user.

Current media technologies are evolving that could change the type of device on which an user views an Advertisement delivered to conventional devices. For example, certain operators are deploying technologies enabling them to transmit Television signals by utilizing IP. While these operators plan to transmit IP Television signals to a Television set, transmitting the signals via IP can enable them to transmit the signals to Personal Computers 0308. Therefore, a Personal Computer 0308 can receive both an Internet Advertisement and an Advertisement that can also be viewed on a Television 0304.

An Outdoor Media Device 0310 is any platform outside of a home or business that can display an Advertisement. Outdoor Media Devices 0310 can be electronic (e.g., an Advertisement viewed on a liquid crystal display (LCD)) or non-electronic (e.g., Advertisement viewed on paper or billboard). The platform may be stationary (e.g., a billboard or end-of-aisle display) or mobile (e.g., an automobile carrying an Advertisement).

For example, a billboard may be a platform holding a still or moving image Advertisement in an outdoor environment, a platform holding a still or moving image Advertisement in an indoor environment, e.g., a hallway or elevator, a poster, and/or a display advertising or featuring Products, e.g., a point-of-purchase display or an end-of-aisle display in supermarkets. A billboard can also be a stationary platform, e.g., a highway billboard or a Television monitor in an elevator, or a mobile platform, e.g., the side of a bus or truck, or a vehicle designed specifically to display advertising. As would be appreciated by any person with ordinary skill in the art, System 0090 can use other forms of Outdoor Media Devices 0310.

Outdoor Media Device 0310 can have one or more I-O Devices. FIG. 4 depicts exemplary Outdoor Media Device 0310 I-O Devices including, but not limited to an Antenna 0442, which can transmit and/or receive signals utilizing any wireless protocol with the preferred embodiment being Bluetooth, an alternative embodiment being 802.11, and alternative embodiments being any other wireless protocol; an Antenna 0444, which can transmit to and/or receive from, respectively, another Antenna via a very short range radio signal utilizing NFC and/or any other contactless standard; a Barcode 0446, and/or an Infrared Device 0448.

Outdoor Media Device 0310 can transmit through its I-O Devices to Wireless Device 0120 and/or Non-Wireless Device 0122 an Advertisement and/or Ad Data Code 0200 from Advertiser System 0100. Outdoor Media Device 0310 can receive through its I-O Devices from Wireless Device 0120 and/or Non-Wireless Device 0122 any communication, including, but not limited to, a response to an Advertisement, a message indicating Wireless Device 0120 user is viewing an Outdoor Media Device 0310 or Wireless Device 0120 I-O Devices utilizing any short-range and/or very short-range wireless protocols are within range of Outdoor Media Device 0310, Static Information 6930 (described in FIG. 69), Dynamic Information 6932, and/or Feedback Information 6960.

Outdoor Media Device 0310 can transmit an Advertisement and/or Ad Data Code 0200 either initiating a transmission to or responding to a reception from Wireless Device 0120. That is, Outdoor Media Device 0310 can broadcast through Antenna 0442 to any Wireless Device within its immediate area a RF signal containing an Advertisement and/or Ad Data Code 0200. Alternatively, Outdoor Media Device 0310 can respond to a request by any Wireless Device for information about the Product advertised on Outdoor Media Device 0310. For example, Wireless Device 0120 user can be walking in the vicinity of Outdoor Media Device 0310, which can be a poster that includes both Antenna 0442 and Barcode 0446. Antenna 0442 can broadcast a RF signal containing an Advertisement and/or Ad Data Code 0200 to the user. Alternatively, the user reading or viewing Outdoor Media Device 0310 can point his/her Wireless Device 0120 at Barcode 0446 to download more information about the Product advertised, e.g., an Advertisement and/or Ad Data Code 0200.

Print media such as Magazine or Newspaper 0312 may have one or more I-O Devices. FIG. 4 depicts exemplary Print I-O Devices including, but not limited to, a Barcode 0452, and/or RFID Antenna 0454, which can support NFC or any comparable standard enabling very short-range communication. Print media 0312 can transmit through its I-O Devices to Wireless Device 0120 and/or Non-Wireless Device 0122 an Advertisement and/or Ad Data Code 0200. Print media 0312 can receive through its I-O Devices from Wireless Device 0120 any communication, including, but not limited to: a response to an Advertisement, a message indicating Wireless Device 0120 user is viewing the Print media or Wireless Device 0120 I-O Devices utilizing any short-range and/or very short-range wireless protocols are within range of Print media 0312, Static Information 6930 (described in FIG. 69), Dynamic Information 6932, and/or Feedback Information 6960.

Product Package 0314 is any type of package in which an Advertiser can place a Product on which an user can view an Advertisement. Product Package 0314 may have one or more I-O Devices. FIG. 4 depicts exemplary Product Package 0314 I-O Devices, including, but not limited to, a Barcode 0462; and/or RFID Antenna 0464, which can support NFC or any comparable standard enabling very short-range communication. Product Package 0314 can transmit through its I-O Devices to Wireless Device 0120 and/or Non-Wireless Device 0122 an Advertisement and/or Ad Data Code 0200. Product Package 0314 can receive through its I-O Devices from Wireless Device 0120 and/or Non-Wireless Device 0122 any communication, including, but not limited to: a response to an Advertisement, a message indicating Wireless Device 0120 user is viewing Product Package 0314 or Wireless Device 0120 I-O Devices utilizing any short-range and/or very short-range wireless protocols are within range of Product Package 0314, Static Information 6930 (described in FIG. 69), Dynamic Information 6932, and/or Feedback Information 6960.

Other Wireless Device 0316 includes one or more I-O Devices. Other Wireless Device 0316 has the same I-O Devices as Wireless Device 0120, described above. FIG. 4 depicts exemplary Other Wireless Device 0316 I-O Devices including, but not limited to, Antenna 0472, which can transmit and/or receive signals utilizing any wireless protocol with the preferred embodiment being Bluetooth, an alternative embodiment being 802.11, and alternative embodiments being any other wireless protocol; Infrared Device 0474; and/or RFID Device (not pictured in FIG. 4), which can support NFC or any comparable standard enabling very short-range communication. Wireless Device 0316 can transmit through its I-O Devices to Wireless Device 0120 and/or Non-Wireless Device 0122 an Advertisement and/or Ad Data Code 0200. Wireless Device 0316 can receive through its I-O Devices from Wireless Device 0120 and/or Non-Wireless Device any communication, including, but not limited to: a response to an Advertisement, a message indicating Wireless Device 0120 user can communicate with Other Wireless Device 0316 or Wireless Device 0120 I-O Devices utilizing any short-range and/or very short-range wireless protocols are within range of Other Wireless Device 0316, Static Information 6930 (described in FIG. 69), Dynamic Information 6932, and/or Feedback Information 6960.

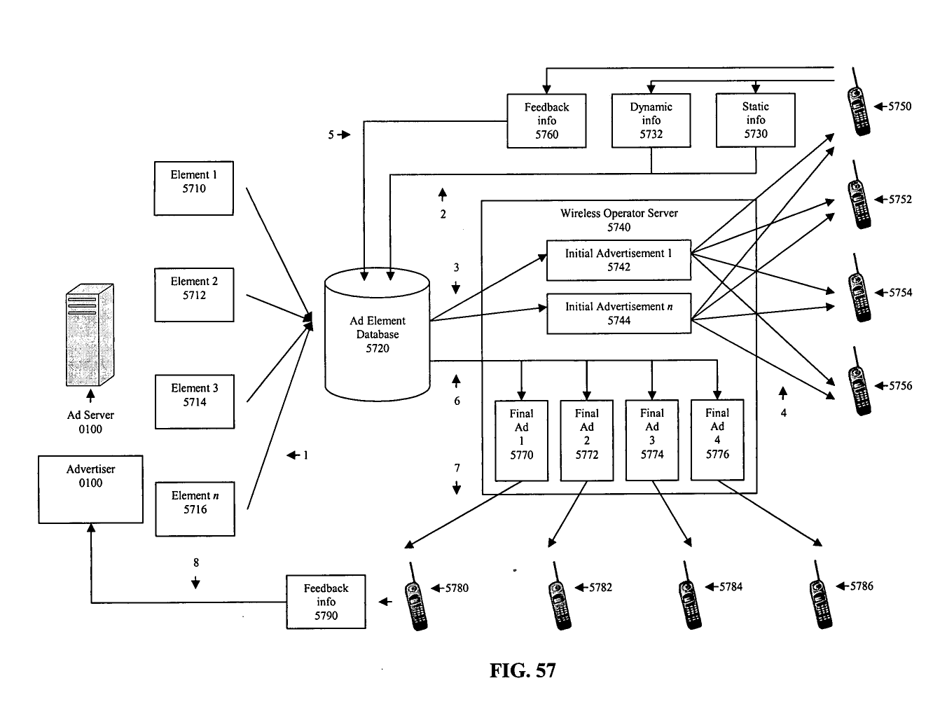

Wireless Base Station 0302 can transmit and/or receive to and/or from, respectively, another Antenna a wireless signal over a wireless network utilizing any long-range wireless protocol including, but not limited to, advance mobile phone system (AMPS), time division multiple access (TDMA), global system for mobile communications (GSM), general packet radio service (GRPS), enhanced data rates for global evolution (EDGE), code division multiple access (CDMA), CDMA2000, any extensions of CDMA2000, wideband CDMA (WCDMA), any extensions of WCDMA, high speed downlink packet access (HSDPA), 802.11, 802.16, 802.20, Ultra Wideband (UWB), digital video broadcasting-handheld (DVB-H), terrestrial integrated services digital broadcasting (ISDB-T), satellite digital multimedia broadcasting (S-DMB), terrestrial digital multimedia broadcasting (T-DMB), and/or any equivalent or successor standards. Wireless Base Station 0302 can transmit through its I-O Devices to Wireless Device 0120 and/or Non-Wireless Device 0122 an Advertisement and/or Ad Data Code 0200. Wireless Base Station 0302 can receive through its I-O Devices from Wireless Device 0120 any communication, including, but not limited to: a response to an Advertisement, a message indicating Wireless Device 0120 user can communicate with Wireless Base Station 0302, Static Information 5730 (described in FIG. 57), Dynamic Information 5732, and/or Feedback Information 5760.

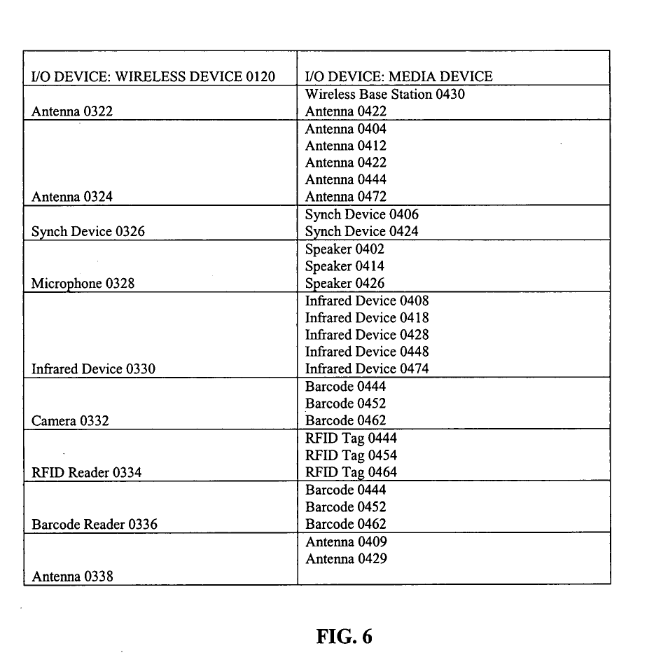

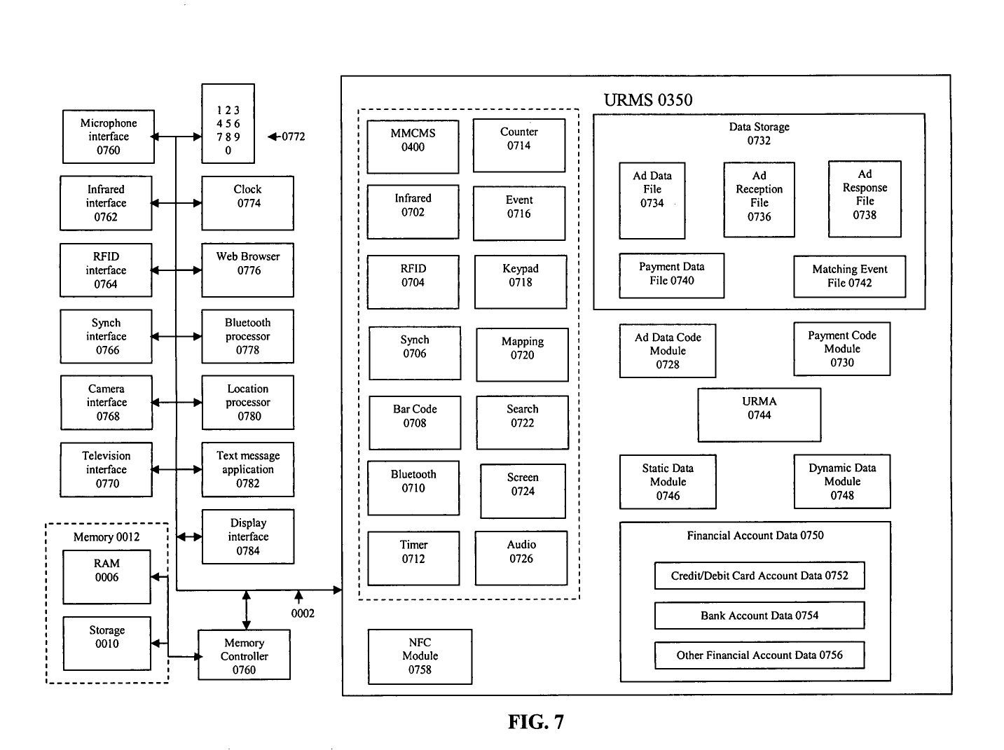

FIG. 6 depicts a table listing the I-O Devices of a Wireless Device 0120 and the I-O Devices of the above described Media Devices 0110 with which the Wireless Device 0120 can exchange data through a wired and/or wireless signal, according to embodiments of the present invention. FIGS. 3 and 4 depict the I-O Devices of Wireless Device 0120.

Wireless Device 0120 can receive an Ad Data Code 0200 through Microphone 0328 from any device with a speaker, including, but not limited to: Television 0304, Radio 0306, and/or Personal Computer 0308. An Advertiser can produce an Ad Data Code 0200 in the form of an audio signal (“Ad Data Audio Signal”) that is transmitted to Media Devices 0110 for retransmission to Wireless Device 0120. An Advertiser can embed Ad Data Audio Signal in the audio signal normally transmitted by Speakers 0402, 0414, and 0426 for Television 0304, Radio 0306, and Personal Computer 0308, respectively. To avoid distorting the normal audio signal containing audio information about programming and/or an Advertisement, Advertiser System 0100 can transmit Ad Data Audio Signal at a frequency outside the range of human hearing. Alternatively, the Advertiser can transmit Ad Data Audio Signal at a frequency within the range of human hearing, but at a signal power level that is undetectable by human hearing yet detectable by Microphone 0328.

The RFID Reader 0334 of Wireless Device 0120 can receive an Advertisement and/or Ad Data Code 0200 from any device with a RFID Tag, including, but not limited to: Outdoor Media Device 0310, Print Media 0312, and/or Product Package 0314. As described above, Print Media 0312 can include a RFID Tag 0454 that can receive any kind of electromagnetic field that can induce a voltage in the tag to enable the tag to transmit a radio signal carrying information about an Advertisement or an Ad Data Code 0200. In one embodiment, RFID Tag 0454 can receive a changing magnetic field, which can induce a voltage in the tag to enable the tag to transmit the radio signal. In another embodiment, RFID Tag 0454 can receive a light wave, which can induce a voltage in a photovoltaic system capable of converting light into electrical power as part of the tag and enable the tag to transmit the radio signal.

RFID Tag 0454 can include a photovoltaic system capable of converting light at any wavelength into electrical power. The wavelengths can include the wavelengths utilized by sunlight or wavelengths utilized by any manmade source of light. In the preferred embodiment, RFID Tag 0454 can include a photovoltaic system that can convert either sunlight and/or manmade sources of light operating near the infrared spectrum. Because current photovoltaic systems tend to be most efficient at converting light into electrical power near the infrared spectrum, the photovoltaic system could be produced at a lower cost than photovoltaic systems operating at other wavelengths. In another embodiment, RFID Tag 0454 can include a photovoltaic system that can convert either sunlight and/or manmade sources of light operating at wavelengths other than near the infrared spectrum.

RFID Tag 0454 with the photovoltaic system can enable an Advertiser to measure whether a reader of Print Media 0312 is exposed to an Advertisement on a given page inside or on the outside of the Print Media 0312. One current approach can measure whether a reader sees Print Media 0312 Advertisement only if the reader fills out a paper form indicating that he/she read an Advertisement and sends the form by mail to an Advertiser. Another approach can measure whether a reader sees a Print Media 0312 Advertisement if the reader scans with his/her Wireless Device 0120 a barcode associated with the Advertisement that provides a means of contacting the Advertiser, e.g., a URL with a certain code indicating the Advertisement providing the reader the URL.

These approaches require a reader to take some overt action to transmit some information to the Advertiser indicating the reader is exposed to the Advertisement. Under these approaches, the Advertiser cannot know whether the reader is exposed to Advertisements for which the reader does not take some action transmitting information to the Advertiser.

RFID Tag 0454 with the photovoltaic system can enable an Advertiser to measure whether the reader is exposed to an Advertisement on a given page inside or on the outside of the Print Media 0312 without requiring any overt action by the reader. The reader can open the Print media and turn to a given page, which would be exposed to either sunlight or manmade source of light. RFID Tag 0454 with the photovoltaic system can convert the light to electrical power, which can enable the tag to transmit a radio signal to RFID Reader 0334 attached to Wireless Device 0120. As long as the Wireless Device is within range of the radio signal transmitted by RFID Tag 0454, Wireless Device 0120 can receive an Advertisement and/or Ad Data Code 0200 transmitted by the tag.

2.1.2.2 Wireless Device

As depicted in FIG. 3, Wireless Device 0120 can include components, including, but not limited to: one or more Antennas 0322, one or more additional I/O Devices, URMS 0350, one or more Processors 0004, one or more Modems 0344, one or more Baseband Processors 0342, one or more Transceivers 0340, and/or an Operating System 0346.

URMS 0350 is configured to measure if, through what Media Device 0110, when, and/or where an user views an Advertisement and/or if, when, how, and/or to what degree the user responds to the Advertisement. In one embodiment, the present invention can implement URMS 0350 in software. In this implementation, the present invention can store logic for URMS 0350 in Memory 0012 (not shown) in Wireless Device 0120. URMS 0350 is described in further detail in Section 2.1.2.3, below.

CPU 0004 can be a single Processor, more than one Processor, a digital signal processor (DSP), a microprocessor, or any other device that can execute program instructions and data.

Modem 0344 can perform any of the functions of Communications Interface 0014 in addition to providing an interface to peripherals, including, but not limited to: a keypad and/or keyboard, display, SIM card, vibrator, microphone, and/or speaker.

Operating System 0346 is configured to manage one or more application programs in Wireless Device 0120.

In accordance with Wireless Device operating techniques well known to those with ordinary skill in the art, Transceiver 0340 can perform signal processing from and/or to Antenna 0322, including, but not limited to, signal conversion from RF to intermediate frequency (IF) and then from IF to baseband or directly from RF to baseband, signal conversion from baseband to IF and then to RF or directly from baseband to RF, power amplification for transmission to Antenna 0322, switching between reception and transmission, A/D conversion, and/or D/A conversion.

Baseband Processor 0342 is configured to perform signal processing from and to Transceiver 0340, including, but not limited to, modulation, demodulation, A/D conversion, D/A conversion, synchronization, and/or providing an interface to peripherals. Baseband Processor 0342 can be an analog baseband processor, a digital baseband processor, or a combination analog and digital baseband processor.

As would be appreciated by any person with ordinary skill in the art, Wireless Device 0120 can include any combination or integration of Modem 0344, Transceiver 0340, Baseband Processor 0342, or CPU 0004. In other embodiments, other devices can perform the functions performed by each of Modem 0344, Transceiver 0340, Baseband Processor 0342, and CPU 0004.

### 2.1.2.2.1 I-O DEVICES

Wireless Device 0120 can include one or more I-O Devices. A Wireless Device 0120 I-O Device is any device attached to and/or integrated with a Wireless Device that can receive from and/or transmit to other devices information through a wireless and/or wired connection. I-O Devices include, but are not limited to, the following: (i) a Microphone 0328 that can receive and decode the audio transmission of an Ad Data Code 0200; (ii) a Synchronization Device 0326 that can receive a wired transmission of an Advertisement and/or Ad Data Code 0200 when the Wireless Device 0120 is connected to a port of any Media Device 0110, e.g., a Personal Computer 0308 or Television 0304 or a Payment Receipt 1900 when the Wireless Device 0120 is connected to a port of any Payment Device 0134; (iii) an Antenna 0322 that can receive the wireless transmission of an Advertisement, Ad Data Code 0200, and/or Payment Receipt 1900 transmitted over a RF channel from an Outdoor Media Device 0310 or public Television monitor or an Advertisement, Ad Data Code 0200, and/or Payment Receipt 1900 transmitted over a RF channel from a base station of a wireless operator; (iv) a Bluetooth Antenna 0324 that can receive the wireless transmission of an Advertisement and/or Ad Data Code 0200 transmitted in the form of a Bluetooth signal or a Payment Receipt 1900 when the Wireless Device 0120 is within range of any Payment Device 0134; (v) a Barcode Reader 0336 that can read the content of a bar code; (vi) an Infrared Device 0330 that can receive an Advertisement and/or Ad Data Code 0200 transmitted in the form of an infrared signal from another device or a Payment Receipt 1900 when the Wireless Device 0120 is within range of any Payment Device 0134; (vii) a RFID Device 0334 that can receive the wireless transmission of an Advertisement and/or Ad Data Code 0200 from any RFID tag or a Payment Receipt 1900 when the Wireless Device 0120 is within range of any RFID tag; (viii) a NFC Antenna 0338 that can receive the contactless transmission of an Advertisement and/or Ad Data Code 0200 transmitted from a device that can support Near Field Communications or a Payment Receipt 1900 when the Wireless Device 0120 is within range of any Payment Device 0134; and/or (ix) any combination of the above. The present application describes each of these I-O Devices in further detail below.

The Wireless Device 0120 can transmit through its I-O Devices to another Wireless Device and/or any other device data responding to an Advertisement and/or Ad Data Code 0200 or signaling some action with respect to a Product advertised.

Antenna 0322 is configured to transmit to and/or receive from another Antenna, respectively, a long-range wireless signal (typically, longer than several hundred feet) utilizing any wireless air interface protocol. In one embodiment, Antenna 0322 includes an array of Antennas. Wireless air interface protocols include, but are not limited to, AMPS, TDMA, GSM, GPRS, EDGE, CDMA, CDMA2000 and any extensions of CDMA2000, WCDMA and any extensions of WCDMA, HSDPA, 802.11, 802.16, 802.20, UWB, DVB-H, ISDB-T, S-DMB, T-DMB, and/or any equivalent or successor standards. As would be appreciated by any person with ordinary skill in the art, Wireless Device 0120 can support any wireless air interface protocol.

In one embodiment, Wireless Device 0120 communicates via Antenna 0322 to a Wireless Base Station 0302. Wireless Base Station 0302 is a component of a communications network. Wireless Base Station 0302 transmits and/or receives a wireless signal using one of the above mentioned protocols to devices having an Antenna 0322.

Although FIG. 3 depicts one Antenna 0322, any person with ordinary skill in the art will recognize that Wireless Device 0120 can include multiple Antennas 0322 for transmitting and/or receiving a wireless signal, each of which can support a different wireless protocol. For example, Wireless Device 0120 can include one Antenna 0322 to receive a CDMA2000 signal, a second Antenna 0322 to receive a 802.11 signal, and a third Antenna 0322 to receive a 802.16 signal. In another embodiment, Wireless Device 0120 can include one or more Antennas 0322 for transmitting and/or receiving a wireless signal, each of which can support multiple wireless protocols.

Antenna 0322 is configured to receive an Advertisement from Wireless Base Station 0302. In another embodiment, Antenna 0322 is configured to receive an Advertisement through any device that is part of a wireless network, including, but not limited to, a satellite wireless network or another Wireless Device as part of a wireless mesh network (any further reference to Wireless Base Station 0302 shall include the devices).

Antenna 0322 is configured to receive an Ad Data Code 0200 from any Media Device 0110, including, but not limited to: Wireless Base Station 0302 (which shall include any Television programming and/or Advertisements transmitted from Wireless Base Station 0302), Television 0304, Radio 0306, Personal Computer 0308, Outdoor Media Device 0310, Magazine or Newspaper 0312, Product Package 0314, or Other Wireless Device 0316. Antenna 0322 is configured to receive a Payment Receipt 1900 from any Media Device 0110 and/or a Payment Device 0134. Antenna 0322 can transmit any information to Wireless Base Station 0302.

Antenna 0322 can transmit and/or receive signals connecting Wireless Device 0120 to Gateway Mobile Location Center (GMLC) 0160, URMS Map Database 0162, Wireless Operator Billing Database 0164, 3rd Party Payment Database 0166, UPC Database 0168, and/or Advertiser System 0100 to implement the various functions enabled by URMS 0350.

Antenna 0324 is configured to transmit to and/or receive from another Antenna, respectively, a short-range wireless signal (typically shorter than several hundred feet but longer than several inches) utilizing the Bluetooth protocol in the preferred embodiment or any other short-range wireless protocol in another embodiment. In one embodiment, Antenna 0324 is a short-range Antenna. A Short-Range Antenna is any Antenna which can communicate with another Antenna over a short range utilizing any type of short-range wireless protocol, including, but not limited to: Bluetooth, HomeRF, IEEE 802.11, IEEE 802.15.3a or UWB, infrared, e.g., the Infrared Data Association (IrDA) standard, RFID, wireless IEEE 1394 (also known as Wireless Firewire), or Wireless USB. For example, UWB can relay data from a host device to client devices up to about 10 meters away.

Antenna 0324 can receive an Advertisement transmitted by Advertiser System 0100 to Wireless Device 0120. Antenna 0324 is also configured to receive an Ad Data Code 0200 from any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. Antenna 0324 can receive data from any Product or other device with another Antenna that measures whether Wireless Device 0120 user takes some action with respect to the Product or device, including, but not limited to: sampling the Product, visiting a retailer, or buying the Product. Antenna 0324 is configured to receive a Payment Receipt 1900 from any Media Device 0110 and/or a Payment Device 0134. Antenna 0324 is configured to transmit to any of the devices any information, including, but not limited to: information regarding an Advertisement and/or response to an Advertisement.

Synchronization Device/Port 0326 is configured to transmit to and/or receive from another device, respectively, a signal through a wired or wireless communication. The present invention can implement the function of synchronization through any wired or wireless communication, including, but not limited to: any kind of cable; Bluetooth or any other short-range wireless protocol; infrared; RFID; and/or NFC or any comparable standard enabling very short-range communication. Synchronization Device/Port 0326 can communicate with another device through any port, including, but not limited to: a universal asynchronous receiver-transmitter (UART) and a USB.

Synchronization Device/Port 0326 is configured to receive an Advertisement transmitted to Wireless Device 0120. For example, an Advertiser can transmit through the Internet an Advertisement and/or Ad Data Code 0200 to a Personal Computer 0308 for further transmission to Wireless Device 0120 through Synchronization Device/Port 0326. In another example, if a STB 0500 for Television 0304 has the capability of synchronizing with Wireless Device 0120 through a UART, USB, or some other port, Advertiser System 0100 can transmit an Advertisement and/or Ad Data Code 0200 to Television 0304 for further transmission to Wireless Device 0120 through Synchronization Device/Port 0326. Synchronization Device 0326 can receive an Ad Data Code 0200 from any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. Synchronization Device/Port 0326 can receive data from any Product or other device with a synchronization device that measures whether Wireless Device 0120 user takes some action with respect to the Product or device, including, but not limited to: sampling the Product, visiting a retailer, or buying the Product. Synchronization Device/Port 0326 is configured to receive a Payment Receipt 1900 from any Media Device 0110 and/or a Payment Device 0134. Synchronization Device/Port 0326 is configured to transmit to any of the devices any information, including, but not limited to: information regarding an Advertisement and/or response to an Advertisement.

Microphone 0328 is configured to receive a signal from another device through a sound wave or other physical audio communication. Microphone 0328 is configured to receive an Advertisement transmitted by Advertiser System 0100 to Wireless Device 0120 from a speaker connected to any Media Device 0110. Microphone 0328 can receive an Ad Data Code 0200 from any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316.

Infrared Device 0330 is configured to transmit to and/or receive from another infrared device, respectively, a signal utilizing infrared light waves. Infrared Device 0330 can utilize any standard, including, but not limited to, the Infrared Data Association (IrDA) standard.

Infrared Device 0330 is configured to receive an Advertisement transmitted to Wireless Device 0120. Infrared Device 0330 can receive an Ad Data Code 0200 from any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. Infrared Device 0330 can receive data from any Product or other device with an infrared device that measures whether Wireless Device 0120 user takes some action with respect to the Product or device, including, but not limited to: sampling the Product, visiting a retailer, or buying the Product. For example, Wireless Device 0120 user could visit an auto dealership to test-drive an auto or a home to inspect the home. Currently, auto dealers and real estate agents typically ask potential customers to write on paper their contact information to record the customer sampling. Wireless Device 0120 user could exchange information with the auto dealer or real estate agent, which information would represent the sampling of an auto or home by the user. Infrared Device 0330 is configured to receive a Payment Receipt 1900 from any Media Device 0110 and/or a Payment Device 0134. Infrared Device 0330 can transmit to any of the devices any information, including, but not limited to: information regarding an Advertisement and/or response to an Advertisement.

In another embodiment, Wireless Device 0120 can measure the sampling by enabling the device to exchange information with another party utilizing not only Infrared Device 0330, but any other kind of device, including, but not limited to: Antenna 0322; Antenna 0324; Synchronization Device 0326; Microphone 0328; Camera 0332; RFID Antenna 0334; Barcode Reader 0336; and/or NFC Antenna 0338.

Camera 0332 is configured to record any image or video. For example, Camera 0332 can read an image of a bar code or other form of data encoding information about a Product or Advertisement. Camera 0332 can record an image on any Media Device 0110, including, but not limited to, a Magazine or Newspaper 0312, or Product Package 0314.

In general, an RFID Antenna, such as RFID Antenna 0334, is any device that can enable a machine, e.g., a Wireless Device, to transmit to and/or receive from another machine, e.g., a Wireless Device, data wirelessly utilizing any RFID standard. A RFID Antenna can be either a RFID reader, which can receive a wireless signal from an RFID tag, an RFID tag, which can transmit a wireless signal to a RFID reader, or a combination RFID reader/tag.

A RFID Antenna 0334 is configured to generate an electromagnetic field, which induces a voltage in a RFID tag and enables the RFID tag to transmit to the RFID Antenna 0334 a radio signal. RFID Antenna 0334 is configured to convert the received radio signal into a format that can be transferred to an application in Wireless Device 0120. In another embodiment, RFID Antenna 0334 can generate a light wave, which can induce a voltage in a photovoltaic system as part of a RFID tag and enable the REID tag to transmit to the RFID Antenna 0334 a radio signal. In another embodiment, RFID Antenna 0334 can generate a light wave, which can induce a voltage in a photovoltaic system capable of converting light into electrical power as part of a RFID tag and enable the RFID tag to transmit to the RFID Antenna 0334 a light signal. In another embodiment, RFID Antenna 0334 can generate an electromagnetic field to induce a RFID tag to transmit to the RFID Antenna 0334 an electromagnetic signal other than a radio or light signal.

RFID Antenna 0334 is configured to receive an Advertisement transmitted to Wireless Device 0120. RFID Antenna 0334 can receive an Ad Data Code 0200 from any Media Device 0110 with a RFID tag, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. RFID Antenna 0334 can receive data from any Product with a RFID tag that measures whether Wireless Device 0120 user takes some action with respect to the Product, including, but not limited to: sampling the Product, visiting a retailer, or buying the Product. RFID Antenna 0334 is configured to receive a Payment Receipt 1900 from any Media Device 0110 and/or a Payment Device 0134. RFID Antenna 0334 can transmit to any RFID reader or any other RFID Device any information, including, but not limited to: information regarding an Advertisement and/or response to an Advertisement.

In one embodiment, Wireless Device 0120 can include a NFC Antenna 0338. NFC Antenna 0338 is configured to transmit to and/or receive from another device via a very short-range radio signal (typically inches) using NFC or any other contactless standard and/or exchange data with any device that is part of a wireless device, including a SIM card. NFC is a technology enabling a Wireless Device 0120 user to access information in other devices by touching them and/or bringing them within a short distance, typically a few centimeters. The NFC protocol supports the utilization of other wireless protocols. For example, after Wireless Device 0120 exchanges configuration data with the other device utilizing NFC, the devices can continue communication utilizing other wireless protocols, including, but not limited to: Bluetooth or 802.11. The NFC protocol also supports contactless smart card protocols. The NFC protocol supports a variety of functions, including, but not limited to: detection, authentication, reading, and/or writing of data from and/or to other devices utilizing NFC.

Exemplary NFC standards include ISO 18092, ISO 21481, ECMA (340, 352, and 356), ETSI TS 102 190, and any equivalent or successor standards. In another embodiment, exemplary contactless standards (e g., any standard enabling wireless data exchange over short distances (or even in physical contact) and in an unregulated RF band, e.g., 13.56 MHz.) include ISO 14443 for contactless integrated circuit proximity cards, ISO 15693 for contactless integrated circuit vicinity cards, or any equivalent or successor standard to ISO 14443, ISO 14443A/B, ISO 15693, ISO 18092, ISO 21481, ECMA (340, 352, and 356), or ETSI TS 102 190. As would be appreciated by any person with ordinary skill in the art, Wireless Device 0120 can support any comparable standard enabling very short-range communication.

NFC Antenna 0338 is configured to receive an Advertisement from any device that can support NFC or any other contactless standard. NFC Antenna 0338 is also configured to receive an Ad Data Code 0200 from any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. NFC Antenna 0338 is configured to receive a Payment Receipt 1900 from any Media Device 0110 and/or a Payment Device 0134. NFC Antenna 0338 can transmit to any of the devices any information, including, but not limited to: information regarding an Advertisement, response to an Advertisement, and/or payment information.

A Barcode Reader 0336 is configured to transmit a beam of light across a barcode, measuring the amount of light reflected from the barcode, and decoding the barcode. Barcode Reader 0336 can include a variety of means of scanning a barcode and converting light energy to electrical energy, including, but not limited to, a pen type scanner with a light source and photo diode to measure the intensity of light reflected from the barcode; a laser barcode scanner with a laser beam as a light source and photo diode to measure the intensity of light reflected from the barcode; a charge couple device (CCD) scanner with an array of light sensors and a device to measure the emitted ambient light from the barcode; or an image scanner, also known as a camera reader, with a camera to capture an image of a barcode.

The n-digit Product number making up the barcode may or may not contain any descriptive data about a Product. In the example where the barcode does not contain descriptive Product data, Barcode Reader 0336 can transmit the reference number it decodes to URMS 0350, which in turn can transmit the reference number through Antenna 0322 or Antenna 0324. In the example where the barcode does contain descriptive Product data, e.g., a bar code utilizing the format of PDF417, also known in the industry as a two-dimensional barcode, Barcode Reader 0336 can transmit the Product data to a module in Wireless Device 0120 for conversion to an Ad File.

Barcode Reader 0336 is configured to receive an Advertisement transmitted by Advertiser System 0100 to Wireless Device 0120. Barcode Reader 0336 can receive an Ad Data Code 0200 from any Media Device which can transmit and/or display a barcode, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. Barcode Reader 0336 can receive data from any Product with a barcode that measures whether Wireless Device 0120 user takes some action with respect to the Product, including, but not limited to: sampling the Product, visiting a retailer, or buying the Product.

Wireless Device 0120 may also include an I-O Device 0339 which is configured to transmit to and/or receive from another device through a radio signal using any other wireless standard not discussed above.

As would be appreciated by any person with ordinary skill in the art, Wireless Device 0120 can use I-O Devices other than those described herein.

2.1.2.3 User Response Measurement System

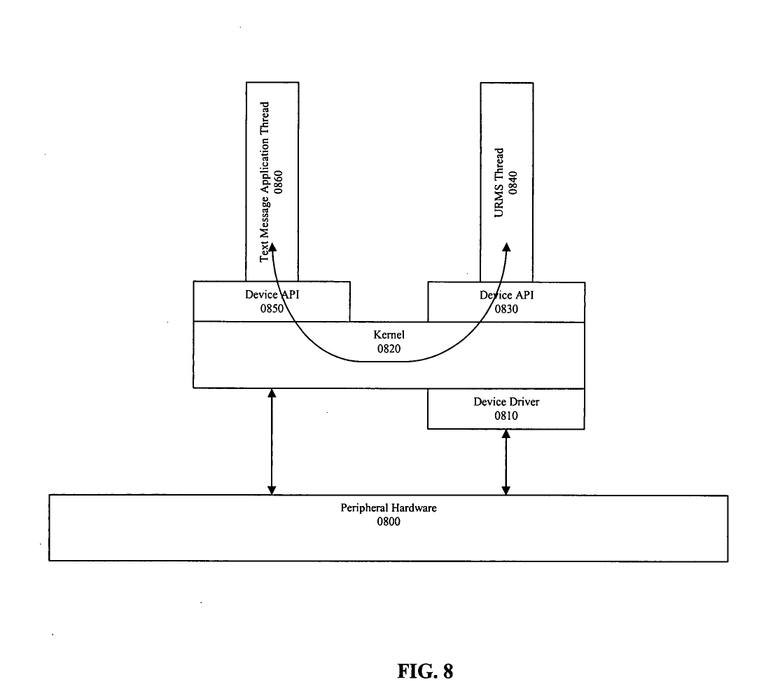

URMS 0350 is a system for measuring if, through what Media Device 0110, when, and/or where an user of Wireless Device 0120 views an Advertisement and/or if, when, how, and/or to what degree the user responds to the Advertisement. As described above, Wireless Device 0120 and/or Non-Wireless Device 0122 includes a URMS. In one embodiment, URMS 0350 can operate as a chip connected to a modem, such as Modem 0344. In another embodiment, URMS 0350 can operate as a software application program on top of operating system, such as Operating System 0346 or as a software program integrated with or embedded in an operating system. This embodiment is described below in reference to FIG. 7. While the present application describes the URMS 0350 as a system located in a Wireless Device 0120, the present invention does not limit the application of URMS 0350 to a Wireless Device 0120. The present invention can adapt URMS 0350 for location on one or more Media Devices 0110 to measure if, when, and/or where an user of such Media Device 0110 views an Advertisement and/or if, when, how, and/or to what degree the user responds to such Advertisement.

In other embodiments, URMS 0350 can operate in Wireless Device 0120 in a variety of ways, including, but not limited to, as program logic integrated in a Modem 0344, a general purpose processor or CPU 0004, a microprocessor, a Baseband Processor 0342, an application processor, a DSP, an application specific integrated circuit (ASIC), a controller, a microcontroller, a field programmable gate array (FPGA), a programmable logic device, other electronic units, or any combination thereof; as a chip integrated with a Modem 0344, a CPU 0004, a microprocessor, a Baseband Processor 0342, an application processor, a DSP, an ASIC, a controller, a microcontroller, a FPGA, a programmable logic device, other electronic units, or any combination thereof; as a chip connected to a CPU 0004, a microprocessor, a Baseband Processor 0342, an application processor, a DSP, an ASIC, a controller, a microcontroller, a FPGA, a programmable logic device, other electronic units, or any combination thereof; as a software program integrated with Operating System 0346; as a software application program operating in or as a helper application in a Web Browser of Wireless Device 0120; or as a software application program operating in a SIM Toolkit.

In the examples where URMS 0350 operates as a software program, URMS 0350 can have access to device hardware, including, but not limited to, Keypad, Microphone, Camera 0332, Television, Location Processor, Bluetooth Baseband Processor, a Barcode Reader 0336, IrDA port, UART port, USB port, a general purpose input/output (GPIO) port, and memory controller. In addition, URMS 0350 may need access to device software, including, but not limited to: Short Messaging Service (SMS), Multimedia Messaging Service (MMS), Enhanced Messaging System (EMS), instant messaging, and/or Web Browser. To access either device hardware or device software, URMS 0350 can utilize its own application programming interfaces (APIs). Alternatively, URMS 0350 can utilize the APIs of programs enabling platform independence. Alternatively, URMS 0350 can utilize the APIs of Operating System 0346. The present invention can enable the installation of URMS 0350 on Wireless Device 0120 in a variety of ways, including, but not limited to: installation at the time of production by the vendor of the device, downloading by the user of the device over-the-air for installation to Wireless Device 0120, or downloading by the user of the device through synchronization with a Personal Computer 0308 for installation to Wireless Device 0120.

URMS 0350 is configured to read and/or store data in any type of Memory 0012, including, but not limited to, any volatile or non-volatile storage medium, RAM 0006, ROM 0008, shared memory, dedicated memory, NAND flash memory, NOR flash memory, and/or Mass Storage 0010. URMS 0350 can access Memory 0012 either indirectly through Memory Controller 0760 or directly to the memory devices.

URMS 0350 may also be configured to transmit and/or receive information to and/or from other devices in Wireless Device 0120 through Bus 0002. Bus 0002 can include, but is not limited to, a system bus and/or a peripheral bus.

FIG. 7 depicts a block diagram of an exemplary URMS 0350, according to embodiments of the present invention. URMS 0350 can include one or more modules, including, but not limited to: MMCMS Module 0400, User Response Measurement Application (URMA) Module 0744, Data Storage Module 0732, Ad Data Code Module 0728, Static Data Module 0746, Dynamic Data Module 0748, Payment Code Module 0730, and Financial Account Data Module 0750.

In one embodiment, URMS includes an optional calendar Module and/or optional GPS Module. The inclusion of the calendar Module and/or GPS Module provides the capability of reminding the use of the wireless device of the time, date, and/or location at which the user can purchase the Product described in the Ad Data Code 0200.

In general, Ad Data Code Module 0728 is configured to perform a variety of functions related to data measuring if, through what Media Device 0110, when, and/or where an user of Wireless Device 0120 and/or a Target Customer views an Advertisement either directly on Wireless Device 0120 and/or any Media Device 0110, including, but not limited to: (1) decompressing, demodulating, and/or decoding a signal carrying Ad Data Code 0200 into data needed to calculate a ROI for the Advertisement viewed, a function which can include, but is not limited to: decompressing, demodulating, and/or decoding a sound wave carrying Ad Data Code 0200 into data constituting parameters which the Module can write to Ad Data File 0734; decompressing, demodulating, and/or decoding an image of a barcode or a string of characters which can be converted into a barcode carrying Ad Data Code 0200 into data constituting parameters which the Module can write to Ad Data File 0734; decompressing, demodulating, and/or decoding a radio signal carrying Ad Data Code 0200 into data constituting parameters which the Module can write to Ad Data File 0734; and/or decompressing, demodulating, and/or decoding an infrared light wave signal carrying Ad Data Code 0200 into data constituting parameters which the Module can write to Ad Data File 0734; (2) storing, writing, and/or appending additional parameters unique to Wireless Device 0120 (e.g., the date, time, and/or location Wireless Device 0120 received Ad Data Code 0200) to the parameters generated by the Advertiser and/or Media Operator 0104 which can enable the present invention to match an user of Wireless Device 0120 and/or Target Customer viewing the Advertisement and the user purchasing a Product promoted in the Advertisement, all of which parameters Ad Data Code Module 0728 can include in an Ad File, which the Module can write to Ad Data File 0734 (in another embodiment, Ad Data Code Module 0728 can write Ad Data Code 0200 to Ad Data File 0734 without adding parameters unique to Wireless Device 0120); and/or (3) writing an image of Ad Data Code 0200 to Ad Data File 0734 for further transmission to any device of a Retailer which can receive Ad Data Code 0200.

Ad Data Code Module 0728 and Payment Code Module 0730 can exchange data with one or more Modules, including, but not limited to: an Infrared Module 0702, an RFID Module 0704, a Synchronization Module 0706, a Barcode Module 0708, an Antenna Module 0710, a Timer Module 0712, a Counter Module 0714, an Event Handler Module 0716, a Keypad Module 0718, a Mapping Module 0720, a Search Module 0722, a Screen Module 0724, and an Audio Module 0726, and/or NFC Module 0758. As would be appreciated by any person with ordinary skill in the art, URMS 0350 can exchange data with other Modules. URMS 0350 may include a combination of these Modules as required by a specific application. Although these Modules are depicted as separate Modules in FIG. 7, one or more of the Modules may be integrated and/or combined. Exemplary Modules with which Ad Data Code Module 0728 and Payment Code Module 0730 can exchange data are described in further detail in Section 2.1.2.3.1 below.

URMA Module 0744 is configured to perform one or more functions, including, but not limited to: (1) searching through any given Ad Data Code 0200, Payment Receipt 1900, Ad Data File 0734, Ad Response File 0738, and/or Payment Data File 0740; (2) matching data, e.g., UPC/EAN/GTIN or name of Product, in: (a) any file containing data on the Advertisements viewed by the user of Wireless Device 0120, including, but not limited to, Ad Data Codes 0200 and/or Ad Data File 0734; (b) any file containing data on the Products purchased by the user, including, but not limited to, Payment Receipts 1900 and/or Payment Data File 0740; and/or (c) any file containing data on the responses by the user to an Advertisement, including, but not limited to, Ad Response File 0738; and/or (3) writing any matching data to Matching Event File 0742. URMA Module is described in further detail in Section 2.1.2.3.3 below

MMCMS Module 0400 is configured to generate an Ad File from Ad Data Code 0200 received from any I-O Device. In another embodiment, Ad Data Code Module 0728 can add parameters unique to Wireless Device 0120 to the parameters from Ad Data Code 0200 to generate an Ad File. In addition, MMCMS Module 0400 is configured to measure the number and types of Advertisements that Wireless Device 0120 (or Non-Wireless Device 0122) receives from the one or more Media Devices 0110. MMCMS Module 0400 transmits the Ad File to an Ad Data File 0734 stored in Data Storage Module 0732.

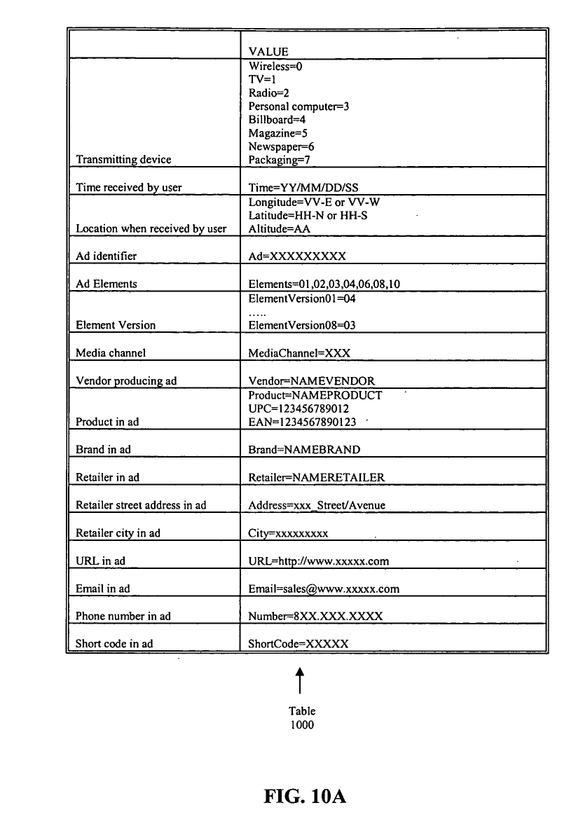

In one embodiment, one or more of the component Modules of the URMS generate values for variables reflecting user viewing of and/or response to an Advertisement. FIG. 9 is a table listing a set of Modules and how each Module can generate values for particular variables reflecting an user viewing an Advertisement and values for particular variables reflecting how an user responds to an Advertisement, according to embodiments of the present invention. Some Modules, e.g., MMCMS Module 0400, can measure just variables reflecting if, through what Media Device 0110, when, and/or where an user views an Advertisement. Other Modules, e.g., Payment Code Module 0730, can measure just variables reflecting if, when, how, or to what degree an user responds to an Advertisement. Screen Module 0724 and Audio Module 0726 are not pictured in FIG. 9, but can also store and/or read values reflecting both an user viewing an Advertisement and how an user responds to an Advertisement.

Payment Code Module 0730 is configured to perform a variety of functions related to data measuring related to data measuring if, when, how, and/or to what degree an user of Wireless Device 0120 and/or a Target Customer responds to an Advertisement viewed on Wireless Device 0120 and/or any Media Device 0110, including, but not limited to: (1) decompressing, demodulating, and/or decoding a signal carrying Payment Receipt 1900 into data needed to calculate a ROI for the Advertisement viewed, a function which can include, but is not limited to: decompressing, demodulating, and/or decoding a sound wave carrying Payment Receipt 1900 into data constituting parameters which the Module can write to Payment Data File 0740; decompressing, demodulating, and/or decoding an image of a barcode or a string of characters which can be converted into a barcode carrying Payment Receipt 1900 into data constituting parameters which the Module can write to Payment Data File 0740; decompressing, demodulating, and/or decoding a radio signal carrying Payment Receipt 1900 into data constituting parameters which the Module can write to Payment Data File 0740; and/or decompressing, demodulating, and/or decoding an infrared light wave signal carrying Payment Receipt 1900 into data constituting parameters which the Module can write to Payment Data File 0740; (2) storing, writing, and/or appending additional parameters unique to Wireless Device 0120 (e.g., the date, time, and/or location Wireless Device 0120 received Payment Receipt 1900) to the parameters generated by the Retailer which can enable the present invention to match an user of Wireless Device 0120 and/or Target Customer viewing the Advertisement and the user purchasing a Product promoted in the Advertisement; all of which parameters Payment Code Module 0730 can include in a Payment File, which the Module can write to Payment Data File 0740 (in another embodiment, Payment Code Module 0730 can write Payment Receipt 1900 to Payment Data File 0740 without adding parameters unique to Wireless Device 0120); and/or (3) writing an image of Payment Receipt 1900 to Payment Data File 0740 for further transmission to any device which can receive Payment Receipt 1900.

Payment Code Module 0730 coordinates with one or more external databases and/or systems such as Wireless Operator Billing Database 0164 and Third Party Payment Database 0166 to measure any response by an user of Wireless Device 0120 and/or Target Customer to an Advertisement. In addition, Payment Code Module 0730 is configured to parse received and/or generated payment information (e.g., a Payment Receipt 1900).

Static Data Module 0746 can include parameters identifying characteristics of the user of Wireless Device 0120 relevant to his/her purchasing behavior that remain constant over a given period of time.

Dynamic Data Module 0748 can include parameters identifying characteristics of Wireless Device 0120 relevant to the purchasing behavior of the user of the Device that can change over a given period of time.

Financial Account Data Module 0750 can comprise one or more components, including, but not limited to: Credit/Debit Card Account Data 0752, which can include data identifying the credit and/or debit account of the user of Wireless Device 0120; Bank Account Data 0754, which can include data identifying the bank account of the user of Wireless Device 0120; and/or Other Financial Account Data 0756, which can include data identifying any other financial account of the user of Wireless Device 0120.

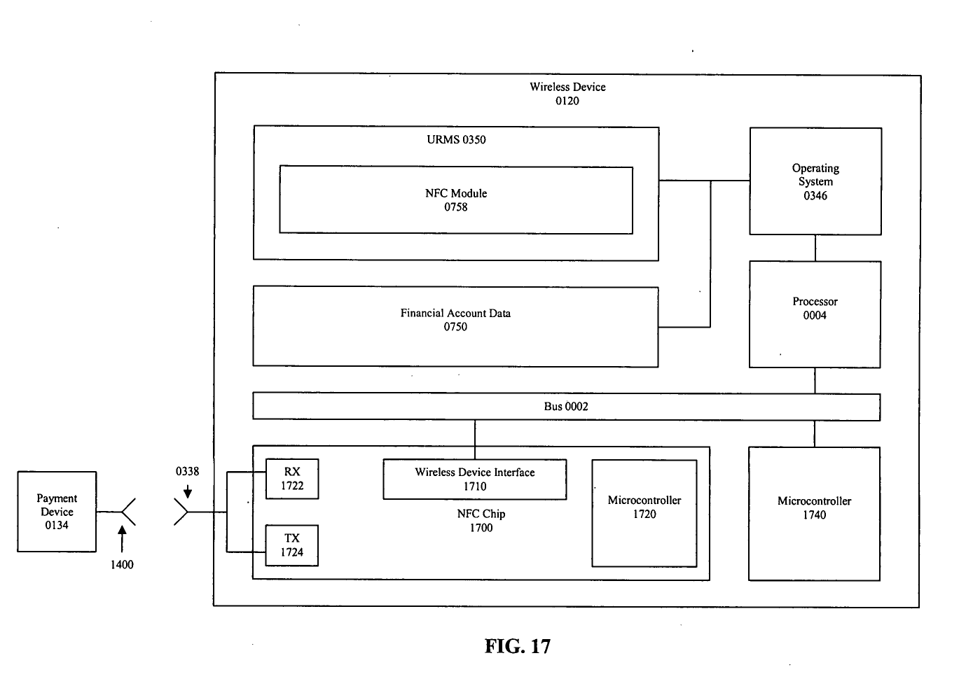

NFC Module 0758 can exchange data between NFC Chip 1700 described in FIG. 17 and any Module in URMS 0350.

The component Modules of URMS 0350 can receive and/or transmit information from and/or to other devices in Wireless Device 0120. If URMS 0350 is a chip connected to Modem 0344, the component Modules can receive and/or transmit information from and/or to other devices in Wireless Device 0120 either directly through Bus 0002 or indirectly through one or more devices, including, but not limited to: a Modem 0344, CPU 0004, a Baseband Processor 0342, an application processor, or a DSP. If URMS 0350 is a software application program operating on top of Operating System 0346, the component Modules can receive and/or transmit information from and/or to other devices in Wireless Device 0120 through processes enabled by Operating System 0346.

URMS 0350 and its Modules can transmit and/or receive data internally and externally in a variety of ways, including, but not limited to, utilizing: a message-passing system of Operating System 0346; any APIs of Operating System 0346; Web Browser 0776; or any other system or protocol enabling internal data exchange within Wireless Device 0120 or external data exchange with devices external to Wireless Device 0120. The present invention defines a Web Browser as a software application enabling an user to view and interact with any content on a web page. A Web Browser can reside on any Data Processing System. A Wireless Device 0120 can contain a Web Browser 0776.

These means of data exchange can enable URMS 0350 to exchange data with other devices in Wireless Device 0120, any given URMS 0350 Module to exchange data with any other URMS 0350 Module, any given URMS 0350 Module to exchange data with any other device in Wireless Device 0120, URMS 0350 to exchange data with any device external to Wireless Device 0120, and any given URMS 0350 Module to exchange data with any device external to Wireless Device 0120.

URMS 0350 receives and/or transmits information from and/or to other devices in Wireless Device 0120 through interfaces or devices including, but not limited to: Microphone Interface 0760; Infrared Interface 0762; RFID Interface 0764; Synchronization Interface 0766; Camera Interface 0768; Television Interface 0770; Keypad 0772 which can include, but is not limited to: the keys representing any alphanumeric character, the keys representing any non-alphanumeric character, e.g., “.”, “/”, a space key, or a return key; the keys representing any specialized function, e.g., direct access to the Internet, email, or text messaging; or any kind of key or input device enabling the user to navigate around a web page, e.g., an input device enabling the user to move a cursor up, down, left, and/or right across a web page and/or pressing the device to represent an input or “click” of the position located by the cursor; Clock 0774; Web Browser 0776 which can support any language including, but not limited to HTML, wireless application protocol (WAP), and/or wireless markup language (WML); Bluetooth Processor 0778 which can process signals from Antenna 0324; Location Processor 0780 which can process signals from a global positioning system (GPS) Antenna and/or any other device enabling Wireless Device 0120 to determine its geographical location; Text Message Application 0782; and/or Display Interface 0784. URMS 0350 can receive and/or transmit information from and to other devices not pictured in FIG. 3 through one ore more other interfaces, including, but not limited to: a GPIO interface, a RS-232 interface, a SIM Card interface, and/or a GPS interface.

The types of data that URMS 0350 and its Modules can transmit and/or receive internally and externally can include, but are not limited to: an Advertisement, Ad Data Code 0200, a response to an Advertisement, Static Information, Dynamic Information, Feedback Information, and/or any other communication.

The kinds of APIs that URMS 0350 and its Modules can use to transmit and/or receive data can include, but are not limited to: messaging APIs; sockets APIs for access to network protocols; or communications APIs. URMS 0350 and its Modules can transmit and/or receive data internally and externally utilizing any kind of communications protocol, including, but not limited to: Transmission Control Protocol/Internet Protocol (TCP/IP) protocol suite; IrDA protocol suite; SMS protocol; MMS protocol; WAP protocol; any kind of communications protocol enabling communications between a Wireless Device Operating System 0346 and Personal Computer 0308 operating system; any kind of communications protocol enabling communications between a Wireless Device Operating System 0346 and STB 0500; any kind of communications protocol enabling communications between a Wireless Device Operating System 0346 and any other Media Device 0110; or any other kind of communications protocol. The means by which URMS 0350 and its Modules can transmit and/or receive data internally and externally utilizing the above protocols and APIs are well known to those with ordinary skill in the art.

### 2.1.2.3.1 AD DATA CODE MODULE & PAYMENT CODE MODULE

The following section describes exemplary Modules with which Ad Data Code Module 0728 and/or Payment Code Module 0730 can exchange data. As would be appreciated by any person with ordinary skill in the art, such Modules can exchange data with additional or alternative Modules, as required.

An Infrared Module 0702 is configured to receive an Advertisement and/or Ad Data Code 0200 from one or more Media Devices 0110 and/or Payment Receipt 1900 from one or more Media Devices 0110 and/or Payment Device 0134 via Infrared Device 0330 and Infrared Interface 0762. Infrared Module 0702 may also be configured to enable Wireless Device 0120 to transmit an infrared signal to another device like a Television STB 0500 to perform functions such as responding to an Advertisement. Infrared Module 0702 may also be configured to measure whether an user takes an action with respect to a Product including, but not limited to, sampling the Product, visiting a retailer, or buying the Product.

RFID Module 0704 is configured to receive an Advertisement and/or Ad Data Code 0200 from one or more Media Devices 0110 and/or Payment Receipt 1900 from one or more Media Devices 0110 and/or Payment Device 0134 via RFID Antenna 0334 and RFID Interface 0764. RFID Module 0704 may also be configured to enable Wireless Device 0120 to transmit a RFID signal to another device to perform functions like responding to an Advertisement. RFID Module 0704 may be further configured to measure whether an user takes an action with respect to a Product including, but not limited to, sampling the Product, visiting a retailer, or buying the Product.

Synchronization Module 0706 is configured to receive an Advertisement and/or Ad Data Code 0200 and/or Payment Receipt 1900 from one or more Media Devices 0100 and/or Payment Device 0134 via Synchronization Device 0326 and Synchronization Interface 0766 and/or to measure whether an user takes some action with respect to a Product, including, but not limited to sampling the Product, visiting a retailer, or buying the Product. Synchronization Module 0706 can enable Wireless Device 0120 to exchange data with any other device, including, but not limited to: a device residing on or attached to a network, e.g., a Personal Computer 0308 or Television 0304, in which case Wireless Device 0120 acts like a client and the network device acts like a server; a device that does not reside on or is not attached to a network, e.g., another Wireless Device, in which case both Wireless Devices can exchange data on a peer-to-peer basis; or some other device. Synchronization Module can utilize any kind of protocol to exchange data with other devices, including, but not limited to: SyncML Representation Protocol developed by the Open Mobile Alliance; any equivalent or successor protocols; any other kind of protocol for specifying the exchange of data across different devices; or any extension to the protocols enabling the search and retrieval of specific types of files, including an Ad Data Code 0200.

Synchronization Interface 0766 enables the Wireless Device 0120 to synchronize with any Media Device 0110, including, but not limited to: a Television 0304 and a Personal Computer 0308. The Synchronization Interface 0766 detects and configures the port used by Wireless Device 0120 to connect to the Media Device 0110. For example, when Wireless Device 0120 connects to a Personal Computer 0308, the Synchronization Interface 0766 detects and configures the port, which can include, but is not limited to: a serial port, e.g., a UART port, a USB port, an IEEE 1394 serial bus port, an infrared port, a Bluetooth port, a 9- or 25-pin communications port, and/or an Ethernet or wireless local area network connection for remote synchronization.

Barcode Module 0708 is configured to receive an Advertisement, Ad Data Code 0200, and/or data signaling some action taken by an user from one or more Media Devices 0110 via Infrared Device and Infrared Interface 0762, Camera 0332 and Camera Interface 0768, Barcode Reader 0336, and/or any other I-O Device. Barcode Module 0708 may also be configured to measure whether an user takes an action with respect to a Product including, but not limited to, sampling the Product, visiting a retailer, or buying the Product.

Antenna Module 0710 is configured to receive an Advertisement and/or Ad Data Code 0200 from one or more Media Devices 0110 and/or Payment Receipt 1900 from one or more Media Devices 0110 and/or Payment Device 0134 via any Antenna, including, but not limited to, Antenna 0322, Antenna 0324, Antenna 0338, and/or Antenna 0339, and Bluetooth Processor 0778 and/or any other processor that processes signals transmitted or received over any wireless protocol. Antenna Module 0710 may also be configured to enable Wireless Device 0120 to transmit a signal to another device to perform functions like responding to an Advertisement. Antenna Module 0710 may also be configured to measure whether an user takes an action with respect to a Product including, but not limited to, sampling the Product, visiting a retailer, or buying the Product.

Timer Module 0712 is configured to measure the time an user performs an action or receives certain information, amount of time (e.g., duration) of certain events/actions, and/or difference in time between certain user events/actions. For example, MMCMS Module 0400 can call Timer Module 0712 to record the time Wireless Device 0120 (or Non-Wireless Device 0122) receives an Advertisement and the time the user of the device performs a task related to the interest the user has in the Product advertised or the user's response to an Advertisement. For example, Payment Code Module 0730 can call Timer Module 0712 to record the time the user buys the Product advertised. These measurements can enable an Advertiser to measure the difference in time between the time the user views an Advertisement and the time the user buys the Product advertised. In an embodiment, any Module can call Timer Module 0712 to record the time an user views and Advertisement and/or the time an user responds to an Advertisement.

Counter Module 0714 is configured to measures the number of times the user of Wireless Device 0120 performs certain actions. Any Module can record if an user of Wireless Device 0120 performs an action one or more times. For example, if the user views the same Advertisement multiple times, Counter Module 0714 can measure the number of times the user views the Advertisement. In this example, Web Browser 0776 can read if the user calls the same IP address on the Internet or the same file in Memory 0012. The number of times an user views an Advertisement can be one variable URMA Module 0744 measures to generate a score reflecting the degree of response of the user to the Advertisement.

Event Handler Module 0716 is configured to measure whether Wireless Device 0120 user performs certain actions. For example, if the user opens a particular text message, Event Handler Module 0716 can record the opening and call Timer Module 0712 to record the time the user opens the message. The time that the user opens the message can be one variable URMA Module 0744 measures to generate a score reflecting the degree of response of the user to the Advertisement.

Keypad Module 0718 is configured to measure whether a Wireless Device 0120 user inputs into the device or selects utilizing Keypad 0772 the name, phone number, email address, uniform resource locator (URL), short code, address, and/or other alphanumeric representation of the vendor, retailer, or Product advertised.

Mapping Module 0720 is configured to measure whether a Wireless Device 0120 user visits a physical retailer or a department of the Retailer. Mapping Module 0720 coordinates with Location Processor 0780 and one or more external databases such as GMLC 0160 and URMS Map Database 0162 to measure such activity. In one embodiment, other Modules can call Mapping Module 0720 to record the location of the user when viewing or responding to an Advertisement.

Search Module 0722 is configured to measure whether a Wireless Device 0120 user searches through a browser, text message, or any other method to access information such as the vendor, Product, or retailer advertised. In addition, Search Module 0722 is configured to measure whether a Wireless Device 0120 user views an Advertisement when presented with an Advertisement at a given search engine web site.

Screen Module 0724 is configured to measure whether a Wireless Device 0120 user inputs into the device or selects utilizing Display Interface 0784 any response to a function on a web page or any other kind of program or menu enabling an user to interact with it. The user can input a response by utilizing any kind of device that touches the screen of the device, e.g., the finger of the user, a stylus, or any other kind of pointing device.

Audio Module 0726 is configured to measure whether Wireless Device 0120 user inputs into the device or selects utilizing Microphone Interface 0760 any response to a function on a web page or any other kind of program or menu enabling an user to interact with it through audio means. The user can input a response, e.g., selecting an option among a menu, by speaking into Microphone 0328. The Module can record if the user selected a particular response through a variety of means, including, but not limited to: an Advertiser System 0100 can transmit to Wireless Device 0120 an Ad Data Code 0200 associated with the response or option selected by the user; Advertiser System 0100, a Wireless Operator, or a Third Party Server 0150 can convert speech to text and then review the text to determine which response or option the user selected; Wireless Device 0120 can initiate a voice call by speaking a phone number that matches a phone number in Ad Data File 0734, which Audio Module 0726 can recognize by Wireless Device 0120 converting the speech to text; or Wireless Device 0120 can initiate a web page request by speaking a URL that matches a URL in Ad Data File 0734, which Audio Module 0726 can recognize by Wireless Device 0120 converting the speech to text.

For example, Wireless Device 0120 user can listen to a menu of options of potential hotels or motels while driving. The menu can be provided by a web site or a service provided by a Wireless Operator or Third Party Server 0150 accessed by the user, which enables the user to interact with the site or service through audio commands. The user can select one option, e.g., one hotel, to contact through Wireless Device 0120. The device can contact the hotel through a variety of means, including, but not limited to: making a voice call to the hotel or transmitting a data connection to the hotel. When the user selects one hotel and the device contacts the hotel, the hotel can transmit to the device an Ad Data Code 0200 associated with the response. In this example, Advertiser System 0100, i.e., a server operated by the hotel, can measure whether Wireless Device 0120 user “viewed” its Advertisement by selecting the hotel among a menu of hotels by speaking into the device. To enable Advertiser System 0100 to measure whether the user responded to the Advertisement, other Modules, e.g., Mapping Module 0720 or Payment Code Module 0730, can measure if the user visited the hotel or purchased a room at the hotel, respectively.

### 2.1.2.3.2 DATA STORAGE

Data Storage Module 0732 is configured to store the data collected from Modules that can generate and/or collect data for processing by other systems, applications, or Modules such as URMA Module 0744. Data Storage Module 0732 includes an Ad Data File 0734, an Ad Reception File 0736, and/or an Ad Response File 0738. Data Storage Module 0732 can store data in any Memory 0012 that is part of Wireless Device 0120, including, but not limited to, RAM 0006, flash memory, Mass Storage 0010, and/or a SIM card.

Ad Data File 0734 contains the Ad Files created by MMCMS Module 0400. An Ad File is the combination of Ad Data Code 0200 and any information added by MMCMS Module 0400 describing the characteristics of an Advertisement, e.g., the time an user of Wireless Device 0200 viewed such Advertisement, that would enable the URMS to measure if, when, how, and/or to what degree an user responds to the Advertisement.

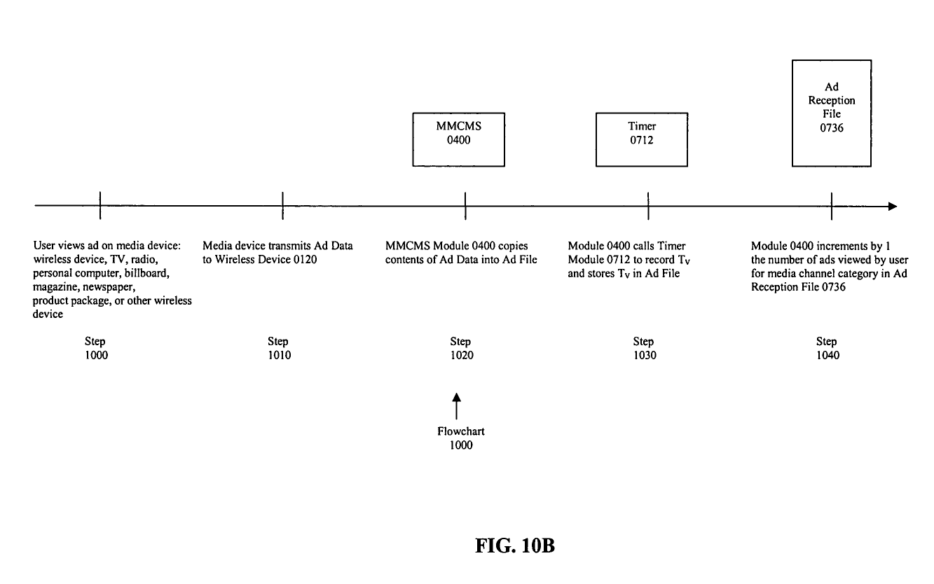

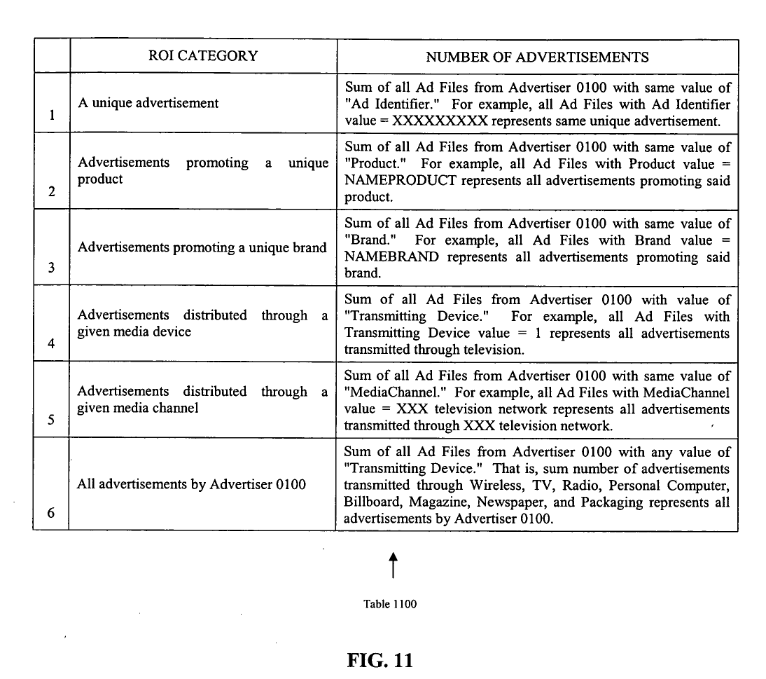

FIG. 10A shows an exemplary template for an Ad File associated with each Ad Data Code 0200, according to embodiments of the present invention. The objective of the Ad File is to provide data to Wireless Device 0120 enabling it both: (a) to measure if, through what Media Device 0110, when, and/or where Wireless Device 0120 user views an Advertisement distributed through any Media Channel, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316; and/or (b) to measure if, when, how, and/or to what degree the user responds to the Advertisement.

The type of data enabling the measurement can include, but is not limited to: the transmitting device through which Wireless Device 0120 receives Ad Data Code 0200, which is measured by the appropriate Module as described in FIG. 10B; the time when Wireless Device 0120 receives Ad Data Code 0200, the location of Wireless Device 0120 when it receives Ad Data Code 0200, an Ad Identifier supplied by Advertiser System 0100, which identifies each unique Advertisement if the Advertiser wants to measure the effectiveness of the Advertisement; Ad Elements (defined in FIG. 58), which Advertiser System 0100 associates with the Advertisement to help enable Advertiser System 0100 to measure the effectiveness of a given Ad Element; Element Versions (defined in FIG. 59), which Advertiser System 0100 associates with the Advertisement to help enable Advertiser System 0100 to measure the effectiveness of a given Element Version; Media Channel, which Advertiser System 0100 associates with the Advertisement to help enable Advertiser System 0100 to measure the effectiveness of a given Media Channel; data identifying the vendor of the Product advertised to enable Modules 0400 and 0702 through 0726 to match any user response associating the vendor name with an Advertisement by the vendor; data identifying the Product advertised, either utilizing the name of the Product, a code for the Product, e.g., UPC, EAN, GTIN, or another means of identifying a given Product, to enable Modules 0400 and 0702 through 0726 to match any user response associating the Product with an Advertisement of the Product; data identifying the brand advertised to enable Modules 0400 and 0702 through 0726 to match any user response associating the brand with an Advertisement of the brand; data identifying the Retailer advertised to enable Modules 0400 and 0702 through 0726 to match any user response associating the Retailer with an Advertisement of the Retailer; data identifying the Retailer street address advertised to enable Mapping Module 0720 to match any location of Wireless Device 0120 with the address advertised; data identifying the Retailer city advertised to enable Mapping Module 0720 to match any location of Wireless Device 0120 with the city advertised; data identifying the URL advertised to enable Keypad Module 0718, Search Module 0722, and/or any other Module to match any user response associating the URL with an Advertisement including the URL; data identifying the email address advertised to enable Modules 0400 and 0702 through 0726 to match any user response associating the email address with an Advertisement including the email address; data identifying the phone number advertised to enable Modules 0400 and 0702 through 0726 to match any user response associating the phone number with an Advertisement including the phone number; data identifying the short code or text messaging address advertised to enable Modules 0400 and 0702 through 0726 to match any user response associating the short code or text messaging address with an Advertisement including the short code or text messaging address; and/or data identifying the category of the Product advertised.

An Advertiser can supply the above data for transmission directly to Wireless Device 0120 and/or indirectly through any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. Advertiser System 0100 can supply the data in one file or multiple files.

Ad Reception File 0736 contains information that can enable an Advertiser to measure and compare the effectiveness of advertising transmitted through different Media Devices 0110. In an embodiment, Ad Reception File 0736 contains information about how many Advertisements through any given Media Device an user of Wireless Device 0120 views for a given Product over a given time period.

Ad Response File 0738 contains information about if, when, how, and/or to what degree a Wireless Device 0120 user performs certain actions related to a Product, vendor, and/or Retailer in Advertisements viewed by the user. Any Module that collects data about Wireless Device 0120 user response to an Advertisement stores the values it collects in Ad Response File 0738.

Payment Data File 0740 contains information about any data generated and/or collected by Payment Code Module 0730.

Matching Event File 0742 contains information about any data generated by URMA Module 0744.

### 2.1.2.3.3 USER RESPONSE MEASUREMENT APPLICATION (URMA) MODULE

While the present invention teaches how a URMA Module 0744 can calculate the ROI of a given Advertisement by utilizing data generated and/or collected by modules and/or devices described in the present invention, URMA Module 0744 can calculate the ROI of a given Advertisement by utilizing data generated and/or collected by other modules and/or devices not described in the present invention.

Generally, the URMA Module 0744 calculates the denominator of the ROI for a given Media Channel by summing the number of Advertisements received by all users exposed only to the Media Device 0110 or Media Channel. For example, while most users in any population will receive Advertisements for a given Product through multiple media channels, some users in the population will receive the Advertisements through only Television 0304. The URMA Module 0744 calculates the ROI denominator by summing the number of Television Advertisements received by the users. The URMA Module 0744 calculates the average User Response Score for just the users and divides the User Response Score by the ROI denominator. This method can enable an Advertiser to determine how users respond solely to Television advertising.

In one embodiment, URMA Module 0744 can be located in URMS 0350, as illustrated in FIG. 7. In another embodiment, URMS 0350 can transmit the data collected by its Modules to a Wireless Operator, which can have a computer program product perform the functions of URMA Module 0744 on the data. In another embodiment, URMS 0350 can transmit the data collected by its Modules to Advertiser System 0100, which can have a computer program product perform the functions of URMA Module 0744 on the data. In another embodiment, URMS 0350 can transmit the data collected by its Modules to a Third Party Server 0150 (instead of Wireless Operator or Advertiser System 0100), which can have a computer program product perform the functions of URMA Module 0744 on the data.

In another embodiment, a Third Party Server 0150 can directly collect the same data collected by the URMS 0350 Modules that measure both if an user views an Advertisement and how an user responds to an Advertisement and then execute a computer program product that performs the functions of URMA Module 0744 on the data. For example, a Third Party Server 0150 can directly collect data on the Advertisements viewed by an user from a TV Operator or Internet Server 6940 in FIG. 69. In addition, a Third Party Server 0150 can directly collect from a credit/debit card vendor the data on the payments made by an user if the user utilizes a credit/debit card to buy the Product promoted in a given Advertisement.

URMA Module 0744 is configured to generate an User Response Score, which reflects the degree of responsiveness of an user to a unique Advertisement, and sum the number of Advertisements viewed by the user to calculate the ROI. In the preferred embodiment, the URMA Module 0744 calculates the User Response Score by summing the Products of each variable measuring the degree of user responsiveness to an Advertisement by their respective weights. An Advertiser can calculate a ROI by dividing the average User Response Score by the number of Advertisements transmitted to the users.

An Advertiser can compare the ROI across different Media Channels in one embodiment as follows. An Advertiser can calculate the ROI for a given Media Device 0110 by taking the average User Response Score for those users who received Advertisements through only the Media Device 0110 and dividing the User Response Score by the number of those Advertisements transmitted to the users. For example, some users in any population will receive Advertisements for a given Product through a Wireless Device 0120. The URMS calculates the average User Response Score for just the users and divides the User Response Score by the number of wireless Advertisements received by the users to generate the ROI for Advertisements distributed through Wireless Devices 0120. Other users in any population will receive Advertisements for a given Product through only Television 0304. The URMS calculates the average User Response Score for just the users and divides the User Response Score by the number of Television Advertisements received by the users to generate the ROI for Advertisements distributed through Television 0304. The Advertiser then compares the ROI of wireless Advertisements against the ROI of Television Advertisements to determine which Media Device advertising was more effective.

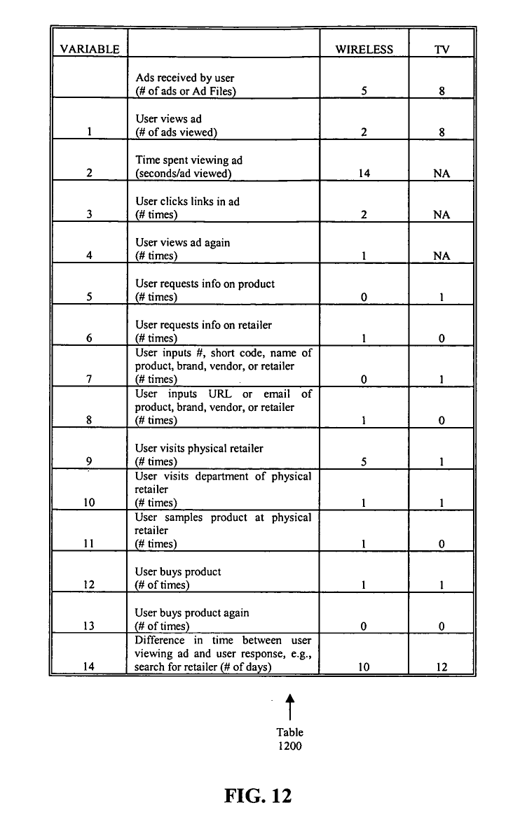

FIG. 12 depicts an exemplary table comparing user responses to Wireless Advertisements and Television Advertisements.

URMA Module 0744 can calculate a ROI to enable an Advertiser to: (a) determine whether the benefit of any given Advertisement is greater or less than its cost; and/or (b) compare the ROI of Advertisements across different Media Devices 0110 and/or Media Channels. URMA Module 0744 can calculate the ROI for an individual user and/or a group of users. For any given individual user, URMA Module 0744 can calculate the ROI for a given Advertisement, those Advertisements promoting a given Product, those Advertisements promoting a given brand, those Advertisements through any given Media Device 0110, e.g., Television 0304, those Advertisements through any given Media Channel, e.g., a given cable television network, and/or those Advertisements from Advertiser System 0100. For any given group of users, Advertiser System 0100 can sum the data collected from each of the users in the group to calculate the ROI in each of the above categories.

To generate the denominator of the ROI for an individual user over a given time period, URMA Module 0744 can utilize values from Ad Data File 0734 and Ad File Template 1000, as illustrated in FIG. 10, to sum the number of Advertisements viewed by the user during the time period. To determine a ROI on an economic or financial basis, an Advertiser can multiply the number of each Advertisement by the average unit cost it paid to distribute the Advertisement.

To generate the numerator of the ROI for an individual user during the time period, URMA Module 0744 can utilize values from one or more of the following variables from Ad Response File 0738 and Table 1200 in FIG. 12. Table 1200 shows the different variables measuring how an user can respond to any given Advertisement, which can include, but are not limited to:
1. The number of times user views an Advertisement.
2. The amount of time an user spends viewing an Advertisement.
3. The number of times an user clicks the links in an Advertisement.
4. The number of times an user views an Advertisement again.
5. The number of times an user requests information on the Product.
6. The number of times an user requests information on a retailer where the user can buy the Product.
7. The number of times an user inputs the number, short code, or name of the Product, vendor, or retailer.
8. The number of times an user inputs the URL of the Product, vendor, or retailer.
9. The number of times an user visits a physical retailer.
10. The number of times an user visits a department of a physical retailer selling the Product.
11. The number of times an user samples the Product at a physical retailer.
12. The number of times an user buys the Product at any retailer, e.g., a physical or online retailer.
13. The number of times an user buys the Product again.
14. The difference in time between the time an user views an Advertisement and the time the user performs a task on Wireless Device 0120 that reflects a response to the Advertisement.

In other embodiments, URMA Module 0744 can utilize values from other variables that can be measured by the Modules in FIG. 7. The addition of new Modules measuring different types of user responses to an Advertisement can enable URMA Module 0744 to add more variables.

Each of the above variables represents different degrees of responsiveness of an user to an Advertisement. Most Advertisers would consider a high value of Variable 12 and Variable 13 to represent the most effective response to an Advertisement.

Using the systems and methods described herein, an Advertiser can measure the effectiveness of an Advertisement not only by measuring whether and how often an user buys a Product advertised, but also by measuring responses to an Advertisement that are short of buying the Product advertised yet still indicative of user interest in the Product advertised. Even if an Advertisement produced a low value on Variable 12 and Variable 13, an Advertisement that produced a high value on one or more of Variables 1-11 could still reflect significant user interest in the Product advertised that could produce high scores on Variable 12 and Variable 13 in the long-term. Most of these intermediate variables are data that Advertisers cannot measure reliably with current technology. The systems and methods described herein enable an Advertiser to measure such intermediate variables.

Different Advertisers can value different variables differently. To some Advertisers, an user sampling of a Product can be a reliable predictor of the user buying the Product. For example, some research suggests that a test drive of an automobile often leads to a purchase of the automobile. In this example, an automobile Advertiser could attribute a high weight on the value of Variable 11. To other Advertisers, an user sampling of a Product can be an unreliable predictor of the user buying the Product. For example, a vendor of raw meat or seafood typically cannot enable potential customers to sample its Product. In this example, a raw meat or seafood Advertiser could attribute a low weight on the value of Variable 11.

An Advertiser can apply any kind of formula it wishes to generate the numerator of the ROI. In one embodiment, URMA Module 0744 can apply the following formula (“Weighted Sum Formula”) to generate an User Response Score (URS), which can reflect the overall degree of responsiveness of an user to an Advertisement.
URS=[(Variable 1)*(Weight 1)]+[(Variable 2)*(Weight 2)]+[(Variable 3)*(Weight 3)]+ . . . +[(Variable n)*(Weight n)]
The sum of Weights 1-n should total 100%.

URMA Module 0744 can utilize the User Response Score as the numerator in the ROI. URMA Module 0744 can utilize the ROI Category preferred by Advertiser System 0100 as the denominator in the ROI. To generate one measure of ROI, URMA Module 0744 can divide the User Response Score by the Number of Advertisements in any given ROI Category.

Utilizing the User Response Score as the numerator could make it difficult for an Advertiser to isolate the effect that a unique Advertisement, Advertisements distributed through a given Media Device 0110, and Advertisements distributed through a given Media Channel will have on the ROI for Categories 1, 4, and 5, respectively. The overall User Response Score can measure the response of an user to multiple unique Advertisements, Advertisements distributed through multiple Media Devices 0110, and Advertisements distributed through multiple Media Channels. For example, an user can receive two or more unique Advertisements promoting Product named XYZ with UPC Code 123456789012. The User Response Score could measure, e.g., the purchase of Product XYZ. Without some factor directly linking the purchase of Product XYZ to a specific unique Advertisement, an Advertiser could find it difficult to determine how to attribute which purchases of Product XYZ to which unique Advertisement. Similarly, an user can receive Advertisements for Product XYZ through both Television 0304 and Personal Computer 0308 or an user can receive Advertisements for Product XYZ through both broadcast television network 1 and cable television network 2.

In the case of ROI Categories 1, 4, and 5, URMA Module 0744 can utilize the User Response Score of just those user responses for which the user receives just one unique Advertisement, the user receives Advertisements distributed through a single Media Device 0110, and the user receives Advertisements distributed through a single Media Channel, respectively. Narrowing the denominator to the measures can enable an Advertiser to attribute any user response to one unique Advertisement, one Media Device 0110, or one Media Channel.

In the case of ROI Categories 2, 3, and 6, URMA Module 0744 can utilize the User Response Score of all user responses. If an Advertiser wants to calculate the ROI for all Advertisements transmitted to the user promoting a unique Product (Category 2), Advertiser System 0100 can utilize the User Response Score measuring the response of the user relating to the Product advertised as identified by the Product name and/or UPC Code.

For a group of users, an Advertiser System 0100 can utilize the sum of the User Response Score of the user group as the numerator and the number of Advertisements in any given ROI Category as the denominator to calculate the ROI. Just as in the case of calculating a ROI for an individual user, utilizing all of the User Response Scores as the numerator could make it difficult for an Advertiser to isolate the effect that a unique Advertisement, Advertisements distributed through a given Media Device 0110, and Advertisements distributed through a given Media Channel will have on the ROI for Categories 1, 4, and 5, respectively.

In the case of Categories 1, 4, and 5 for a group of users, URMA Module 0744 can utilize the User Response Score of just those users for which the users receive just one unique Advertisement, the users receive Advertisements distributed through a single Media Device 0110, and the users receive Advertisements distributed through a single Media Channel, respectively. Narrowing the denominator to the measures can enable an Advertiser to attribute the responses of the group of users to one unique Advertisement, one Media Device 0110, or one Media Channel.

For example, an Advertiser can calculate the ROI across two different Media Devices 0110. Some users in any group of users will receive Advertisements for Product named XYZ with UPC Code 123456789012 only through the Wireless Base Station 0302. An Advertiser can reliably attribute any user responses, e.g., purchases of Product XYZ among the users, to Advertisements received through Wireless Base Station 0302. URMA Module 0744 can calculate the ROI for Advertisements distributed through Wireless Base Station 0302 by utilizing the User Response Score of just the users.

Other users in the group of users will receive Advertisements for Product XYZ with UPC Code 123456789012 only through Television 0304. Advertiser System 0100 can reliably attribute any user responses, e.g., purchases of Product XYZ among the users, to Advertisements received through Television 0304. URMA Module 0744 can calculate the ROI for Advertisements distributed through Television 0304 by utilizing the User Response Score of just the users.

The Advertiser can then compare the ROI of wireless Advertisements against the ROI of Television Advertisements to determine which Advertisement was more effective. The larger the group of users whose scores the Advertiser can measure, the greater the probability that there will be a significant number of users who receive Advertisements through one Media Device 0110 or one Media Channel and the higher the reliability of any ROI calculation of Advertisements through the Media Device 0110 or Media Channel.

### 2.1.2.3.4 EXEMPLARY IMPLEMENTATION OF URMS

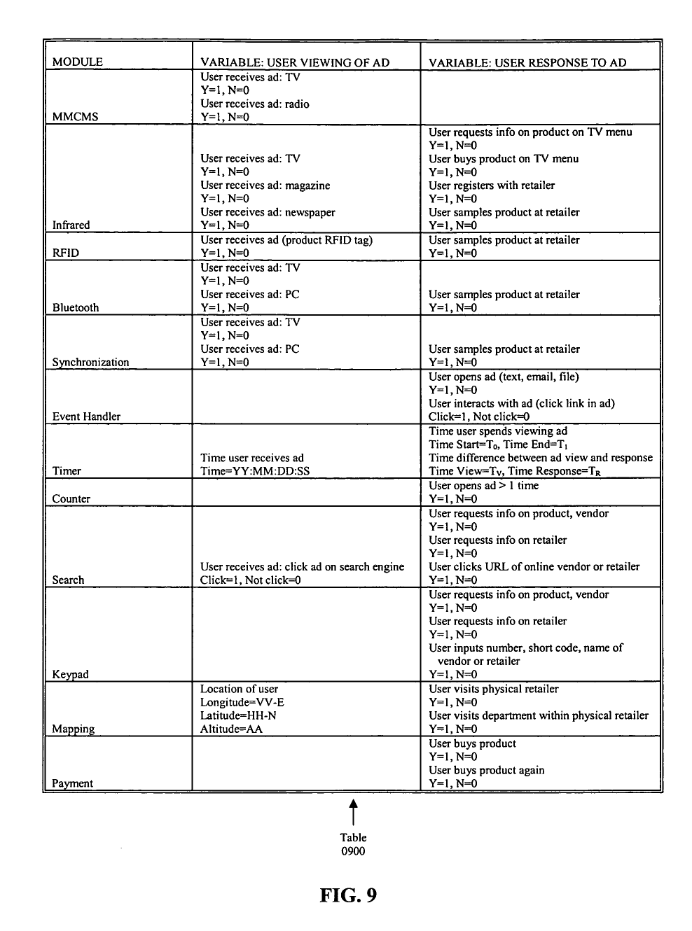

FIG. 8 depicts a block diagram of an exemplary implementation of a URMS in a Wireless Device 0120 as a software application program operating on top of an operating system, such as Operating System 0346 of FIG. 3, according to embodiments of the present invention. In one embodiment, the component Modules of URMS 0350 can receive and/or transmit data from and/or to Peripheral Devices 0800 in Wireless Device 0120 through Operating System 0346. Peripheral Devices 0800 can include, but are not limited to, one or more of the devices numbered from 0760 through 0784 in FIG. 7.

Some operating systems do not permit a software application program to access directly a hardware device. For use with such operating systems, Kernel 0820 accesses hardware devices through one or more Device Drivers 0810. A Device Driver 0810 can provide a Device's API 0830 to which URMS Thread 0840 can link. URMS Thread 0840 can access a hardware device through API 0830 either synchronously or asynchronously.

In addition, some operating systems do not permit a software application program to access directly another software application. For use with such operating systems, Kernel 0820 coordinates access to the applications. FIG. 8 depicts an exemplary access by URMS Thread 0840 to another application, e.g., Text Message Application Thread 0860, through Kernel 0820.

In another embodiment, URMS 0350 can operate with an operating system that permits the component Modules of URMS 0350 to receive and/or transmit information directly from and/or to Peripheral Devices 0800 in Wireless Device 0120. In another embodiment, URMS 0350 can operate as an applet in a virtual machine operating on top of Operating System 0346.

2.1.2.4 Multiple Media Channel Measurement System (MMCMS)

The present invention includes a system and related methods for a Wireless Device to measure if, through what Media Device 0110, when, and/or where a wireless user views an Advertisement distributed through any Media Channel to determine the effectiveness of the Advertisement. The present invention refers to the system as the MMCMS. The MMCMS comprises a MMCMS Module 0400 for converting an Ad Data Code 0200 into an Ad File, the I-O Devices of one or more Wireless Devices 0120, described above in Section 2.1.2.2.1, one or more Media Devices 0110, described above in Section 2.1.2.1, and the associated I-O Devices of the Media Devices 0110.

The MMCMS can enable Advertiser System 0100 to measure not only the ROI of an Advertisement transmitted by Wireless Base Station 0302 to Wireless Device 0120, but also the ROI of an Advertisement transmitted by Media Devices 0110 other than Wireless Base Station 0302. An Advertiser can find it difficult to measure with current approaches if, when, how, and/or to what degree an user responds to an Advertisement distributed through many Media Devices 0110. There exist approaches for measuring whether an user views an Advertisement through devices like Television 0304 and Radio 0306 and whether an user responds to an Advertisement distributed to devices enabling the user to send to an Advertiser a response like Personal Computer 0308 and Wireless Device 0120. An Advertiser can measure whether an user buys a Product in response to an Advertisement distributed to Personal Computer 0308 or Wireless Device 0120 as long as the user buys the Product at an online vendor or retailer.

However, these approaches generally do not measure whether an user takes actions short of buying a Product advertised yet still indicative of user interest in the Product advertised. Moreover, these approaches generally do not measure whether an user buys a Product at a physical vendor or retailer. The MMCMS can enable Advertiser System 0100 to measure and compare the ROI of Advertisements distributed through multiple Media Devices 0110.

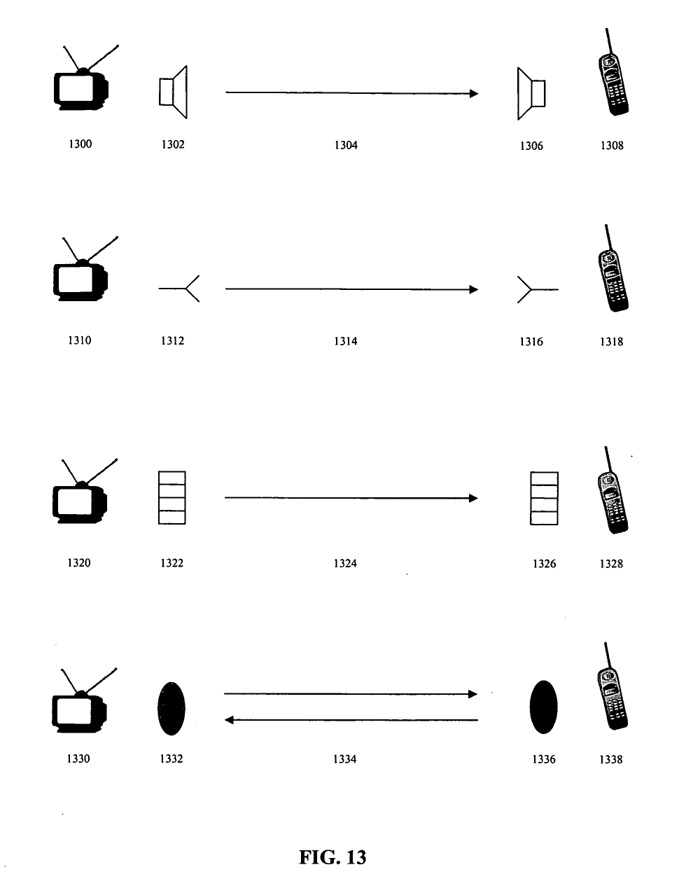

FIG. 13 depicts a diagram of a specific embodiment of the MMCMS exchanging data in the case of a Television Advertisement, according to embodiment of the present invention. A Television can transmit and/or receive an Advertisement and/or Ad Data Code 0200 to and/or from Wireless Device 0120 through a variety of means, including, but not limited to: Television 1300 transmitting an Advertisement and/or Ad Data Code 0200 through Speaker 1302 through Medium 1304, which can be a physical air channel to Microphone 1306 of Wireless Device 1308; Television 1310 transmitting an Advertisement and/or Ad Data Code 0200 through Antenna 1312, which can have the same or similar functions of Antenna 0324, through Medium 1314, which can be an electromagnetic channel, to Antenna 1316, which can have the same or similar functions of Antenna 0324 to Wireless Device 1318; Television 1320 transmitting an Advertisement and/or Ad Data Code 0200 through Synchronization Device 1322, which can have the same or similar functions of Synchronization Device 0326, through Medium 1324, which can be a wired channel, to Synchronization Device 1326, which can have the same or similar functions of Synchronization Device 0326, to Wireless Device 1328; Television 1330 transmitting an Advertisement and/or Ad Data Code 0200 through Infrared Device 1332, which can have the same or similar functions of Infrared Device 0330, through Medium 1334, which can be a wireless channel supporting infrared communications, to Infrared Device 1336, which can have the same or similar functions of Infrared Device 0330, to Wireless Device 1330. In another embodiment, the MMCMS can support any other kind of means of transmitting an Advertisement and/or Ad Data Code 0200 from any other kind of device attached to a Television 0304.

### 2.1.3 PAYMENT ARCHITECTURE

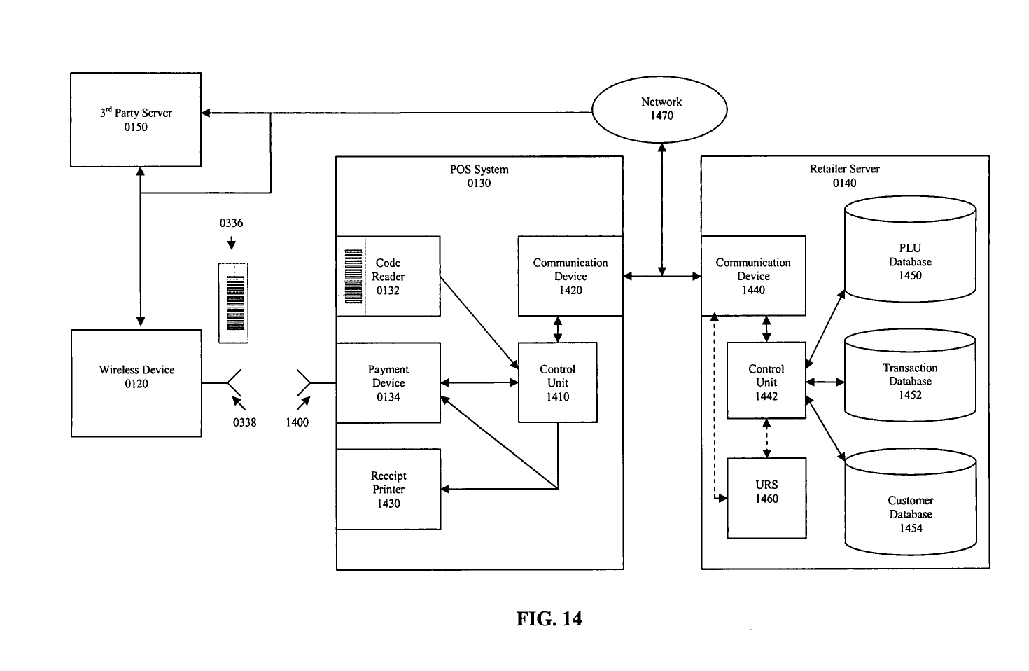

FIG. 14 depicts a functional block diagram of a portion of System 0090 measuring an user response to an Advertisement by purchasing a Product at a Retailer, according to embodiments of the present invention. The payment portion of the system includes Wireless Device 0120, Third Party Server 0150, POS System 0130, Retailer Server 0140, and Network 1470.

Wireless Device 0120 is configured to transmit to Code Reader 0132 any Ad Data Code 0200 and/or Ad Data File 0734 and/or exchange with Payment Device 0134 any data needed to execute the purchase of one or more Products. Section 2.1.2.2 above described in detail Wireless Device 0120.

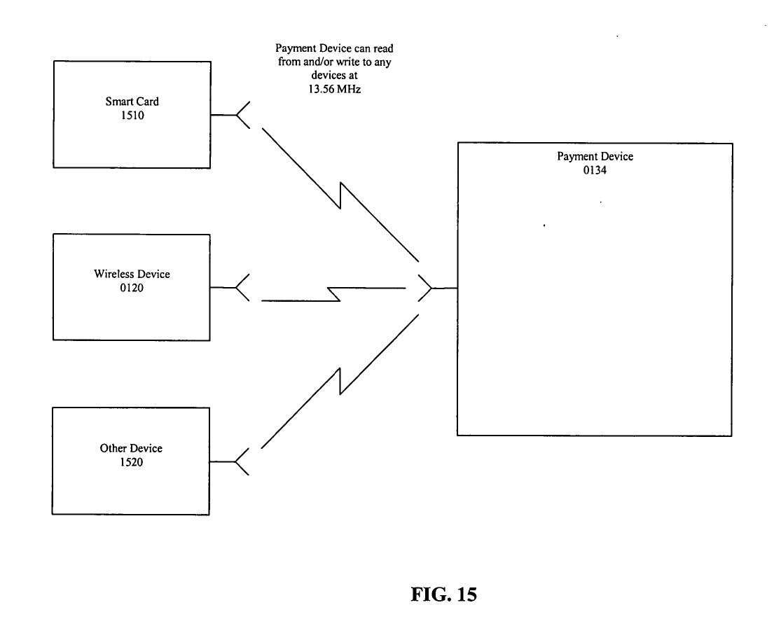

POS System 0130 includes one or more components, including, but not limited to: Code Reader 0132; Payment Device 0134; NFC Device 1400; Control Unit 1410; Receipt Printer 1430, which can be any device which prints in physical form a receipt of the Product(s) purchased by an user of Wireless Device 0120; and Communication Device 1420, which can be any device enabling the exchange of data between POS System 0130 and Retailer Server 0140 either directly or through Network 1470. FIG. 15 depicts an exemplary process for any contactless device, including Wireless Device 0120, to exchange data with a Payment Device 0134, according to embodiments of the present invention.

NFC Device 1400 is a Data Processing System configured to enable Payment Device 0134 to exchange data with Wireless Device 0120 and/or any other device utilizing the NFC or any other contactless standard. NFC Device 1400 can comprise at least a Processor 0004 designed to process data utilizing such standard and a Communications Interface 0014 designed to transmit and/or receive signals utilizing such standard.

Control Unit 1410 is configured to perform one or more of the following functions, including, but not limited to: receive from Code Reader 0132 any Ad Data Code 0200 and/or parsing from the Code the unique code identifying the Product promoted in a given Advertisement; receive from Payment Device 0134 any data enabling Wireless Device 0120 to pay for one or more Products; transmit to Retailer Server 0140 a request to look up the name of the Product associated with the unique code identifying the Product promoted in a given Advertisement, and/or the unit price of the Product; receive from Retailer Server 0140 a file containing the data constituting Payment Receipt 1900; transmit to Receipt Printer 1430 a file containing the data constituting Payment Receipt 1900, a physical copy of which Receipt Printer 1430 can print for user; and/or transmit to Payment Device 0134 a file containing the data constituting Payment Receipt 1900, an electronic copy of which Payment Device 0134 can transmit to Wireless Device 0120 through NFC Device 1400.

Retailer Server 0140 includes one or more components, including, but not limited to: Communication Device 1440, Control Unit 1442, PLU Database 1450, Transaction Database 1452, and/or Customer Database 1454. Although Retailer Server 0140 in the present embodiment can include separate databases for PLU Database 1450, Transaction Database 1452, and Customer Database 1454, Retailer Server 0140 can include any one or more combination of databases which include data in databases 1450, 1452, and 1454. Retailer Server 0140 can be integrated with POS System 0130, collocated with POS System 0130, or located separately from POS System 0130 either in or outside a given store. In one embodiment, Retailer Server 0140 can include Retailer user response measurement system (RURS) 1460, which is a computer program product capable of performing one or more the functions performed by URMS 0350. In an embodiment, RURS 1460 can receive, process, store, and/or transmit any data, including, but not limited to, data in: Ad Data Codes 0200, Payment Receipts 1900, Ad Data File 0734, Ad Response File 0738, Payment Data File 0740, and/or Matching Event File 0742. In addition, RURS 1460 can transmit through Network 1470 any of the data to Advertiser System 0100 directly or indirectly through Third Party Server 0150. RURS 1460 can find matches between any Product purchased and any Product promoted in an Advertisement viewed by user of Wireless Device 0120 through one or more means, including, but not limited to, the following steps: (1) search through Payment Receipt 1900, Transaction Database 1452, Customer Database 1454, or any other database at POS System 0130, Retailer Server 0140, and/or any other server containing the data for the unique code, e.g., UPC/EAN/GTIN, identifying any Product purchased by user of Wireless Device 0120; (2) search through any Ad Data Code 0200 and/or Ad Data File 0734 received from Wireless Device 0120 for the unique code of any Product purchased by user of Wireless Device 0120; (3) match data, e.g., UPC/EAN/GTIN or name of Product, in any file containing data on the Advertisements viewed by the user and any file containing data on the Products purchased by the user; and/or (4) write any matching data to Matching Event File 0742.

Control Unit 1442 is configured to receive from POS System 0130 a request to look up the name of the Product associated with the unique code identifying the Product promoted in a given Advertisement, and/or the unit price of the Product; and/or transmit to POS System 0130 a file containing the data constituting Payment Receipt 1900;

Network 1470, over which Retailer Server 0140 can transmit to Wireless Device 0120, any Media Device 0110, Advertiser directly, and/or Third Party Server 0150 indirectly any data, including, but not limited to, data in: Ad Data Codes 0200, Payment Receipts 1900, Ad Data File 0734, Ad Response File 0738, Payment Data File 0740, and/or Matching Event File 0742. Network 1470 can be any type of network, including, but not limited to: WLAN 0030 and/or WWAN 0032, e.g., the Internet.

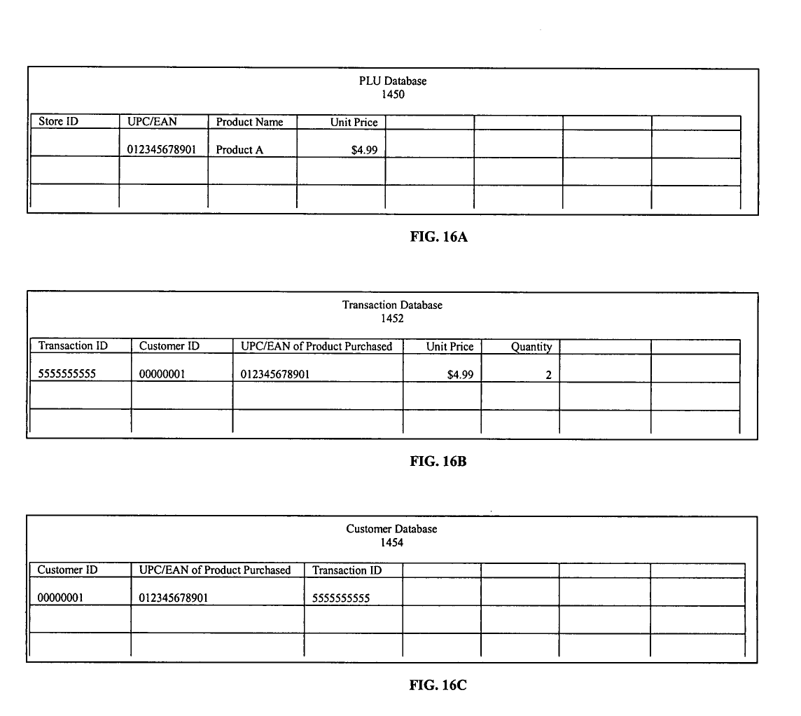

FIG. 16A is a diagram illustrating an exemplary PLU Database, according to embodiments of the present invention. FIG. 16B is a diagram illustrating an exemplary Transaction Database, according to embodiments of the present invention. FIG. 16C is a diagram illustrating an exemplary Customer Database, according to embodiments of the present invention.

FIG. 17 depicts a functional block diagram of an exemplary Wireless Device 0120 with a URMS 0350 capable of communicating with a NFC Chip 1700, according to embodiments of the present invention. Wireless Device 0120 may include Processor 0004; Bus 0002; Operating System 0346; URMS 0350, which can be stored in Memory (not shown); Financial Account Data 0750, which can be stored in Memory (not shown); NFC Module 0758, which can be stored in Memory (not shown); and/or NFC Chip 1700, which can include an integrated Microcontroller 1720; Microcontroller 1740, if NFC Chip 1700 does not include an integrated Microcontroller, and/or NFC Antenna 0338. In the present apparatus, URMS 0350 can transmit and/or receive data from and/or to any Module in URMS 0350, e.g., data in Ad Data File 0734, Ad Response File 0738, Payment Data File 0740, and/or Financial Account Data 0750, to and/or from NFC Chip 1700 through Operating System 0346, Processor 0004, and Bus 0002. In another embodiment, URMS 0350 can transmit and/or receive data, e.g., data in Ad Data File 0734, Ad Response File 0738, Payment Data File 0740, and/or Financial Account Data 0750, to and/or from NFC Chip 1700 through one or more other means, including, but not limited to: directly to and/or from NFC Chip 1700 through Bus 0002, or indirectly to and/or from NFC Chip 1700 through Processor 0004 and Bus 0002.

NFC Chip 1700 can comprise components, including, but not limited to: Wireless Device Interface 1710, which can support one or more interfaces with Wireless Device 0120, including, but not limited to: Serial UART, USB, any other standard interfaces, or any proprietary interfaces; an integrated Microcontroller 1720, which can manage communication with either or both the RF interface and Wireless Device 0120; RX 1722, which can receive signals from Payment Device 0134; TX 1724, which can transmit signals to Payment Device 0134; and/or NFC Antenna 0338. NFC Chip 1700 can include other components not included in FIG. 17 that are necessary to implement the NFC standard and/or enable URMS 0350 to exchange data with NFC Chip 1700.

In another embodiment, the present system can include a SIM card. NFC Chip 1700 can enable the SIM card to interoperate with NFC Antenna 0338 through a standard interface.

### 2.2 METHODS

The present invention can support the measurement of an user viewing an Advertisement regardless of whether the user views the Advertisement in the Media Program or Media Location in which an Advertiser originally transmitted the Advertisement. New technologies and products are enabling an user to view an Advertisement: (1) at a different time than when an Advertiser and/or Media Operator originally transmitted the Advertisement to any Media Device 0110, e.g., when an user records a Media Program and the Advertisements transmitted during such Media Program and views the Media Program and Advertisements at a later time; and/or (2) independently of the Media Program with which an Advertiser originally transmitted the Advertisement, e.g., when an user views an Advertisement that is transmitted as a file not associated with any Media Program or Media Location like an user downloading an Advertisement from a Web site or receiving an Advertisement as an attachment to an email.

By associating an Ad Data Code 0200 with any Advertisement, the present invention can enable the measurement of an user viewing the Advertisement regardless of whether the user views the Advertisement at a different time than when an Advertiser and/or Media Operator originally transmitted the Advertisement or the user views the Advertisement as a file not associated with any Media Program or Media Location. The present invention describes a variety of means of associating an Ad Data Code 0200 with any Advertisement in Section 2.2.1.

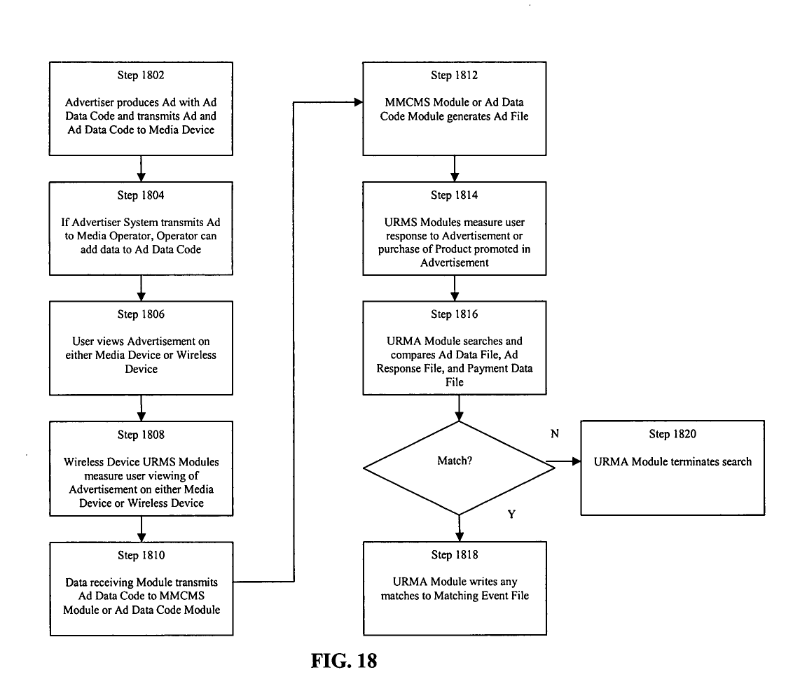

FIG. 18 depicts a flowchart 1800 of a method for measuring details related to user viewing of an Advertisement and/or user response(s) to one or more viewed Advertisements, according to embodiments of the present invention. The present invention can implement the present method by executing a subset of the steps depicted in flowchart 1800, executing the steps in different order, and/or executing other or additional related or equivalent steps.

In step 1802, an Advertiser produces an Advertisement which may include an Ad Data Code 0200. Advertiser System 0100 transmits the Advertisement and associated Ad Data Code 0200 to a Media Operator 0104. In another embodiment, Advertiser System 0100 can transmit the Advertisement and associated Ad Data Code 0200 to the Media Devices 0110 directly. In one embodiment, the Advertiser can provide an economic incentive, e.g., a coupon, for the user to record the code into his/her Wireless Device 0120 by including in Ad Data Code 0200 the basic UCC Coupon Code, the UCC/EAN 128 Coupon Extended Code, the corresponding version for any given country/region, or any other type of code that can enable Code Reader 0132 to record an economic incentive. In another embodiment, an Advertiser can produce an Advertisement without any economic incentive for the user to record the code into his/her Wireless Device 0120 and just transmit the Advertisement and/or Ad Data Code 0200 to a Media Operator 0104. In another embodiment, an Advertiser can produce a separate Advertisement and Ad Data Code 0200 that describes the Advertisement and can transmit each file to a Media Operator 0104.

In step 1804, a Media Operator 0104 transmits to any Media Device 0110 the Advertisement, which can include an Ad Data Code 0200, in a Media Program and specifically in a Media Location. In another embodiment, an Advertiser can produce an Advertisement which can include an Ad Data Code 0200 and transmit the Advertisement to a Media Operator 0104, which can add additional data to the Code, e.g., data identifying the Media Operator 0104, Media Program, Media Location, date, and/or time in or during which the Advertisement is placed.

In step 1806, an user of Wireless Device 0120 and/or a Target Customer views an Advertisement on any Media Device 0110. As described above, an user may view an ad visually (e.g., viewing on a display) or aurally (e.g., listening from a speaker). An Advertiser typically transmits an Advertisement as a separate or discrete programs or files during the transmission of a program or file viewed, heard, and/or read by an user. For example, an Advertiser typically transmits an Advertisement, e.g., a 30-second Advertisement, on Television 0304 before or after a Television program or segment of the Television program. However, an Advertiser can have a Television program or segment of the Television program include the use and/or display of its Product in the Television program (or “product placement”).

While FIG. 7 depicts a Display Interface 0784 for viewing an Advertisement, any person with ordinary skill in the art would appreciate other means of displaying an Advertisement, including, but not limited to: transmission of the Advertisement for processing to a CPU 0004, a graphics processor, a DSP, or an application processor before transmission to Display Interface 0784.

While the present application may refer to an Advertisement transmitted to a Wireless Device 0120 or Non-Wireless Device 0122, the present application intends the reference to apply to an Advertisement transmitted to the Wireless Device 0120 or Non-Wireless Device 0122, either directly through a wireless network or indirectly through any other Media Device 0110.

In step 1808, the present invention measures details related to user viewing of an Advertisement. When a data receiving Module such as Infrared Module 0702, RFID Module 0704, Synchronization Module 0706, Barcode Module 0708, and Antenna Module 0710 receives an Advertisement, the data receiving Module transmits the Advertisement to a presentation Module such as Display Interface 0784 or speaker (not pictured).

In step 1810, data related to the Advertisement viewed by the user is received by the device. If the data receiving Module receives Ad Data Code 0200 associated with the Advertisement viewed in step 1806, the data receiving Module transmits the Ad Data Code 0200 to MMCMS Module 0400 for conversion into an Ad File.

The present invention can enable an Advertiser System 0100 to transmit directly to a Wireless Device 0120 an Advertisement and/or its associated Ad Data Code 0200. For example, the Advertiser System 0100 can transmit an Advertisement and its associated Ad Data Code 0200 directly and/or indirectly through an Internet Operator (e.g., a search engine), a Wireless Operator, and/or a Third Party Server 0150 enabling the transmission of data to a Wireless Device 0120. The Wireless Device 0120 can receive the Advertisement and its associated Ad Data Code 0200 in a variety of means, including, but not limited to: calling a Web Browser 0776 to display the Advertisement and to write and/or store its associated Ad Data Code 0200 if the code is in the form of a cookie in Memory 0012; calling a media player to display the Advertisement outside of Web Browser 0776 and to write and/or store its associated Ad Data Code 0200 in Memory 0012; calling a text messaging application to display the Advertisement and to write and/or store its associated Ad Data Code 0200 in Memory 0012; and/or calling a multimedia messaging application to display the Advertisement and to write and/or store its associated Ad Data Code 0200 in Memory 0012.

An Advertiser System 0100 can transmit an Ad Data Code 0200 to a Wireless Device 0120 at any time, including, but not limited to, before transmission of the Advertisement which information in Ad Data Code 0200 describes, during transmission of the Advertisement which information in Ad Data Code 0200 describes, and/or after transmission of the Advertisement which information in Ad Data Code 0200 describes. For product placement Advertisements, an Advertiser can transmit an Ad Data Code 0200 at the same time when the Product is being used in the Television program. The objective of transmitting an Ad Data Code 0200 at the time is to enable the URMS to measure if, when, how, and/or to what degree an user responds to the product placement.

An Advertiser System 0100 can transmit an Ad Data Code 0200 to a Wireless Device 0120 over the same or different network than it transmits the associated Advertisement to the Wireless Device 0120. An Advertiser can transmit an Ad Data Code 0200 to a Wireless Device 0120 not only through a Wireless Base Station 0302, but through any other Media Device 0110, including, but not limited to, a Television 0304, a Radio 0306, a Personal Computer 0308, an Outdoor Media Device 0310, a magazine or newspaper, a Product Package, and/or another Wireless Device. An Advertiser can transmit the information in an Ad Data Code 0200 in one or more files.

In an embodiment, the user of Wireless Device 0120 can actively record an Ad Data Code 0200. In addition or alternatively, a Media Device 0110 can transmit an Ad Data Code 0200 received from Advertiser System 0100 to Wireless Device 0120. In one embodiment, Wireless Device 0120 includes logic to prompt the user to determine whether the user wants to store the Ad Data Code 0200 in Wireless Device 0120. In addition or alternatively, Wireless Device 0120 receives the Ad Data Code 0200 and executes the appropriate functions without prompting the user of the Wireless Device 0120. If Wireless Device 0120 is turned on, is within transmission distance of any I-O Device of a Media Device 0110, and receives Ad Data Code 0200, an Advertiser can assume that the user of Wireless Device 0120 at least had the opportunity to view an Advertisement associated with the Ad Data Code 0200.

The user of Wireless Device 0120 can actively record the Ad Data Code 0200 using a variety of methods, including but not limited to the following. If the Wireless Device 0120 includes a Camera 0332 and Ad Data Code 0200 is in the form of a barcode, the user can take a picture of the barcode with the Wireless Device 0120 camera. In another embodiment, if Ad Data Code 0200 is in the form of a n-digit character string, the user can take a picture of the string with the Wireless Device 0120 camera that has the capability of converting the string into a barcode.

If the user has a camera that is not attached to a Wireless Device 0120, the user can take a picture of the barcode or n-digit number with the camera. Utilizing any method readily apparent to any person with ordinary skill in the art, the user can transfer the picture from the camera to the Wireless Device 0120.

If the Wireless Device 0120 includes a Short-Range Antenna 0324 and Ad Data Code 0200 is in the form of data that can be received by the Antenna, the user can aim the Antenna at a Media Device 0110 with a Short-Range Antenna to receive the data.

If the Wireless Device 0120 includes a Wired Port 0326 and Ad Data Code 0200 is in the form of data that can be received by the Port, the user can connect the Port to a Media Device 0110 with a Wired Port to receive the data.

If the Wireless Device 0120 includes a Microphone 0328 and Ad Data Code 0200 is in the form of data that can be received by the Microphone, the user can aim the Microphone at a Media Device 0110 with a Speaker to receive the data.

If the Wireless Device 0120 includes an Infrared Transceiver 0330 and Ad Data Code 0200 is in the form of data readable by the Transceiver, the user can aim the Transceiver at the data to record the data.

If the Wireless Device 0120 includes a RFID Device 0334 and Ad Data Code 0200 is in the form of data that can be received by the Device, the user can aim the Device at a Media Device 0110 with a RFID Tag to receive the data.

If the Wireless Device 0120 includes a Barcode Reader 0336 and Ad Data Code 0200 is in the form of a barcode, the user can aim the Reader at the barcode to record the barcode.

If the Wireless Device 0120 includes a NFC Antenna 0338 and Ad Data Code 0200 is in the form of data that can be received by the Device, the user can aim the Device at a Media Device 0110 with a NFC Antenna 0338 to receive the data.

If the Wireless Device 0120 includes any other type of I-O Device 0339 and Ad Data Code 0200 is in the form of data that can be received by the I-O Device, the user can aim the I-O Device at a Media Device 0110 with a compatible I-O Device to receive the data.

If such Media Device 0110 is capable of receiving, storing, processing, and/or transmitting an Ad Data Code 0200, e.g., STB 0500 controlling a Television 0304, a Media Operator 0104 can transmit such Advertisement and its associated Ad Data Code 0200 through methods comparable to the methods described herein for an Internet Operator.

The Media Device 0110 can transmit to Wireless Device 0200 an Ad Data Code 0200 using a variety of methods, including but not limited to the following. If the Wireless Device 0120 includes a Short-Range Antenna 0324 and Ad Data Code 0200 is in the form of data that can be received by the Antenna, a Media Device 0110 can transmit the Ad Data Code 0200 to Short-Range Antenna 0324.

If the Wireless Device 0120 includes a Wired Port 0326 and Ad Data Code 0200 is in the form of data that can be received by the Port, a Media Device 0110 can transmit the Ad Data Code 0200 to Port 0326.

If the Wireless Device 0120 includes a Microphone 0328 and Ad Data Code 0200 is in the form of data that can be received by the Microphone, a Media Device 0110 can transmit the Ad Data Code 0200 to Microphone 0328.

If the Wireless Device includes an Infrared Transceiver 0330 and Ad Data Code 0200 is in the form of data readable by the Transceiver, a Media Device 0110 can transmit the Ad Data Code 0200 to Infrared Transceiver 0330.

If the Wireless Device 0120 includes a RFID Device 0334 and Ad Data Code 0200 is in the form of data that can be received by the Device, a Media Device 0110 can transmit the Ad Data Code 0200 to RFID Device 0334.

If the Wireless Device 0120 includes a NFC Antenna 0338 and Ad Data Code 0200 is in the form of data that can be received by the Device, a Media Device 0110 can transmit the Ad Data Code 0200 to NFC Antenna 0338.

If the Wireless Device 0120 includes any other type of I-O Device 0339 and Ad Data Code 0200 is in the form of data that can be received by the I-O Device, a Media Device 0110 can transmit the Ad Data Code 0200 to I-O Device 0339.

In step 1812, MMCMS Module 0400 and/or Ad Data Code Module 0728 can receive Ad Data Code 0200 and generate and/or update an Ad File for the Advertisement viewed on either Media Device 0100 and/or Wireless Device 0120. MMCMS Module 0400 and/or Ad Data Code Module 0728 can add the following data. For example, MMCMS Module 0400 and/or Ad Data Code Module 0728 may determine the time at which the Advertisement was viewed using Timer Module 0712. The time viewed (Tᵥ) can then be recorded in the Ad File. In addition or alternatively, the MMCMS Module 0400 may increment by 1 the number of ads viewed by the user for the media channel category (e.g., Television, Internet, etc). Details related to the number of ads viewed by the user by media channel category are stored in Ad Reception File 0736.

For example, assume an user views one Advertisement for Product named XYZ with UPC Code 123456789012 through Television 0304. MMCMS Module 0400 records the type of Media Device 0110, in this example, Television 0304, through which the user viewed the Advertisement. In FIG. 10, an Ad File based on the sample Ad File template 1000 records any Advertisement viewed through Television 0304 with a value equal to 1. In this example, MMCMS Module 0400 increments by one (1) the number of Advertisements viewed by the user through Television 0304 in Ad Reception File 0736.

In step 1814, URMS 0350 Modules can measure details related to an user's response(s) to one or more viewed Advertisement. Step 1812 includes the following steps.

Any URMS 0350 Module can generate a record in the Ad Response File 0738 reflecting the response of an user to an Advertisement. For example, a data receiving Module may receive data signaling some action taken by an user (e.g., sampling or buying a Product). After receiving such information, the data receiving Module forwards or write the data to an Ad Response File 0738.

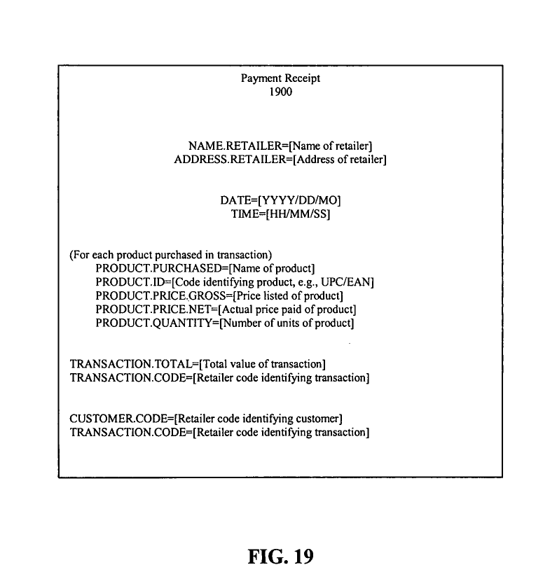

Payment Code Module 0730 can generate a Payment File reflecting an user purchase of a Product promoted in an Advertisement. Payment Code Module 0730 can write a Payment File to Payment Data File 0740. For example, Wireless Device 0120 receives or generates a Payment Receipt 1900 indicating purchase of a Product. FIG. 19 depicts an exemplary Payment Receipt 1900 which a Retailer and/or Wireless Device 0120 can produce, according to embodiments of the present invention. In one embodiment, Payment Receipt 1900 can be an electronic record of the purchase of one or more Product(s) by an user of Wireless Device 0120 and/or Target Customer, which can include the unique code, e.g., the UPC/EAN/GTIN, utilized by Advertisers and/or Retailers to identify each Product purchased by the user of Wireless Device 0120 and/or Target Customer. In another embodiment, Payment Receipt 1900 can include additional data, including, but not limited to: selling price, number of units of Product, method of payment, customer code, and/or transaction code.

The Customer Code is any data used by a Retailer to identify uniquely a given customer, including, but not limited to: any code assigned by a Retailer to a customer to encourage frequent purchases or shopper loyalty, whose data the present invention defines as “Shopper Loyalty ID Code”; a phone number, a name, and/or any other data a Retailer uses to identify uniquely a given customer.

The Transaction Code is any data used by a Retailer to identify uniquely a given transaction, which data can be any format, including, but not limited to: a barcode; any string of characters which can be converted into a barcode by software in a Wireless Device 0120 and/or a Retailer Server 0140; and/or data which can be transmitted in a radio signal. The present invention can include methods utilizing the Transaction Code to identify one or more Products purchased by an user of Wireless Device 0120, an user of any Media Device 0120, and/or Target Customer. In the case of an user of Wireless Device 0120 making a purchase at a Retailer, Wireless Device 0120 can transmit one or more Ad Data Codes 0200 and/or Ad Data Files 0734 to a POS System 0130, which can write and/or store in Transaction Database 1452 and/or Customer Database 1454 the Ad Data Codes 0200 and/or Ad Data Files 0734 in one or more records and/or associate the Ad Data Codes 0200 and/or Ad Data Files 0734 with the data in the Transaction Code identifying one or more Products purchased in such transaction, including, but not limited to: the UPC/EAN/GTIN; or any other data identifying such Product. If a Retailer stores Ad Data Codes 0200 and/or Ad Data Files 0734 in Transaction Database 1452, the Retailer Server 0140 can transmit the associated Ad Data Codes 0200 and/or Ad Data Files 0734 and Product data from Transaction Code to a variety of devices that can utilize such data to identify one or more Products purchased by such user. In the case of an user making a purchase at a Retailer without Wireless Device 0120, the Retailer Server 0140 can transmit the Product data from Transaction Code to a variety of devices that can utilize such data to identify one or more Products purchased by a given user. In such case, the present invention would require that the Transaction Code be associated with an Existing Unique ID Code (defined in Section 3.0) to enable a receiving device to associate the Products purchased with an user of a Wireless Device 0120, an user of any Media Device 0110, and/or a Target Customer. For example, an user can purchase one or more Products in a given Transaction without using his/her Wireless Device 0120, e.g., with cash or a credit/debit card. In the case such user pays with cash, he/she can use some other type of data identifying him/her, e.g., a Shopper Loyalty ID Code. In the case such user pays with a credit/debit card, such transaction can identify an unique customer through the credit/debit card. In the above cases, Retailer Server 0140 can transmit the data from a Transaction Code to any device through any of the methods described in the present invention, in particular, as described in Section 2.2.1.6.1.

The benefit of utilizing data on the Products purchased in a given transaction identified by the Transaction Code is because some Retailers do not include in a Payment Receipt 1900 some unique code utilized by Advertisers and/or Retailers to identify the Product as described in the definition of Ad Data Code 0200 in Section 2.1.1, e.g., an UPC/EAN/GTIN. In the case of a Payment Receipt 1900 including only a Product name or abbreviation of such Product, URMS 0350 can generate errors in matching a Product purchased with a Product promoted in a given Advertisement unless the Advertiser utilizes the same abbreviation as the Retailer (which can be the case where an Advertiser is the Retailer).

A Wireless Device 0120, any Media Device 0110, an Advertiser System 0100, and/or a Third Party Server 0150 can receive Payment Receipt 1900 through a variety of means, including, but not limited to: a Retailer can generate Payment Receipt 1900 and transmit it to Wireless Device 0120 through Payment Device 0134, NFC Device 1400, and NFC Antenna 0338; a Retailer can generate Payment Receipt 1900 and transmit it to Wireless Device 0120, any Media Device 0110, an Advertiser System 0100, and/or a Third Party Server 0140 through Network 1470, e.g., a POS System 0130 and/or a Retailer Server 0140 can generate a Payment Receipt 1900 in electronic form and transmit Payment Receipt 1900 to any of the above devices through a network, e.g., the Internet; a Retailer can generate Payment Receipt 1900 and transmit it to Wireless Device 0120 through any I-O Device of Wireless Device 0120 other than NFC Antenna 0338, e.g., a Wireless Device 0120 can purchase a Product directly from an online Retailer, which can transmit a Payment Receipt 1900 to Wireless Device 0120.

A Retailer can generate Payment Receipt 1900 in any format for transmission to Wireless Device 0120 through Payment Device 0134. The format can include, but is not limited to: rich text format (RTF), text ANSI (TXT ANSI), text Unicode (TXT Unicode), HTML, eXtensible Markup Language (XML), portable document format (PDF), Microsoft Word (DOC), Microsoft Excel (XLS), and/or Word for Macintosh Document (MCW). Payment Receipt 1900 can include any receipt typically produced and/or transmitted by existing versions of Payment Device 0134 to Receipt Printer 1430 or any other type of receipt produced and/or transmitted by Payment Device 0134.

For example, Event Handler Module 0716 can measure whether the user opens a text message from Advertiser System 0100. The user response, i.e., opening the text message, is directly related to the Advertisement.

In step 1816, URMA Module 0744 compares data stored in Ad Response File 0738 and Payment Data File 0740 and data stored in Ad Data File 0734. If a match exists, operation proceeds to step 1816. If no match exists, operation proceeds to step 1818.

Step 1816 can use any method to match data not only by searching for an exact match of data in any file describing an Advertisement viewed with data in any file describing a Product purchased that was promoted in such Advertisement, but also for an inexact match of such data. The present invention can support tools like predictive models and training models well known to any person with ordinary skill in the art to correct data and/or impute missing data. For example, a Payment Receipt 1900 can spell the name of a Product or Retailer incorrectly. Step 1814 can support tools to enable the matching of a closely spelled Product or Retailer in a Payment Receipt 1900 with a correctly spelled Product or Retailer in an Ad Data Code 0200.

In step 1818, URMA Module 0744 writes and/or stores in Matching Event File 0742 data showing a match of a Product described in any Ad Data Code 0200, Ad File, and/or Ad Data File 0734 with a Product described in any Payment Receipt 1900, Payment File, Payment Data File 0740, and/or Ad Response File 0738.

In step 1820, URMA Module 0744 terminates search for match.

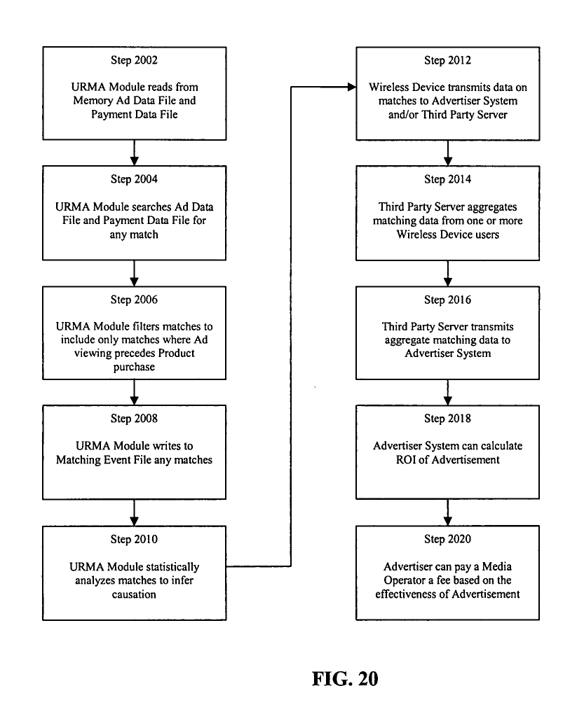

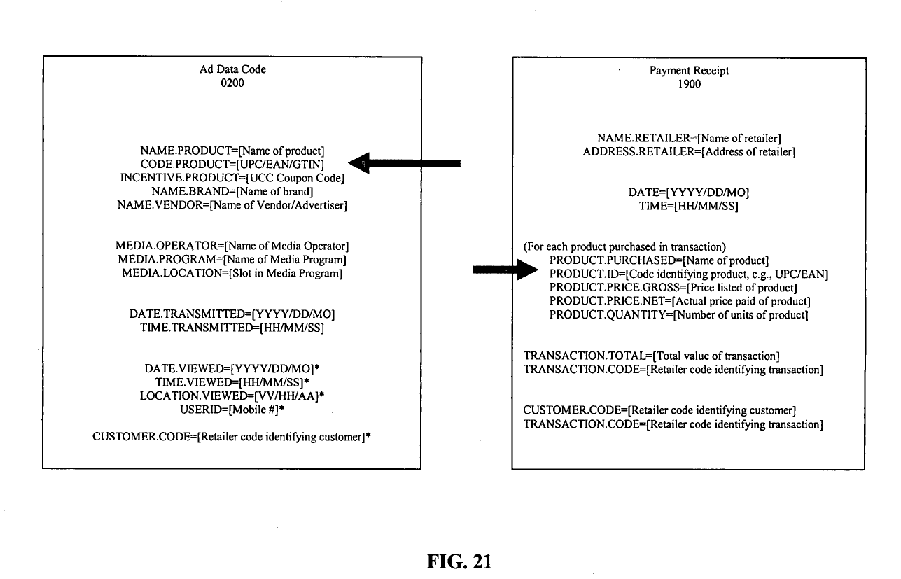

FIG. 20 depicts a flowchart of an exemplary method for comparing data describing an Advertisement and data describing the purchase of a Product, according to embodiments of the present invention. Flowchart 2000 is described with continued reference to the Ad Data Code 0200 and Payment Receipt 1900 depicted in FIG. 21. The present invention can implement flowchart 2000 by executing a subset of the steps, executing the steps in different order, and/or executing other or additional related or equivalent steps.

In step 2002, URMA Module 0744 in Wireless Device 0120 can read the Ad Data File 0734, Ad Response File 0738, and/or Payment Data File 0740 from Memory 0012 in Wireless Device 0120.

In step 2004, URMA Module 0744 can search through Ad Data File 0734, Ad Response File 0738, and/or Payment Data File 0740 for any match of a Product purchased with a Product promoted in an Advertisement viewed. In the preferred embodiment, URMA Module 0744 can search through just the fields in each file containing a unique code utilized by Advertisers and/or Retailers to identify a Product, e.g., the UPC/EAN/GTIN of the Product, for any matching string of, for example, UPC/EAN/GTINs. In another embodiment, URMA Module 0744 can search through the complete files for any matching string of numbers with the same number of digits as a unique code utilized by Advertiser and/or Retailers to identify a Product, e.g., the UPC/EAN/GTIN of the Product. In another embodiment, URMA Module 0744 can search through the complete files for any matching string of alphanumeric characters. While the last embodiment can yield a match of the name of the Product, the potential for error is greater than the first two embodiments because some Retailers may abbreviate the name of any given Product and there could be a match of names in Ad Data File 0734, Ad Response File 0738, and/or Payment Data File 0740 which does not necessarily apply to Products.

In step 2006, URMA Module 0744 can filter the set of matching strings of UPC/EAN/GTINs where an Ad Data Code 0200 has a date/time stamp that precedes the date/time stamp of a Payment Receipt 1900. The present method can enable an Advertiser to withdraw from any ROI calculation any matching strings of UPC/EAN/GTINs where an Ad Data Code 0200 has a date/time stamp that succeeds the date/time stamp of a Payment Receipt 1900. In another embodiment, the present method can enable an Advertiser to withdraw from any ROI calculation any matching strings of UPC/EAN/GTINs where an Ad Data Code 0200 has a date/time stamp that precedes the date/time stamp of a Payment Receipt 1900 outside a certain time period.

Any Module that collects data about an user response to an Advertisement can compare the values it collects against the values in Ad Files in Ad Data File 0734 to determine whether there is a match. A match indicates that the user performed some action regarding a Product after the user viewed an Advertisement related to the Product.

For example, MMCMS Module 0400 receives an Ad Data Code 0200 which includes data showing that the user viewed through Television 0304 an Advertisement for a Product named XYZ with UPC Code 123456789012, Ad Data Code Module 0728 processes Ad Data Code 0200 (e.g., by adding data about the time and location during and at which Wireless Device 0120 receives Ad Data Code 0200) and stores the values in Ad File ABC, and Ad Data Code Module 0728 transmits the Ad File to Ad Data File 0734. One week later, Wireless Device 0120 receives a Payment Receipt 1900 which includes data showing that the user bought at retailer DEF the Product XYZ with UPC Code 123456789012, Payment Code Module 0730 processes Payment Receipt 1900 (e.g., by adding data about the location at which Wireless Device 0120 receives Payment Receipt 1900) and stores the values in Payment File GHI, and Payment Code Module 0730 transmits the Payment File to Payment Data File 0740. URMA Module 0744 compares the Product name and/or UPC code with all values in Ad Data File 0734. URMA Module 0744 finds the Product name and/or UPC Code in Ad File ABC.

URMA Module 0744 can measure whether the user buys a Product with the same Product name and/or UPC Code as a Product name and/or UPC Code included in an Advertisement viewed by the user earlier. In some cases, Advertiser System 0100 can attribute the user response directly to the Advertisement. For example, if the Advertisement included an electronic coupon that is coded to associate directly with the Advertisement and user of Wireless Device 0120 uses the coupon when paying for the Product advertised, Advertiser System 0100 can attribute the user response directly to the Advertisement even if the user buys the Product in a physical retailer. In another example, if the Advertisement included a link to an online vendor or online retailer and the user clicks the link to buy the Product advertised, Advertiser System 0100 can attribute the user response directly to the Advertisement.

A match in step 2004 can enable an Advertiser to infer one of two possibilities: (a) the user viewed an Advertisement for Product XYZ and bought the Product one week later in response to the Advertisement; or (b) the user viewed an Advertisement for Product XYZ and would have bought the Product one week later even if the user did not view the Advertisement. However, a match per se cannot enable an Advertiser to conclude that the Advertisement caused the user to buy the Product advertised. However, the application of certain statistical analytical techniques in URMA Module 0744 well known to anyone with ordinary skill in the art can enable the Advertiser to determine whether the probability that the user bought the Product in response to the Advertisement is statistically significant. Moreover, a match can provide an Advertiser more information regarding the response of the user to the Advertisement than the Advertiser has with current technology.

In step 2008, URMA Module 0744 can write to Matching Event File 0742 the records of any Ad Data Codes 0200, Payment Receipts 1900, Ad Data File 0734, Ad Response File 0738, and/or Payment Data File 0740 with matching strings of UPC/EAN/GTINs.

In step 2010, the present invention can perform a statistical analysis of any data stored in Ad Data File 0734, Ad Response File 0738, Payment Data File 0740, and/or Matching Event File 0742. As described above, URMA Module 0744 can perform such statistical analysis. In another embodiment, a Module external to URMA Module 0744 can perform such statistical analysis. For example, a computer program product located at Advertiser System 0100 and/or Third Party Server 0150 can perform such statistical analysis on data stored in Ad Data File 0734, Ad Response File 0738, Payment Data File 0740, and/or Matching Event File 0742 from one or more users of Wireless Device 0120. An example of step 2008 for Television Advertisements is described in further detail in Section 2.2.1.1 below.

For example, URMS 0350 can call URMA Module 0744, which can: (1) search through any file containing data on the Advertisements viewed by the user, including, but not limited to, Ad Data Code 0200 and/or Ad Data File 0734; (2) search through any file containing data on the Products purchased by the user, including, but not limited to, Payment Receipt 1900 and/or Payment Data File 0740; (3) any file containing data on the responses by the user to an Advertisement, including, but not limited to, Ad Response File 0738; and/or (4) match any data uniquely identifying the Product promoted in the Advertisement with the Product promoted in any Advertisements viewed by the user, e.g., UPC/EAN/GTIN or name of Product, among Ad Data Code 0200, Payment Receipt 1900, Ad Data File 0734, Ad Response File 0738, and/or Payment Data File 0740; and/or (4) write any matching data to Matching Event File 0742. A match between an Advertisement viewed by the user as identified by the Ad Data Code 0200 and the purchase of a Product promoted in the Advertisement as identified by Payment Receipt 1900 can indicate to Advertiser that the Advertisement could have influenced the user to purchase the Product. While the user could have purchased the Product in any event, the availability of data generated by the present method can provide an Advertiser more data about the relationship between an Advertisement and subsequent user purchasing behavior than an Advertiser has available today. In addition, if user of Wireless Device 0120 explicitly uploaded Ad Data Code 0200 into the Device, e.g., by using Camera 0332 to record an image of a barcode as part of an Advertisement or click-through an Advertisement when visiting a web page, an Advertiser can reasonably conclude that the Advertisement more directly influenced subsequent user purchasing behavior.

In another embodiment, any Media Device 0110, POS System 0130, or Retailer Server 0140 can call a Module the equivalent functionality of URMA Module 0744 to: (1) search through Ad Data Code 0200 and Payment Receipt 1900; (2) match any data uniquely identifying the Product promoted in the Advertisement, e.g., UPC or name of Product, in both Ad Data Code 0200 and Payment Receipt 1900 or Ad Data File 0734, Ad Response File 0738, and Payment Data File 0740; and/or (3) write any matching data to Matching Event File 0742.

In step 2012, Wireless Device 0120 can transmit data, including, but not limited to, Ad Data Code 0200, Payment Receipt 1900, Ad Data File 0734, Ad Response File 0738, Payment Data File 0740, and/or Matching Event File 0742, to Advertiser System 0100 either directly or indirectly through Third Party Server 0150. In another embodiment, the present invention can transmit data to Advertiser System 0100 or Third Party Server 0150 in a variety of means, including, but not limited to: from any Media Device 0110 to Third Party Server 0150 or Advertiser System 0100; from any Web Server to Third Party Server 0150 or Advertiser System 0100 where the Web Server transmitted to any Media Device 0110 any type of file, e.g., a cookie, indicating the downloading of an Advertisement to the Media Device 0110, e.g., a Personal Computer 0308; from POS System 0130 to Third Party Server 0150 or Advertiser System 0100; and/or from Retailer Server 0140 to Third Party Server 0150 or Advertiser System 0100.

In step 2014, Third Party Server 0150 can aggregate matching data from multiple Wireless Devices 0200.

In step 2016, Third Party Server 0150 can transmit the aggregate matching data to Advertiser System 0100.

In step 2018, Advertiser System 0100 can utilize the matching data to calculate the ROI of the Advertisement transmitted to one or more users.

In step 2020, an Advertiser can pay a Media Operator 0104 a fee based on the actual purchase of a Product promoted in the Advertisement, instead of a click-through or an ad impression. By generating an ROI of the Advertisement, the present method can enable an Advertiser to attribute a value to an Advertisement and determine the maximum it should pay for distribution of the Advertisement.

In another embodiment, Wireless Device 0120 can transmit any Ad Data Codes 0200 received and/or Ad Data File 0734 generated to other devices for distributed calculation of ROI for the Advertisement viewed. Such devices can include, but are not limited to: the Media Device 0110 from which Wireless Device 0120 can receive an Ad Data Code 0200, e.g., if user of Wireless Device 0120 views an Advertisement on Television 0304 and responds to such Advertisement through any of the I-O Devices of such Television 0304 for transmission to Advertiser through Television Operator; and/or the POS System 0130 to which Wireless Device 0120 can transmit an Ad Data Code 0200 when purchasing a Product promoted in such Advertisement.

In FIG. 21, Ad Data Code 0200 can include fields for the date, time, and/or location during or at which Wireless Device 0120 displayed the Advertisement, which Ad Data Code Module 0728 can insert into Ad Data Code 0200. In addition, Ad Data Code Module 0728 can insert into Ad Data Code 0200 an user ID. In another embodiment, Ad Data Code Module 0728 converts Ad Data Code 0200 into an Ad File, which can have the same data as the Ad Data Code 0200 depicted in FIG. 21.

In addition, Ad Data Code 0200 can include a field for Customer Code.

A Media Device 0110 can insert a value for the field, “Customer Code,” into Ad Data Code 0200. By including such a value, the present invention can enable System 0090 to match the value in Customer Code in Ad Data Code 0200 with the value in Customer Code in Payment Receipt 1900 to ensure the accurate measurement of the user viewing a given Advertisement and the same user purchasing the Product promoted in such Advertisement.

### 2.2.1 EXAMPLES

2.2.1.1 Measurement of User Viewing Advertisement on Television Media Device

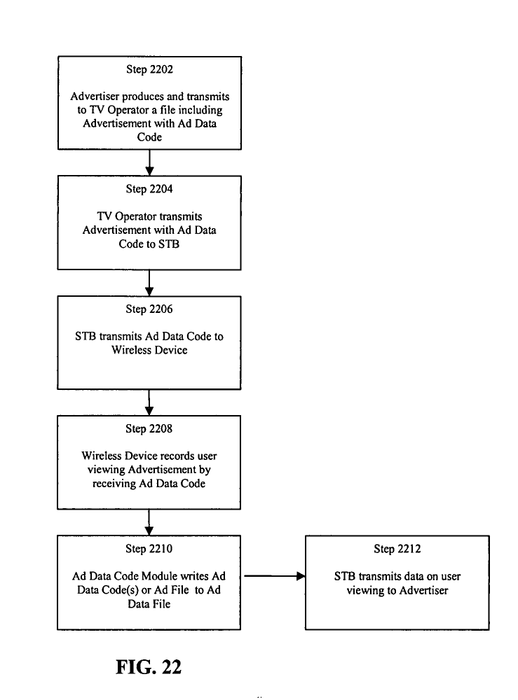

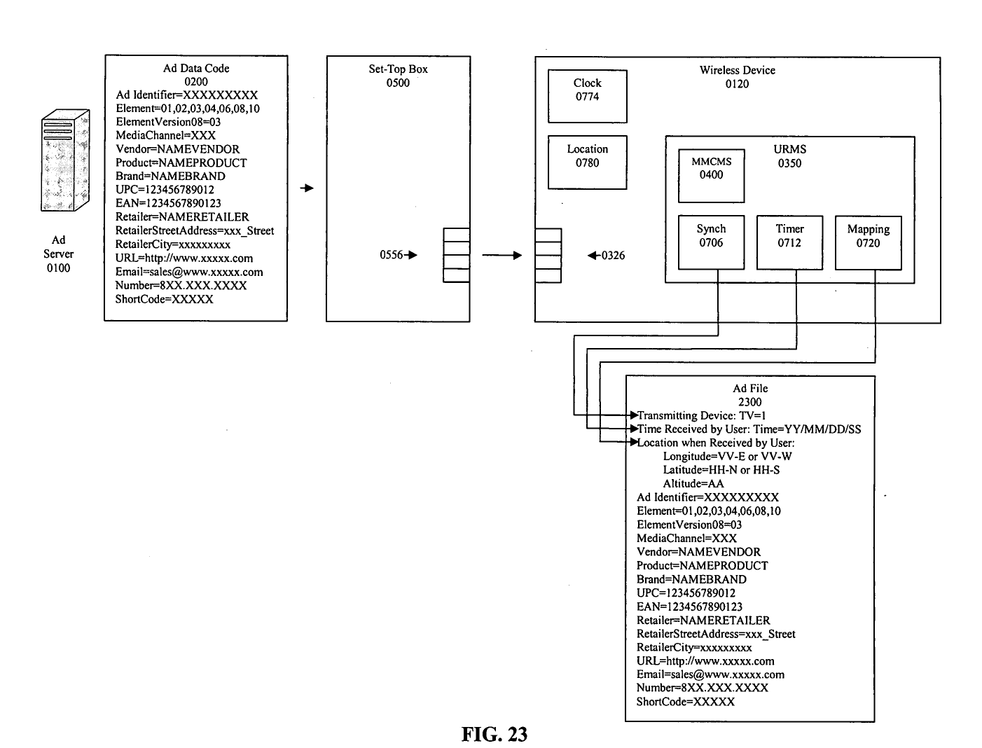

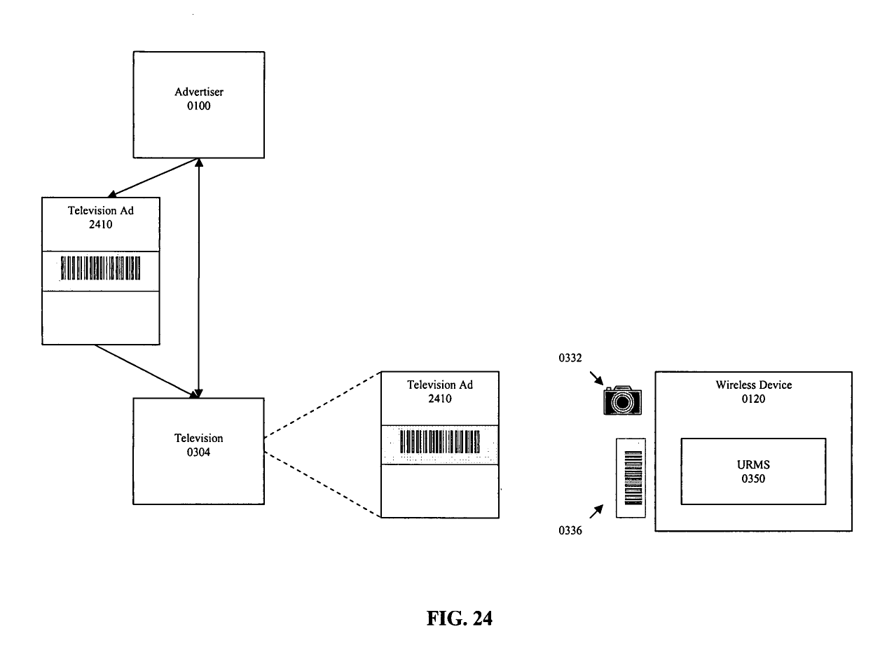

FIG. 22 is a flowchart 2200 of an exemplary method for enabling a Wireless Device 0120 to record its user viewing of an Advertisement on a Television, according to embodiments of the present invention. Flowchart 2200 is described with continued reference to the systems depicted in FIGS. 23 and 24. However, flowchart 2200 is not limited to that embodiment. The present invention can implement flowchart 2200 by executing a subset of the steps, executing the steps in different order, and/or executing other or additional related or equivalent steps.

In step 2202, an Advertiser produces an Advertisement including an Ad Data Code 0200. The Advertiser System 0100 may transmit to a Television operator an Advertisement which includes an Ad Data Code 0200. In another embodiment, the Advertiser System 0100 can transmit Advertisement and Ad Data Code 0200 directly to STB 0500.

A Television operator is any entity that operates, distributes, and/or transmits a Television Program and/or sells or leases a media location. A Television operator can include, but is not limited to: a Television station; a Television network; and/or a distributor of Television programs, including, but not limited to, a cable system operator; a direct broadcast satellite operator; and/or a telecommunications network operator, which can include an operator of a wired network, wireless network, or combination of wired and wireless networks.

Ad Data Code 0200 includes the specific data describing the characteristics of a given Advertisement. In the example shown in FIG. 10, the values for each field represent the specific values describing the Advertisement. For example, this Advertisement includes Elements 01, 02, 03, 04, 06, 08, and 10, which for purposes of this example are the Ad Elements in Table 5800 in FIG. 58. For Element 08, which means the Advertisement includes a celebrity endorser, Ad Data Code 0200 includes a value=03, which means the Advertisement includes Celebrity Endorser C. Ad Data Code 0200 includes a value for MediaChannel=XXX, which means Advertiser System 0100 is transmitting the Advertisement through, in this example, a Television network named XXX.

At Step 2204, STB 0500 receives the Advertisement and/or Ad Data Code 0200 from the Advertiser or Television operator. FIG. 24 depicts an exemplary Television Advertisement 2410. Advertisement and/or Ad Data Code 0200 can be transmitted in a variety of ways. For example, Ad Data Code 0200 can be embedded as part of the Video Signal. A Television Operator can embed the Code as part of an analog Video Signal and/or digital Video Signal. In an analog Video Signal, a Television Operator can embed the Code in a variety of means, including, but not limited to: imprinting the Code on an audio subcarrier or producing and transmitting the Code as an integral part of the Advertisement transmitted in the Video Signal. In a digital Video Signal, a Television Operator can embed the Code in a variety of means, including, but not limited to: slotting the Code into the MPEG-2 transportation stream.

In addition or alternatively, the Ad Data Code 0200 may be transmitted in a blanking interval (“Blanking Interval”) of any analog Television signal, which can include a vertical blanking interval (VBI) or horizontal blanking interval (HBI). A Television Operator can transmit the Code in the Blanking Interval utilizing methodology well known to those with ordinary skill in the art. In one embodiment of the present means, a Television Operator can transmit the Code in eXtended Data Services (XDS), which enables the transmission of any data transmitted with any analog Television signal.

In addition or alternatively, the Ad Data Code 0200 may be transmitted in any out-of-band (OOB) data channel, including, but not limited to, any Forward Data Channel, which is a channel carrying data utilizing any protocol from a source or retransmission point, e.g., a headend in a cable television system, to STB 0500. A Television Operator can transmit the Code in an OOB data channel utilizing methodology well known to those with ordinary skill in the art.

Advertiser System 0100 can transmit Ad Data Code 0200 utilizing IP packets. As would be appreciated by any person with ordinary skill in the art, Advertiser System 0100 can transmit Ad Data Code 0200 through other methods.

In step 2206, STB 0500 can transmit and/or display to an user of Wireless Device 0120 an Ad Data Code 0200. The transmission/display can occur in a variety of means. For example, the Ad Data Code 0200 can be embedded as part of the Video Signal on the screen of Television Set 0560, e.g., displaying a barcode or any string of characters which can be converted into a barcode as part of the Advertisement displayed at any location on the screen of Television Set 0560. In addition or alternatively, the screen of Television Set 0560 can display Ad Data Code 0200 carried in the Blanking Interval.

In another example, Ad Data Code 0200 can transmit the Code carried in any OOB data channel to any I-O Device of Wireless Device 0120 in a variety of means, including, but not limited to: transmitting the Code in the form of a sound wave from Audio Interface 0530 through Speaker 0550 to Microphone 0328; transmitting the Code in the form of a radio signal from Smart Card Interface 0532 through Antenna 0552 to NFC Antenna 0338; transmitting the Code in the form of a radio signal from Bluetooth Interface 0534 through Antenna 0554 to Antenna 0324; transmitting the Code in the form of a carrier signal from Wired Interface 0536 through Port 0556 to Port 0326; transmitting the Code in the form of a radio signal operating in the infrared frequency spectrum from IrDA Interface 0538 through IrDA Transceiver 0558 to IrDA Transceiver 0330. In one embodiment, Port 0556 is a USB wireless device.

While the above description applies to the transmission of Ad Data Code 0200 to a STB 0500, which includes a Synchronization Device 0556 that can retransmit Ad Data Code 0200 to Wireless Device 0120, the present invention can enable the transmission of Ad Data Code 0200 to a STB 0500, which can support a variety of other means of retransmitting Ad Data Code 0200 to Wireless Device 0120, including, but not limited to: utilizing Bluetooth or any other short-range wireless protocol; utilizing an Infrared Device; utilizing a RFID Device; and/or utilizing a NFC Device. All of these processes for exchanging data between two devices are well known to those with ordinary skill in the art.

In step 2206, STB 0500 can transmit or display to an user of Wireless Device 0120 an Ad Data Code 0200 through a variety of means. An Advertiser would typically want Wireless Device 0120 to receive Ad Data Code 0200, e.g., in the form of a radio signal, and/or an user of Wireless Device 0120 to view Ad Data Code 0200, e.g., in the form of a barcode, during the same time period when the user is viewing an Advertisement. For any Media Device 0110 displaying an Advertisement statically, e.g., a Print publication displaying Ad Data Code 0200 in the form of a barcode as part of or near an Advertisement, there is no need to synchronize the transmission of Ad Data Code 0200 with the transmission of an Advertisement. However, for any Media Device 0110 displaying an Advertisement dynamically, e.g., a Television 0304, a Radio 0306, or a Personal Computer 0308 displaying an Advertisement in video and/or audio format, an Advertiser would want to synchronize the transmission of Ad Data Code 0200 with the transmission of the Advertisement.

While the following discussion teaches a method for enabling synchronization of Ad Data Code 0200 and Advertisement for a Television Advertisement, the present invention can apply the method to enable synchronization of Ad Data Code 0200 and Advertisement for an Advertisement transmitted to and/or displayed on any Media Device 0110.

There are at least three means by which a Television Operator can transmit Ad Data Code 0200 and Advertisement to STB 0500 and transmit or display Ad Data Code 0200 and Advertisement to an user of Wireless Device 0120:
1. Transmit to STB 0500 Ad Data Code 0200 and Advertisement as part of the same Video Signal and display both Ad Data Code 0200 and Advertisement on a TV Display Device (“Synchronization Scenario 1”).
2. Transmit to STB 0500 Ad Data Code 0200 and Advertisement as part of the same Video Signal and display Advertisement on a TV Display Device and transmit Ad Data Code 0200 to Wireless Device 0120 (“Synchronization Scenario 2”).
3. Transmit to STB 0500 Ad Data Code 0200 and Advertisement as separate signals and display Advertisement on a TV Display Device and transmit Ad Data Code 0200 to Wireless Device 0120 (“Synchronization Scenario 3”).

In Synchronization Scenario 1, an user of Wireless Device 0120 can view Ad Data Code 0200 and Advertisement simultaneously, because Ad Data Code 0200 and Advertisement are part of the same Video Signal displayed on a TV Display Device. For any Ad Data Code 0200 carried in the Blanking Interval, STB 0500 can utilize methodology well known to those with ordinary skill in the art to synchronize the transmission of Ad Data Code 0200 with Advertisement, e.g., by using any timecode, e.g., the Vertical Interval timecode (VITC), which is a type of the Society of Motion Picture and Television Engineers (SMPTE) timecode.

In Synchronization Scenario 2, a Television Operator can transmit a Video Signal that includes both Ad Data Code 0200 and Advertisement in the form of video over IP. An Advertiser can supply separately an Ad Data Code 0200 and Advertisement to a Television Operator. An Advertiser may want to generate different Ad Data Codes 0200 for any given Advertisement. For example, to measure the difference in effectiveness, an Advertiser can generate different Ad Data Codes 0200 for an Advertisement transmitted on Television network A on Wednesday at 10:30 AM and the same Advertisement transmitted on Television network B on Thursday at 3:30 PM. A Television Operator can convert the Ad Data Code 0200 and Advertisement received from the Advertiser from an analog or digital signal to the format it utilizes, e.g., video over IP. A Television Operator can utilize a variety of means of enabling STB 0500 to separate Ad Data Code 0200 and Advertisement and display Advertisement on a TV Display Device and transmit Ad Data Code 0200 to Wireless Device 0120 through a variety of STB 0500 I-O Devices. These means can include, but are not limited to: assigning in the IP header of packets containing Ad Data Code 0200 certain data enabling STB 0500 to identify Ad Data Code 0200 such that CPU 0510 can store the packet in Memory 0514 or transmit the packet to any of STB 0500 I-O Devices; and/or assigning unique IP addresses to each I-O Device within any given STB 0500 and transmitting Ad Data Code 0200 to the IP address and Advertisement to Video Processor 0512 for transmission to TV Display Device.

In Synchronization Scenario 3, a Television Operator can transmit an Advertisement in the form of a Video Signal and Ad Data Code 0200 in any OOB data channel.

In Synchronization Scenarios 2 and 3, there is a risk that STB 0500 will display Advertisement on TV Display Device at a different time than it can transmit Ad Data Code 0200 through any of its I-O Devices. While Television Operator can transmit both Ad Data Code 0200 and Advertisement concurrently and expect that STB 0500 will display Advertisement on TV Display Device at approximately the same time it transmits Ad Data Code 0200 through any of its I-O Devices, the present invention can ensure synchronization in a variety of means.

For example, Television operator can identify the first frame of video for any given Advertisement (“Originating Ad Frame”) and last frame of video for any given Advertisement (“Terminating Ad Frame”), utilize any timecode system to assign time data, e.g., in the form HOURS:MINUTES:SECONDS:FRAME, to Originating Ad Frame and Terminating Ad Frame, and transmit data on timecodes for the frames to STB 0500. Utilizing its clock, STB 0500 can limit the transmission of the associated Ad Data Code 0200 through any of its I-O Devices within the time specified for the frames.

In another example, a Television Operator can transmit Ad Data Code 0200 either before or concurrently with the transmission of the associated Advertisement. If Television Operator transmits the Ad Data Code 0200 before the transmission of the associated Advertisement, STB 0500 should store the Ad Data Code 0200 in Memory 0514. When encoding the Advertisement at a central control point, e.g., a headend, Television Operator can generate a synchronization signal to insert in a Blanking Interval during the transmission of the Advertisement some unique code indicating the Originating Ad Frame and Terminating Ad Frame. When STB 0500 receives the Video Signal carrying the Advertisement, a Blanking Interval detector can identify the unique code and enable STB 0500 to identify the time when it can read the associated Ad Data Code 0200 from Memory 0514 and transmit the Ad Data Code 0200 to one or more of its I-O Devices.

In the preferred embodiment, a Television Operator (or any Advertiser System 0100 or Media Operator 0104) can transmit to STB 0500 (or any Media Device 0110) Ad Data Code 0200 either before or concurrently with the transmission of the associated Advertisement. In another embodiment, a Television Operator (or any Advertiser System 0100 or Media Operator 0104) can transmit to STB 0500 (or any Media Device 0110) Ad Data Code 0200 after the transmission of the associated Advertisement. The problem with transmitting Ad Data Code 0200 after the transmission of the associated Advertisement is that an user of the Media Device 0110 receiving the Advertisement can view such Advertisement and respond to such Advertisement before the reception of its associated Ad Data Code 0200. An Advertiser wants to measure the viewing of any Advertisement for a given Product before an user responds to such Advertisement, e.g., buying the Product promoted in such Advertisement.

Where STB 0500 or any Media Device 0110 can store the associated Advertisement for future display, the later transmission of Ad Data Code 0200 could avoid the risk of receiving an Ad Data Code 0200 after an user views the associated Advertisement. In addition, an Advertiser System 0100 or Media Operator 0104 can transmit an Ad Data Code 0200 specifying the date and time of transmission of the associated Advertisement. In this embodiment, a Media Device 0110 can record the reception of the associated Advertisement even if it receives Ad Data Code 0200 subsequently. However, in this embodiment, an user of Media Device 0110 can view an Advertisement at a later date and time than when Media Device 0110 receives the Advertisement.

In step 2208, an user with Wireless Device 0120 views the Advertisement on Television Set 0560. Wireless Device 0120 can record the viewing in a variety of ways. For example, an user can utilize any I-O Device of Wireless Device 0120 to record an image of Ad Data Code 0200 on the screen of Television Set 0560 in a variety of means, including, but not limited to: utilizing Camera 0332 to record an image of Ad Data Code 0200 in the form of a barcode and Ad Data Code Module 0728 to decode the barcode into parameters for writing to Ad Data File 0734; utilizing Camera 0332 to record an image of Ad Data Code 0200 in the form of any string of characters which can be converted into a barcode by Ad Data Code Module 0728 and the Module to decode the barcode into parameters for writing to Ad Data File 0734; and/or utilizing Barcode Reader 0336 to read an image of Ad Data Code 0200 in the form of a barcode and Ad Data Code Module 0728 to decode the barcode into parameters for writing to Ad Data File 0734.

In addition or alternatively, Wireless Device 0120 can receive Ad Data Code 0200 in the form of a sound wave through Microphone 0328, which can utilize Ad Data Code Module 0728 to decode the wave into parameters for writing to Ad Data File 0734. In another example, Wireless Device 0120 can receive Ad Data Code 0200 in the form of a radio signal through NFC Antenna 0338, which can utilize Ad Data Code Module 0728 to decode the signal into parameters for writing to Ad Data File 0734.

Wireless Device 0120 can also receive Ad Data Code 0200 in the form of a radio signal through Antenna 0324, which can utilize Ad Data Code Module 0728 to decode the signal into parameters for writing to Ad Data File 0734. Wireless Device 0120 can also receive Ad Data Code 0200 in the form of a carrier signal through Port 0326, which can utilize Ad Data Code Module 0728 to decode the signal into parameters for writing to Ad Data File 0734. Wireless Device 0120 can further receive Ad Data Code 0200 in the form of an infrared signal through IrDA Transceiver 0330, which can utilize Ad Data Code Module 0728 to decode the signal into parameters for writing to Ad Data File 0734.

In step 2210, information related to the viewing of the Advertisement is generated and stored in the Wireless Device. For example, URMS 0350 applies a variety of Modules to assign data to Ad Data Code 0200 for conversion into Ad File 2300, including, but not limited to: Synchronization Module 0706, which identifies the type of transmitting device from which Wireless Device 0120 receives Ad Data Code 0200 and its associated Advertisement, in this example, Synchronization Module 0706 receives Ad Data Code 0200 and its associate Advertisement from a Television and assigns a value=1 for the “Transmitting Device” field; Timer Module 0712 assigns a date/time stamp to determine the date and time Wireless Device 0120 receives Ad Data Code 0200 and its associated Advertisement; Mapping Module 0720 assigns the longitude, latitude, and altitude at the time Wireless Device 0120 receives Ad Data Code 0200 and its associated Advertisement. The data in Ad Data Code 0200 and the additional data assigned by URMS 0350 constitute Ad File 2300.

In step 2212, data related to the viewing of the Advertisement is transmitted to Television Operator and/or Advertiser. The data can be transmitted in a variety of ways. For example, Wireless Device 0120 can transmit to any I-O Device of STB 0500 through any of its I-O Devices data indicating that user of Wireless Device 0120 viewed the Advertisement. After receiving the signal, any I-O Device of STB 0500 can transmit a signal through its respective Interface to CPU 0510, which can retransmit the signal to Television Operator in any OOB data channel, including, but not limited to, any Reverse Data Channel, which is a channel carrying data utilizing any protocol, e.g., IP, from STB 0500 to a central control point of a Television system, e.g., a headend in a cable television system. The present method can enable the transmission of data from STB 0500 to a Television Operator utilizing any standard, including, but not limited to, Digital Video Broadcasting Return Channel for Cable (DVB-RCC); and/or Digital Video Broadcasting Return Channel for Terrestrial broadcasting (DVB-RCT).

STB 0500 can transmit data to Television Operator in any OOB data channel on any schedule. Some existing Television systems do not enable real-time upstream transmission in the OOB data channel. Other existing and future Television systems enable real-time upstream transmission in the OOB data channel. Because calculation of the ROI of any given Advertisement is not time-sensitive, it is not necessary to transmit in real-time data recording if an user of Wireless Device 0120 viewed an Advertisement. The present method can enable STB 0500 to transmit data recording if an user of Wireless Device 0120 viewed an Advertisement in real-time or delayed, e.g., by storing the data in Memory 0514 and transmitting at a later time either an individual data or batches of data.

Wireless Device 0120 can also transmit to Advertiser System 0100 and/or Third Party Server 0150 through Antenna 0322 data indicating that user of Wireless Device 0120 viewed the Advertisement.

The data Wireless Device 0120 user can transmit to Television Operator can be any data indicating he/she viewed an Advertisement, including, but not limited to, a IP packet, e.g., ACK, acknowledging receipt of packets constituting an Advertisement and/or Ad Data Code 0200; and/or a file generated by Ad Data Code Module 0728 acknowledging receipt of an Advertisement and/or Ad Data Code 0200.

While the above description applies to the construction of an Ad File 2300 in the case of a Television Advertisement, the present invention can enable the construction of an Ad File for an Ad Data Code 0200 and its associated Advertisement transmitted to any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. The present invention can apply the same method described above for converting an Ad Data Code 0200 into an Ad File 2300, except that the URMS 0350 would assign whichever Module received the Ad Data Code 0200 to identify variables including, but not limited to: whichever type of transmitting device from which Wireless Device 0120 receives the Ad Data Code 0200 and its associated Advertisement and assign its corresponding value for the “Transmitting Device” field. When the present invention uses the term, Ad File 2300, it applies such term to an Ad File generated from an Ad Data Code 0200 transmitted to any Media Device 0110.

2.2.1.2 Measurement of User Viewing Advertisement on Personal Computer Media Device

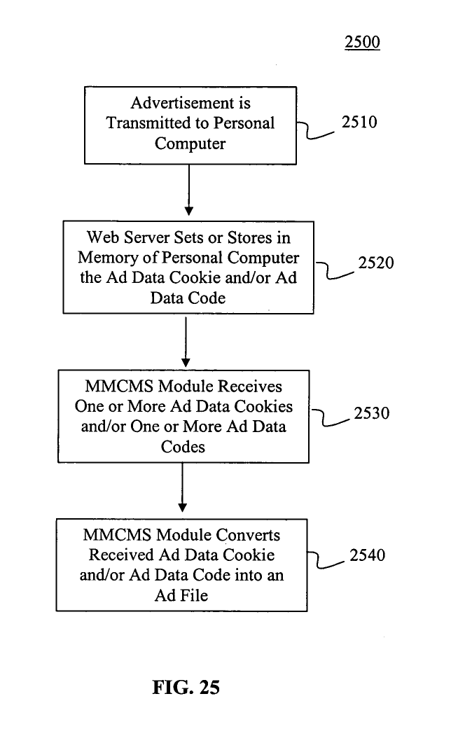

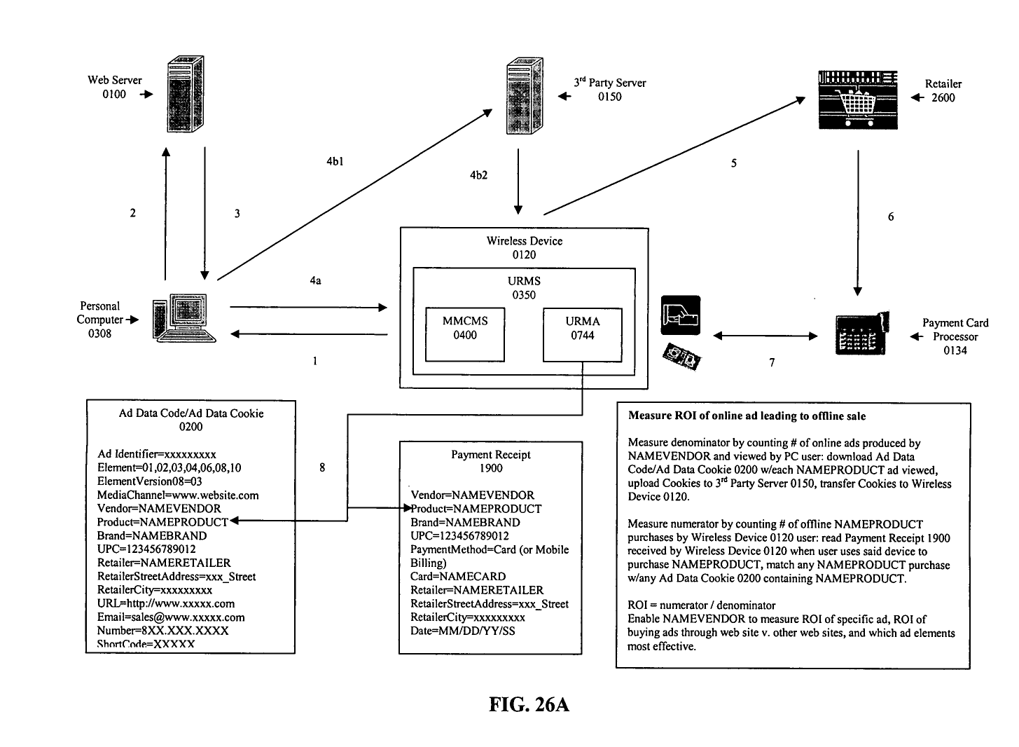

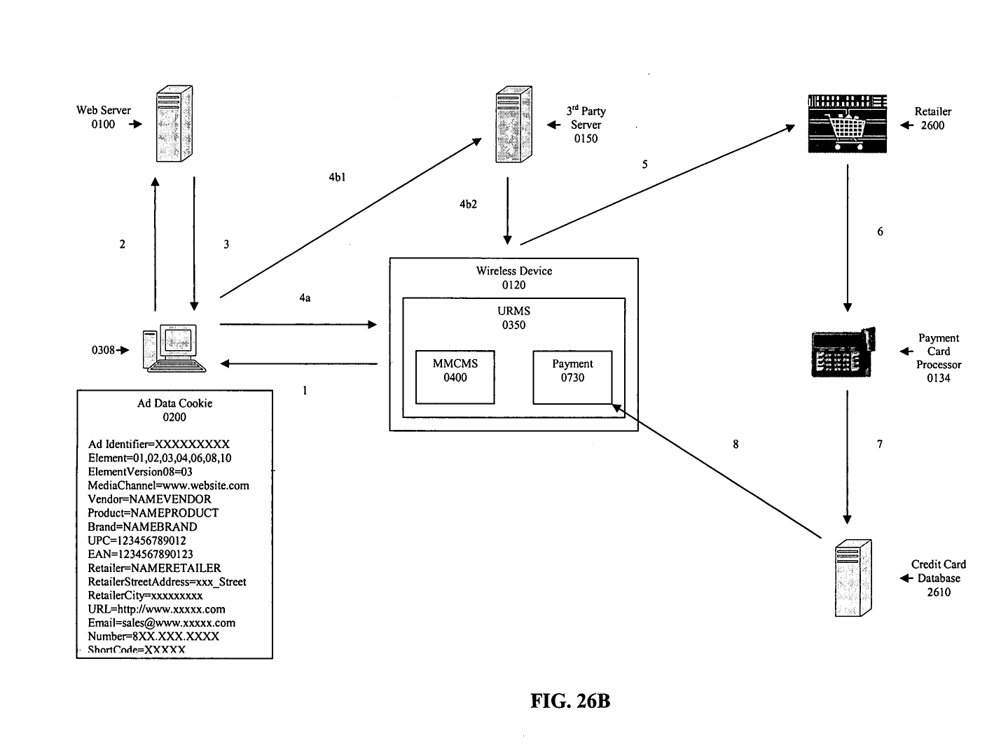

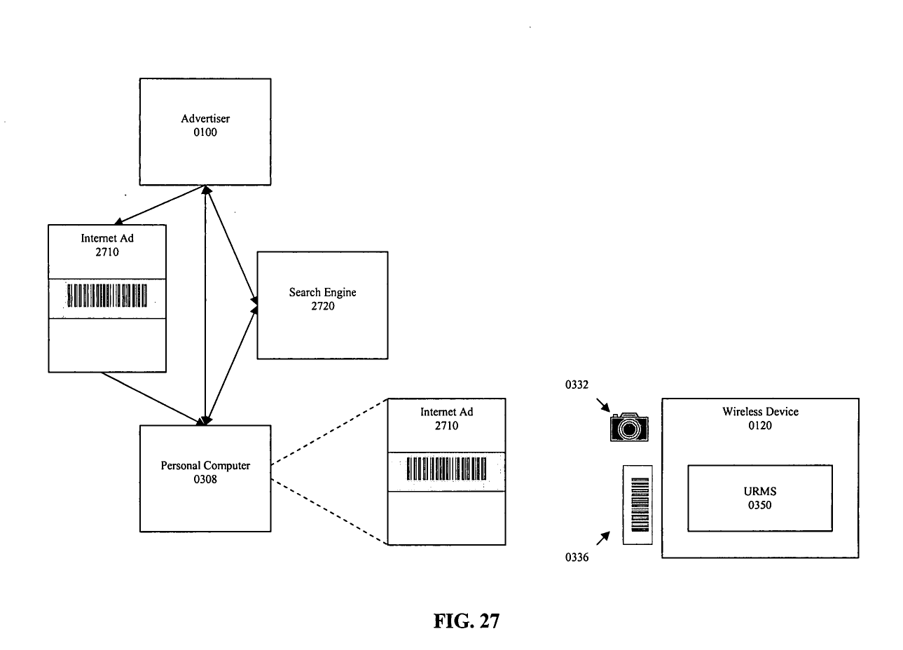

FIG. 25 depicts an exemplary flowchart 2500 of measurement of the ROI for an Advertisement to a Personal Computer 0308, according to embodiments of the present invention. Method 2500 is described with reference to the system depicted in FIG. 26A, FIG. 26B, and FIG. 27. However, Method 2500 is not limited to those embodiments.

In step 2510, an Advertisement, which may include an Ad Data Code 0200, is transmitted to Personal Computer 0308. For example, an Internet Operator may transmit the Advertisement to the Personal Computer 0308. For example, an Internet Operator typically transmits to Memory 0012 of Personal Computer 0308 a cookie utilizing any method readily apparent to any person with ordinary skill in the art. Any entity can transmit to a Personal Computer 0308 an Ad Data Code 0200 in a variety of means, including, but not limited to: adding and/or appending the data in an Ad Data Code 0200 to the cookie an Internet Operator would typically transmit to a Personal Computer 0308; generating an Ad Data Code 0200 in the form of a cookie it would typically transmit to a Personal Computer 0308; generating an Ad Data Code 0200 in the form of one or more cookies and transmitting both the additional cookies and the cookie it would typically transmit to a Personal Computer 0308; generating an Ad Data Code 0200 in the form of a Web page and transmitting the Web page to a Personal Computer 0308, whose Web Browser can parse the Web page for the data in the Ad Data Code 0200 (e.g., by extracting the data associated with certain HTML tags) for processing by Personal Computer 0308 and/or Wireless Device 0120; and/or embedding an Ad Data Code 0200 in a Web page including the Advertisement and transmitting the Web page to a Personal Computer 0308, whose Web Browser can parse the Web page for the data in the Ad Data Code 0200 for processing by Personal Computer 0308 and/or Wireless Device 0120. The present invention can support the inclusion of data in an Ad Data Code 0200 in one or more cookies through a variety of means, including, but not limited to: including the data in Ad Data Code 0200 in one cookie; including the data in Ad Data Code 0200 in a plurality of cookies, e.g., having one cookie with one name-value pair for one variable or field in Ad Data Code 0200 as depicted in FIG. 2 and a plurality of cookies with other name-value pairs for other variables or fields in Ad Data Code 0200; and/or assigning an unique code to the set of all name-value pairs for a given Ad Data Code 0200 (“Omni ADC Code”), assigning Omni ADC Code as a value in a name-value pair, storing the Omni ADC Code in a Web Server, and transmitting to any Media Device 0110 a cookie that includes the Omni ADC Code as a value in a name-value pair.

In addition or alternatively, Advertisements can be transmitted to Personal Computer 0308 through means other than a Personal Computer 0308 user requesting a web page containing an Advertisement, including, but not limited to: an Advertisement transmitted through an email to Personal Computer 0308, an Advertisement transmitted through an instant message to Personal Computer 0308, an Advertisement transmitted as what is commonly referred to as a “pop-up,” or any other means of transmitting an Advertisement to Personal Computer 0308.

In addition or alternatively, the Internet Advertisement (e.g., Internet Advertisement 2710 of FIG. 27) can be in any form that can be read by one or more I-O Devices of Wireless Device 0120, including, but not limited to: a barcode, any string of characters which can be converted into a barcode by software in Wireless Device 0120, or data which can be transmitted in a radio signal and/or through a cable.

In step 2520, Web Server 0100 sets or stores in Memory 0012 of Personal Computer 0308 the Ad Data Cookie and/or an Ad Data Code 0200. The present invention defines an Ad Data Cookie as an Ad Data Code 0200 in the form of a cookie describing the Advertisement viewed by the user. In general, an Ad Data Cookie includes NAME=VALUE pairs providing values for one or more variables listed in exemplary Ad Data Code 0200 illustrated in FIG. 2. An example of an Ad Data Cookie 0200 is illustrated in FIG. 26A.

The process of a Web Server writing, setting or storing, reading, and retrieving a cookie to or from Memory 0012 of Personal Computer 0308 is well known to any person with ordinary skill in the art. Typically, a Web Browser allows a Web Server to view a cookie created by another Web Server, but only in accordance with rules set by the Web Browser. For example, a Web Browser can generally allow a Web Server to view cookies created by Web Servers from the same server domain. Moreover, Web Browser can generally allow a Web Server to view cookies created by Web Servers from the same or higher-level folders within the same server domain. A Web Browser generally sets such rules to prevent a Web Server from viewing cookies written by other Web Servers. One way a Web Browser can limit which Web Servers can view a cookie is to have the Web Server writing a cookie include a description of the range of URLs for which the state information is valid. If Web Browser makes any future requests of a web page which falls in a URL range, the Web Browser can transmit to the Web Server all cookies stored by the Web Browser.

Personal Computer 0308 may delete a cookie or not store a cookie for a variety of reasons, including, but not limited to: the user rejecting the storing of a cookie in Memory 0012 of Personal Computer 0308 by the Web Browser; the number of cookies stored by each web domain in Memory 0012 of Personal Computer 0308 reaches the maximum allowed; the total number of cookies stored in Memory 0012 of Personal Computer 0308 reaches the maximum allowed; or Personal Computer 0308 may delete a cookie if the expiration date of the cookie is reached. In this situation, the present invention can record whether Personal Computer 0308 user views an Advertisement by receiving a transmission from Advertiser System 0100 whose web site the user visited in a variety of ways, including, but not limited to: if the Advertiser can associate the static IP address with the user; or if the user provided information about the user to the Web Server serving the Advertisement.

In addition or alternatively, the user of the Wireless Device 0120 can record an image of Ad Data Code 0200 (e.g., in the form of a barcode as part of Internet Advertisement 2710 on display of Personal Computer 0308).

In step 2530, MMCMS Module 0400 receives one or more Ad Data Cookies and/or one or more Ad Data Codes 0200. MMCMS Module 0400 can receive one or more Ad Data Cookie(s) in a variety of ways. Exemplary methods for receiving one or more Ad Data Cookies are described in detail in Section 2.2.1.2.1 below.

In step 2540, MMCMS Module 0400 converts the received Ad Data Cookie and/or Ad Data Code 0200 into an Ad File. The Ad File can include information about each Advertisement viewed by one or more users of Personal Computer 0308.

As would be appreciated by any person with ordinary skill in the art, Method 2500 can support cookie handling either on the “client-side” and/or “server-side.” Method 2500 can also support Web Browser loading one or more cookies available on a web page, assembling all the cookies available on the web page into a single string or what is commonly referred to as a document cookie, and/or processing cookies in an alternative means.

In addition to the steps described above, an user of Wireless Device 0120 can purchase a Product promoted in such Advertisement; a Retailer Payment Device 0134 can transmit to Wireless Device 0120 and/or another device a Payment Receipt 1900; URMS 0350 can call Payment Code Module 0730 to parse Payment Receipt 1900 for data needed to calculate a ROI for the Advertisement viewed, which such Module can write to Payment Data File 0740; and/or URMA Module 0744 can search through any files containing data on Advertisements viewed by user and search through any files containing data on Products purchased by user, and match data uniquely identifying a purchased Product, e.g., the UPC/EAN/GTIN with data identifying a Product promoted in a viewed Advertisement.

Note that although the above flowchart describes processes for recording information about the Advertisements viewed by Personal Computer 0308 user and enabling Wireless Device 0120 to retrieve the information, the above methods can be utilized to record information about the Advertisements viewed by Wireless Device 0120 user on and retrieve the information from any device, including Television 0304, Radio 0306, Wireless Base Station 0302, Outdoor Media Device 0310, Magazine or Newspaper 0312, Product Package 0314, or Other Wireless Device 0316.

### 2.2.1.2.1 METHODS FOR RECEPTION OF AD DATA COOKIE

### 2.2.1.2.1.1 ADVERTISER TRANSMISSION

While the present invention describes methods for enabling any Media Device 0110 to receive an Ad Data Cookie, the methods are not limited to that embodiment. The present invention can support the reception of any type of data that describes an Advertisement, including, but not limited to: an Ad Data Cookie and/or an Ad Data Code 0200.

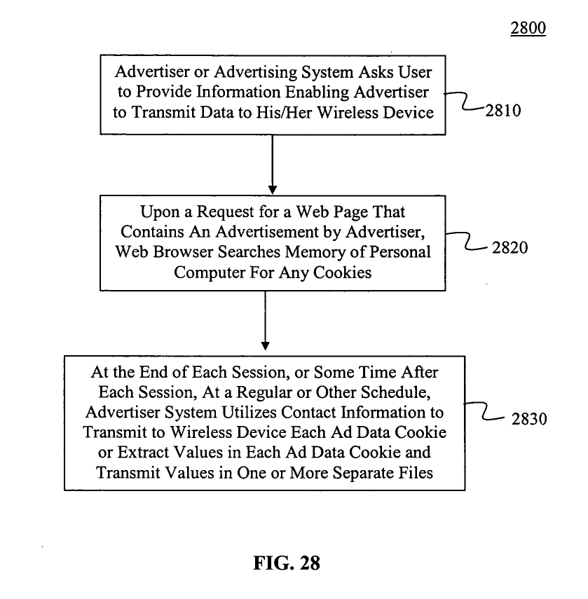

FIG. 28 depicts a flowchart 2800 of Advertiser transmission of Ad Data Cookie to a Wireless Device 0120, according to embodiments of the present invention. Method 2800 is described with reference to the exemplary system of FIG. 26A. However, Method 2800 is not limited to that embodiment. The present invention can implement the Advertiser transmission of an Ad Data Cookie by executing a subset of the steps in FIG. 28, executing the steps in different order, and/or executing other or additional related or equivalent steps.

In step 2810, the Advertiser or Advertising System 0100 can ask an user to provide information enabling the Advertiser to transmit data to his/her Wireless Device 0120. For example, Advertiser can ask the user for the phone number or text messaging address of the user's Wireless Device 0120. If the user provides the information, then the Advertiser can write and store in a web server associated with the Advertiser and/or Memory 0012 of Personal Computer 0308 a cookie that includes one or more NAME=VALUE pairs identifying the contact information (“Contact Cookie”).

In step 2820, upon a request for a web page that contains an Advertisement by the Advertiser, Web Browser searches Memory 0012 of Personal Computer 0308 for any cookies, including Ad Data Cookies, stored by Advertiser System 0100. If Web Browser finds any the cookies, including Ad Data Cookies, the browser can transmit to Advertiser System 0100 the cookies, including Ad Data Cookies, and/or the NAME=VALUE pairs in the Ad Data Cookies in a separate file.

In step 2830, during each session of the user with the web page, at the end of each session, or some time after each session, at a regular or other schedule, Advertiser System 0100 utilizes the contact information in Contact Cookie to transmit to Wireless Device 0120 each Ad Data Cookie, or extract the values in each Ad Data Cookie and transmit the values in one or more separate files. In another embodiment, Advertiser System 0100 can transmit Ad Data Cookies received from Personal Computer 0308 user to a Third Party Server 0150 that can collect Ad Data Cookies for transmission to Wireless Device 0120 (“Third-Party”). The Third-Party can either: (i) retransmit to Wireless Device 0120 the Ad Data Cookies received by Advertiser System 0100 from Personal Computer 0308; or (ii) aggregate Ad Data Cookies received by any and/or all Advertisers 0100 from Personal Computer 0308 and retransmit to Wireless Device 0120 the Ad Data Cookies in a number of files that is smaller than the number of Advertisers 0100 receiving Ad Data Cookies from Personal Computer 0308.

To address the case where the user requests a web page that contains an Advertisement by an Advertiser and does not subsequently request a web page with the domain name of the Advertiser System 0100, the present method can record the user initial viewing of an Advertisement by an Advertiser by generating and storing at the Advertiser System 0100 Web Server an Ad Data Cookie. During each session, at the end of each session, or some time after each session, at a regular or other schedule, Advertiser System 0100 can transmit to Wireless Device 0120 the Ad Data Cookie(s).

### 2.2.1.2.1.2 THIRD PARTY URL TRANSMISSION

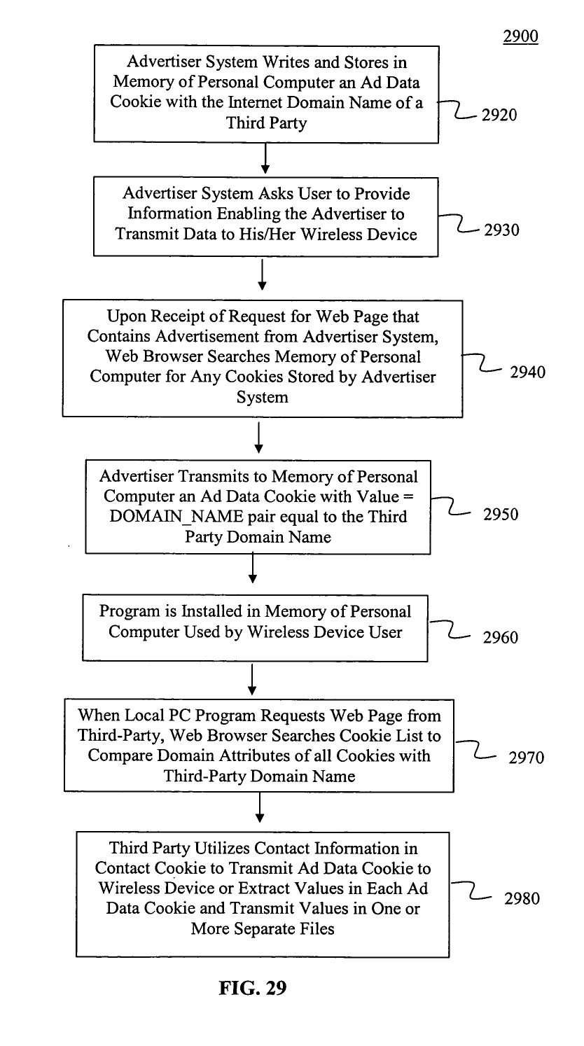

FIG. 29 depicts a flowchart 2900 of Third Party Server 0150 URL transmission of Ad Data Cookie to a Wireless Device 0120, according to embodiments of the present invention. Method 2900 is described with reference to the exemplary system of FIG. 26A. However, Method 2900 is not limited to that embodiment. The present invention can implement the Advertiser transmission of Ad Data Cookie by executing a subset of the steps in FIG. 29, executing the steps in different order, and/or executing other or additional related or equivalent steps.

First, in the step 2920 (Ad Data Cookie writing step), Advertiser System 0100 can write and store in Memory 0012 of Personal Computer 0308 an Ad Data Cookie with the Internet domain name of, not Advertiser System 0100, but a Third-Party. In addition, Advertiser System 0100 can write and store in Memory 0012 of Personal Computer 0308 an Ad Data Cookie with a path attribute matching the pathname component of the URL of the Third-Party. For example, in most Web Browsers, the path “/” is the most general path. In general, a web page writing a cookie sets the value in the domain=DOMAIN_NAME pair equal to the domain name of the web site. The purpose of the web page writing a cookie that sets the value in the domain=DOMAIN_NAME pair equal to the Third-Party domain name is to enable the Third-Party to retrieve any and all Ad Data Cookies. Because a Personal Computer 0308 user would probably view Advertisements from many different web sites, it is more efficient for one Third-Party to retrieve any and all Ad Data Cookies from each Personal Computer 0308 user than it is for each Advertiser System 0100 to retrieve the Ad Data Cookies from each Personal Computer 0308 user. Moreover, it is more efficient for one Third-Party to aggregate all Ad Data Cookies from all Advertisers 0100 and transmit all the data in one file to Wireless Device 0120 than it is for each Advertiser System 0100 to transmit separately its own respective Ad Data Cookies to Wireless Device 0120.

Current Web Browsers require that a web page writing a cookie set the value in the domain=DOMAIN_NAME pair equal to the domain name of the web site. The above Step 1 in the present Third-Party URL Transmission Method would require the vendors of Web Browser to enable a web page writing and storing a cookie in Memory 0012 of Personal Computer 0308 to set the value in the domain=DOMAIN_NAME pair equal to the domain name of a Third-Party.

In step 2930, Advertiser System 0100 asks the user to provide information enabling the Advertiser to transmit data to his/her Wireless Device 0120. For example, Advertiser System 0100 can ask the user for the phone number or text messaging address of the user's Wireless Device 0120. If the user provides the information, then Advertiser System 0100 can write and store in Memory 0012 of Advertiser System 0100 web server and/or Personal Computer 0308 a Contact Cookie with a value in the domain=DOMAIN_NAME pair equal to the domain name of a Third-Party and a path attribute matching the pathname component of the URL of the Third-Party.

In step 2940, upon receipt of a request for a web page that contains an Advertisement from Advertiser System 0100, Web Browser searches Memory 0012 of Personal Computer 0308 for any cookies stored by Advertiser System 0100. If Advertiser System 0100 stored cookies with a value in domain=DOMAIN_NAME pair equal to the Advertiser System 0100 domain name, Web Browser will find the cookies and transmit the cookies and/or the NAME=VALUE pairs in the cookies separately to Advertiser System 0100. However, Web Browser will not fetch any Ad Data Cookies generated by Advertiser System 0100 with a value in domain=DOMAIN_NAME pair equal to the Third-Party domain name.

In step 2950, at the time the user requests any web page that contains an Advertisement from Advertiser System 0100, the Advertiser transmits to Memory 0012 of Personal Computer 0308 an Ad Data Cookie with a value in domain=DOMAIN_NAME pair equal to the Third-Party domain name.

In step 2960, a program is installed in Memory 0012 of Personal Computer 0308 used by Wireless Device 0120 user (“Local PC Program”). Note that this step does not occur each time method 2800 is performed and would also likely be performed prior to or concurrently with the above steps. The program can access the Internet from Personal Computer 0308. The program (e.g., Local PC Program) can perform several functions, including, but not limited to: (a) interoperate with Synchronization Module 0706 to enable Wireless Device 0120 to read and/or retrieve Ad Data Cookie from Memory 0012 of Personal Computer 0308; or (b) initiate a request from Personal Computer 0308 to retrieve a web page operated by Third-Party. Thus, during each session with a given web page, at the end of each session, or some time after each session, at a regular or other schedule, the Local PC Program can initiate a request to get a web page operated by Third-Party.

In step 2970, when Local PC Program requests a web page from Third-Party, Web Browser searches the cookie list to compare the domain attributes of all cookies with the Third-Party domain name. If there is a match, Web Browser can review the path=PATH attribute to determine if it should transmit the cookie. If Advertiser System 0100 wrote and stored in Memory 0012 of Personal Computer 0308 any Ad Data Cookies with a value in domain=DOMAIN_NAME pair equal to the Third-Party domain name and a matching pathname, then Web Browser can transmit to the Third-Party those Ad Data Cookies. By retrieving any cookies with the Third-Party domain name, the present step can enable Local PC Program to retrieve data on any and/or all Advertisements viewed by Personal Computer 0308 user in the case where Personal Computer 0308 Web Browser permits the setting and storage of third-party cookies.

In step 2980, during each session, at the end of each session, or some time after each session, at a regular or other schedule, Third-Party can utilizing the contact information in Contact Cookie transmit to Wireless Device 0120 each Ad Data Cookie, or extract the values in each Ad Data Cookie and transmit the values in one or more separate files.

### 2.2.1.2.1.3 THIRD PARTY COOKIE

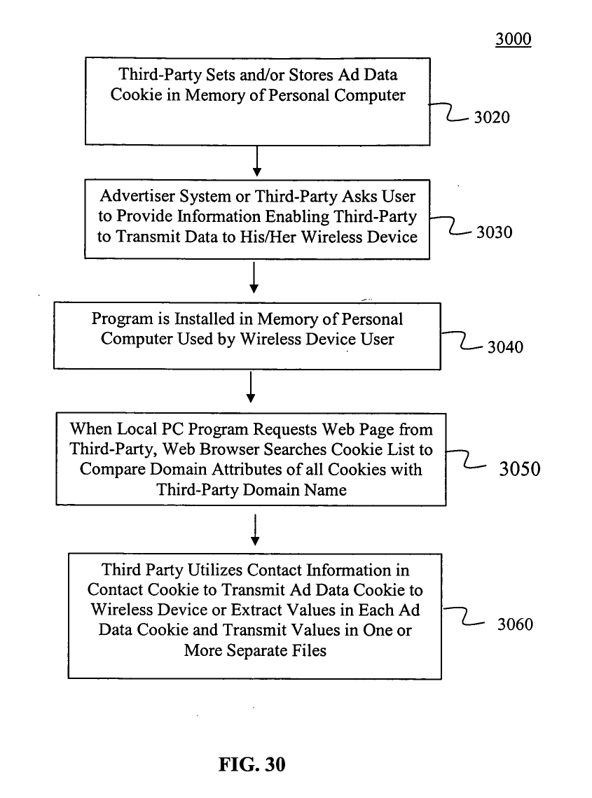

FIG. 30 depicts a flowchart 3000 of third party cookie method for transmission of Ad Data Cookie to a Wireless Device 0120, according to embodiments of the present invention. Method 3000 is described with reference to the exemplary system of FIG. 26A. However, Method 3000 is not limited to that embodiment. The present invention can implement the Advertiser transmission of Ad Data Cookie by executing a subset of the steps in FIG. 30, executing the steps in different order, and/or executing other or additional related or equivalent steps.

In step 3020, in lieu of step 2820 (the Ad Data Cookie writing step), the Third-Party Cookie Method can include the following step. If Personal Computer 0308 user requests a web page that contains an Advertisement by Advertiser System 0100 and Personal Computer 0308 Web Browser permits the setting or storage of third-party cookies, a third-party can set and/or store an Ad Data Cookie in Memory 0012 of Personal Computer 0308. As described above, an Ad Data Cookie is a cookie that includes NAME=VALUE pairs providing values for one or more of the variables listed in Ad Data Code 0200 that describe a given Advertisement. A Third-Party Ad Data Cookie as an Ad Data Cookie set or stored by a web site with a domain other than the one requested by Web Browser. A Third-Party can set and/or store in Memory 0012 of Personal Computer 0308 a Third-Party Ad Data Cookie by providing an element in the web page requested by Web Browser. This element can include, but is not limited to: an image or the contents of an IFRAME. The process of enabling the storage of a third party cookie, of which a Third-Party Ad Data Cookie is a subclass, is well known to those with ordinary skill in the art.

In step 3030, Advertiser System 0100 or the Third-Party asks the user to provide information enabling the Third-Party to transmit data to his/her Wireless Device 0120. For example, Advertiser System 0100 or the Third-Party can ask the user for the phone number or text messaging address of the user's Wireless Device 0120. If the user provides the information, then the Third-Party can write and store in Memory 0012 of Third-Party web server and/or Personal Computer 0308 a Contact Cookie with a value in the domain=DOMAIN_NAME pair equal to the domain name of a Third-Party and a path attribute matching the pathname component of the URL of the Third-Party.

In step 3040, the present method installs a Local PC Program in the Memory 0012 of Personal Computer 0308 used by Wireless Device 0120 user. Note that this step does not occur each time Method 2900 is performed and would also likely be performed prior to or concurrently with the above steps. The program can access the Internet from Personal Computer 0308. The program (e.g., Local PC Program) can perform several functions, including, but not limited to: (a) interoperate with Synchronization Module 0706 to enable Wireless Device 0120 to read and/or retrieve Ad Data Cookie from Memory 0012 of Personal Computer 0308; or (b) initiate a request from Personal Computer 0308 to retrieve a web page operated by Third-Party. Thus, during each session with a given web page, at the end of each session, or some time after each session, at a regular or other schedule, the Local PC Program can initiate a request to get a web page operated by Third-Party.

In step 3050, when Local PC Program requests a web page from Third-Party, Web Browser can search the cookie list to compare the domain attributes of all cookies with the Third-Party domain name. If there is a match, Web Browser can review the path=PATH attribute to determine if it should transmit the cookie. If the Third-Party wrote and stored in Memory 0012 of Personal Computer 0308 any Ad Data Cookies with a value in domain=DOMAIN_NAME pair equal to the Third-Party domain name and a matching pathname, then Web Browser can transmit to the Third-Party the Ad Data Cookies. By retrieving any and/or cookies with the Third-Party domain name, the present step can enable Local PC Program to retrieve data on any and/or all Advertisements viewed by Personal Computer 0308 user in the case where Personal Computer 0308 Web Browser permits the setting and storage of third-party cookies.

In step 3060, during each session, at the end of each session, or some time after each session, at a regular or other schedule, Third-Party can utilizing the contact information in Contact Cookie transmit to Wireless Device 0120 each Ad Data Cookie, or extract the values in each Ad Data Cookie and transmit the values in one or more separate files.

### 2.2.1.2.1.4 WIRELESS DEVICE SYNCHRONIZATION

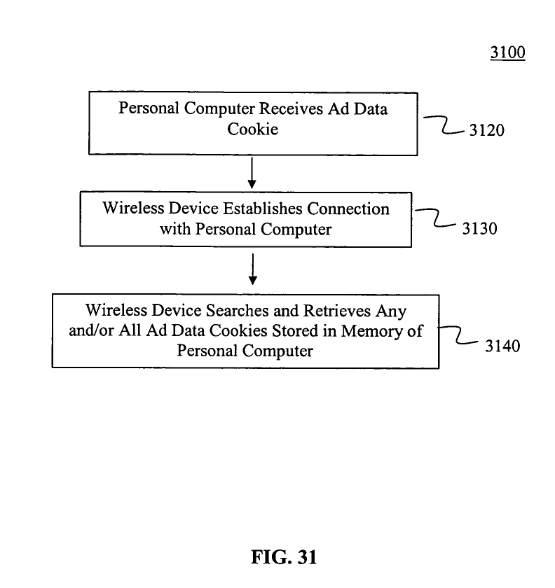

FIG. 31 depicts a flowchart 3100 of a wireless device synchronization method for transmission of Ad Data Cookie to a Wireless Device 0120, according to embodiments of the present invention. Method 3100 is described with reference to the exemplary system of FIG. 26A. However, Method 3100 is not limited to that embodiment. The present invention can implement the Advertiser transmission of Ad Data Cookie by executing a subset of the steps in FIG. 31, executing the steps in different order, and/or executing other or additional related or equivalent steps.

In one embodiment, a Personal Computer includes a program Module or application enabling Wireless Device 0120 to retrieve the Ad Data Code 0200 from Memory 0012 of Personal Computer 0308 through synchronization (“Synchronization Program”) utilizing any method readily apparent to any person with ordinary skill in the art. The program Module or application may be provided by an Advertiser or a Third Party Server 0150.

In step 3120, as described in step 2820, Personal Computer 0308 can receive an Ad Data Cookie in a variety of ways, including, but not limited to: Advertiser System 0100 can set or store in Memory 0012 of Personal Computer 0308 an Ad Data Cookie with a value in domain=DOMAIN_NAME pair equal to the Advertiser System 0100 domain name; Advertiser System 0100 can set or store in Memory 0012 of Personal Computer 0308 an Ad Data Cookie with a value in domain=DOMAIN_NAME pair equal to the domain name of a Third-Party; or a Third Party can set or store in Memory 0012 of Personal Computer 0308 an Ad Data Cookie with a value in domain=DOMAIN_NAME pair equal to the domain name of the Third-Party.

In step 3130, Wireless Device 0120 can establish a connection with Personal Computer 0308 in a variety of ways, including, but not limited to: through Antenna 1522 utilizing Bluetooth or any other short-range wireless protocol; through Synchronization Device 1524; through Infrared Device 1528; and/or through a RFID Device, including any RFID Device or other device that can support NFC or any comparable standard enabling short-range communication. All of these processes and devices for exchanging data between two devices are well known to those with ordinary skill in the art.

In step 3140, Wireless Device 0120 can search and retrieve any and/or all Ad Data Cookies stored in Memory 0012 of Personal Computer 0308 by utilizing a variety of protocols, including, but not limited to: SyncML Representation Protocol developed by the Open Mobile Alliance; any successor protocols; any other kind of protocol for specifying the exchange of data across different devices; or any extension to the protocols enabling the search and retrieval of specific types of files, including an Ad Data Cookie.

While the rest of the specification describing the present step applies to the SyncML Representation Protocol, the present step can support search and retrieval of any and/or all Ad Data Cookies stored in Memory 0012 of Personal Computer 0308 utilizing alternative protocols in a similar or comparable manner.

Wireless Device 0120 can achieve capabilities exchange by using the SyncML GET command to search and retrieve from Memory 0012 of Personal Computer 0308 any information documents, e.g., Ad Data Cookies.

Wireless Device 0120 can search in Memory 0012 of Personal Computer 0308 any information documents, e.g., Ad Data Cookies, by using the SyncML SEARCH command. SyncML can restrict the search and synchronization to a subset of information documents in Memory 0012 of Personal Computer 0308. For example, SyncML can limit the search to those Ad Data Cookies set or stored in Memory 0012 of Personal Computer 0308 since the last synchronization.

Wireless Device 0120 can retrieve from Memory 0012 of Personal Computer 0308 any individual attributes or values from any information documents, e.g., Ad Data Cookies, by utilizing a XML Document Filter. The present step can access an individual attribute or individual value from any name-value pair by utilizing script tags as specified by SyncML. The objective of enabling the retrieval of individual attributes or values is to enable the present method to retrieve data that Advertiser System 0100 might have set or stored in a cookie that did not follow the format of an Ad Data Cookie, but still presented information relating to the description of an Advertisement.

### 2.2.1.2.1.5 WIRELESS DEVICE SEARCH

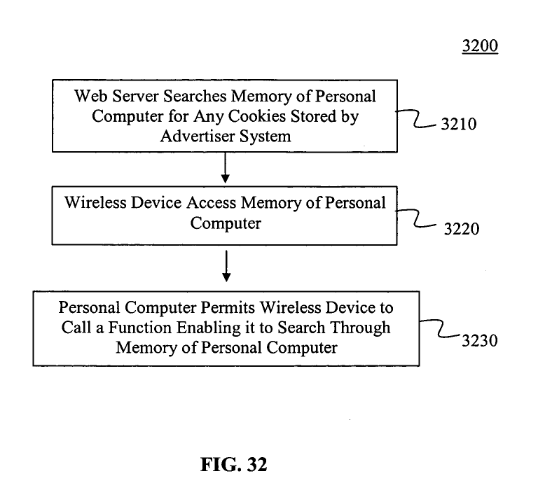

FIG. 32 depicts a flowchart 3200 of a Wireless Device synchronization method for transmission of Ad Data Cookie to a Wireless Device 0120, according to embodiments of the present invention. Method 3200 is described with reference to the exemplary system of FIG. 26A. However, Method 3200 is not limited to that embodiment. The present invention can implement the Advertiser transmission of Ad Data Cookie by executing a subset of the steps in FIG. 32, executing the steps in different order, and/or executing other or additional related or equivalent steps.

In step 3210, each time an user requests a web page that contains an Advertisement from Advertiser System 0100, Web Browser searches Memory 0012 of Personal Computer 0308 for any cookies stored by Advertiser System 0100. If Web Browser finds any the cookies, the Web Browser can transmit the cookies and/or the NAME=VALUE pairs in the cookies separately to Advertiser System 0100.

In step 3220, Wireless Device 0120 accesses Memory 0012 of Personal Computer 0308 in a variety of ways, including, but not limited to: Wireless Device 0120 user attaching Synchronization Device 0326 to Synchronization Device 1524; Wireless Device 0120 user transmitting a request to access Memory 0012 of Personal Computer 0308 through Antenna 1522 utilizing Bluetooth or another wireless protocol; Wireless Device 0120 user transmitting a request to access Memory 0012 of Personal Computer 0308 through Infrared Device 1528; or Wireless Device 0120 user transmitting a request to access Memory 0012 of Personal Computer 0308 through a RFID Device (not pictured in FIG. 15), which can support NFC or any comparable standard enabling short-range communication.

In step 3230, Personal Computer 0308 permits Wireless Device 0120 to call a function enabling it to search through Memory 0012 of Personal Computer 0308 utilizing a file manager type of program. The search can be limited to a search of any cookie file. In the preferred embodiment, most or all Advertisers, either individually, through a formal group like an industry association, through an informal group, or through advertising agencies, can agree upon a standard NAME=VALUE pair that describes the cookie as a data file containing information about an Advertisement viewed by Personal Computer 0308 user (“Open Standard Ad Data Cookie”). In another embodiment, a vendor providing a service to Advertisers of measuring the ROI by utilizing the present inventions of the URMS 0350 and MMCMS can notify Advertisers that it can enable Wireless Device 0120 to search through Memory 0012 of Personal Computer 0308 for only cookie files with a NAME=VALUE pair the vendor defines as a data file containing information about an Advertisement viewed by Personal Computer 0308 user (“Proprietary Standard Ad Data Cookie”). In this case, any Advertiser System 0100 wanting Wireless Device 0120 to find a cookie the Advertiser stored on Personal Computer 0308 can store the cookie with the NAME=VALUE pair.

### 2.2.1.2.2 EXAMPLES

FIG. 26A depicts a specific embodiment of how the URMS 0350 and MMCMS can measure and calculate the ROI for a typical Advertisement transmitted to a Personal Computer utilizing the payment functionality of a Wireless Device, according to embodiments of the present invention. FIG. 26A shows how the URMS 0350 and MMCMS can execute steps in the following sequence. The present invention can implement the present method by executing a subset of the steps depicted in FIG. 26A, executing the steps in different order, and/or executing other or additional related or equivalent steps. While FIG. 26A depicts a specific embodiment of how the present invention can measure and calculate the ROI in the case of a Physical Retailer 2600, the present invention can measure and calculate the ROI in the case of any Retailer, including, but not limited to: a physical retailer; an online retailer, a retailer from which a Wireless Device 0120 and/or Target Customer orders by making a phone call, or a retailer from which a Wireless Device 0120 and/or Target Customer makes a purchase order through physical delivery, i.e., through mail order.

First, when Wireless Device 0120 user synchronized his/her Wireless Device 0120 with Personal Computer 0308, Local PC Program can read and/or retrieve any Ad Data Cookies set or stored in Memory 0012 of Personal Computer 0308 for transmission to Wireless Device 0120. MMCMS Module 0400 and/or Ad Data Code Module 0728 can convert each Ad Data Cookie into an Ad File, which contains information about each Advertisement viewed by Personal Computer 0308 user. Ad Data Code Module 0728 can write the Ad Data Cookie and/or Ad File to Ad Data File 0734.

Another means for Wireless Device 0120 to retrieve any Ad Data Cookies set or stored in Memory 0012 of Personal Computer 0308 is for Local PC Program to initiate a request at a regular or irregular schedule to retrieve from Third-Party Server 0150 a web page operated by the Third-Party Server 0150 which set or stored the Ad Data Cookies. The present method includes the step, because most current Web Browsers permit a web site to retrieve only those cookies set or stored by a web site with the same domain name. After retrieving any Ad Data Cookies stored in Memory 0012 of Personal Computer 0308, Third-Party Server 0150 can transmit the Ad Data Cookies to Wireless Device 0120 for conversion into an Ad File.

In another embodiment, if Web Server 0100 can retrieve any Ad Data Cookies set or stored in Memory 0012 of Personal Computer 0308, Web Server 0100 can transmit the Cookies to Wireless Device 0120 either: (i) directly to Wireless Device 0120; or (ii) indirectly to Wireless Device 0120 through Third-Party Server 0150. In order for Web Server 0100 to identify how to transmit the Cookies to Wireless Device 0120, Personal Computer 0308 can provide such communications information to Web Server 0100.

At any time after the preceding steps, Wireless Device 0120 user can visit a Physical Retailer 2600.

Wireless Device 0120 user can purchase a given Product.

Wireless Device 0120 user can utilize any payment system enabled by Wireless Device 0120. In the present embodiment, Wireless Device 0120 has the functionality of enabling Wireless Device 0120 user to pay for a purchase by utilizing a credit card application embedded in Wireless Device 0120. In another embodiment, Wireless Device 0120 has the functionality of enabling Wireless Device 0120 user to pay for a purchase by utilizing a form of electronic cash embedded in Wireless Device 0120. The credit card application and electronic cash application are well known to any person with ordinary skill in the art.

In the present embodiment, Payment Device (or Payment Card Processor) 0134 can generate a Payment Receipt 1900 and transmit the receipt to Wireless Device 0120 through any of the means described in the present invention.

Payment Code Module 0730 can convert each Payment Receipt 1900 into a Payment File, which contains information about any Product purchased by the user of Wireless Device 0120. Payment Code Module 0730 can write the Payment Receipt 1900 and/or Payment File to Payment Data File 0740.

URMA Module 0744 can compare the values in Payment Receipt 1900, Payment Data File 0740, and/or Ad Response File 0738 with the values in Ad Data Cookie and/or Ad Data File 0734 to determine if there is a match. If URMA Module 0744 finds a match between certain variables, including, but not limited to: vendor, Product, brand, and/or UPC/EAN/GTIN, URMA Module 0744 can conclude that there is an association between an Advertisement promoting the vendor, Product, or brand viewed by Personal Computer 0308 user and the purchase of the Product or brand by Wireless Device 0120 user. In another embodiment, Payment Code Module 0730 can store the values in Payment Receipt 1900 in Ad Response File 0738 and subsequently search all the values in Ad Response File 0738 for any match with values in Ad Data Cookies and/or Ad Data File 0734.

While an Advertiser cannot necessarily conclude that the viewing of an Advertisement promoting a given Product by Personal Computer 0308 user as evidenced by Ad Data Cookie caused Wireless Device 0120 user to purchase the Product, the data collected by the present invention can provide an Advertiser more information than available now about any potential relationship between viewing of an Advertisement and any subsequent purchase a Product advertised.

FIG. 26B depicts a functional block diagram of a specific embodiment of an exemplary system for measuring the ROI for an Advertisement transmitted to a Personal Computer 0308 utilizing the payment functionality of a credit/debit card external to a Wireless Device 0120, according to embodiments of the present invention. The present invention can implement the present method by executing a subset of the steps depicted in FIG. 26B, executing the steps in different order, and/or executing other or additional related or equivalent steps.

First, when Wireless Device 0120 user synchronized his/her Wireless Device with Personal Computer 0308, Local PC Program can read and/or retrieve any Ad Data Cookies 0200 set or stored in Memory 0012 of Personal Computer 0308 for transmission to Wireless Device 0120. MMCMS Module 0400 and/or Ad Data Code Module 0728 can convert each Ad Data Cookie into an Ad File, which contains information about each Advertisement viewed by Personal Computer 0308 user. Ad Data Code Module 0728 can write the Ad Data Cookie and/or Ad File to Ad Data File 0734.

Another means for Wireless Device 0120 to retrieve any Ad Data Cookies set or stored in Memory 0012 of Personal Computer 0308 is for Local PC Program to initiate a request at a regular or irregular schedule to retrieve from Third-Party Server 0150 a web page operated by the Third-Party Server 0150 which set or stored the Ad Data Cookies. The present method includes the step, because most current Web Browsers permit a web site to retrieve only those cookies set or stored by a web site with the same domain name. After retrieving any Ad Data Cookies stored in Memory 0012 of Personal Computer 0308, Third-Party Server 0150 can transmit the Ad Data Cookies to Wireless Device 0120 for conversion into an Ad File.

In another embodiment, if Web Server 1900 can retrieve any Ad Data Cookies set or stored in Memory 0012 of Personal Computer 0308, Web Server 0100 can transmit the Cookies to Wireless Device 0120 either: (i) directly to Wireless Device 0120; or (ii) indirectly to Wireless Device 0120 through Third-Party Server 0150. In order for Web Server 0100 to identify how to transmit the Cookies to Wireless Device 0120, Personal Computer 0308 can provide such communications information to Web Server 0100.

At any time after the preceding steps, Wireless Device 0120 user can visit a Physical Retailer 2600.

Wireless Device 0120 user can purchase a given Product.

Wireless Device 0120 user can utilize a credit/debit card external to Wireless Device 0120 to purchase a given Product. Retailer 2600 can utilize the process for clearing a credit/debit card transaction that is well known to any person with ordinary skill in the art.

If the issuer of the credit card utilized by Wireless Device 0120 user permits, Credit Card Database 2610 can transmit to Wireless Device 0120 and/or any Media Device 0110 utilized by the user of Wireless Device 0120 an electronic copy of the transactions paid for by the credit card (“Credit Card Receipt”). Credit Card Database 2610 can transmit the Credit Card Receipt either directly to Wireless Device 0120, indirectly to Wireless Device 0120 through a Third-Party Server 0150, and/or directly to a Media Device 0110 utilized by the user of Wireless Device 0120. Payment Code Module 0730 and URMA Module 0744 (not pictured) can the follow the same process after receiving a Payment Receipt 1900 described in FIG. 26A. The Credit Card Receipt can include some, all, or more data than a Payment Receipt 1900. If the Credit Card Receipt includes data on one or more Products purchased by the user of Wireless Device 0120 and/or the Retailer at which the user of Wireless Device 0120 purchased one or more Products, Payment Code Module 0730 and URMA Module 0744 can apply the same methods described in the present invention to process such data and find a match between certain variables, including, but not limited to: vendor, Product, brand, UPC/EAN/GTIN, and/or Retailer.

2.2.1.3 Measurement of User Viewing of and Response to Advertisement by Search Module

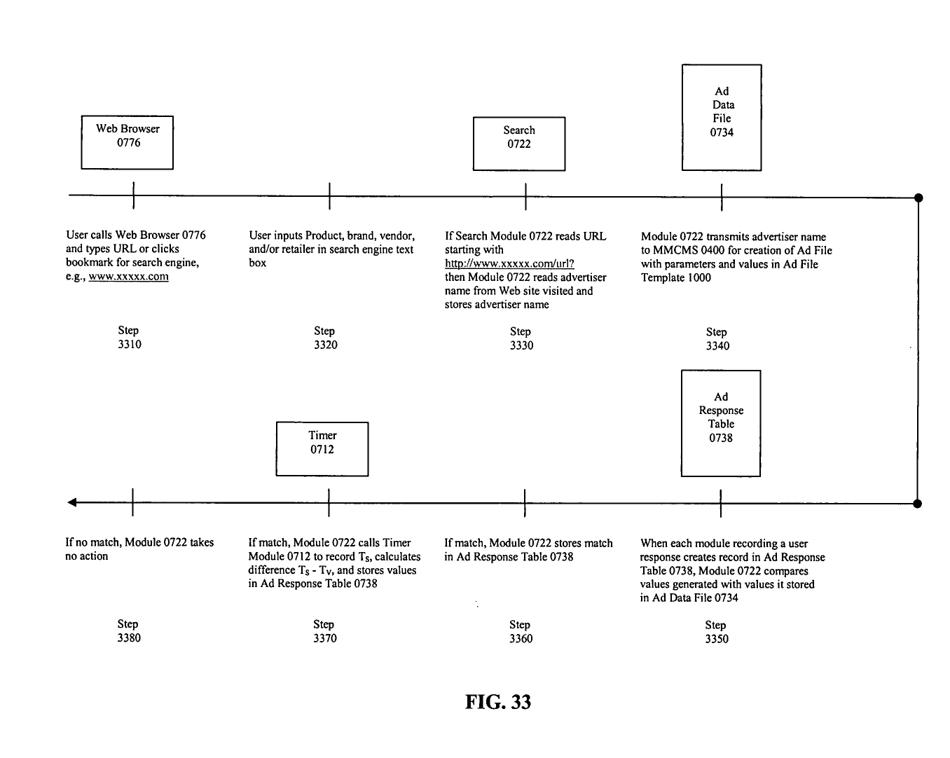

FIG. 33 depicts a flowchart 3300 of a method for measuring whether Wireless Device 0120 user views an Advertisement at a search engine and determining if there is a match between an user response and an Advertisement viewed by the user, according to embodiments of the present invention. The present invention can implement Search Module 0722 by executing a subset of the steps in Method 3300, executing the steps in different order, and/or executing other or additional related or equivalent steps.

In step 3310 the user of Wireless Device 0120 accesses an Advertisement placed in an interactive channel. The interactive channel can be any type of content with which an user can interact, including, but not limited to: a search engine web site, a web site that includes banner Advertisements, contextual Advertisements, or similar types of Advertisements, a “pop-up” Advertisement, an Advertisement distributed through e-mail or text messaging, or an Advertisement provided through a wireless operator. For example, if the interactive channel is a web site, the user may activate a Web Browser 0776 and type a URL for the desired web site or click a bookmark for the desired web site.

In step 3320, the user of Wireless Device 0120 searches for information on a Product, brand, vendor, and/or retailer. For example, an user may input Product, brand, vendor, and/or retailer information into a text box provided by the search engine.

In step 3330, Search Module 0722 reads the URL, which the user of Wireless Device 0120 clicks. Search Module 0722 reads the Advertiser name from the web site visited and stores the Advertiser name.

In addition or alternatively, if a Wireless Device 0120 user views an Advertisement at a search engine web site by using Keypad 0772, Keypad Module 0718 can record the activity as the user viewing the Advertisement. If the Advertiser placing the Advertisement at the search engine generates data accompanying the Advertisement that include, but is not limited to, at least some of the data in Ad Data Code 0200, Keypad Module 0718 records the activity and communicates the data to Search Module 0722.

In addition or alternatively, if a Wireless Device 0120 user views an Advertisement at a search engine web site by using any kind of device that touches the screen of the Wireless Device 0120, e.g., the finger of the user, a stylus, or some other kind of pointing device, Screen Module 0724 can record the activity as the user viewing the Advertisement. If the Advertiser placing the Advertisement at the search engine generates data accompanying the Advertisement that include, but is not limited to, at least some of the data in Ad Data Code 0200, Screen Module 0724 records the activity and communicates the data to Search Module 0722.

In addition or alternatively, if a Wireless Device 0120 user views an Advertisement at a search engine web site by using any kind of audio command through Microphone Interface 0760, Audio Module 0726 can record the activity as the user viewing the Advertisement. If the Advertiser placing the Advertisement at the search engine generates data accompanying the Advertisement that include, but is not limited to, at least some of the data in Ad Data Code 0200, Audio Module 0726 records the activity and communicates the data to Search Module 0722.

In addition or alternatively, if a Wireless Device 0120 user views an Advertisement at a search engine web site by using any other type of input device other than Keypad 0772, a device that touches the screen of Wireless Device 0120, or any kind of audio command, a Module associated with the input device or devices used can record the activity as the user viewing the Advertisement. If the Advertiser placing the Advertisement at the search engine generates data accompanying the Advertisement that include, but is not limited to, at least some of the data in Ad Data Code 0200, the Module associated with the input device or devices records the activity and communicates the data to Search Module 0722.

In step 3340, Search Module 0722 transfers data associated with the Advertisement to the MMCMS or Ad Data Code Module 0728 for creation of an Ad File. The parameters and values of an exemplary Ad File are illustrated in Table 1000.

In step 3350, Search Module 0722 compares the values it stored in Ad Data File 0734 measuring any Advertisement viewed with the data in Ad Response File 0738 reflecting a response by an user to an Advertisement. A Wireless Device 0120 user can engage in activity that reflects his/her response to the online Advertisement. These responses can include, but are not limited to, the following. The user can request information about the Product advertised, which could be measured by Keypad Module 0718, Search Module 0722, or other Module. The user can input the phone number, short code, or name of the Product, brand, vendor, or retailer advertised, which could be measured by Keypad Module 0718. The user can visit a physical retailer advertised, which could be measured by Mapping Module 0720. The user can visit a department of a physical retailer advertised, which could be measured by Mapping Module 0720. The user can sample the Product advertised, which could be measured by any method described at the earlier section describing Infrared Device 0330. The user can buy the Product advertised, which could be measured by Payment Code Module 0730. Measuring the above activities can enable Advertiser System 0100 to calculate the numerator of the ROI of an online Advertisement, i.e., the degree of user response by online and offline to an online Advertisement.

In addition, the response of an user viewing an online Advertisement by engaging in activity at a physical retailer can be measured through some kind of coupon downloaded by user into the user's Wireless Device 0120. If Wireless Device 0120 user downloads an electronic coupon into the device from a web site and redeems the coupon at a physical retailer, a record the download can be created as an event in which the user views an Advertisement and the coupon redeeming as an event in which the user responds to the Advertisement.

Search Module 0722 compares values in Ad Response File 0738 with values stored in Ad Data File 0734. If a match exists, operation proceeds to step 3360. If no match exists, operation proceeds to step 3370.

In step 3360, Search Module 0722 stores match details in Ad Response File 0738.

In step 3370, information related to the user's payment is determined and stored in Ad Response File 0738. For example, Search Module 0722 may call timer Timer Module 312 to record the time of purchase. Search Module 0722 may then calculate the difference between the time purchased and the time the associated Advertisement was viewed. One or more of these values may then be stored in Ad Response File 0738.

In step 3380, operation ends.

An Advertiser can benefit from the recording of Wireless Device 0120 user viewing an Advertisement at a search engine web site as follows. In general, an Advertiser or a search engine web site can measure the ROI of an online Advertisement leading to an online sale because the Advertiser knows the denominator, i.e., the cost of the Advertisements placed at the search engine web site, and the numerator, i.e., the number of users viewing its Advertisements placed at the search engine web site and their purchase activity at the Advertiser web site. However, an Advertiser can measure only the number of users and their purchase activity at its web site. Current technology does not enable an Advertiser to measure the number of users responding to its Advertisement placed at the search engine by engaging in some kind of activity, including purchasing, at its physical distribution channels, e.g., a physical retailer selling the Product advertised. The inability of an Advertiser or the search engine to measure if, when, how, or to what degree an user responds to an online Advertisement by engaging in some kind of activity, including purchasing, at physical retailers means that an Advertiser or the search engine is underestimating the total ROI of an online Advertisement if any users respond to an online Advertisement by engaging in some kind of activity at physical retailers.

One method enabling an Advertiser to measure the response of an user viewing an online Advertisement by engaging in activity at a physical retailer is by matching any response recorded by any Module in Ad Response File 0738 with any data recorded by any Module in Ad Data File 0734. For example, Wireless Device 0120 user can view a web page of a search engine. At the web page, the user can view an Advertisement. The user can “click-through” the Advertisement by utilizing Keypad 0772, any kind of device that touches the screen of the device, any kind of audio command, or any other type of input device. Keypad 0772 can record the click-through by recording the URL associated with the click-through. Alternatively, Advertiser System 0100 can transmit to Wireless Device 0120 an Ad Data Code 0200 associated with the click-through when user selects the Advertisement with Keypad 0772. Any kind of device that touches the screen of the device can record the click-through by recording the URL associated with the click-through. Alternatively, Advertiser System 0100 can transmit to Wireless Device 0120 an Ad Data Code 0200 associated with the click-through when user selects the Advertisement with the device. Any kind of audio command can record the click-through by recording the URL associated with the click-through. Alternatively, Advertiser System 0100 can transmit to Wireless Device 0120 an Ad Data Code 0200 associated with the click-through when user selects the Advertisement with an audio command. Measuring the above activities can enable Advertiser System 0100 to calculate the denominator of the ROI of an online Advertisement, i.e., the number of users viewing an online Advertisement.

The present methods can enable Advertiser System 0100 to measure if the user searches for information about an online or physical retailer that focuses on the category of a Product in an Advertisement viewed by the user. The present invention can generate a database that assigns retailers that focus on a Product category into each Product category. If the user searches for information about a retailer in a given Product category, Search Module 0722 can determine if there is a match between the retailer Product category searched and any vendor, Product, or brand value in Ad Data File 0734. For example, if the user viewed an Advertisement about a book and then subsequently searches for online or physical retailers that focus on selling books, Search Module 0722 can determine a match of any values in the Product category, books, and store the response in Ad Response File 0738. In another embodiment, Search Module 0722 can record an user search for information about a Product at an online or physical retailer that sells a wide range of Product categories. For example, the user viewing an Advertisement about a book could subsequently search for the book not at a book retailer, but at an online auction web site or a physical retailer that sells a wide range of Product categories. If the user visits the web page of the online auction web site that focuses on books or searches for information about the book department of a physical retailer that sells a wide range of Product categories, Search Module 0722 can determine a match of any values in the Product category, books, and store the response in Ad Response File 0738.

2.2.1.4 Measurement of User Viewing Advertisement on Print Media Device

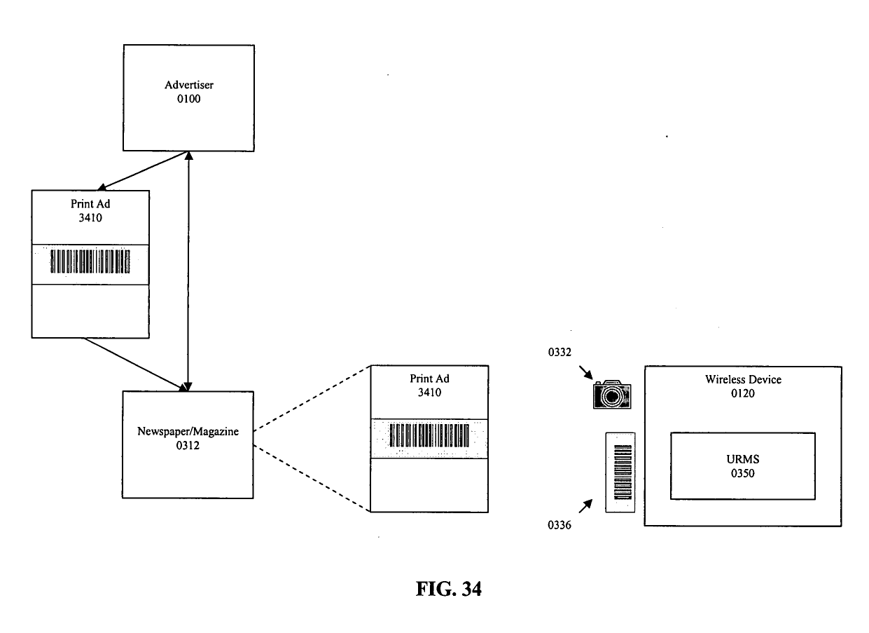

FIG. 34 depicts an exemplary system 3400 enabling an user of Wireless Device equipped with one or more I-O Devices capable of recording an Ad Data Code 0200 to record the Code from an Advertisement viewed in a Print publication, e.g., a newspaper or magazine, according to embodiments of the present invention. System 3400 includes an Advertiser System 0100, a Print Advertisement 3410, a Newspaper or Magazine 0312, and a Wireless Device 0120.

Advertiser System 0100 is one or more servers that can produce and/or transmit an Advertisement, Print Advertisement 3410 in the present embodiment, to any Media Device 0110, which in the present embodiment is Newspaper/Magazine 0450.

Print Advertisement 3410 can be in any form that can be read by one or more I-O Devices of Wireless Device 0120, including, but not limited to: a barcode, any string of characters which can be converted into a barcode by software in Wireless Device 0120, or data which can be transmitted in a radio signal.

Wireless Device 0120 is described in detail in Section 2.1.2.2 above.

2.2.1.5 Response Measured by Payment Code Module

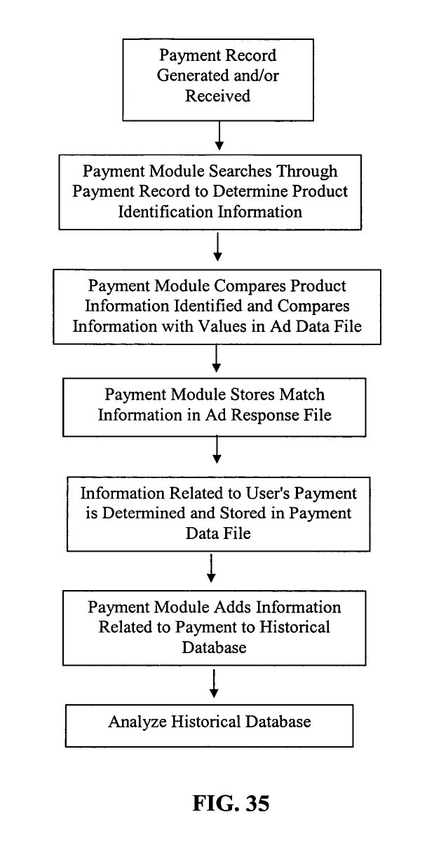

FIG. 35 depicts a flowchart 3500 of an exemplary method of how Payment Code Module 0730 can measure and/or process data on any Products purchased by Wireless Device 0120 user, according to embodiments of the present invention. The present invention can implement flowchart 3500 by executing a subset of the steps, executing the steps in different order, and/or executing other or additional related or equivalent steps.

In step 3510, Wireless Device 0120 can generate and/or receive a payment record. Wireless Device 0120 can generate a payment record in a variety of ways, including, but not limited to: the user utilizing Wireless Device 0120 and its associated payment functionality to purchase a Product, whose functionality can include, but is not limited to: assessing a charge on the user's phone bill, debiting funds from a prepaid account, or other means of generating electronic forms of cash; the user utilizing Wireless Device 0120, which can have the functionality of processing a credit and/or debit card transaction; the user utilizing a credit/debit card without utilizing Wireless Device 0120 to purchase a Product; the user utilizing an online payment system to purchase a Product; the user utilizing an electronic coupon downloaded in Wireless Device 0120; or the user utilizing an electronic ticket that has already been purchased or will be purchased to enable Wireless Device 0120 user to exchange for a Product. Step 905 is described in further detail in Section 2.2.1.6.2 below.

In one embodiment, the payment record has the format as Payment Receipt 1900. As would be appreciated by any person with ordinary skill in the art, a payment record can take any form, as required by the system and/or application.

In step 3512, Payment Code Module 0730 can search through a payment record to determine Product identification information. Product identification may include the name of the Product and/or vendor, its associated UPC/EAN/GTIN, or any other such data related to the Product. URMA Module 0744 can search the payment record on any schedule or upon the occurrence of any event, including, but not limited to: periodically, the reception of a Payment Receipt 1900, and/or the occurrence of an user response to an Advertisement.

In the case of the user utilizing Wireless Device 0120, whether utilizing its associated payment functionality or the functionality of processing a credit/debt card transaction, to purchase a Product, Payment Code Module 0730 can call the appropriate software in Wireless Device 0120 processing the transaction. Payment Code Module 0730 can search through any transaction for the name of the Product, vendor, or other identifying data about the Product or transaction.

Payment Code Module 0730 can search through any or all of the payment systems utilized by Wireless Device 0120; any kind of electronic ticket received or stored by Wireless Device 0120; and/or any kind of content or applications downloaded, viewed, and/or accessed by user on Wireless Device 0120. Payment Code Module 0730 can search through these payment systems, tickets, and content/applications not only to write and/or store a record of any Product purchased or consumed in Payment Data File 0740, but to write and/or store data in a historical user product preference (HUPP) Database. Payment Code Module 0730 can write and/or store to HUPP Database data generated from the search that reflect the Product preferences of Wireless Device 0120 user to enable an Advertiser to determine how receptive the user would be to an Advertisement for its Product.

In addition, Payment Code Module 0730 can search through any kind of data identifying any content or applications downloaded, viewed, and/or accessed by user on Wireless Device 0120. The data can be generated by the vendor of the content or application or by Wireless Device 0120.

For example, Wireless Device 0120 user can download a ringtone featuring recording artist A. Wireless Device 0120 user can pay for the ringtone utilizing any payment system utilized by Wireless Device 0120, in which case Payment Code Module 0730 can search through the payment system and write and/or store a record of any Product purchased in Ad Response File 0738 and/or Payment Data File 0740. Wireless Device 0120 user can download the ringtone without paying for it, in which case Payment Code Module 0730 can search through any data generated by the vendor of the ringtone and write and/or store a record of any Product consumed in Ad Response File 0738 and/or Payment Data File 0740. If Wireless Device 0120 user downloads or accesses frequently ringtones by recording artist A, an Advertiser can assume that Wireless Device 0120 user may be receptive to an Advertisement for any Product featuring or related to recording artist A.

Other examples can include, but are not limited to: Wireless Device 0120 user downloading or accessing frequently on Wireless Device 0120 a wireless baseball game, which data a vendor of baseball Products can analyze to determine if the user would be receptive to an Advertisement for baseball fan Products or baseball game tickets; Wireless Device 0120 user downloading or accessing frequently on Wireless Device 0120 a screensaver or image of an actor or actress, which data a vendor of a Television program or film featuring the actor or actress can analyze to determine if the user would be receptive to an Advertisement for its Television program or film; or Wireless Device 0120 user downloading or accessing frequently on Wireless Device 0120 a travel application or restaurant search application, which data a vendor of travel services or a restaurant, respectively, can analyze to determine if the user would be receptive to an Advertisement for its travel services or restaurant.

The vendor of any wireless content or application can utilize XML to describe the attributes of the content or application. In this case, Payment Code Module 0730 can search through a XML document associated with, attached to, or integrated in the wireless content or application to write and/or store a record of any Product consumed in Ad Response File 0738 and/or Payment Data File 0740.

In step 3514, Payment Code Module 0730 compares Product information identified in step 3512 and compares the information with values in Ad Data File 0734. For example, Payment Code Module 0730 may compare the variables NAMEPRODUCT, NAMEBRAND, NAMEVENDOR, and/or the UPC/EAN/GTIN number. If a match exists, operation then proceeds to step 3516. If no match exists, operation then proceeds to step 3520.

In step 3516, Payment Code Module 0730 stores match information in Ad Response File 0738.

In step 3518, information related to the user's payment is determined and stored in Payment Data File 0740. For example, Payment Code Module 0730 may call Timer Module 312 to record the time of purchase. Payment Module 0730 may then calculate the difference between the time purchased and the time the associated Advertisement was viewed. One or more of these values may then be stored in Payment Data File 0740. Operation then proceeds to step 3520.

In step 3520, Payment Code Module 0730 adds information related to the payment to a historical database. This step is optional. In one embodiment, the historical database (e.g., HUPP Database) includes information related to one or more Products purchased by an user. In one embodiment, Payment Code Module 0730 identifies one or more of the Products purchased and assigns each Product to a Product category in the historical database. For example, if an user purchased a cereal brand XXX, Payment Code Module 0730 can assign the purchase to the cereal Product category and/or increment the number of purchases in the cereal Product category.

An Advertiser, URMS 0350, or a Third Party Server 0150 can search through the database to determine what type of Products the user likes and/or does not like. Advertisers, including, but not limited to, vendors of Products and/or retailers of Products, would value such data, because it could help determine whether they transmit an Advertisement of the Products to the user. For example, if an Advertiser knew that an user is a vegetarian, vendors of meat Products, retailers that sell meat Products, and/or restaurants that serve meat Products, can decide not to transmit an Advertisement promoting their meat Products.

In step 3522, the historical database is analyzed. This step is optional. Also, note that this step can be performed independently of the other steps included in flowchart 3500. Step 3522 can be performed at any time and may be performed in parallel with one or more other steps of flowchart 3500. Methods for analyzing the historical database are described in further detail in Section 2.2.3.

2.2.1.6 Method for Generation and/or Receipt of Payment Information

### 2.2.1.6.1 GENERATION BY RETAILER

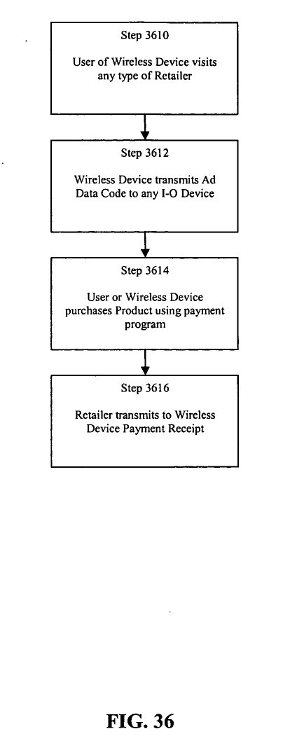

FIG. 36 depicts a flowchart 3600 of a method for the generation and transmission of payment information by a retailer, according to embodiments of the present invention. FIG. 36 is described with continued reference to the systems depicted in FIGS. 1 and 14. However, flowchart 3600 is not limited to those embodiments. The present invention can implement flowchart 3600 by executing a subset of the steps, executing the steps in different order, and/or executing other or additional related or equivalent steps. Flowchart 3600 describes one embodiment in which the present invention can enable an Advertiser to measure if an Advertisement leads to a sale where an user of a Wireless Device 0120 can redeem an Ad Data Code 0200 which includes an economic incentive.

In Step 3610, the user of Wireless Device 0120 can visit any type of Retailer, including, but not limited to: a physical retailer, an online retailer, a retailer through making a phone call, or a retailer through physically delivering, i.e., through mail order, a purchase order.

In step 3612, Wireless Device 0120 reads Ad Data Code 0200 from Ad Data File 0734 and transmits the Code to any I-O Device or Display 0120. A Retailer can receive the Code through one or more means. Exemplary methods for receiving Ad Data Code 0200 are described below. As would be appreciated by any person with ordinary skill in the art, the present invention can use other methods.

For example, at a physical retailer, the user of Wireless Device 0120 can display the Code in the form of a barcode on Display 0120 and hold Wireless Device 0120 at a distance and angle to enable Code Reader 0132 at the Retailer to record the Code.

In another example, at a physical retailer, the user of Wireless Device 0120 can transmit the Code wirelessly from any its I-O Devices, including, but not limited to, Short-Range Antenna 0324, Infrared Transceiver 0330, RFID Device 0334, NFC Antenna 0338, or I-O Antenna 0339, to any Code Reader 0132 at the Retailer POS which includes I-O Devices capable of receiving the Code wirelessly.

In another example, at an online retailer with which the user of Wireless Device 0120 communicates through a wireless Internet connection originated by the Device, the user can transmit the Code wirelessly to the retailer.

In another example, at a retailer with which the user of Wireless Device 0120 communicates through making a wireless phone call originated by the Device, the user can transmit the Code wirelessly to the retailer.

In a another example, a retailer to which the user of Wireless Device 0120 physically delivers a purchase order through the mail, the user can transmit the Code wirelessly to the retailer through the retailer's Web site.

In step 3614, Wireless Device 0120 purchases a Product. A Product can be purchased using a variety of methods. Exemplary methods are described below. As would be appreciated by any person with ordinary skill in the art, the present invention can use other methods for purchasing a Product.

For example, at a physical retailer, the user can purchase a Product at the Retailer POS System 0130 by utilizing a payment program in the Wireless Device 0120. The payment program can enable Wireless Device 0120 to pay for the Product by transmitting to a Payment Device 0134 at the Retailer POS System 0130 any data (“Payment Data”), including, but not limited to: transmitting the credit card data of the user; transmitting the debit card data of the user; deducting from a cash balance stored in the Wireless Device; or adding a charge to the bill of the subscriber of the Wireless Device. The payment program can transmit the data wirelessly from any of its I-O Devices, including, but not limited to, Short-Range Antenna 0324, Infrared Transceiver 0330, RFID Antenna 0334, NFC Antenna 0338, or I-O Device 0339, to any Payment Device 0134 at the Retailer POS System 0130 which includes I-O Devices capable of receiving the data wirelessly.

In another example, at an online retailer with which the user of Wireless Device 0120 communicates through a wireless Internet connection originated by the Device, the user can purchase an electronic Product, e.g., an electronic ticket, by executing any steps specified by the online retailer.

In another example, an online retailer with which the user of Wireless Device 0120 communicates through a wireless Internet connection originated by the Device, the user can purchase a physical Product, e.g., a shirt, by executing any steps specified by the online retailer.

In step 3616, after Wireless Device 0120 transmits to Payment Device 0134 Payment Data to Retailer, the present invention can verify user purchase of the Product promoted in an Advertisement. Verification can occur using one or more methods. Exemplary methods are described below. As would be appreciated by any person with ordinary skill in the art, the present invention can use additional or alternative methods.

For example, at a physical retailer, Payment Device 0134 can transmit to Wireless Device 0120 in electronic form a Payment Receipt 1900. Payment Receipt 1900 can include unique code, e.g., UPC/EAN/GTIN, utilized by Advertisers and/or Retailers to identify the Product. In another embodiment, Payment Device 0134, any other device in POS System 0130, Retailer Server 0140, and/or any other device processing data which includes any unique code, e.g., UPC/EAN/GTIN, utilized by Advertisers and/or Retailers to identify the Product can transmit to Advertiser directly or indirectly through Third Party Server 0150 in electronic form a Payment Receipt 1900. While the present method enables the transmission of Payment Receipt 1900 from Payment Device 0134 to Wireless Device 0120 as part of an electronic transaction, another embodiment can enable the transmission of Payment Receipt 1900 from Payment Device 0134 to Wireless Device 0120 if the user of Wireless Device 0120 pays for the transaction with cash.

In another embodiment, at an online retailer with which the user of Wireless Device 0120 communicates through a wireless Internet connection originated by the Device, the Retailer can transmit a file including one or more the data in Payment Receipt 1900.

In another embodiment, the present method can measure without executing Step 3612 if an user of the Wireless Device 0120 purchases the Product promoted in the Advertisement, i.e., without the Wireless Device 0120 transferring Ad Data Code 0200 to Code Reader 0132. In this embodiment, after Payment Device 0134 transmits to Wireless Device 0120 a Payment Receipt 1900, the Wireless Device 0120 can call a computer program product capable of verifying user purchase of the Product promoted in the Advertisement by: (1) searching through Payment Receipt 1900 all data uniquely identifying some or all the Products purchased, e.g., the UPC/EAN/GTIN of each Product purchased; (2) searching through all Ad Data Code 0200 stored in Memory 0012 of Wireless Device 0120 for any UPC matching any UPC in Payment Receipt 1900; (3) selecting any Ad Data Code 0200 with a UPC match; (4) creating a record which contains data indicating the UPC match, which confirms the user purchase of the Product promoted in the Advertisement; and (5) if the Code includes an economic incentive, e.g., a coupon, transmitting the specific Ad Data Code 0200 associated with the UPC wirelessly from any of its I-O Devices, including, but not limited to, Short-Range Antenna 0324, Infrared Transceiver 0330, RFID Device 0334, NFC Antenna 0338, or I-O Device 0339, to Payment Device 0134 which includes I-O Devices capable of receiving the data wirelessly. The Retailer can redeem the coupon included in the Ad Data Code 0200 in the same manner as in Step 3612.

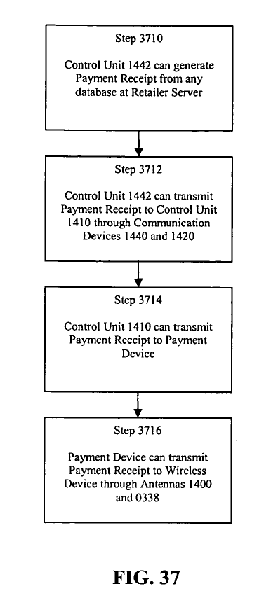

FIG. 37 is a flowchart 3700 depicting an exemplary method of enabling a Retailer to transmit data measuring if the user of Wireless Device purchased a Product, e.g., Payment Receipt 1900, according to embodiments of the present invention. Flowchart 3700 is described with reference to exemplary systems depicted in FIGS. 1 and 14. However, flowchart 3700 is not limited to those embodiments. The present invention can implement flowchart 3700 by executing a subset of the steps, executing the steps in different order, and/or executing other or additional related or equivalent steps.

In Step 3710, Control Unit 1442 or any other device in Retailer Server 0140 generates a Payment Receipt 1900 from data in one or more databases, including, but not limited to, PLU Database 1450, Transaction Database 1452, and/or Customer Database 1454.

In step 3712, Control Unit 1442 transmits Payment Receipt 1900 to Control Unit 1410 through Communication Device 1440 and Communication Device 1420.

In step 3714, Control Unit 1410 transmits Payment Receipt 1900 to Payment Device 0134 in addition to or in lieu of transmitting the Receipt to Receipt Printer 1430.

In step 3716, Payment Device 0134 can transmit Payment Receipt 1900 to Wireless Device 0120 through Antenna 1400 and NFC Antenna 0338 and/or Network 1470.

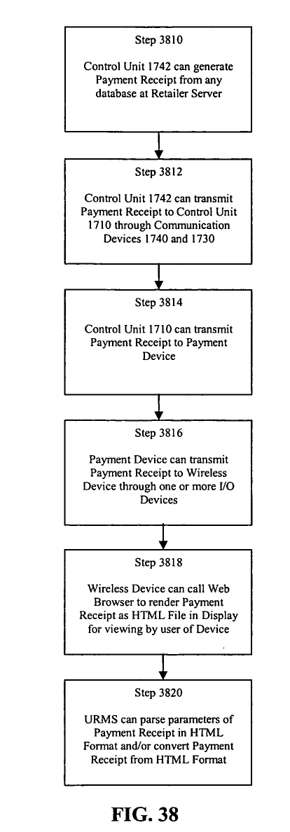

FIG. 38 depicts a flowchart 3800 of an exemplary method for transmitting a Payment Receipt 1900 to Wireless Device 0120 in a HTML format for viewing by the Web Browser 0766 of Wireless Device 0120, according to embodiments of the present invention. Flowchart 3800 is described with reference to exemplary systems depicted in FIGS. 1 and 14. However, flowchart 3800 is not limited to those embodiments. The present invention can implement flowchart 3800 by executing a subset of the steps, executing the steps in different order, and/or executing other or additional related or equivalent steps.

In step 3810, Control Unit 1442 or any other device in Retailer Server 0140 can generate Payment Receipt 1900 in the form of a HTML file from data in one or more databases, including, but not limited to, PLU Database 1450, Transaction Database 1452, and/or Customer Database 1454.

In step 3812, Control Unit 1442 can transmit Payment Receipt 1900 to Control Unit 1410 through Communication Device 1440 and Communication Device 1420.

In step 3814, Control Unit 1410 can transmit Payment Receipt 1900 to Payment Device 0134 in addition to or in lieu of transmitting the Receipt to Receipt Printer 1430.

In step 3816, Payment Device 0134 can transmit Payment Receipt 1900 to Wireless Device 0120 through one or more I-O Devices, including, but not limited to, Bluetooth Antenna 0324, Infrared Transceiver 0330, RFID Device 0334, and/or I-O Device 0339, utilizing any short-range wireless standard, which can include, but is not limited to, Bluetooth, HomeRF, IEEE 802.11, IEEE 802.15.3a or UWB, infrared, wireless IEEE 1394, or Wireless USB. In another embodiment, Retailer Server 0140 and/or POS System 0130 can transmit Payment Receipt 1900 to Wireless Device 0120 through Network 1470, which can include a wired and/or wireless connection to the Internet.

At Step 3818, Wireless Device 0120, in general, and/or Operating System 0346, in particular, can call Web Browser 0776 of Wireless Device 0120 to render Payment Receipt 1900 as a HTML file in Display 0120 for viewing by user of Wireless Device 0120.

In step 3820, URMS 0350 can call Payment Code Module 0730 to: (1) parse directly the parameters of Payment Receipt 1900 in a HTML format and/or write to Payment Data File 0740 those parameters needed to calculate a ROI for the Advertisement viewed; and/or (2) convert Payment Receipt 1900 from HTML format to any other format which URMS 0350 and/or any of its Modules can parse for parameters needed to calculate a ROI for the Advertisement viewed and/or write to Payment Data File 0740 the parameters.

In another embodiment, a Retailer can transmit a Specific Transaction Record, in general, and/or Payment Receipt 1900, in particular, to an Advertiser System 0100 directly or indirectly through a Third Party Server 0150. The present embodiment can provide several benefits. First, a Retailer can transmit Specific Transaction Record to an Advertiser System 0100 directly or indirectly through a Third Party Server 0150 through a wired or wireless connection to the Internet, e.g., through Network 1470. Because transmitting data through a wired connection to the Internet is typically less expensive than transmitting data through a licensed wireless network, the present alternative embodiment can cost less than a Retailer transmitting Payment Receipt 1900 to Wireless Device 0120, which then transmits the Receipt to Advertiser System 0100 through a licensed wireless network. Second, a Retailer can bundle multiple Specific Transaction Records for different users of Wireless Devices 0120 and transmit them to Advertiser System 0100 at lower unit cost than the individual Wireless Devices 0120. The total bandwidth required to transmit two Specific Transaction Records together should be less than the total bandwidth required to transmit each of the two Specific Transaction Records separately because of lower costs in data overhead.

### 2.2.1.6.2 GENERATION BY THE WIRELESS DEVICE

A Wireless Device 0120 can generate payment information (e.g., a payment record) when an user utilizes the payment functionality of the Wireless Device 0120 to purchase a Product. For example, the Wireless Device 0120 user can buy a Product (e.g., a music CD of “Singer's Greatest Hits”) at a physical retailer using the Wireless Device 0120. In this example, the Wireless Device 0120 includes a software application (e.g., wireless payment application) enabling the device to process payment in a variety of ways, including, but not limited to: withdrawing funds from the user's bank account, assessing a charge on the user's credit card account, or assessing a charge on the user's Wireless Device bill.

The software application (e.g., wireless payment application) can generate a record listing the name of the Product purchased, its associated UPC/EAN/GTIN, or any other data identifying the Product or transaction. Payment Code Module 0730 can include a function that can call the wireless payment application and search through the payment application's records.

In the example of the CD purchase, Payment Code Module 0730 finds the name of the Product, “Singer's Greatest Hits,” sold by vendor, “Generic Music Label.” Payment Code Module 0730 can search through Ad Data File 0734 to determine if the user viewed any Advertisement with the same Product name and/or vendor. For example, in Ad Data Code 0200, there are fields for NAMEPRODUCT and NAMEVENDOR. If any Ad Data Code 0200 in Ad Data File 0734 includes the Product name “Singer's Greatest Hits” and/or “Generic Music Label,” Payment Code Module 0730 declares a match and stores the record of the payment transaction and the Advertisement in Ad Response File 0738.

### 2.2.1.6.3 GENERATION BY THIRD PARTY CREDIT/DEBIT CARD VENDOR

As described above, an user can purchase a Product with a credit/debit card without utilizing Wireless Device 0120. In this case, either when an user makes a payment using his/her credit/debit card or at some regular or other interval, the credit/debit card vendor operating 3^{rd} Party Payment Database 0166 in FIG. 1 can transmit a record of the transaction to Wireless Device 0120. The record can include data listing the name of the Product purchased, its associated UPC/EAN/GTIN, or any other data identifying the Product or transaction. Payment Code Module 0730 can then generate a Payment File and write and/or store the Payment File in Payment Data File 0740.

### 2.2.1.6.4 ELECTRONIC TICKET

As described above, Payment Code Module 0730 can search through the data contained in any kind of electronic ticket. Wireless Device 0120 user can download an electronic ticket into Wireless Device 0120 either by paying for the ticket utilizing any payment system in Wireless Device 0120 or by downloading the ticket after paying for the ticket utilizing another device, e.g., Personal Computer 0308. For example, Wireless Device 0120 user can use his/her Personal Computer 0308 to purchase an electronic ticket, which he/she can download into Personal Computer 0308. The vendor of the electronic ticket can enable an user to transfer the ticket from Personal Computer 0308 to Wireless Device 0120. In this case, Wireless Device 0120 would not have a record of the payment for the ticket. Payment Code Module 0730 can search through any kind of electronic data to find the same kind of information contained in Ad Data Code 0200.

In one embodiment, most or all Advertisers, either individually, through a formal group like an industry association, through an informal group, or through advertising agencies, can agree upon a standard format for including the data in an electronic ticket the Payment Code Module 0730 would need to associate an user downloading of the ticket with an Advertisement viewed by the user. For example, an electronic ticket can include one or more of the variables included in Ad Data Code 0200 and assigned values to each variable. In this case, Payment Code Module 0730 can search through the electronic ticket for values associated with a variable to determine if there is a match with any values in Ad Data File 0734. For example, an electronic ticket can include values for the following variables in Ad Data Code 0200: NAMEVENDOR, NAMEPRODUCT, and NAMEBRAND. Payment Code Module 0730 can compare the values for the variables to determine if they match any values for the same variables in Ad Data File 0734. If there is a match, Payment Code Module 0730 can store the match in Ad Response File 0738.

In another embodiment, the vendor of an electronic ticket can include the values for one or more variables listed in Ad Data Code 0200 without associating the value with a variable. In this case, Payment Code Module 0730 can search through the electronic ticket for values that match any values in Ad Data File 0734. In another embodiment, the vendor of an electronic ticket can utilize XML to describe the attributes of the ticket. In this case, Payment Code Module 0730 can search through the an XML document associated with, attached to, or integrated in the electronic ticket for values in the name-value pairs that match any values in Ad Data File 0734.

Electronic tickets downloaded to Wireless Device 0120 that Payment Code Module 0730 can search can include, but are not limited to: tickets for travel, including, but not limited to: airline, train, bus, taxi, or boat; tickets for performances, including, but not limited to: movies, concerts, or sporting events; or any other kind of ticket.

2.2.1.7 Response Measured by Event Handler Module

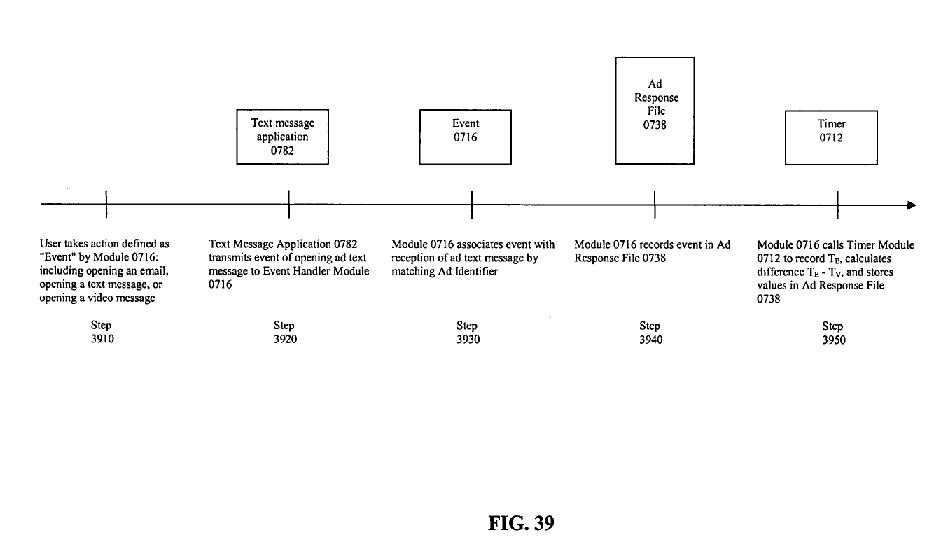

FIG. 39 depicts a flowchart 3900 measuring the reception of a text message by Event Handler Module 0716 from a given Media Device 0110, according to embodiments of the present invention. The present invention can implement Event Handler Module 0716 by executing a subset of the steps in flowchart 3900, executing the steps in different order, and/or executing other or additional related or equivalent steps.

2.2.1.8 Response Measured by Keyboard Module

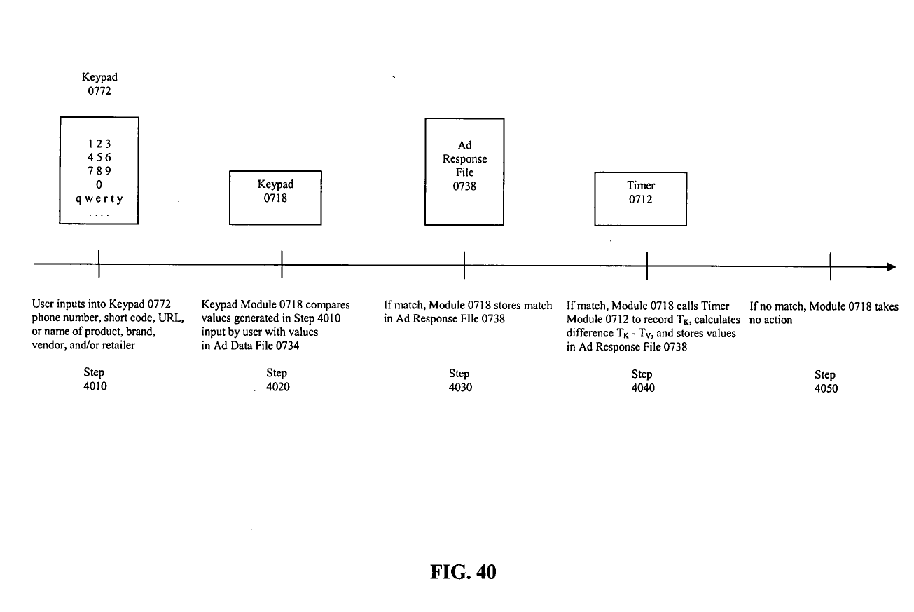

FIG. 40 depicts a flowchart 4000 measuring the user input data by Keypad Module 0718, according to embodiments of the present invention. The present invention can implement Keypad Module 0718 by executing a subset of the steps in flowchart 4000, executing the steps in different order, and/or executing other or additional related or equivalent steps.

2.2.1.9 Response Information Measured by Mapping Module

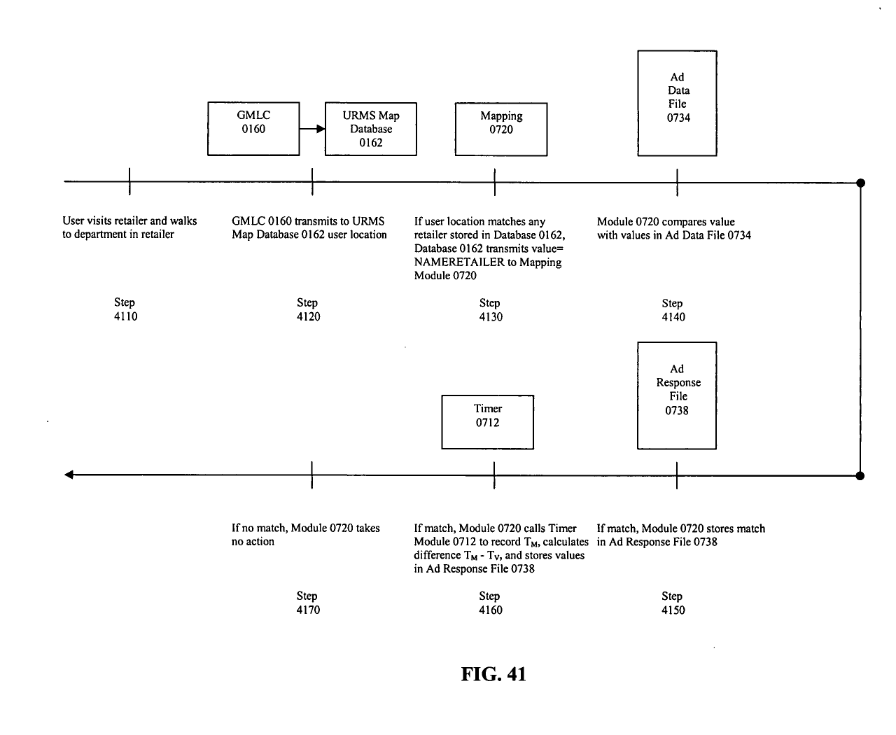

FIG. 41 shows a specific embodiment of how Mapping Module 0720 can measure if Wireless Device 0120 visits a physical retailer advertised, according to embodiments of the present invention. The present invention can implement Mapping Module 0720 by executing a subset of the steps in FIG. 41, executing the steps in different order, and/or executing other or additional related or equivalent steps.

2.2.1.10 General Measurement of Viewing

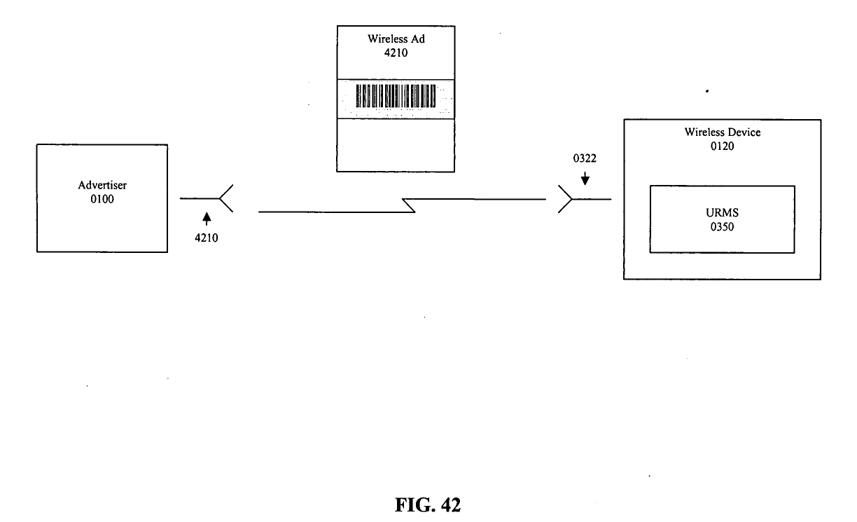

FIG. 42 depicts an exemplary system enabling an user of Wireless Device 0120 equipped with one or more I-O Devices capable of recording an Ad Data Code 0200 to record the Code from an Advertisement viewed on the Device display, according to embodiments of present invention. System 4200 may include an Advertiser System 0100, a Wireless Advertisement 4210, and/or Wireless Device 0120.

Advertiser System 0100 is a server that can produce and/or transmit an Advertisement, which is Wireless Advertisement 4210 in the present embodiment, to any Media Device 0110, which in the present embodiment is Wireless Device 0120.

Wireless Advertisement 4210 can be in any form that can be read by one or more I-O Devices of Wireless Device 0120, including, but not limited to: a barcode, any string of characters which can be converted into a barcode by software in Wireless Device 0120, or data which can be transmitted in a radio signal.

### 2.2.2 EXEMPLARY URMA PROCESSING

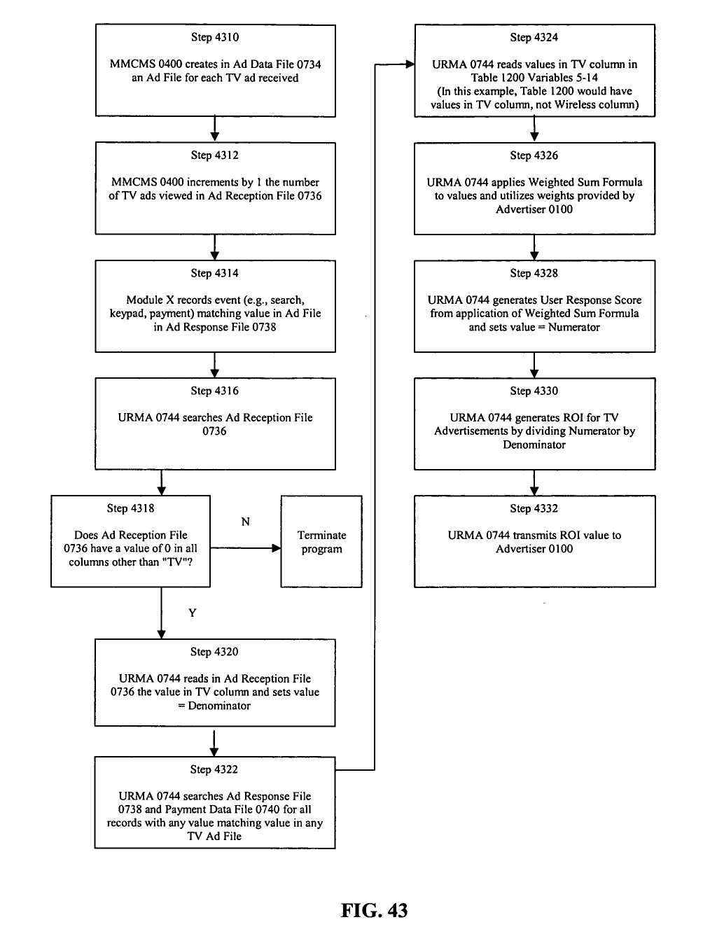

FIG. 43 depicts a flowchart 4300 of an exemplary method for processing the calculation of ROI for a Television Advertisement within URMA Module 0744, according to embodiments of the present invention. The present invention can implement flowchart 4300 by executing a subset of the steps, executing the steps in different order, and/or executing other or additional related or equivalent steps. While flowchart 4300 describes how URMA Module 0744 can calculate the ROI for a Television Advertisement, the present invention can apply URMA Module 0744 to calculate the ROI for an Advertisement transmitted to any Media Device 0110 and/or Wireless Device 0120.

### 2.2.3 METHOD FOR ANALYSIS OF HISTORICAL DATABASE OF PAYMENT INFORMATION

This section describes ways in which Payment Code Module 0730 or another internal or external Module or application can analyze data stored in a historical database of payment information. As would be appreciated by any person with ordinary skill in the art, the present invention can use other ways of analyzing the information not discussed in this section.

Payment Code Module 0730 can analyze the purchases in any given Product category to determine the degree to which an user is loyal to a given brand or switches brands frequently. An Advertiser in a Product category would value such data, because the Advertiser, both the vendor of the brand to which the user is loyal and the vendor of competing brands, generally prefer not to advertise to users who are loyal to a brand. The vendor of the brand to which the user is loyal can afford to devote advertising budget resources to other users, because the loyal user is unlikely to switch from the loyal brand. The vendor of competing brands can devote advertising budget resources to other users, because the loyal user is unlikely to switch to the competing brand.

Payment Code Module 0730 can analyze purchases in any given Product category to determine the degree to which an user prefers different types of Products within a Product category. Payment Code Module 0730 can apply any kind of criteria to divide Products within the Product category, including, but not limited to: price, feature, function, and/or size. For example, Payment Code Module 0730 can divide the Product category of automobiles into three different price categories: high, medium, or low. Payment Code Module 0730 can use any price level to determine the boundaries for each price category. If HUPP Database shows that an user regularly purchased automobiles in the high price category, an Advertiser selling high price automobiles could decide to transmit an Advertisement promoting its high price automobile, while an Advertiser selling low price automobiles could decide not to transmit an Advertisement promoting its low price automobile.

Payment Code Module 0730 can analyze purchases in any given Product category to infer whether an user is receptive to Advertisements in a Product category. If the HUPP Database shows that an user has not purchased or purchases infrequently a given Product category, an Advertiser selling Products in that Product category can decide not to transmit an Advertisement promoting Products in that Product category.

Payment Code Module 0730 can analyze purchases in any given Product category to confirm or reject any data provided by an user about his/her Product preferences. If an user provides data in a profile indicating his/her preference for, e.g., meat Products, but never or rarely buys meat Products according to the HUPP Database, an Advertiser can decide not to transmit an Advertisement promoting meat Products.

### 3.0 MEASURING USER CONSUMPTION AND/OR RESPONSE TO ADVERTISING USING INDIVIDUAL OR DEVICE IDENTIFIERS

The present invention can determine whether an Advertisement delivered to any Media Device 0110 results in a sale in any Retail Channel also by utilizing unique codes identifying Wireless Device 0120, the user of Wireless Device 0120, any Media Device 0110, the user of any Media Device 0110, and/or the Target Customer, associating such unique codes with any Advertisement and/or Ad Data Codes 0200 transmitted to any Media Device 0110 and/or any Payment Receipt 1900 in any Retail Channel, and transmitting such unique codes, Ad Data Codes 0200, and/or Payment Receipts 1900 from a Wireless Device 0120, Media Device 0110, POS System 0130, and/or Retailer Server 0140 to an Advertiser System 0100 directly or indirectly through a Third Party Server 0150.

The present invention can assign an unique code to identify Wireless Device 0120, the user of Wireless Device 0120, any Media Device 0110, the user of any Media Device 0110, and/or the Target Customer, which can enable the anonymous viewing of an Advertisement and anonymous purchasing of a Product promoted in such Advertisement by the user of such Device (“Anonymous User ID Code”), i.e., a unique code that is not associated with any personally identifiable information of the user of such Device. Ad Data Code Module 0728 can write and/or append an Anonymous User ID Code to the record of any Ad Data Code 0200 received by Wireless Device 0120 whose parameters the Module can write to Ad Data File 0734. Payment Code Module 0730 can write and/or append an Anonymous User ID Code to the record of any Payment Receipt 1900 received by Wireless Device 0120 whose parameters the Module can write to Payment Data File 0740. While a typical Payment Receipt 1900 generated by a Retailer can include personally identifiable information, e.g., the name of the purchaser and/or the credit/debit card number of the purchaser, Payment Code Module 0730 can scan a Payment Receipt 1900 and write to Payment Data File 0740 data that excludes any such personally identifiable information.

Whether the present invention assigns an Anonymous User ID Code or assigns an unique code or existing code to identify Wireless Device 0120, the user of Wireless Device 0120, any Media Device 0110, the user of any Media Device 0110, and/or the Target Customer that is associated with personally identifiable information of the user of such Device (“Identifiable User ID”), the present invention can enable the calculation of ROI for the Advertisement viewed on distributed devices. That is, the present invention can enable the calculation of ROI for the Advertisement viewed: (1) on a single device, e.g., Wireless Device 0120, which can calculate the ROI for an Advertisement by reading data from Ad Data File 0734 and Payment Data File 0740 stored locally; (2) across multiple devices, e.g., Wireless Device 0120 can calculate the denominator of the ROI for an Advertisement by reading data from one or more records in Ad Data File 0734 stored on Wireless Device 0120 and/or Retailer Server 0140 can calculate the numerator of the ROI for an Advertisement by reading data from one or more records in Payment Data File 0740 stored on Retailer Server 0140, which received Payment Data File 0740 from Wireless Device 0120 when the user of Wireless Device 0120 purchased a Product promoted in such Advertisement.

The present invention can distinguish a Target Customer from a Wireless Device 0120 and an user of Wireless Device 0120 by defining a Target Customer as an individual whose response to such Advertisement an Advertiser wishes to track and who may not use a Wireless Device 0120. That is, the present invention includes systems, methods, apparatus, and/or computer program products enabling an Advertiser to measure the viewing of an Advertisement and responses, including, but not limited to, purchasing of Products promoted in such Advertisement and/or Intermediate Response, to such Advertisement by a Target Customer without requiring any change to Wireless Device 0120. For example, the present invention includes systems, methods, apparatuses, and/or computer program products enabling an Advertiser to measure: (1) the viewing of an Advertisement by a Target Customer by having such consumer input his/her Shopper Loyalty ID Code into a Media Device 0110 and associating such Shopper Loyalty ID Code with an Ad Data Code 0200 for a given Advertisement; and (2) responses to such Advertisement by a Target Customer by obtaining transaction data from a Retailer associated with such consumer using his/her shopper loyalty card.

A unique code, referred to herein as a “Unique WD Code,” is data which uniquely identifies a Wireless Device 0120, the user of a Wireless Device 0120, and/or a Target Customer. The Unique WD Code can assume a variety of forms, including, but not limited to: (1) alphanumeric form (i.e., any series of letters and/or numbers which are in a form that a computer program product can process), (2) non-alphanumeric form, including, but not limited to: any audio, image, video, and/or biometric-based data which can uniquely identify Wireless Device 0120, the user of Wireless Device 0120, and/or the Target Customer. As would be appreciated by any person with ordinary skill in the art, the Unique WD Code can take other forms.

An Existing Unique ID Code is an unique code of any data type generated by a Third Party for a purpose other than measuring advertising effectiveness and/or personalization of an Advertisement. Examples of Existing Unique ID Codes include, but are not limited to, shopper loyalty program identification data, membership identification data, checking account identification data, communication address data, SIM card number, and the Electronic Identification Number (EIN) of the Wireless Device 0120.

Many retailers utilize a shopper loyalty program that may or may not offer special discounts to encourage users to shop at the retailer or partners/affiliates of the retailer. Typically, most retailers offering shopper loyalty programs require an user to scan at Code Reader 0132 a card, which can include a barcode, alphanumeric code, magnetic stripe, and/or any other means identifying a shopper loyalty ID code. In another embodiment, a retailer enables an user to input into POS System 0130 data with which the Retailer can associate an unique user of Wireless Device 0120 and/or a Target Customer. For example, some Retailers enable an user to input his/her phone number, which the retailer then utilizes to associate the user with an existing Shopper Loyalty ID Code. One advantage of utilizing a Shopper Loyalty ID Code as the Existing Unique ID Code is that it enables an Advertiser to measure if an user purchases a Product promoted in an Advertisement by using cash, as long as the user inputs the Shopper Loyalty ID Code.

Organizations or businesses other than Retailers typically generate and transmit to an user some type of code uniquely identifying the user (“Membership ID Code”). For example, most health plans issue a member a card uniquely identifying the member. Most schools issue a student a card uniquely identifying the student. Most membership organizations, e.g., an association, issue a member a card uniquely identifying the member. The membership ID code can be used by the systems and methods described herein as an Existing Unique ID Code.

Most Retailers accept checks as a form of payment for a Product. The systems and methods described herein can use information associated with a check, referred to herein as Check Unique ID code, to identify the writer of the check, including, but not limited to, the name of the writer of the check, the checking account number, and/or the bank; the name of the writer of the check, a subset of the checking account number (to limit or obviate the disclosure of personally identifiable information), and/or the name of the bank; the routing number of the bank and the full checking account number; and/or any other data that can uniquely identify the writer of the check.

The systems and methods described herein may also utilize as the Existing Unique ID Code any communication address, referred to herein as a Communication Unique ID code, associated with the Wireless Device 0120, the user of the Wireless Device 0120, any Media Device 0110, the user of any Media Device 0110, or a Target Customer. Examples of communication addresses include, but are not limited to, a telephone number of the wireline telephone service of the user of Wireless Device 0120 and/or Target Customer; the wireless telephone number associated with Wireless Device 0120 and/or Target Customer, an email address of the user of Wireless Device 0120, the user of any Media Device 0110, and/or Target Customer, and/or the mailing address of the user of Wireless Device 0120, the user of any Media Device 0110, and/or Target Customer.

The systems and methods described herein may also utilize a SIM card number and/or electronic identification number (EIN) associated with the Wireless Device 0120 and/or the Target Customer, as the Existing Unique ID Code.

The difference between an Unique WD Code and an Existing Unique ID Code is that: (1) an Unique WD Code is an unique code of any data type which uniquely identifies Wireless Device 0120, the user of Wireless Device 0120, and/or the Target Customer and which an Advertiser System 0100 and/or a Third Party Server 0150 generates for the purpose of enabling an Advertiser to measure advertising effectiveness and/or personalize an Advertisement; and (2) an Existing Unique ID Code is an unique code of any data type which identifies Wireless Device 0120, the user of Wireless Device 0120, any Media Device 0110, the user of any Media Device 0110, and/or the Target Customer and which an Advertiser System 0100 and/or a Third Party Server 0150 does not generate for the purpose of enabling an Advertiser to measure advertising effectiveness and/or personalize an Advertisement.

The present invention can enable the measurement of an user viewing of and response to an Advertisement using an Unique WD Code and/or an Existing Unique ID Code regardless of how an user purchases a Product promoted in an Advertisement. That is, the present invention can measure such purchase whether an user purchases the Product at a physical retailer, an online retailer, a retailer from which a Wireless Device 0120, any Media Device 0110, and/or Target Customer orders by making a phone call, or a retailer from which a Wireless Device 0120, any Media Device 0110, and/or Target Customer makes a purchase order through physical delivery, i.e., through mail order.

By transmitting unique codes from a Media Device 0110 or POS System 0130, the present system and methods can reduce the demand for storage, processing, and wireless transmission capacity on Wireless Device 0120, which is typically more limited than storage, processing, and transmission capacity on a Media Device 0110, POS System 0130, or Retailer Server 0140. In addition, the present system and methods can enable an Advertiser to track if an Advertisement delivered to any Media Device 0110 results in a sale in a Retail Channel without requiring a Retailer to transmit electronically Payment Receipt 1900 or similar payment record to Wireless Device 0120, which should increase the number of transactions that can be measured. Further, by utilizing an Anonymous User ID Code that excludes any personally identifiable information, the present systems and methods can enable an Advertiser to track if an Advertisement delivered to any Media Device 0110 results in a sale in a Retail Channel without utilizing personally identifiable information about an user.

### 3.1 ARCHITECTURE

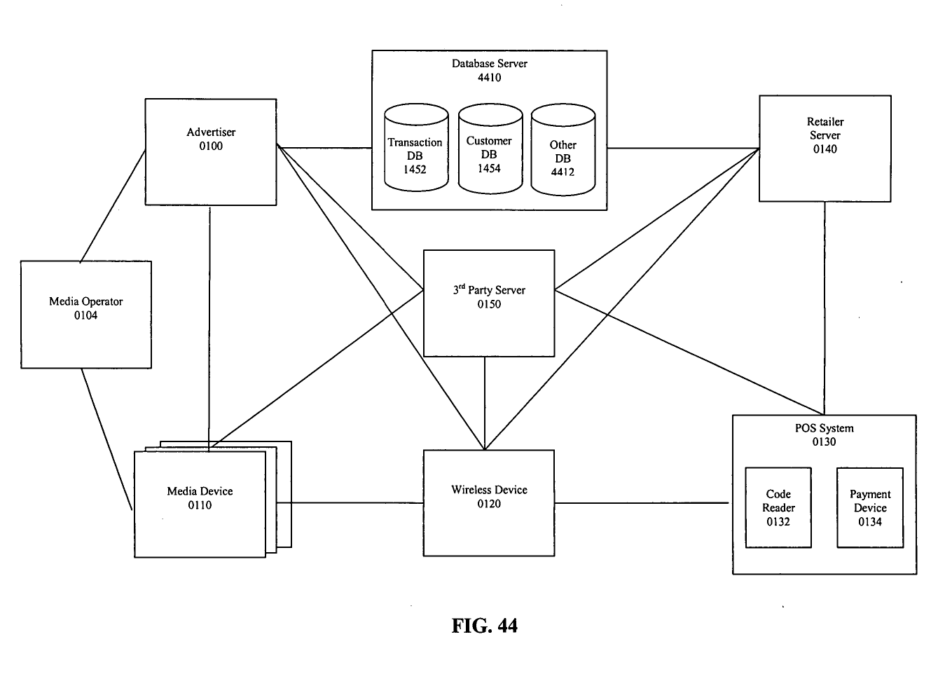

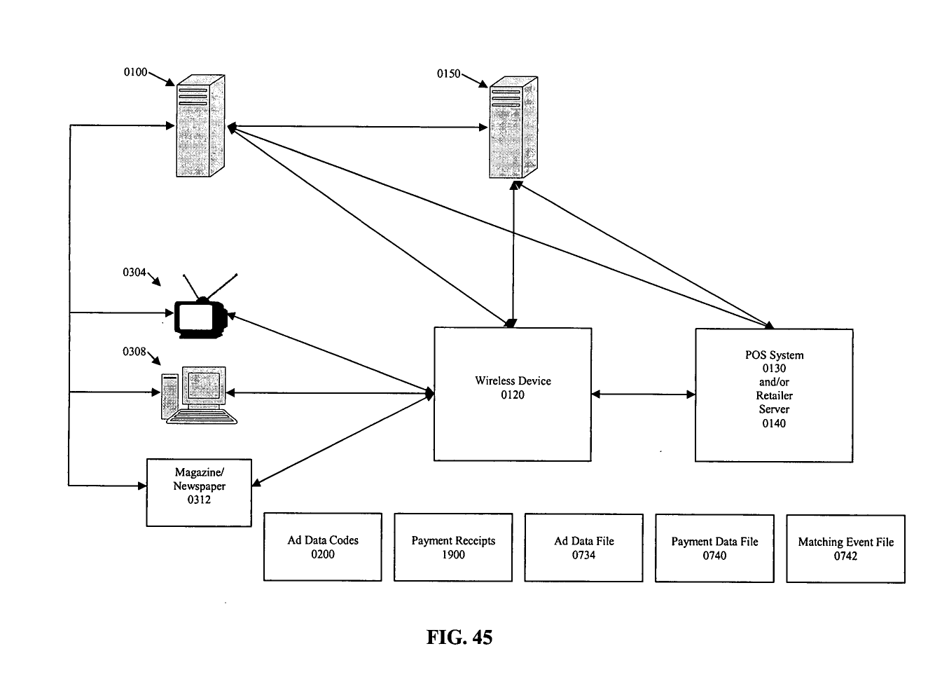

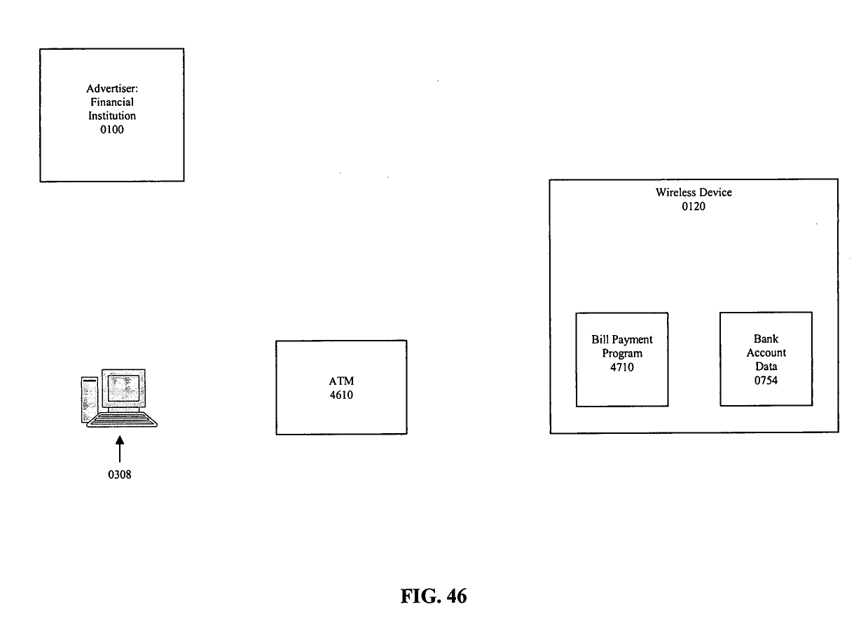

FIG. 44 depicts a block diagram of an exemplary system 4400 for measuring user viewing of and response to Advertisements using unique individual or device identifiers, according to embodiments of the present invention. System 4400 can include, but is not limited to: an Advertiser System 0100, a Third Party Server 0150, a Wireless Device 0120, one or more Media Devices 0110, a POS System 0130, a Retailer Server 0140, and/or a Database Server 4410.

Advertiser System 0100 can include a set of the functionality described above in Section 2. In addition, Advertiser System 0100 is configured to receive data from any Media Device 0110 uniquely identifying a Wireless Device 0120, an user of Wireless Device 0120, the Media Device 0110, an user of Media Device 0110, and/or a Target Customer, including, but not limited to, Unique WD Code, Existing Unique ID Code, and/or any other unique code. The Advertiser System 0100 may be further configured to associate the unique identification code with an Ad Data Code 0200.

Wireless Device 0120 includes a set of the components and functionality described above in Sections 1 and 2. In addition, Wireless Device 0120 is configured to transmit through its I-O Devices an Unique WD Code 4910 and/or Existing Unique ID Code 5110 to a Media Device 0110 configured to receive such codes. Wireless Device 0120 is further configured to transmit through its I-O Devices the Unique WD Code 4910 and/or Existing Unique ID Code 5110 to any POS System 0130. Wireless Device 0120 can include an Ad Data Code Module 0728, a Payment Code Module 0730, an URMA Module 0744, an Ad Data File 0734, a Payment Data File 0740, an Ad Response File 0738, and a Matching Event File 0742. As would be appreciated by any person with ordinary skill in the art, a Wireless Device 0120 may include additional components (such as those described in Section 2 above).

In addition to the functionality described above in Section 2, Ad Data Code Module 0728 is configured to write and/or store an Unique WD Code and/or Existing Unique ID Code and/or transmitting the codes to a Media Device 0110 and/or Payment Device 0134.

Payment Code Module 0730 may include a set of the functionality described above in Section 2. In addition, Payment Code Module 0730 is configured to store, write, and/or append additional parameters unique to Wireless Device 0120 to the parameters generated by a Retailer, which can include, but are not limited to: transmitting a unique code that identifies Wireless Device 0120, the user of Wireless Device 0120, any Media Device 0110, the user of any Media Device 0110, and/or the Target Customer, which can enable the present invention to match an user of Wireless Device 0120 viewing the Advertisement and such user purchasing a Product promoted in such Advertisement; and/or the date, time, and/or location Wireless Device 0120 received Payment Receipt 1900, whose parameters such Module can write to Payment Data File 0740.

Media Devices 0110 are described in detail in Section 2 above. In addition to a set of the functionalities described above, Media Devices 0110 are configured to associate the Unique WD Code 4910 and/or Existing Unique ID Code 5110 with Ad Data Code 0200. A Media Device 0110 is further configured to transmit the associated Unique WD Code 4910 and/or Existing Unique ID Code 5110 and Ad Data Code 0200 to Advertiser System 0100 directly or indirectly through a Third Party Server 0150.

In another embodiment, Advertiser System 0100 and/or Third Party Server 0140 can associate an Ad Data Code 200 with an Unique WD Code 4910 and/or Existing Unique ID Code 5110 through a variety of means, including, but not limited to, the following method.

When a Media Device 0110 transmits to an Advertiser System 0100 a request for an Advertisement, the Advertiser System 0100 can transmit the Advertisement and then associate an Ad Data Code 0200 with an Unique WD Code 4910 and/or Existing Unique ID Code 5110 as follows.

First, Media Device 0110 can transmit to an Advertiser System 0100 through a network, e.g., the Internet, an Unique WD Code 4910 and/or Existing Unique ID Code 5110 to a data-handling process at Advertiser System 0100, which can write and/or store such codes in any Memory 0012 of Advertiser System 0100 in a variety of means, including, but not limited to: utilizing the POST method in HTTP to transmit a block of data, e.g., the Unique WD Code 4910 and/or Existing Unique ID Code 5110, to Advertiser System 0100; utilizing the PUT method in HTTP to transmit a block of data, e.g., the Unique WD Code 4910 and/or Existing Unique ID Code 5110, to Advertiser System 0100; utilizing the PUT method in FTP to transmit a block of data, e.g., the Unique WD Code 4910 and/or Existing Unique ID Code 5110, to Advertiser System 0100; and/or utilizing the SEND method in SMTP to transmit a block of data, e.g., the Unique WD Code 4910 and/or Existing Unique ID Code 5110, to Advertiser System 0100. The present invention can utilize any method readily apparent to any person with ordinary skill in the art to enable Advertiser System 0100 to authenticate a request by a Media Device 0110 to transmit to Advertiser System 0100 an Unique WD Code 4910 and/or Existing Unique ID Code 5110 and/or Media Device 0110 to provide said authentication information.

Second, Advertiser System 0100 can identify the Media Device 0110 transmitting an Unique WD Code 4910 and/or Existing Unique ID Code 5110 as the same Media Device 0110 to which it transmitted an Advertisement in a variety of means, including, but not limited to: reading the IP address in the source address field of an IP header of the packet(s) constituting or carrying the Unique WD Code 4910 and/or Existing Unique ID Code 5110 and matching said source address with the IP address in the destination address field of an IP header of the packet(s) constituting the Advertisement and/or its associated Ad Data Code; and/or reading the email address in the FROM request-header field in HTTP of a file including the Unique WD Code 4910 and/or Existing Unique ID Code 5110 and matching said email address with the email address to which the Advertiser System 0100 transmitted an Advertisement and/or its associated Ad Data Code.

Third, Advertiser System 0100 can associate the Unique WD Code 4910 and/or Existing Unique ID Code 5110 with the Ad Data Code 0200 describing the Advertisement Advertiser System 0100 transmitted to the Media Device 0110.

In general, a POS System 0130 is a system operated by a Retailer to execute the sale of a Product. POS System 0130 and Retailer Server 0140 include a set of the components and functionality described above in Section 2. In addition, POS System 0130 and/or Retailer Server 0140 are configured to associate an Unique WD Code 4910 and/or Existing Unique ID Code 5110 with the Specific Transaction Record 4920. POS System 0130 and/or Retailer Server 0140 is further configured to transmit the associated Unique WD Code and/or Existing Unique ID Code and Specific Transaction Record to Advertiser System 0100 directly or indirectly through a Third Party Server 0150.

POS System 0130 and/or Retailer Server 0140 can identify data on an electronic or non-electronic form that uniquely identifies the user of Wireless Device 0120, the user of any Media Device 0110, and/or the Target Customer, e.g., the name on a check, the financial institution issuing the check (as identified by, e.g., the name or routing number of the financial institution), and a subset of the checking account number. POS System 0130 and/or Retailer Server 0140 can transmit an Existing Unique ID Code to an Advertiser System 0100 directly or indirectly through Third Party Server 0150. The user of Wireless Device 0120 and/or Target Customer can transmit Existing Unique ID Code to any Media Device 0110, which can associate the code with any Ad Data Code 0200 and transmit the associated Existing Unique ID Code and Ad Data Code 0200 to an Advertiser System 0100 and/or Third Party Server 0150. Advertiser System 0100 and/or Third Party Server 0150 can then: (1) search through the purchases made by the user of Wireless Device 0120 and/or Target Customer identified by the Existing Unique ID Code; (2) search through the Advertisements viewed by the user of Wireless Device 0120 and/or Target Customer identified by the Existing Unique ID Code; and (3) matching any purchases of a Product with a Product promoted in an Advertisement viewed by the user and/or Target Customer.

In a physical retailer, POS System 0130 can comprise a Code Reader 0132 and a Payment Device 0134. In an online retailer, POS System 0130 comprises a Payment Device 0134.

Code Reader 0132 can read data transmitted from Wireless Device 0120, user of Wireless Device 0120, and/or Target Customer. Code Reader 0132 may be fixed or mobile. In addition, Code Reader 0132 can read data from a barcode, a string of characters which can be converted into a barcode, or any other form of data including a Unique WD Code and/or an Existing Unique ID Code. In one embodiment, Code Reader 0132 can also read data embedded in a paper-based check (e.g., a check reader utilized by some retailers).

In another embodiment, Code Reader 0132 can scan a smart card, a non-smart card, and/or Wireless Device 0120. A smart card is any card that is embedded with a microprocessor, which can process data on the card, and memory, which can store data on the card. A Smart Card can be either a “contact” card which can exchange data with a card reader by a variety of means of contacting such card reader or a “contactless” card which can exchange data with a card reader by using radio frequency signals. A non-smart card is any card that is not a Smart Card. A Non-Smart Card can include data in any form, including, but not limited to, a barcode or any string of characters which can be converted into a barcode, that can be read by a POS System 0130, in general, and a Code Reader 0132, in particular. For example, most Retailers issue consumers a card, which includes a Shopper Loyalty ID Code. A Retailer can assign a Shopper Loyalty ID Code through a variety of means, including, but not limited to: printing on the card a barcode or any string of characters which can be converted into a barcode; and/or embedding such code in a magnetic stripe on the card.

Payment Device 0134 includes a set of the functionality described in Section 2.

Database Server 4410 can be a server that can include one or more databases, including, but not limited to: Transaction Database 1452; Customer Database 1454; and/or Other Database 4412. Database Server 4410 can be the same server as Advertiser System 0100, Retailer Server 0140, or a different server. Database Server 4410 can store the records of transactions, regardless of the retail channel through which an user purchased one or more Products. The retail channels can include, but are not limited to: a physical retailer, an online retailer, a retailer from which an user orders by making a phone call, or a retailer from which an user makes a purchase order through physical delivery, i.e., through mail order.

Transaction Database 1452 is configured to store one or more records, each of which can include one or more values about any given transaction, including, but not limited to: an Existing Unique ID Code 5110; an Unique WD Code 4910; an Ad Data Code 0200 or any of the values included in such code, of which one value can be an Existing Unique ID Code 5110 (e.g., an Ad Data Code 0200 can be in the form of an electronic coupon redeemed by an user); and/or a Specific Transaction Record 4920 or any of the values included in such record, including, but not limited to, an Existing Unique ID Code 5110, an unique code utilized by an Advertiser and/or Retailer to identify a Product, e.g., UPC/EAN/GTIN, and/or any data identifying such Advertiser and/or Retailer.

Customer Database 1454 is configured to store one or more records, each of which can include one or more values about any given customer, actual or potential, including, but not limited to, an Existing Unique ID Code 5110; an Unique WD Code 4910; an Ad Data Code 0200 or any of the values included in such code, of which one value can be an Existing Unique ID Code 5110; and/or a Specific Transaction Record 4920 or any of the values included in such record, including, but not limited to, an Existing Unique ID Code 5110, an unique code utilized by an Advertiser and/or Retailer to identify a Product, e.g., UPC/EAN/GTIN, and/or any data identifying such Advertiser and/or Retailer.

Other Database 4412 can be any database other than a Transaction Database 1452 or a Customer Database 1454, and can be configured to store one or more records, each of which can include one or more values, including, but not limited to, an Existing Unique ID Code 5110; an Unique WD Code 4910; an Ad Data Code 0200 or any of the values included in such code, of which one value can be an Existing Unique ID Code 5110; and/or a Specific Transaction Record 4920 or any of the values included in such record, including, but not limited to, an Existing Unique ID Code 5110, an unique code utilized by an Advertiser and/or Retailer to identify a Product, e.g., UPC/EAN/GTIN, and/or any data identifying such Advertiser and/or Retailer.

The databases described in FIG. 44 can be the same databases described in FIG. 14. That is, Transaction Database 1452 in FIG. 44 can be the same database as Transaction Database 1452 in FIG. 14, and Customer Database 1454 in FIG. 44 can be the same database as Customer Database 1454 in FIG. 14. For example, Database Server 4410 can include the same databases as the databases on Retailer Server 0140, e.g., where an Advertiser is an automobile dealer which both advertises and sells a Product it advertises or any physical retailer which both advertises and sells Products it advertises. In another embodiment, Advertiser System 0100 and a Retailer Server 0140 can operate jointly the databases on Database Server 4410, e.g., where an Advertiser is an automobile manufacturer and one or more Retailers are affiliated automobile dealers. In another embodiment, Advertiser System 0100 can access the Database Server 4410 operated by Retailer Server 0140 of affiliated Retailers, e.g., where an Advertiser is an automobile manufacturer with the permission and capability to access the databases of affiliated automobile dealers. In another embodiment, Advertiser System 0100 can access the Database Server 4410 operated by Retailer Server 0140 of independent Retailers, e.g., where an Advertiser has the permission and capability to access the databases of independent Retailers selling its Products, like supermarkets, drugstores, and mass merchandisers. In another embodiment, Advertiser System 0100 can access directly the Database Server 4410, e.g., where an Advertiser owns and/or operates Retailer Server 0140, e.g., where a manufacturer owns and/or operates its own physical and/or online stores. In another embodiment, Advertiser System 0100 can access the Database Server 4410 operated by Retailer Server 0140 of an online Retailer, e.g., where an Advertiser has the permission and capability to access the databases of such online Retailers.

In another embodiment, Transaction Database 1452 can be a database different from Transaction Database 1452 and/or Customer Database 1454 can be a database different from Customer Database 1454. In the present embodiment, even where an Advertiser is also a Retailer, Database Server 4410 can include a Customer Database 1454 in FIG. 44 which is different from Customer Database 1454 in FIG. 14, e.g., where an Advertiser is a physical retailer which has a Web Server transmitting an Advertisement and its associated Ad Data Code 0200 and also has a Retailer Server 0140 where it processes specific transactions.

In addition to a set of the functionality described in Section 2, Third Party Server 0150 is configured to exchange data with Media Device 0110, Wireless Device 0120, POS System 0130, Retailer Server 0140, Database Server 4410, and/or Advertiser System 0100. The data can include, but is not limited to: Unique WD Codes, Existing Unique ID Codes, Ad Data Codes 0200, Payment Receipts 1900, Ad Data File 0734, Payment Data File 0740, Ad Response File 0738, and/or Matching Event File 0742.

### 3.1.1 EXEMPLARY SYSTEMS

FIG. 45 depicts a functional block diagram of a system 4500 enabling the exchange of Ad Data Codes 0200, Payment Receipts 1900, Ad Data Files 0734, Payment Data Files 0740, Ad Response File 0738 (not pictured), and/or Matching Event Files 0742 between an Advertiser System 0100 and one or more devices, according to embodiments of the present invention. To calculate the ROI of any given Advertisement and/or determine the CPS to bid or pay for any given Media Location, an Advertiser System 0100 requires either: (1) the original data measuring the user viewing of Advertisements and user purchasing of Products promoted in such Advertisements, e.g., data included in Ad Data Codes 0200, Payment Receipts 1900, Ad Data File 0734, Payment Data File 0740, Ad Response File 0738, and/or Matching Event File 0742; and/or (2) the data analyzing data included in Ad Data File 0734, Payment Data File 0740, Ad Response File 0738, and/or Matching Event File 0742.

System 4500 includes one or more devices that can receive, collect, process, store, and/or transmit data constituting one or more Ad Data Codes 0200, Payment Receipts 1900, Ad Data Files 0734, Payment Data Files 0740, Ad Response Files 0738 (not pictured), and/or Matching Event Files 0742. These devices can include, but are not limited to: one or more Wireless Device 0120, one or Media Devices 0110 which can receive, collect, process, store, and/or transmit one or more Ad Data Codes 0200, Payment Receipts 1900, Ad Data Files 0734, Payment Data Files 0740, Ad Response Files 0738, and/or Matching Event Files 0742, one or more Payment Devices 0134 which can receive, collect, process, store, and/or transmit one or more Ad Data Codes 0200, Payment Receipts 1900, Ad Data Files 0734, Payment Data Files 0740, Ad Response Files 0738, and/or Matching Event Files 0742, one ore more Third Party Servers 0150, and/or one or more Advertiser Systems 0100.

The Media Devices 0110 may include any of the Media Devices 0110 discussed above in Section 2. A Payment Device 0134 may be connected to and/or integrated with a POS System 0130 and/or Retailer Server 0140.

FIG. 46 depicts a functional block diagram of a system enabling the exchange of Ad Data Codes 0200, Payment Receipts 1900, Ad Data Files 0734, Payment Data Files 0740, Ad Response Files 0738, and/or Matching Event Files 0742 between an Advertiser that is a financial institution with an ATM and one or more devices, according to embodiments of the present invention. Note that the system of FIG. 46 can be used in conjunction with the methods described in Sections 2 and 3 herein.

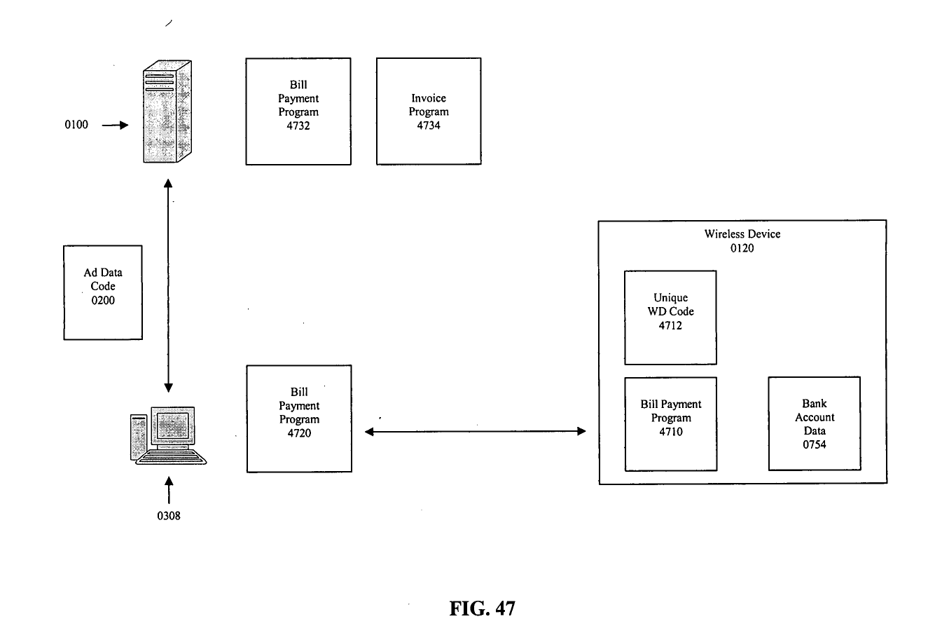

FIG. 47 depicts a functional block diagram of a system enabling the measurement of an user viewing of an Advertisement and an user paying for a Product through a bill payment program on a Wireless Device 0120 or any Media Device 0110, according to embodiments of the present invention.

Wireless Device 0120 includes a Unique WD Code 4712, Existing Unique ID Code (not pictured), Bill Payment Program 4710, and/or Bank Account Data 0754.

Personal Computer 0308 includes a Bill Payment Program 4720 and/or Existing Unique ID Code (not pictured).

Advertiser System 0100 includes a Bill Payment Program 4732, and/or Invoice Program 4734. In this embodiment, Advertiser System 0100 can both transmit one or more Advertisements and their associated Ad Data Codes 0200 as well as execute online transactions by billing an user of any Media Device, e.g., Personal Computer 0308, through Invoice Program 4734 and receiving online payments through Bill Payment Program 4732.

### 3.2 METHODS

### 3.2.1 UNIQUE CODE

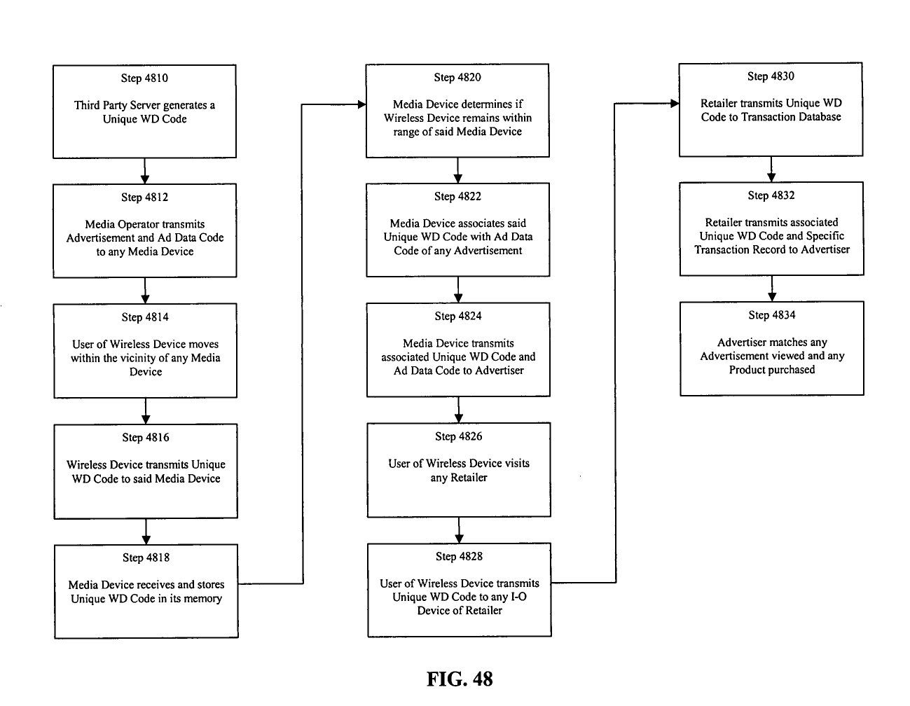

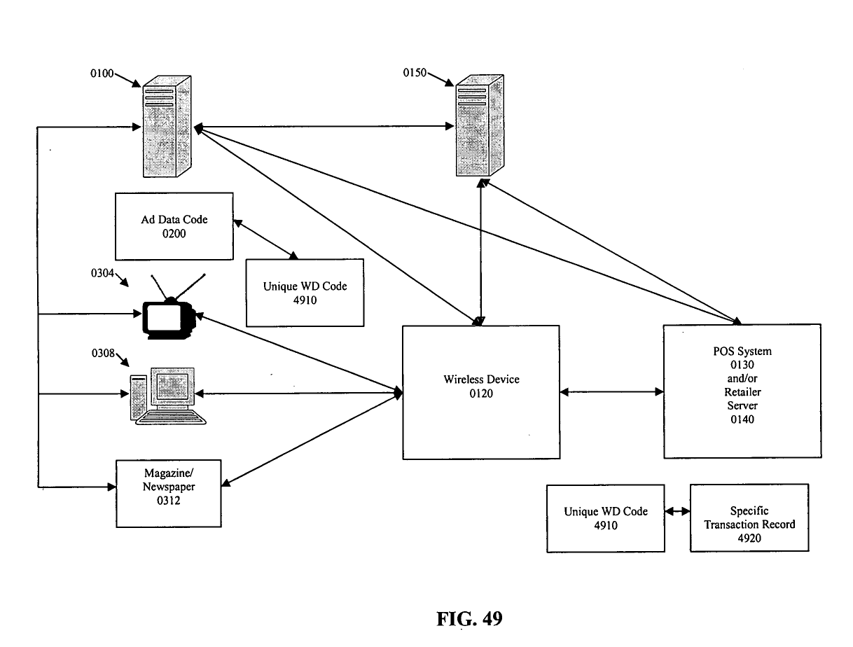

FIG. 48 depicts a flowchart 4800 of an exemplary method of enabling an Advertiser to track if an Advertisement delivered to any Media Device 0110 results in a sale in any Retail Channel using an Unique WD Code, according to embodiments of the present invention. Flowchart or Method 4800 is described with reference to the system depicted in FIG. 49. However, flowchart 4800 is not limited to that embodiment. The present invention can implement flowchart 4800 by executing a subset of the steps, executing the steps in different order, and/or executing other or additional related or equivalent steps.

In step 4810, an Unique WD Code is generated and transmitted to a Wireless Device 0120. In one embodiment, Third Party Server 0150 generates the Unique WD Code. An Unique WD Code can be assigned and transmitted to Wireless Device 0120, the user of Wireless Device 0120, and/or the Target User its/his/her Unique WD Code through a variety of means.

For example, the manufacturer or assembler of Wireless Device 0120 may install an Unique WD Code in Wireless Device 0120 at the time of manufacture or assembly. In addition or alternatively, the wireless operator or other company providing Wireless Device 0120 may install the code in Wireless Device 0120 after manufacture or assembly and before delivery of Wireless Device 0120 to the user. In addition or alternatively, the user may download the code to Wireless Device 0120 after delivery of the device through any wired network, wireless network, or combination of wired and wireless networks. Wireless Device 0120 can physically store its Unique WD Code in Memory 0012. Wireless Device 0120 can logically store its Unique WD Code in any computer program product or module located in Wireless Device 0120, including, but not limited to, Ad Data Code Module 0728 and/or Payment Code Module 0730. As would be appreciated by any person with ordinary skill in the art, the present invention can use other techniques for loading the code in Wireless Device 0120.

In addition to storage in Wireless Device 0120, the code can be stored in another device having a memory. For example, the code may be transmitted to a smart card utilized by the Target Customer. In addition or alternatively, the code may be delivered to the Target Customer on a physical card (“Physical Card Unique WD Code”) for the consumer.

In step 4812, a Media Operator 0104 transmits to or publishes on any Media Device 0110 the Advertisement, which can include an Ad Data Code 0200, in a Media Program, in general, and specifically in a Media Location. In addition, in this step, an individual can view the Advertisement.

In step 4814, the Wireless Device 0120 enters the coverage area of a Media Device 0110. The coverage area is determined by the transmission range of the type of I-O Device used to receive communications. For example, the coverage area may be the transmission range of the Short-Range Antenna and/or Wired Port of a Media Device 0110.

In step 4816, Ad Data Code Module 0728 can transmit the Unique WD Code through one or more I-O Devices which are within transmission range of one or more Short-Range Antennas of the Media Device 0110 and/or connected to a Wired Port of the Media Device 0110. Ad Data Code Module 0728 can include any method which can automatically transmit the Unique WD Code if Wireless Device 0120 is within transmission range of one or more I-O Devices of any Media Device 0110.

In step 4818, the Media Device 0110 receives and stores in its memory the Unique WD Code. If the Media Device 0110 can receive the Unique WD Code, an Advertiser can generally assume that the user of Wireless Device 0120 is in the vicinity of the Media Device 0110 and is exposed to any Advertisement displayed on the Media Device 0110. For example, Class 2 radios, typically found in wireless devices, which utilize the Bluetooth protocol have a range of 10 meters. An Advertiser can generally assume that if Wireless Device 0120 can transmit utilizing Bluetooth protocol a Unique WD Code to any Media Device 0110, the user of Wireless Device 0120 is exposed to an Advertisement displayed on the Media Device 0110. If the Media Device 0110 cannot receive the Unique WD Code, an Advertiser can generally assume that the user of Wireless Device 0120 is not in the vicinity of the Media Device 0110 and is not exposed to an Advertisement displayed on the Media Device 0110.

If the Media Device 0110 is a Personal Computer 0308, Personal Computer 0308 can receive and store in its Memory 0012 the Unique WD Code. If the Media Device 0110 is a Television 0304, STB 0500 (illustrated in FIG. 5) can receive and store in Memory 0514 the Unique WD Code. If the Media Device 0110 is any other Media Device 0110 with memory, it can receive and store in its memory the Unique WD Code.

In step 4820, the Media Device 0110 can determine if Wireless Device 0120 remains within range of the Media Device 0110, which can enable an Advertiser to assume reasonably that the user of Wireless Device 0120 is exposed to an Advertisement displayed on the Media Device 0110. A variety of techniques can be used to determine if Wireless Device 0120 remains within range of the Media Device 0110.

For example, the Media Device 0110 can poll periodically through any of its Short-Range Antennas and/or Wired Port the Wireless Device 0120 utilizing any method readily apparent to any person with ordinary skill in the art. As long as the Media Device 0110 receives some form of acknowledgment or response from Wireless Device 0120, the Media Device 0110 can conclude that Wireless Device 0120 is within range of the Media Device 0110. When the Media Device 0110 does not receive some form of acknowledgment or response from Wireless Device 0120, the Media Device 0110 can conclude that an user of Wireless Device 0120 has moved the Wireless Device 0120 out of range of the Media Device 0110. The acknowledgment or response from Wireless Device 0120 can include the Unique WD Code of Wireless Device 0120.

In another example, the Wireless Device 0120 can periodically transmit to the Media Device 0110 data indicating that the Wireless Device 0120 is within range of the Media Device 0110 (“WD Vicinity Data”) utilizing any method readily apparent to any person with ordinary skill in the art. As long as the Media Device 0110 receives WD Vicinity Data, the Media Device 0110 can conclude that Wireless Device 0120 is within range of the Media Device 0110. When the Media Device 0110 does not receive WD Vicinity Data within a given time period, the Media Device 0110 can conclude that an user of Wireless Device 0120 has moved the Wireless Device 0120 out of range of the Media Device 0110. WD Vicinity Data can include the Unique WD Code of Wireless Device 0120.

As would be appreciated by any person with ordinary skill in the art, other techniques for determining if Wireless Device 0120 remains within range of the Media Device 0110 can be used.

In step 4822, when the Media Device 0110 receives an Advertisement and its associated Ad Data Code 0200, the Media Device 0110 can associate the Unique WD Code with the Ad Data Code 0200. The present method can ensure that the Media Device 0110 can associate the Unique WD Code with the Ad Data Code 0200 only when Wireless Device 0120 is within range of the Media Device 0110 in a variety of means, including, but not limited to: setting a time-to-live value for the Unique WD Code that is related to the continued reception of WD Vicinity Data by the Media Device 0110.

The Media Device 0110 can associate the Unique WD Code with the Ad Data Code 0200 through a variety of means, including, but not limited to: writing the Unique WD Code to a field in Ad Data Code 0200; appending the Unique WD Code to Ad Data Code 0200; and/or generating a date/time stamp for the reception of the Ad Data Code 0200, generating a date/time stamp for the Unique WD Code, transmitting separately both the Ad Data Code 0200 and the Unique WD Code to an Advertiser System 0100 directly or indirectly through a Third Party Server 0150, and enabling Advertiser System 0100 and/or Third Party Server 0150 to match those Unique WD Code and Ad Data Code 0200 with equal date/time stamps or similar date/time stamps (i.e., within a given range).

If the Media Device 0110 is a Personal Computer 0308, the association of the Unique WD Code with the Ad Data Code 0200 means that the user of Wireless Device 0120 was in the vicinity of Personal Computer 0308 at the time Personal Computer 0308 displayed the Advertisement identified by its Ad Data Code 0200. Advertiser System 0100 can reasonably assume that the user of Wireless Device 0120 was exposed to the Advertisement.

If the Media Device 0110 is a Television 0304, the association of the Unique WD Code with the Ad Data Code 0200 means that the user of Wireless Device 0120 was in the vicinity of STB 0500 at the time Television 0304 displayed the Advertisement identified by its Ad Data Code 0200. Advertiser System 0100 can reasonably conclude that the user of Wireless Device 0120 was exposed to the Advertisement.

If the Media Device 0110 is any other Media Device 0110, the association of the Unique WD Code with the Ad Data Code 0200 means that the user of Wireless Device 0120 was in the vicinity of the Media Device 0110 at the time the display device of the Media Device 0110 displayed the Advertisement identified by its Ad Data Code 0200. Advertiser System 0100 can reasonably conclude that the user of Wireless Device 0120 was exposed to the Advertisement.

The method of flowchart 4800 can enable an Advertiser System 0100 to transmit directly to a Wireless Device 0120 an Advertisement and its associated Ad Data Code 0200. The Wireless Device 0120 can associate the Unique WD Code with the Ad Data Code 0200 utilizing the same methods that any other Media Device 0110 can use to associate the Unique WD Code with the Ad Data Code 0200.

In step 4824, the Media Device 0110 can transmit the associated Unique WD Code and Ad Data Code 0200 to an Advertiser System 0100 directly or indirectly through a Third Party Server 0150. The association of the codes can enable Advertiser System 0100 to conclude reasonably that the user of Wireless Device 0120 was exposed to the Advertisement identified by its associated Ad Data Code 0200.

In another embodiment, the Media Device 0110 can transmit the Unique WD Code for which the Media Device 0110 generated a date/time stamp to Advertiser System 0100 directly or indirectly through Third Party Server 0150, either or both of which can compare the date/time stamp of the Unique WD Code and the date/time stamp of any Advertisements displayed on the Media Device 0110 as stored on a database. For example, if Advertiser System 0100 receives a file indicating the date/time stamp of Unique WD Code indicating that Wireless Device 0120 was in the vicinity of a Television 0304, Radio 0410, or Personal Computer 0308 receiving a video transmission of an Advertisement, Advertiser System 0100 can match the date/time stamp with the date/time of any Advertisements it transmitted to the Media Devices 0110. In the present embodiment, Advertiser System 0100 does not need to transmit an Ad Data Code 0200 to a Media Device 0110 to measure if a Wireless Device 0120 was exposed to an Advertisement. Advertiser System 0100 can determine that a Wireless Device 0120 was exposed to an Advertisement by associating an Unique WD Code which a Media Device 0110 identifies as present in the vicinity at the date/time Advertiser System 0100 transmits an Advertisement with an Ad Data Code 0200 on Advertiser System 0100, instead of on a Media Device 0110.

In step 4826, the user of Wireless Device 0120 can visit any type of Retailer, including, but not limited to: a physical retailer, an online retailer, a retailer through making a phone call, or a retailer through physically delivering, i.e., through mail order, a purchase order.

In step 4828, the user of Wireless Device 0120 can transmit its Unique WD Code to any to any I-O Device of a Retailer. A Retailer can receive the Unique WD Code through one or more means

For example, at a physical retailer, the user of Wireless Device 0120 can display the Unique WD Code in the form of a barcode on Display 0120 of the Wireless Device 0120 and hold Wireless Device 0120 at a distance and angle to enable Code Reader 0132 at the Retailer to record the Code.

In another example, at a physical retailer, the user of Wireless Device 0120 can transmit the Unique WD Code wirelessly from any its I-O Devices, including, but not limited to, Short-Range Antenna 0324, Infrared Transceiver 0330, RFID Device 0334, NFC Antenna 0338, or I-O Device 0339, to any Code Reader 0132 at the POS System 0130 which includes I-O Devices capable of receiving the Unique WD Code wirelessly.

In another example, at an online retailer with which the user of Wireless Device 0120 communicates through a wireless Internet connection originated by the Device, the user can transmit the Unique WD Code wirelessly to the retailer.

In another example, at a retailer with which the user of Wireless Device 0120 communicates through making a wireless phone call originated by the Device, the user can transmit the Unique WD Code wirelessly to the retailer.

In another example, at a retailer to which the user of Wireless Device 0120 physically delivers a purchase order through the mail, the user can transmit the Unique WD Code wirelessly to the retailer through the retailer's Web site.

As would be appreciated by any person with ordinary skill in the art, the present invention can use other techniques for receiving the Unique WD Code.

In step 4830, the Retailer can transmit the Unique WD Code from: (1) the Retailer device that receives the Unique WD Code from the Wireless Device 0120; to (2) Retailer Server 0140 that contains a database of transactions executed by the Retailer.

At a physical retailer, the Retailer can transmit the Unique WD Code from Code Reader 0132 and/or Payment Device 0134 to Control Unit 1410 (illustrated in FIG. 14), which in turn can transmit through Communication Device 1420 and Communication Device 1440 the Unique WD Code to Control Unit 1442, which in turn can transmit the Unique WD Code to Transaction Database 1452. The Retailer can associate the Unique WD Code with the record of the Transaction executed by the user of Wireless Device 0120 at the Retailer, which is stored in Transaction Database 1452. The record of the Transaction can be any description by the Retailer of the transaction, including, but not limited to, Payment Receipt 1900, and/or any record of the specific transaction executed by the user of Wireless Device 0120 (“Specific Transaction Record”). The Retailer can associate the Unique WD Code with the Specific Transaction Record in a variety of means, including, but not limited to: writing the Unique WD Code to a field in Transaction Database 1452; appending the Unique WD Code to the Specific Transaction Record; and/or generating a date/time stamp for the generation of the Specific Transaction Record, generating a date/time stamp for the Unique WD Code, transmitting separately both the Specific Transaction Record and the Unique WD Code to an Advertiser System 0100 directly or indirectly through a Third Party Server 0150, and enabling Advertiser System 0100 and/or Third Party Server 0150 to match those Unique WD Code and Specific Transaction Record with equal date/time stamps or similar date/time stamps (i.e., within a given range).

In step 4832, the Retailer can transmit the associated Unique WD Code and Specific Transaction Record to an Advertiser System 0100 directly or indirectly through a Third Party Server 0150. The association of the codes can enable Advertiser System 0100 to conclude that the user of Wireless Device 0120 made the specific transaction.

In step 4834, Advertiser System 0100 and/or Third Party Server 0150 can utilize a computer program product with the same functionality as URMS 0350 to call URMA Module 0744, which can: (1) search through any file containing data on the Advertisements viewed by an user with a given Unique WD Code; (2) search through any file containing data on the Products purchased by the user, e.g., an user with the Unique WD Code; (3) match any data uniquely identifying the Product promoted in the Advertisement with the Product promoted in any Advertisements viewed by the user, e.g., UPC/EAN/GTIN or name of Product; and/or (4) write any matching data to Matching Event File 0742. A match between an Advertisement viewed by the user as identified by the Ad Data Code 0200 and the purchase of a Product promoted in the Advertisement as identified by the Specific Transaction Record as confirmed by the Unique WD Code can indicate to Advertiser that the Advertisement could have influenced the user to purchase the Product.

In another embodiment, a Media Device 0110 can transmit such Ad Data Code 0200 to Wireless Device 0120, which can associate such Ad Data Code 0200 with such Unique WD Code. Wireless Device 0120 can then transmit the associated Ad Data Code 0200 and Unique WE Code to an Advertiser System 0100 directly or indirectly through a Third Party Server 0150.

In another embodiment, POS System 0130 can transmit through Payment Device 0134 or any other means the Specific Transaction Record to Wireless Device 0120, which can associate such Specific Transaction Record with such Unique WD Code. Wireless Device 0120 can then transmit the associated Specific Transaction Record and Unique WD Code to an Advertiser System 0100 directly or indirectly through a Third Party Server 0150

### 3.2.2 EXISTING UNIQUE ID CODE

In another embodiment, the system can track if an Advertisement delivered to any Media Device 0110 results in a sale in any Retail Channel by utilizing an Existing Unique ID Code identifying a specific Wireless Device 0120, an user of Wireless Device 0120, any Media Device 0110, an user of Media Device 0110, and/or Target Customer, associating such code with any Advertisement and/or Ad Data Codes 0200 delivered to any Media Device 0110 and/or any Payment Receipt 1900 in any Retail Channel, and transmitting such code, Ad Data Codes 0200, and/or Payment Receipts 1900 from a Media Device 0110 and/or POS System 0130 to an Advertiser System 0100 directly or indirectly through a Third Party Server 0150. This method can include the same set of steps as FIG. 48 except the utilization of an Existing Unique ID Code instead of an Unique WD Code, in general, and: (1) the type of data identifying a specific Wireless Device 0120, the user of Wireless Device 0120, a Media Device 0110, the user of Media Device 0110, and/or the Target Customer; (2) the means by which a Wireless Device 0120, an user of Wireless Device 0120, an user of Media Device 0110, and/or the Target Customer can input into and/or transmit to a Media Device 0110 an Unique WD Code and/or an Existing Unique ID Code; (3) the means by which a Wireless Device 0120, the user of Wireless Device 0120, a Media Device 0110, the user of Media Device 0110, and/or the Target Customer can transmit to a Retailer an Unique WD Code and/or an Existing Unique ID Code; and/or (4) the means by which a Retailer can associate an Unique WD Code and/or an Existing Unique ID Code with a Specific Transaction Record.

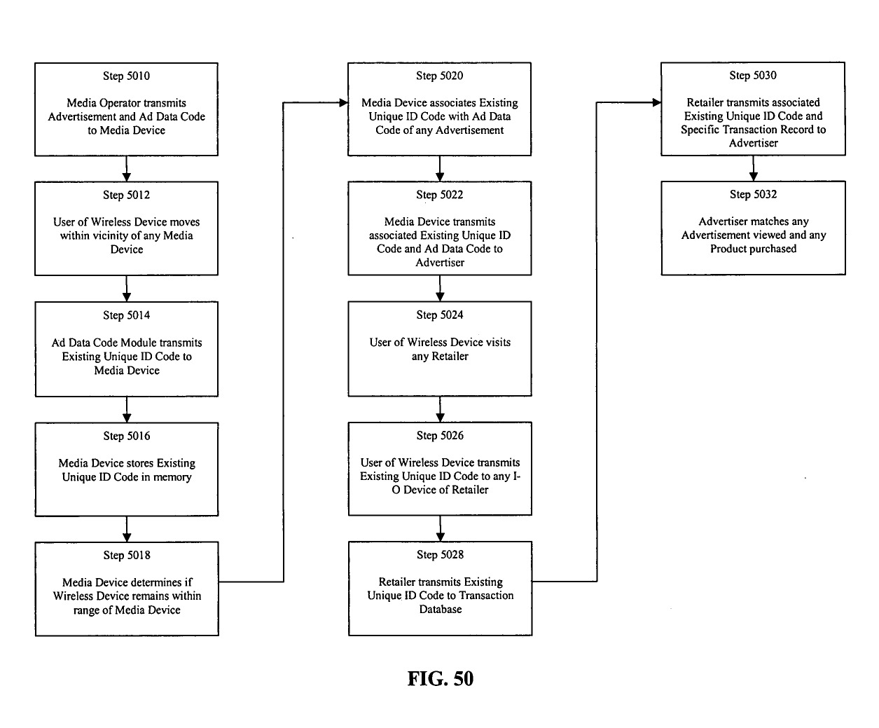

FIG. 50 depicts a flowchart 5000 of an exemplary method of enabling an Advertiser to track if an Advertisement delivered to any Media Device 0110 results in a sale in any Retail Channel using an Existing Unique ID Code, according to embodiments of the present invention. Flowchart or Method 5000 is described with reference to the system depicted in FIG. 49. However, flowchart 5000 is not limited to that embodiment. The present invention can implement flowchart 5000 by executing a subset of the steps, executing the steps in different order, and/or executing other or additional related or equivalent steps.

In step 5010, a Media Operator 0104 transmits or publishes on any Media Device 0110 the Advertisement, which can include an Ad Data Code 0200, in a Media Program and specifically in a Media Location. In addition, in this step, an individual can view the Advertisement.

In step 5012, the Wireless Device 0120 enters the coverage area of a Media Device 0110. The coverage area is determined by the transmission range of the type of I-O Device used to receive communications. For example, the coverage area may be the transmission range of the Short-Range Antenna and/or Wired Port of a Media Device 0110.

In step 5014, Ad Data Code Module 0728 can transmit the Existing Unique ID Code through one or more I-O Devices which are within transmission range of one or more Short-Range Antennas of the Media Device 0110 and/or connected to a Wired Port of the Media Device 0110. Ad Data Code Module 0728 can include any method which can automatically transmit the Existing Unique ID Code if Wireless Device 0120 is within transmission range of one or more I-O Devices of any Media Device 0110.

For example, a Synchronization Program can enable Wireless Device 0120 to transmit to Personal Computer 0308 an Existing Unique ID code.

In step 5016, the Media Device 0110 receives and stores in its memory the Existing Unique ID Code. In addition to the techniques described in flowchart 4800, a Media Device 0110 may receive an Existing Unique ID Code in a variety of additional ways.

For example, (a) an user of Wireless Device 0120 and/or Target Customer can scan a barcode and/or any string of characters which can be converted into a barcode by software in a Wireless Device 0120 that contains the Existing Unique ID Code, e.g., a card containing a Shopper Loyalty ID Code, into Wireless Device 0120 through Camera 0232 and/or Barcode Reader 0234; (b) the Wireless Device 0120 can convert the barcode into an Existing Unique ID Code and write and store the code in Ad Data Code Module 0728 and/or Payment Code Module 0730; (c) the Ad Data Code Module 0728 can transmit the Existing Unique ID Code to any Media Device 0110 through any I-O Device of Wireless Device 0120 to any I-O Device of the Media Device 0110; and/or (d) the Media Device 0110 can write and store the Existing Unique ID Code to and in its memory, e.g., Memory 0012 of a Personal Computer 0308, and Memory 0514 of a STB 0500.

In another example, (a) an user of Wireless Device 0120 and/or Target Customer can input any string of characters that comprises an Existing Unique ID Code, e.g., a card containing a Shopper Loyalty ID Code, into Wireless Device 0120 through Keypad 0766 of the Wireless Device 0120; (b) the Wireless Device 0120 can write and store the code in Ad Data Code Module 0728 and/or Payment Code Module 0730; (c) the Ad Data Code Module 0728 can transmit the Existing Unique ID Code to any Media Device 0110 through any I-O Device of Wireless Device 0120 to any I-O Device of the Media Device 0110; and/or (d) the Media Device 0110 can write and store the Existing Unique ID Code to and in its memory, e.g., Memory 0012 of a Personal Computer 0308, and Memory 0514 of a STB 0500.

In an additional example, (a) an user of Wireless Device 0120 and/or Target Customer can place a contactless Smart Card within transmission range of a card reader capable of receiving data from a contactless Smart Card and/or place a contact Smart Card in physical contract of a card reader capable of receiving data from a contact Smart Card wherein the Smart Card contains the Existing Unique ID Code; (b) the Wireless Device 0120 store Existing Unique ID Code in Ad Data Code Module 0728 and/or Payment Code Module 0730; (c) the Ad Data Code Module 0728 transmit the Existing Unique ID Code to any Media Device 0110 through any I-O Device of Wireless Device 0120 to any I-O Device of the Media Device 0110; and/or (d) the Media Device 0110 can write and store the Existing Unique ID Code to and in its memory, e.g., Memory 0012 of a Personal Computer 0308, and Memory 0514 of a STB 0500.

In another example, an user of Wireless Device 0120, an user of any Media Device 0110, and/or Target Customer can orally communicate the Existing Unique ID Code to any Media Device 0110, which can include a computer program product capable of converting speech to data, which Media Device 0110 can then write and store to and in its memory, e.g., Memory 0012 of a Personal Computer 0308, and Memory 0514 of a STB 0500.

In another example, an user of Wireless Device 0120 and/or Target Customer can orally communicate the Existing Unique ID Code through Microphone 0328 to Wireless Device 0120, which can include a computer program product capable of converting speech to data, which Wireless Device 0120 can store the Existing Unique ID Code in Ad Data Code Module 0728 and/or Payment Code Module 0730, which Ad Data Code Module 0728 can transmit the Existing Unique ID Code to any Media Device 0110 through any I-O Device of Wireless Device 0120 to any I-O Device of the Media Device 0110, and/or which the Media Device 0110 can write and store the Existing Unique ID Code to and in its memory, e.g., Memory 0012 of a Personal Computer 0308, and Memory 0514 of a STB 0500.

In step 5018, the Media Device 0110 can determine if Wireless Device 0120 remains within range of the Media Device 0110, which can enable an Advertiser to assume reasonably that the user of Wireless Device 0120 is exposed to an Advertisement displayed on the Media Device 0110. The techniques for making this determination were described above in reference to FIG. 48.

In step 5020, when the Media Device 0110 receives an Advertisement and its associated Ad Data Code 0200, the Media Device 0110 can associate the Existing Unique ID Code with the Ad Data Code 0200. The present method can ensure that the Media Device 0110 can associate the Existing Unique ID Code with the Ad Data Code 0200 only when Wireless Device 0120 is within range of the Media Device 0110. Techniques for performing this step were described above in reference to FIG. 48.

In step 5022, the Media Device 0110 can transmit the associated Existing Unique ID Code and Ad Data Code 0200 to an Advertiser System 0100 directly or indirectly through a Third Party Server 0150. The association of the codes can enable Advertiser System 0100 to conclude that the user of Wireless Device 0120 was exposed to the Advertisement identified by its associated Ad Data Code 0200.

In step 5024, the user of Wireless Device 0120 can visit any type of Retailer, including, but not limited to: a physical retailer, an online retailer, a retailer through making a phone call, or a retailer through physically delivering, i.e., through mail order, a purchase order.

In step 5026, the user of Wireless Device 0120 can transmit the Existing Unique ID Code to any to any I-O Device of a Retailer. In addition to the techniques described in reference to FIG. 48, an user of Wireless Device 0120 and/or a Target Customer can transmit to a Retailer an Existing Unique ID Code through the following means, including, but not limited to: (1) the user of Wireless Device 0120 and/or the Target Customer orally communicating the Existing Unique ID Code to the person administering POS System 0130, who can transmit or input the code into POS System 0130; and/or the user of Wireless Device 0120, Target Customer; (2) the user of Wireless Device 0120 and/or the Target Customer orally communicating the Existing Unique ID Code to a POS System 0130 which can convert speech to data; and/or (3) a person administering POS System 0130 can input the code into POS System 0130 by scanning the code into Code Reader 0132 and/or manually inputting the Existing Unique ID Code into a Keyboard 0022 or any other input device of the POS System 0130.

In step 5028, the Retailer can transmit the Existing Unique ID Code from: (1) the Retailer device that receives the Existing Unique ID Code from the Wireless Device 0120, e.g., POS System 0130; to (2) the Retailer server that contains a database of transactions executed by the Retailer, e.g., Retailer Server 0140.

In step 5030, the Retailer can transmit the associated Existing Unique ID Code and Specific Transaction Record to an Advertiser System 0100 directly or indirectly through a Third Party Server 0150. The association of the codes can enable Advertiser System 0100 to conclude that the user of Wireless Device 0120 made the specific transaction.

A Retailer can associate an Existing Unique ID Code with a Specific Transaction Record though the following means, including, but not limited to, for an Existing Unique ID Code that was issued by the Retailer, e.g., a Shopper Loyalty ID Code, the Retailer can: (a) transmit the code from: (i) an I-O Device of POS System 0130 receiving the code from the Wireless Device 0120, the user of Wireless Device 0120, and/or the Target Customer; to (ii) a Transaction Database 1452, a Customer Database 1454, or any other database at POS System 0130 and/or Retailer Server 0140 enabling the writing, storage, and/or reading/retrieval of a record for the user of Wireless Device 0120 and/or the Target Customer; (b) search for the record with an user ID that is equal to the Existing Unique ID Code; (c) generate a Specific Transaction Record for the transaction made by the user of Wireless Device 0120 and/or the Target Customer; and/or (d) transmit the Specific Transaction Record to an Advertiser System 0100 directly or indirectly through a Third Party Server 0150. For an Existing Unique ID Code issued by the Retailer, it is unnecessary to utilize the means described in Step 4830 to associate an Existing Unique ID Code with a Specific Transaction Record, because the Retailer can recognize the Existing Unique ID Code.

In an additional example, for an Existing Unique ID Code that was not issued by the Retailer, e.g., a Check Unique ID Code, the Retailer can: (a) transmit the code from: (i) an I-O Device of POS System 0130 receiving the code from the Wireless Device 0120, an user of Wireless Device 0120, and/or a Target Customer, e.g., a check reader; to: (ii) a Transaction Database 1452, a Customer Database 1454, or any other database at POS System 0130 and/or Retailer Server 0140 enabling the writing, storage, and/or reading/retrieval of a record for the user of Wireless Device 0120 and/or the Target Customer; (b) generate a Specific Transaction Record for the transaction made by the user of Wireless Device 0120 and/or the Target Customer; and (c) associate the Existing Unique ID Code with the Specific Transaction Record in a variety of means, e.g., the methods described in Step 4830 for associating an Unique WD Code with a Specific Transaction Record; and/or (d) transmit the associated Existing Unique ID Code and Specific Transaction Record to an Advertiser System 0100 directly or indirectly through a Third Party Server 0150.

In step 5032, Advertiser System 0100 and/or Third Party Server 0150 can utilize a computer program product with the same functionality as URMS 0350 to call URMA Module 0744, which can: (1) search through any file containing data on the Advertisements viewed by an user with a given Existing Unique ID Code; (2) search through any file containing data on the Products purchased by the user, i.e., an user with the Existing Unique ID Code; (3) match any data uniquely identifying the Product promoted in the Advertisement with the Product promoted in any Advertisements viewed by the user, e.g., UPC/EAN/GTIN or name of Product; and/or (4) write any matching data to Matching Event File 0742.

For example, an Advertiser System 0100 transmitting an Advertisement promoting an automobile can measure if an user of Wireless Device 0120 and/or a Target Customer responds to the Advertisement as follows. The user of Wireless Device 0120 and/or a Target Customer can input Check Unique ID Code into a Media Device 0110, which can then associate Check Unique ID Code with an Ad Data Code 0200 which describes the Advertisement. The user of Wireless Device 0120 and/or a Target Customer can write a check as a down payment or for the entire purchase price of an automobile. An automobile dealer selling the automobile to the user of Wireless Device 0120 and/or the Target Customer can receive the check, input the Check Unique ID Code manually or through a check reader into a Transaction Database 1452, Customer Database 1454, or any other database at POS System 0130 and/or Retailer Server 0140 enabling the writing, storage, and/or reading/retrieval of a record of the transaction, which can associate the Check Unique ID Code with a Specific Transaction Record for the automobile purchased by the user of Wireless Device 0120 and/or the Target Customer. The dealer can transmit the associated Check Unique ID Code and Specific Transaction Record to the user of Wireless Device 0120 in the form of an electronic receipt, and/or the Advertiser System 0100 directly or indirectly through a Third Party Server 0150.

### 3. EXAMPLES

### 3.3.1 EXISTING UNIQUE ID CODE

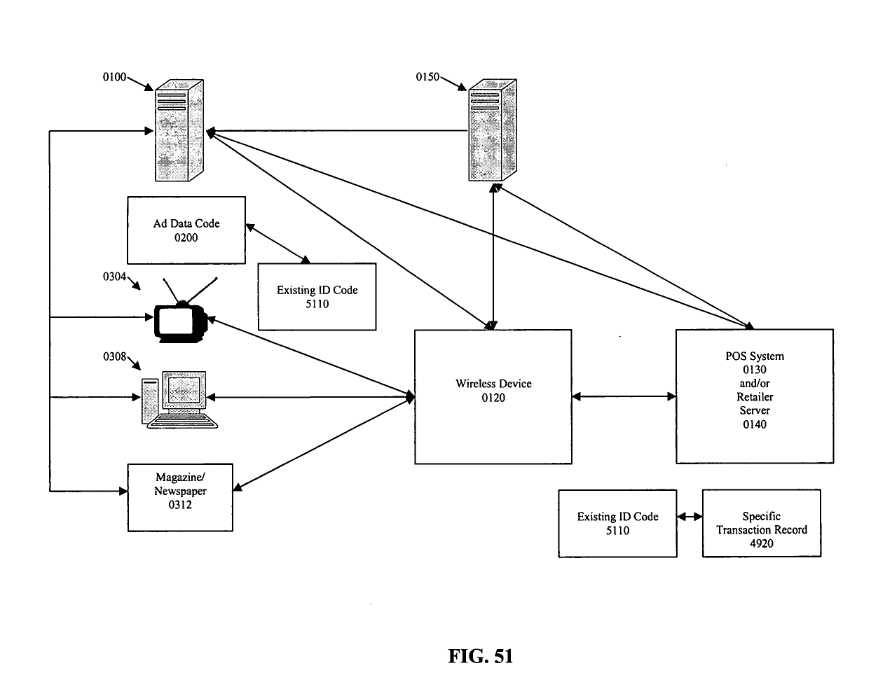

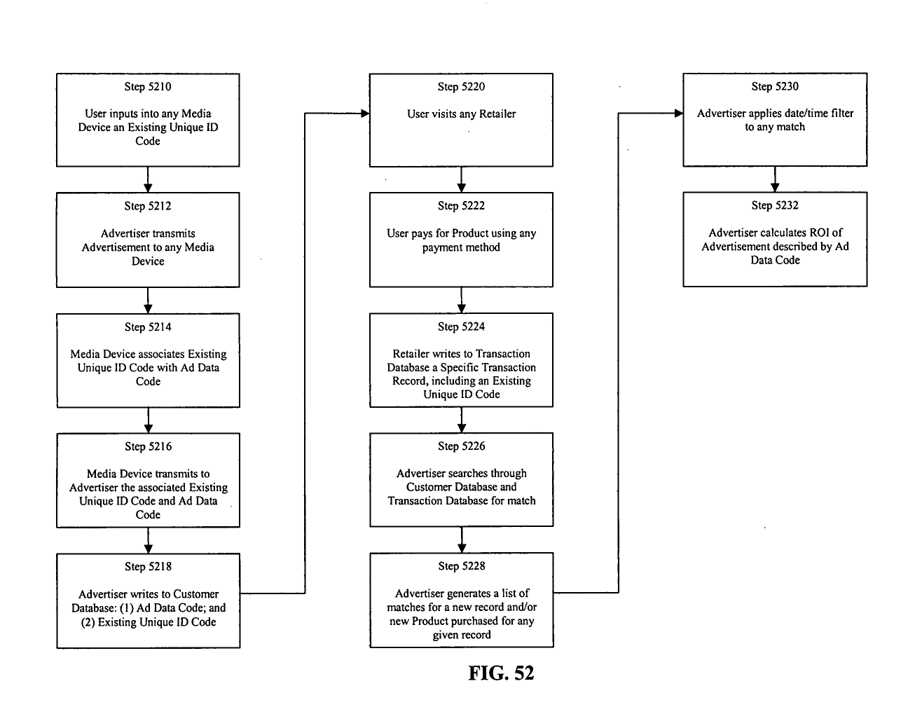

FIG. 52 depicts a flowchart 5200 of an exemplary method of enabling an Advertiser to track if an Advertisement delivered to a Media Device 0110 results in a sale at a retailer, where the retailer is the Advertiser or affiliated with the Advertiser, according to embodiments of the present invention. Flowchart or Method 5200 is described with continued reference to the system illustrated in FIG. 51. However, flowchart 5200 is not limited to that embodiment. The present invention can implement flowchart 5200 by executing a subset of the steps, executing the steps in different order, and/or executing other or additional related or equivalent steps.

In step 5210, an user can input an Existing Unique ID Code into any Media Device 0110.

In step 5212, a Media Operator 0104 transmits or publishes on any Media Device 0110 the Advertisement, which can include an Ad Data Code 0200, in a media program and specifically in a media location. In addition, in this step, an individual can view the Advertisement.

In step 5214, the Media Device 0110 can associate the Existing Unique ID Code stored in such Media Device 0110 with such Ad Data Code 0200 utilizing one of the techniques described herein. In another embodiment, the Media Device 0110 can transmit the Existing Unique ID Code stored in the Media Device 0110 to Advertiser System 0100, which can associate the Existing Unique ID Code with a copy of the Ad Data Code 0200 transmitted to the Media Device 0110.

In step 5216, the Media Device 0110 can transmit to Advertiser System 0100 the associated Existing Unique ID Code and Ad Data Code 0200.

In step 5218, Advertiser System 0100 can write to Customer Database 1454 a new record the Existing Unique ID Code and Ad Data Code 0200. In another embodiment, Advertiser System 0100 can write to another database (“Non-Customer Database”) a new record that includes values for the Existing Unique ID Code and such Ad Data Code 0200.

In step 5220, an user can visit any Retailer. An user can visit any Retailer through any means, including, but not limited to: physically visiting a physical retailer; retrieving a web page of an online Retailer through a network, e.g., the Internet; communicating with a Retailer through a phone call, e.g., a toll-free telephone number; and/or transmitting a purchase order through a physical delivery system, e.g., mail-order.

In one embodiment, the Retailer can be Advertiser System 0100 or any entity with a Transaction Database 1452, Customer Database 1454, and/or Other Database 4412 which Advertiser System 0100 can directly or indirectly access. That is, an Advertiser can have its own Retail Channel with which an user can communicate directly. The Retail Channel can include, but is not limited to: a physical store whose Transaction Database 1452, Customer Database 1454, and/or Other Database 4412 such Advertiser System 0100 can access through any means including, but not limited to, the Advertiser owning, operating, franchising, and/or otherwise controlling such physical store; an online store whose Transaction Database 1452, Customer Database 1454, and/or Other Database 4412 such Advertiser System 0100 can access; a means of purchasing a Product from such Advertiser System 0100 through a phone call, e.g., a toll-free telephone number, where such Advertiser System 0100 can access a Transaction Database 1452, Customer Database 1454, and/or Other Database 4412 storing data on any sales of such Product; and/or a means of purchasing a Product from such Advertiser System 0100 through a physical delivery system, e.g., mail-order, where such Advertiser can access a Transaction Database 1452, Customer Database 1454, and/or Other Database 4412 storing data on any sales of such Product.

Examples of a Retailer being an Advertiser or any entity with a Transaction Database 1452, Customer Database 1454, and/or Other Database 4412 such Advertiser System 0100 can access can include the following examples.

For example, an Advertiser which is an automobile manufacturer with a dealer network and/or a division or related company that can finance the purchases of automobiles from such manufacturer may be a retailer and Advertiser. In this example, the automobile manufacturer and/or Advertiser System 0100 can access the Transaction Database 1452, Customer Database 1454, and/or Other Database 4412 of the automobile dealer selling the manufacturer's automobiles or the related company financing the purchase of the manufacturer's automobiles.

In another example, an Advertiser which is an automobile dealer may be a Retailer and Advertiser. In this example, the Retailer/Advertiser and/or Advertiser System 0100 can access its Transaction Database 1452, Customer Database 1454, and/or Other Database 4412, which can store data on any sales of an automobile from such dealer.

In another example, an Advertiser which is a financial institution may be a Retailer and Advertiser. In this example, the financial institution and/or Advertiser System 0100 can access its Transaction Database 1452, Customer Database 1454, and/or Other Database 4412 which can store data on any sales of a Product from such financial institution.

In step 5222, an user can purchase a Product using any payment method. The payment method can include any means of paying for a Product, including, but not limited to: cash; a credit/debit card; a check; a deduction from a cash balance stored in a Wireless Device 0120; an addition of a charge to the bill of the subscriber of a Wireless Device 0120; an electronic finds transfer; an electronic form of payment, e.g., an online payment method; and/or an agreement to incur debt, e.g., a home mortgage, an auto loan, or a lease agreement. By utilizing any payment method, including means other than those provided by a Wireless Device 0120, the present method can enable an Advertiser to track if an Advertisement delivered to any Media Device 0110 results in a sale in any Retailer without requiring the use of such Wireless Device 0120 to pay for a Product.

In step 5224, the Retailer can write to Transaction Database 1452 a new Specific Transaction Record 4920, which can include an Existing Unique ID Code 5110 and/or a description of the Product purchased by such user. For example, an automobile dealer can write to Transaction Database 1452 a new Specific Transaction Record 4920, which can include an Existing Unique ID Code 5110, e.g., a Check Unique ID Code, and/or a description of an automobile purchased by such user. In another embodiment, such Retailer can write to an existing record for the user purchasing a Product in a Customer Database 1454 one or more values, including, but not limited to: an Existing Unique ID Code 5110, and/or an unique code utilized by an Advertiser and/or Retailer to identify a Product, e.g., UPC/EAN/GTIN. For example, for an user who has previously purchased an automobile from an automobile dealer, such dealer can have an existing record for such user in a Customer Database 1454. If such user purchases another automobile from such dealer, such dealer can write to such existing record one or more values, including, but not limited to: an Existing Unique ID Code 5110, e.g., a Check Unique ID Code, and/or a description of the new automobile purchased by such user.

In step 5226, Advertiser System 0100 can search through Transaction Database 1452, Customer Database 1454, and/or Other Database 4412 for any records which have the same Existing Unique ID Code during a time period of interest to Advertiser System 0100. In particular, if an Advertiser System 0100 wants to measure if an user purchased a Product promoted in an Advertisement transmitted by Advertiser System 0100 during a time period, YYYY/MM/DD/HH/SS₁ to YYYY/MM/DD/HH/SS₂, Advertiser System 0100 can search through Transaction Database 1452 for any Specific Transaction Record or Customer Database 1454 for any existing record with a date/time stamp for the purchase of a Product during such time period which has the same Existing Unique ID Code as an Existing Unique ID Code associated with an Ad Data Code 0200 with a date/time stamp for the viewing of an Advertisement promoting such Product during such time period.

In step 5228, Advertiser System 0100 can generate a list of records with matching Existing Unique ID Codes as described in Step 5226. These matches can indicate that an user with an Existing Unique ID Code who viewed an Advertisement promoting a Product purchased such Product.

In step 5230, Advertiser System 0100 can limit the matches to those purchases of such Product occurring after the transmission of such Advertisement by filtering the list of records with matching Existing Unique ID Codes to generate a list of records where a Specific Transaction Record 4920 occurs after the transmission of an Ad Data Code 0200.

In step 5232, Advertiser System 0100 can calculate the ROI of an Advertisement promoting a Product by calculating a ratio in a variety of means, including, but not limited to: (1) where: (a) the numerator equals the sum of: (i) Specific Transaction Records 4920 which record a purchase of such Product during the time period of interest; and (ii) existing records in Customer Database 1454 which record a purchase of such Product during the time period of interest; and (b) the denominator equals the sum of the number of Ad Data Codes 0200 associated with such Advertisement transmitted by Advertiser System 0100 during the time period of interest; (2) where (a) the numerator equals the sum of: (i) Specific Transaction Records 4920 which record a purchase of such Product during the time period of interest; and (ii) existing records in Customer Database 1454 which record a purchase of such Product during the time period of interest; and (b) the denominator equals the sum of the number of Ad Data Codes 0200 associated with such Advertisement transmitted by Advertiser System 0100 to a given type of Media Device 0110, Media Program, and/or Media Location during the time period of interest.

### 3.3.2 TRANSMISSION OF VICINITY DATA TO STB

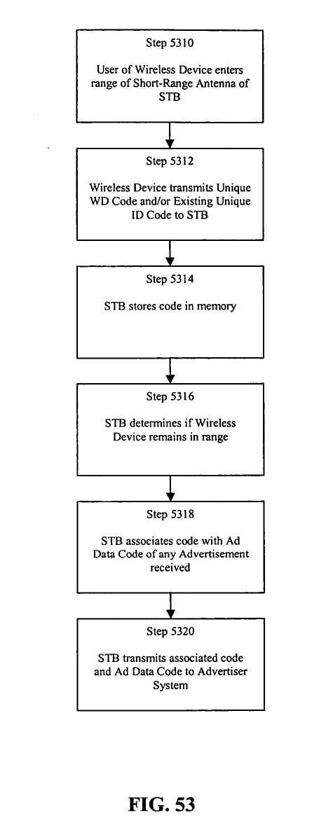

FIG. 53 depicts a flowchart 5300 of an exemplary method for a Wireless Device 0120 having an Unique ID Code and/or Existing Unique ID Code to transmit to a STB 0500 Wireless Device Vicinity Data, according to embodiments of the present invention. As long as STB 0500 is receiving WD Vicinity Data, an Advertiser can reasonably conclude that the user of Wireless Device 0120 is exposed to any Advertisement displayed by TV Display Device. The present invention can implement flowchart 5200 by executing a subset of the steps, executing the steps in different order, and/or executing other or additional related or equivalent steps.

In step 5310, an user of Wireless Device 0120 enters the vicinity of STB 0500, i.e., the range within which the Wireless Device 0120 can exchange data through one or more of its I-O Devices with any I-O Device of STB 0500.

In step 5312, Wireless Device 0120 can transmit its Unique WD Code and/or Existing Unique ID Code through a variety of means, including, but not limited to: (1) utilizing any Short-Range Antenna of the Wireless Device 0120 to transmit the signal to any Short-Range Antenna of STB 0500; and/or (2) utilizing any Port 0326 of the Wireless Device 0120 to transmit the signal to any Port 0556 of STB 0500.

In step 5314, STB 0500 can store the Unique WD Code and/or Existing Unique ID Code in Memory 0514.

In step 5316, STB 0500 can determine if Wireless Device 0120 remains within range of STB 0500 by utilizing the methods described in Step 4820.

In step 5318, when STB 0500 receives an Advertisement and its associated Ad Data Code 0200, STB 0500 can associate the Unique WD Code and/or Existing Unique ID Code with the Ad Data Code 0200 by utilizing the methods described in Step 4822. In another embodiment, STB 0500 can generate a date/time stamp for the Unique WD Code and/or Existing Unique ID Code and transmit the Unique WD Code and/or Existing Unique ID Code along with its date/time stamp to an Advertiser System 0100 directly or indirectly through a Third Party Server 0150, which can then compare the date/time stamp of the Unique WED Code and/or Existing Unique ID Code with a database of date/time stamps of any Advertisements transmitted by Advertiser System 0100.

In step 5320, STB 0500 can transmit the associated Unique WD Code and/or Existing Unique ID Code and Ad Data Code 0200 to an Advertiser System 0100 directly or indirectly through a Third Party Server 0150.

In an embodiment of flowchart 5300, an user of Wireless Device 0120 can utilize Wireless Device 0120 to control certain functions of STB 0500 (“WD Remote Control Device”) by utilizing methods any method readily apparent to any person with ordinary skill in the art. The device can perform a variety of functions, including, but not limited to: turning on or off TV Display Device and/or changing the channel of STB 0500. For example, when an user of Wireless Device 0120 utilizes the device to change the channel of STB 0500, Wireless Device 0120 can transmit to STB 0500 its Unique WED Code, Existing Unique ID Code, and/or WD Vicinity Data, which indicates to Advertiser System 0100 that Wireless Device 0120 remains within range of STB 0500 and that the user of Wireless Device 0120 is exposed to any Advertisement displayed on the TV Display Device. In addition, if an user of Wireless Device 0120 utilizes the device to mute the audio volume of STB 0500, an Advertiser System 0100 can reasonably assume that, although the Wireless Device 0120 may be in the vicinity of the TV Display Device, the user of Wireless Device 0120 is probably not viewing and evidently is not hearing an Advertisement. In the present embodiment, a computer program product in Wireless Device 0120 that controls certain functions of STB 0500 can at the time the user of WD Remote Control Device mutes the audio volume modify WD Vicinity Data to indicate that although the WD Remote Control Device is in the vicinity of the TV Display Device, the user of the device is not hearing an Advertisement. At the time the user of WD Remote Control Device turns off the mute function, the computer program product can modify WD Vicinity Data to indicate that the user can hear an Advertisement.

In another embodiment of the present invention, an Advertiser System 0100 can determine if a Wireless Device 0120, an user of Wireless Device 0120, an user of Television 0304, and/or a Target Customer is exposed to any Advertisement displayed on the TV Display Device by associating an Unique WD Code and/or Existing Unique ID Code with data residing on a source or retransmission point, e.g., a headend in a cable television system, and/or on STB 0500 that is generated and/or collected by a Television Operator or a Third Party collecting the data on behalf of the Television Operator (“TV Operator Viewing Data”). For example, cable operators can measure and record which channels any given STB 0500 is transmitting at any given time. The present invention can enable an Advertiser System 0100 and/or Television Operator to determine: (1) if a Wireless Device 0120 and/or an user of Wireless Device 0120 is exposed to any Advertisement displayed on the TV Display Device; and (2) if the Wireless Device 0120 and/or the user of Wireless Device 0120 responds to an Advertisement displayed on the TV Display Device. The present invention can enable the association of an Unique WD Code and/or Existing Unique ID Code with TV Operator Viewing Data by utilizing the systems, methods, apparatuses, and/or computer program products described throughout the present application.

### 3.3.3 ASSOCIATION OF UNIQUE CODE WITH PAYMENT INFORMATION

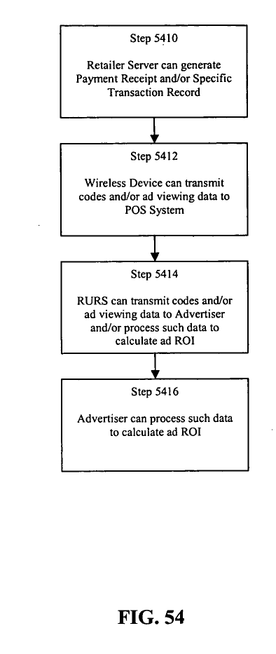

FIG. 54 depicts a flowchart 5400 of a method for associating an unique code with payment information, according to embodiments of the present invention. Flowchart 5400 is described with continued reference to the systems of FIGS. 14, 44, 49, and 51. However, flowchart 5400 is not limited to those embodiments. The present invention can implement flowchart 5400 by executing a subset of the steps, executing the steps in different order, and/or executing other or additional related or equivalent steps.

At Step 5410, Control Unit 1442 or any other device in Retailer Server 0140 can generate Payment Receipt 1900, in particular, and/or Specific Transaction Record, in general, from data in one or more databases, including, but not limited to: PLU Database 1450, Transaction Database 1452, Customer Database 1454, and/or Other Database 4412.

At Step 5412, Wireless Device 0120 can transmit any Unique WD Code 4910, Existing Unique ID Code 5110, Ad Data Code 0200, and/or Ad Data File 0734 to Code Reader 0132, Payment Device 0134, and/or any other I-O Device of POS System 0130, which can transmit Unique WD Code 4910, Existing Unique ID Code 5110, Ad Data Code 0200 and/or Ad Data File 0734 to RURS 1460 and/or Control Unit 1442.

At Step 5414, Control Unit 1410, Control Unit 1442, and/or any other device in Retailer Server 0140 can transmit Specific Transaction Record to RURS 1460, which can transmit Specific Transaction Record, Unique WD Code 4910, Existing Unique ID Code 5110, Ad Data Code 0200, and/or Ad Data File 0734 through Network 1470 to Advertiser System 0100 directly or indirectly through Third Party Server 0150. In another embodiment, the present method can modify and/or add functionality to Control Unit 1410 and/or Control Unit 1442 to enable such Unit(s) to transmit Specific Transaction Record, Unique WD Code 4910, Existing Unique ID Code 5110, Ad Data Code 0200, and/or Ad Data File 0734 through Network 1470 to Advertiser System 0100 directly or indirectly through Third Party Server 0150. In another embodiment, RURS 1460 can execute one or more instructions, including, but not limited to: (1) search through Specific Transaction Record, Transaction Database 1452, Customer Database 1454, Other Database 4412, or any other database at POS System 0130, Retailer Server 0140, and/or any other server containing such data for the unique code, e.g., UPC/EAN/GTIN, identifying any Product purchased by user of Wireless Device 0120; (2) search through any Ad Data Code 0200 and/or Ad Data File 0734 received from Wireless Device 0120 for such unique code of any Product purchased by user of Wireless Device 0120; (3) match data, e.g., UPC/EAN/GTIN or name of Product, in any file containing data on the Advertisements viewed by such user and any file containing data on the Products purchased by such user; (4) write any matching data to Matching Event File 0742; and/or (5) transmit Matching Event File 0742 to Advertiser System 0100 directly or indirectly through Third Party Server 0150. In another embodiment, the present method can modify and/or add functionality to Control Unit 1410 and/or Control Unit 1442 to enable such Unit(s) to associate the Unique WD Code 4910 and/or the Existing Unique ID Code 5110 of Wireless Device 0120, the user of Wireless Device 0120, and/or the Target Customer with the Specific Transaction Record. Control Unit 1410 and/or Control Unit 1442 can then transmit the associated Unique WD Code 4910 and/or Existing Unique ID Code 5110 and Specific Transaction Record to Advertiser System 0100 directly or indirectly through Third Party Server 0150.

At Step 5416, Advertiser System 0100 and/or Third Party Server 0150 can search through Specific Transaction Record, Ad Data Code 0200, and/or Ad Data File 0734 to find matches between any Product purchased and any Product promoted in an Advertisement viewed by user of Wireless Device 0120.

### 3.3.4 ELECTRONIC COUPON REDEMPTION

In another embodiment, the present invention can enable a Retailer to transmit data to an Advertiser indicating an user of Wireless Device 0120 purchased a Product promoted in an Advertisement by redeeming Ad Data Code 0200, wherein such Code includes a Response Incentive, e.g., a coupon. While an Advertiser can calculate the ROI of a given coupon by measuring the number of coupons redeemed, the numerator of ROI, and the number of coupons distributed, the denominator of ROI, an Advertiser typically cannot calculate the ROI for any given Media Device 0110, Media Program, Media Location, and/or Media Operator 0104. For example, existing technology does not permit an Advertiser to distribute a coupon to a Television or Radio. Also, an Advertiser cannot easily calculate the ROI for a coupon in physical form distributed through a given Media Program, Media Location, and/or Media Operator 0104.

Existing POS software applications can enable a Retailer to redeem a coupon in either physical form or electronic form by utilizing methods well known to those with ordinary skill in the art. For an electronic coupon, POS System 0130 can process coupon redemption and typically transmit coupon redemption data, either individual transactions or summary of transactions, to an electronic clearing house (ECH) through Network 1470.

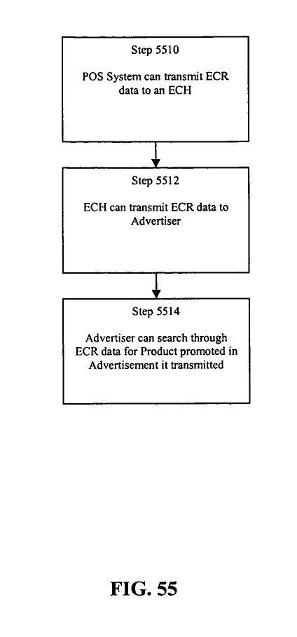

FIG. 55 depicts a flowchart of a method for redeeming an electronic coupon to enable the ROI calculation for a given Advertisement, according to embodiments of the invention. Note that the method depicted in FIG. 55 can be used with embodiments of the unique codes described in Section 3 or embodiments described in Section 2.

At Step 5510, POS System 0130 can transmit to an ECH through Network 1470 electronic coupon redemption (ECR) data for each individual transaction, which can include at least the following data: the unique code identifying the Product purchased, e.g., a UPC coupon code, and data uniquely identifying the Advertisement promoting such Product.

At Step 5512, ECH can transmit through Network 1470 such ECR data to Advertiser System 0100 directly or indirectly through Third Party Server 0150. In another embodiment, POS System 0130 in Step 5510 can transmit such ECR data to Advertiser System 0100 directly or indirectly through Third Party Server 0150.

At Step 5514, Advertiser System 0100 or Third Party Server 0150 can search through such ECR data for those transactions involving one or more Products promoted in an Advertisement transmitted by Advertiser System 0100, which transactions it can identify by matching: (1) the unique code identifying the Product purchased, e.g., a UPC coupon code, in any record of ECR data with (2) the unique code identifying the Product purchased, e.g., a UPC coupon code, in Advertiser System 0100 database of Advertisements transmitted.

### 3.3.5 ELECTRONIC RECEIPT CAPTURE AND/OR RETRIEVAL

In another embodiment, the present invention can enable a Retailer and/or a Third Party that operates an electronic receipt capture and/or retrieval (ERCR) system on behalf of any Retailer to transmit Payment Receipt 1900 to an Advertiser System 0100 directly or indirectly through Third Party Server 0150. Said ERCR operators can perform one or more functions, including, but not limited to: generating an electronic receipt, e.g., Payment Receipt 1900, at POS System 0130, transmitting such electronic receipt to a server located at or off the premises of any given Retailer, storing such electronic receipt, and/or enabling the retrieval of such electronic receipt. A Retailer can operate its own ERCR system, which can perform the same functions as those of such ERCR operators.

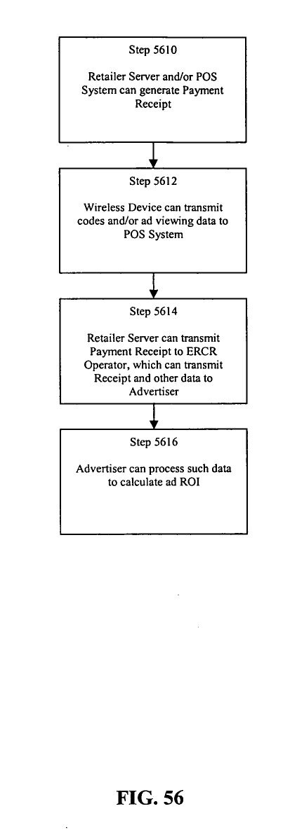

FIG. 56 depicts a flowchart 5600 of a method for electronic receipt capture and/or retrieval, according to embodiments of the present invention. Note that the method depicted in FIG. 56 can be used with embodiments of the unique codes described in Section 3 or embodiments described in Section 2.

At Step 5610, Control Unit 1442 or any other device in Retailer Server 0140 can generate Payment Receipt 1900 from data in one or more databases, including, but not limited to, PLU Database 1450, Transaction Database 1452, Customer Database 1454, and/or Other Database 4412.

At Step 5612, Wireless Device 0120.can transmit any Unique WD Code 4910, Existing Unique ID Code 5110, Ad Data Code 0200, and/or Ad Data File 0734 to Code Reader 0132 and/or Payment Device 0134, either of which can transmit such Unique WD Code 4910, Existing Unique ID Code 5110, Ad Data Code 0200, and/or Ad Data File 0734 to RURS 1460 and/or Control Unit 1442.

At Step 5614, Control Unit 1442 or any other device in Retailer Server 0140 can transmit Payment Receipt 1900 to ERCR operator, which can transmit Payment Receipt 1900 through Network 1470 to Advertiser System 0100 directly or indirectly through Third Party Server 0150. In another embodiment, the present method can modify and/or add functionality to Control Unit 1442 to enable such Unit to transmit Payment Receipt 1900, Unique WD Code 4910, Existing Unique ID Code 5110, Ad Data Code 0200, and/or Ad Data File 0734 through Network 1470 to ERCR operator, which can transmit such data to Advertiser System 0100 directly or indirectly through Third Party Server 0150. In another embodiment, Control Unit 1442 or any other device in Retailer Server 0140 of a Retailer which operates its own ERCR system can transmit Payment Receipt 1900, Unique WD Code 4910, Existing Unique ID Code 5110, Ad Data Code 0200, and/or Ad Data File 0734 to its ERCR server, which can transmit such data to Advertiser System 0100 directly or indirectly through Third Party Server 0150.

In all of the present embodiments of Method 5600, the present invention can before or after transmission to ERCR operator associate the Unique WD Code 4910 and/or Existing Unique ID Code 5110 with Payment Receipt 1900 through a variety of means, including, but not limited to: writing Unique WD Code 4910 and/or Existing Unique ID Code 5110 into a field in Payment Receipt 1900 and transmitting to Advertiser System 0100 directly or indirectly through Third Party Server 0150; and/or appending Unique WD Code 4910 and/or Existing Unique ID Code 5110 with Payment Receipt 1900 and transmitting the combined file to Advertiser System 0100 directly or indirectly through Third Party Server 0150.

At Step 5616, Advertiser System 0100 and/or Third Party Server 0150 can search through Payment Receipt 1900, Unique WD Code 4910, Existing Unique ID Code 5110, Ad Data Code 0200, and/or Ad Data File 0734 to find matches between any Product purchased and any Product promoted in an Advertisement viewed by user of Wireless Device 0120.

In another embodiment, the present invention can enable a Retailer and/or a Third Party that operates an ERCR system to transmit Payment Receipt 1900 directly to Wireless Device 0120, the user of Wireless Device 0120, the user of any Media Device 0110, and/or the Target Customer. Many consumers complain about the difficulty of collecting, organizing, and searching through paper-based receipts. It would be easier for consumers to collect, organize, and search through electronic receipts. It could cost a Retailer less money to print paper-based receipts, if more consumers are willing to receive only electronic receipts. Because many large Retailers already utilize ERCR systems, they have already incurred the costs of utilizing such systems. The only significant incremental cost for Retailers and/or ERCR operators to enable the present embodiment is to transmit Payment Receipt 1900 through wired, wireless, and/or a combination of wired and wireless networks to Wireless Device 0120, the user of Wireless Device 0120, the user of any Media Device 0110, and/or the Target Customer.

In the present embodiment, the present invention can utilize the same steps as Method 5600 except at Step 5614, ERCR Operator and/or Control Unit 1442 or any other device in Retailer Server 0140 of a Retailer which operates its own ERCR system can transmit Payment Receipt 1900, Unique WD Code 4910, Existing Unique ID Code 5110, Ad Data Code 0200, and/or Ad Data File 0734 directly to a Wireless Device 0120, any Media Device 0110, and/or the Target Customer.

### 3.3.6 SHOPPER LOYALTY

In another embodiment, the present invention can enable a Retailer and/or a Third Party that operates a system that collects and/or maintains shopper loyalty program data on behalf of such Retailer (“Third Party SLP Operator”) to transmit transaction data for a given user of Wireless Device 0120 and/or Target Customer to an Advertiser System 0100 directly or indirectly through Third Party Server 0150. A Retailer and/or Third Party SLP Operator can collect, maintain, and/or analyze data on a shopper loyalty program in a variety of databases, including, but not limited to: Transaction Database 1452, Customer Database 1454, and/or Other Database 4412. A Retailer and/or Third Party SLP Operator can transmit to an Advertiser System 0100 directly or indirectly through Third Party Server 0150 data from such databases, including, but not limited to: the name of an user of Wireless Device 0120, an user of any Media Device 0110, and/or Target Customer; the Existing Unique ID Code 5110, which in the present embodiment is the Shopper Loyalty ID Code, and the unique code of the Product(s), e.g., the UPC/EAN/GTIN, purchased by such user of Wireless Device 0120, user of any Media Device 0110, and/or Target Customer.

If a Retailer prefers to maintain the privacy of the user of Wireless Device 0120 and/or Target Customer and the transactions made by such user and/or consumer, the present invention can enable a Retailer to transmit the Shopper Loyalty ID Code and any data in the Specific Transaction Record which excludes any personally identifiable information. In another embodiment, the present invention can enable a Retailer and/or a Third Party SLP Operator to transmit the Shopper Loyalty ID Code and any data in the Specific Transaction Record for a given user of Wireless Device 0120 and/or Target Customer directly to Wireless Device 0120, the user of Wireless Device 0120, any Media Device 0110, the user of any Media Device 0110, and/or the Target Customer.

### 3.4 SUMMARY

The methods and systems can utilize a variety of means to identify an unique Wireless Device 0120, an user of Wireless Device 0120, an unique Media Device 0110, an user of any Media Device 0110, and/or a Target Customer and measuring if such Wireless Device 0120, user of Wireless Device 0120, and/or Target Customer viewed an Advertisement on any Media Device 0110 and responded to such Advertisement in any Retail Channel. The following table summarizes the type of data utilized by the present invention and the device on which such data is located.

| | | Location before Advertiser |
|---|---|---|
| | | and/or Third Party utilizes data |
| Type of Data | File/Data | to calculate ROI |
| Data uniquely describing an | Ad Data Code 0200 | Advertiser System 0100 |
| Advertisement | | Media Device 0110 |
| | | Wireless Device 0120 |
| | | POS System 0130 |
| | | Retailer Server 0140 |
| Data uniquely identifying a | Unique WD Code 4910 and/or | Media Device 0110 |
| Wireless Device 0120, an | Existing Unique ID Code 5110 | Wireless Device 0120 |
| user of Wireless Device | | POS System 0130 |
| 0120, a Media Device 0110, | | Retailer Server 0140 |
| an user of Media Device | | |
| 0110, and/or a Target | | |
| Customer | | |
| Data uniquely identifying a | Specific Transaction Record, | Advertiser System 0100 |
| purchase made by a Wireless | which can include Payment | Database Server 4410 |
| Device 0120, an user of | Receipt 1900 | Wireless Device 0120 |
| Wireless Device 0120, a | Existing record in Customer | Media Device 0110 |
| Media Device 0110, an user | Database | POS System 0130 |
| of Media Device 0110, | | Retailer Server 0140 |
| and/or a Target Customer | | |

The methods and systems can utilize a different Unique WD Code 4910 and/or Existing Unique ID Code 5110 at a Media Device 0110 and/or a Retailer. That is, the systems, methods, apparatuses, and computer program products in the present invention can still identify a unique Wireless Device 0120, an user of Wireless Device 0120, and/or a Target Customer as the device and/or consumer which views an Advertisement and responds to such Advertisement without utilizing the same Unique WD Code 4910 and/or Existing Unique ID Code 5110 at both such Media Device 0110 and/or such Retailer. As long as there exist a table associating the different Unique WD Code(s) 4910 and/or Existing Unique ID Code(s) 5110 and an Advertiser System 0100 and/or Third Party Server 0150 can access such table, the present invention can enable the utilization of different codes at any Media Device 0110 and/or Retailer. Said table can be located on any device, including, but not limited to: Advertiser System 0100, Third Party Server 0150, any Media Device 0110, a Wireless Device 0120, a POS System 0130, and/or a Retailer Server 0140.

For example, an user of Wireless Device 0120 can input a Check Unique ID Code into a first Media Device 0110, e.g., a Personal Computer 0308, Wireless Device 0120 can transmit an Unique WD Code into a second Media Device 0110, e.g., a Television 0304, and an user of Wireless Device 0120 can input a Shopper Loyalty ID Code into a POS System 0130. The present invention can still track if such unique user of Wireless Device 0120 viewed a first Advertisement on Personal Computer 0308, viewed a second Advertisement on Television 0304, and purchased a Product promoted in both the first Advertisement and second Advertisement at a Retailer with POS System 0130. By associating such Check Unique ID Code, such Unique WD Code, and such Shopper Loyalty ID Code in the above table, an Advertiser System 0100 or Third Party Server 0150 can identify Wireless Device 0120 as the unique device viewing such Advertisements and purchasing such Product.

### 4.0 DYNAMIC PRODUCTION OF ADVERTISEMENTS

Dynamic Advertising Production Method (DAPM) utilizes static and/or dynamic information about an user and/or feedback from the user to produce dynamically a unique Advertisement for the user or comparable users. The DAPM utilizes data collected by the MMCMS and/or URMS to help produce dynamically a unique Advertisement for the user or comparable users through the media channels.

The DAPM system and method enables an Advertiser to transmit an Initial Advertisement to users in a sample group and a Final Advertisement to each unique user. An Initial Advertisement is an Advertisement that is a combination of Advertisement elements selected by an Advertiser that reflects the static and dynamic information about an user. A Final Advertisement is an Advertisement that is a combination of Advertisement elements selected by an Advertiser that references the unique Static Information and Dynamic Information about an user and Feedback Information from the user or comparable users.

In another embodiment, the present system enables Advertiser System 0100 to transmit any number of versions of unique Advertisements to users in a sample group to gain the benefit of generating additional Feedback Information from users in a sample group. While additional Feedback Information would increase the probability of an Advertiser producing an Advertisement that can generate a desired response, the incremental benefit from each subsequent version of an Initial Advertisement will probably decline.

### 4.1 ARCHITECTURE

FIG. 57 depicts a block diagram of an exemplary system 5700 for producing dynamic advertising, according to embodiments of the present invention. System 5700 may include an Advertiser System 0100, Ad Element Database 5720, Wireless Operator Server 5740, and one or more Wireless Devices. As would be appreciated by a person with ordinary skill in the art, system 5700 may include additional elements not depicted in FIG. 57.

The DAPM can be administered by a variety of entities, including, but not limited to: a company providing access to the Internet or some other wide area network through a wireless connection, e.g., a wireless operator; a company providing access to the Internet or some other wide area network through a wired connection, e.g., an Internet service provider, a cable system operator, or a digital subscriber line operator; or a third-party that owns or leases the collection of hardware and software described in FIG. 57 and owns or leases wired and/or wireless connections to users and Advertisers.

Advertiser System 0100 is one or more Data Processing Systems configured to receive, store, and/or transmit one or more elements such as elements 5710, 5712, 5714, and 5716, constituting an Advertisement to Ad Element Database 5720. One or more Advertisers can operate Advertiser System 0100. In one embodiment, Advertiser System 0100 can be one or more Data Processing Systems having the capability to perform the functions described in Sections 2 and 3, as well as the functions described in Section 4. In another embodiment, Advertiser System 0100 can be one or more Data Processing Systems having the capability to perform the functions described in Sections 2 and 3 and Advertiser System 0100 can be a separate set of one or more Data Processing Systems having the capability to perform the functions described in Section 4.

Element 1 5710, Element 2 5712, Element 3 5714, and Element n 5716 are different components of an Advertisement that can promote a different feature of the Product, brand, and/or vendor advertised (“Element”). These Elements can include, but are not limited to, the Elements listed in Table 5800 in FIG. 58. Each Element can have different versions, i.e., different values or variations of the same Element (“Version”). For example, Element 1 5710 can promote price and Element 2 5712 can be a celebrity endorser of the Product advertised. Element 1 5710 can have several Versions, including a first Version that offers the Product at price P₁ and a second Version that offers the Product at price P₂. Element 2 5712 can have several Versions, including a first Version that utilizes Celebrity₁ to endorse the Product advertised and a second Version that utilizes Celebrity₂ to endorse the Product advertised. In another embodiment, an Element can be different Products, brands, and/or vendors of which an Advertiser wishes to test the effectiveness. For example, Element 1 5710 can promote different Products, where a first Version can offer Product₁ and a second Version can offer Product₂.

To enable the DAPM to measure how an user responds to Advertisements with different Elements and Versions of Elements, the present invention includes a method for coding the Elements and Versions. In the preferred embodiment, most or all Advertisers, either individually, through a formal group like an industry association, through an informal group, or through advertising agencies, can agree upon a standard set of codes identifying Elements and Versions. Table 5800 in FIG. 58 depicts one example of codes identifying Elements. Each Element can be assigned a unique code. In any Advertisement transmitted to Wireless Device 0120, an Advertiser can include in the field “Ad Elements” in Table 1000 a value corresponding to the code assigned to a given Element. For example, the Element focusing on celebrity endorsers can be assigned a code=08. Thus, the Advertiser transmitting any Advertisement that includes a celebrity endorser can include the code, 08, in the Ad Element field in Table 1000.

Table 1000 can include a field for “Element Version” to enable an Advertiser to include a value corresponding to the code assigned to a given Version of an Element. Each Version can be assigned a unique code. In any Advertisement transmitted to Wireless Device 0120, Advertiser System 0100 can include in the field “Element Version” a value corresponding to the code assigned to a given Version. For example, for the Element focusing on celebrity endorsers, Celebrity A can be assigned a code=01, Celebrity B can be assigned a code=02, Celebrity C can be assigned a code=03, etc. Thus, an Advertiser transmitting any Advertisement that includes Celebrity C can include the code, 03, in the Element Version field in Table 1000.

In another embodiment, each Advertiser could assign its own code for each different Element and Version. To enable URMS 0350 to identify the Element and Version, the Advertiser could supply each Wireless Device 0120 a table associating its codes with the codes of other Advertisers utilizing Elements and Versions in their Advertisements.

Ad Element Database is configured to perform a variety of functions, including, but not limited to, storing Element 1 5710, Element 2, 5712, Element 3 5714, and Element n 5716, applying algorithms to select a combination of Elements that constitute an Advertisement; and/or transmitting to Wireless Operator Server 5740 Initial Advertisement 5742, Initial Advertisement 5744, Final Advertisement 1 5770, Final Advertisement 2 5772, Final Advertisement 3 5774, and Final Advertisement 4 5776. Ad Element Database 5720 can be administered by any entity, including, but not limited to an Advertiser, a wireless operator, and/or a Third Party. Ad Element Database 5720 receives Elements 1-n from Advertiser System 0100 and Feedback Information 5760, Dynamic Information 5732, and Static Information 5730 from one or more Wireless Devices.

Wireless Operator Server 5740 is one or more Data Processing Systems configured to perform a variety of functions, including, but not limited to: storing Element 1 5710, Element 2, 5712, Element 3 5714, and Element n 5716; applying algorithms to select a combination of Elements that constitute an Advertisement; receiving from Ad Element Database 5720 the Elements; receiving from Ad Element Database 5720 Initial Advertisement 5742, Initial Advertisement 5744, Final Advertisement 1 5770, Final Advertisement 2 5772, Final Advertisement 3 5774, and Final Advertisement 4 5776; transmitting Initial Advertisement 1 5742, Initial Advertisement n 5744, and any other versions of Initial Advertisement to Wireless Device 5750, Wireless Device 5752, Wireless Device 5754, and Wireless Device 5756; and/or transmitting Final Advertisement 1 5770, Final Advertisement 2 5772, Final Advertisement 3 5774, and Final Advertisement 4 5776 to Wireless Device 5780, Wireless Device 5782, Wireless Device 5784, and Wireless Device 5786, respectively. Wireless Operator Server 5740 can be administered by a wireless operator, an Advertiser, and/or a Third Party.

n another embodiment, an Advertiser System 0100 and/or a Third Party Server 0150 can perform one or more of the functions of Wireless Operator Server 5740. If a Wireless Device 0120 can transmit and/or receive data through a network, e.g., the Internet, an Advertiser System 0100 and/or a Third Party Server 0150 can transmit one or more Initial Advertisements directly to Wireless Devices 5750-5756, transmit one or more Final Advertisements directly to Wireless Devices 5780-5786, receive Static Info 5730 directly from such Wireless Devices, and/or receive Dynamic Info 5732 directly from such Wireless Devices.

In one embodiment, the DAPM system can utilize Static Information, Dynamic Information, and Feedback Information to produce an Advertisement for transmission to each user of a Wireless Device.

In another embodiment, the DAPM can utilize just the Static Information of a given user of a Wireless Device to produce an Advertisement for transmission to the user. For example, for certain Products aimed at one gender or one age group, knowing just the gender or age of the user can increase the probability that an Advertisement transmitted to users of the gender or age group will generate a desired user response.

In another embodiment, the DAPM can utilize just the Dynamic Information of a given user of a Wireless Device to produce an Advertisement for transmission to the user. In another embodiment, the DAPM can utilize just the Feedback Information to an Initial Advertisement of a given user of a Wireless Device to produce another version of an Advertisement for transmission to the user.

In another embodiment, the DAPM can utilize just the Static Information and Dynamic Information of a given user of a Wireless Device to produce an Advertisement for transmission to the user. In another embodiment, the DAPM can utilize the Static Information of a given user and Feedback Information from the user to produce an Advertisement for transmission to the user. In another embodiment, the DAPM can utilize the Dynamic Information of a given user and Feedback Information from the user to produce an Advertisement for transmission to the user. The present application describes in further detail below Static Information, Dynamic Information, and Feedback Information.

The historical user advertisement preference (HUAP) Database can include data recording the responsiveness of a given user to and preferences of the user for different Advertisements, Elements, combinations of Elements, and Versions of Elements. These preferences can include preferences of a given user for different Versions of a given Element. FIG. 59 shows an embodiment of a table of how a given user responds to different Versions of a single Element, in this case, different celebrity endorsers. As discussed earlier, Table 5900 shows an example of which celebrity endorser appears to generate the most desired response from a given user. In this example, an Advertiser reviewing this data can reasonably conclude that an Advertisement to the user utilizing Endorser B, instead of Endorser A or Endorser C, will generate a more desirable response.

The DAPM can generate the data in Table 5900 in a variety of ways, including, but not limited to, the following means: (a) DAPM can create Table 5900 listing Variables 1−n number of columns listing all the different Versions of celebrity endorsers found in a search of Ad Data File 0734 in Wireless Device 0120; (b) DAPM searches through Ad Data File 0734 in Wireless Device 0120 to find any Advertisements with an Element focusing on celebrity endorsers; in this example, the Element has a code of “08”; (c) DAPM reads the number of all Advertisements with Element=08 and assigns the number of Advertisements with each Version to the appropriate Version column; in this example, a given user could receive 10 Advertisements with Celebrity Endorser A, 9 Advertisements with Celebrity Endorser B, and 14 Advertisements with Celebrity Endorser C; and (d) for the Advertisements, DAPM reads the user responses in Ad Response File 0738 and assigns their respective values to the fields for each of Variables 1−n.

The data in Table 5900 can be one data item that is included in Static Information 5730 or Static Information 6930 for incorporation or insertion into the production of an Initial Advertisement or Final Advertisement.

The preferences may also include preferences of a given user for different Elements. FIG. 58 depicts an embodiment of a table of which Elements appear to generate the most desired response from a given user. In this example, Column 2 describes each Element, Column 3 lists the weight that a given user through his or her responses to Advertisements has implicitly attached to the Element, and Columns 4, 5, and 6 represent the order of preference a given user has for variations of the Element.

The DAPM can generate the data in Table 5800 in a variety of ways. For example, the DAPM can create Table 5800 listing in Column 1 all Elements found through a search of Ad Data File 0734 in Wireless Device 5780. In addition or alternatively, the DAPM creates Column 2, which describes in text form the Element associated with each code identifying a given Element.

In addition or alternatively, the DAPM creates Column 3, which assigns the weight associated with each Element as determined in a variety of means, including, but not limited to, the following method. DAPM searches through Ad Data File 0734 for all Advertisements associated with a given Element; (ii) URMA Module 0744 searches through Ad Response File 0738 and/or Payment Data File 0740 to generate an average User Response Score for the Advertisements; (iii) URMA Module 0744 generates an average ROI for the Advertisements; (iii) DAPM follows the same process for generating an average ROI for other Elements; (iv) DAPM ranks all Elements in terms of their associated ROI; and/or (v) DAPM ascribes a weight in proportion to the difference in ROI among the different Elements. For example, if Advertisements with Element 03 in Table 5800 generate an average User Response Score of 10 and Advertisements with Element 02 generate an average User Response Score of 5, DAPM would ascribe a weight for Element 03 twice as high as the weight for Element 02.

In addition or alternatively, the DAPM creates Column 4 through n, which lists the preferences of a given user for a specific Version for each Element. For example, for the field Ad Element 08, which focuses on celebrity endorsers, the DAPM can list which celebrity endorsers ranked most highly in the responses by user.

The data in Table 5800 can be one data item that is included in Static Information 5730 or Static Information 6930 for incorporation or insertion into the production of an Initial Advertisement or Final Advertisement.

In one embodiment, Advertiser System 0100 can use the data in HUAP Database as Static Information for producing an Advertisement through the DAPM. In another embodiment, Advertiser System 0100 can use the data in HUAP Database as information to use in producing an Advertisement without using the DAPM. For example, an Advertiser can subscribe to a service providing access to the data in HUAP Database for producing Advertisements that do not utilize the DAPM.

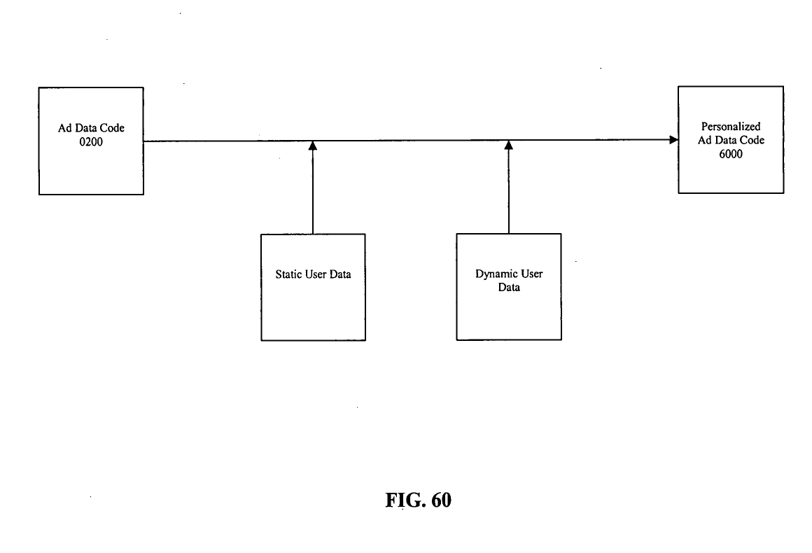

In a further embodiment, an Advertiser can use the static and/or dynamic information to convert a generic Ad Data Code 0200 into a specific Ad Data Code 0200 which reflects the unique characteristics of the user of the Wireless Device 0120. FIG. 60 depicts an exemplary process for converting a generic Ad Data Code 0200 into an user specific Ad Data Code 6000, according to embodiments of the present invention.

### 4.1.1 STATIC INFORMATION

Static Information 5730 is the Static Information associated with a Wireless Device 0120, such as Wireless Device 5750. Static Information includes any type of information related to an user's ability and willingness to receive, view, hear, and/or interpret an Advertisement that does not change over a time period shorter than the duration of the transmission of an Advertisement. Each user with a Wireless Device has his/her unique Static Information. Static Information can be information related to an user's ability and willingness to receive, view, hear, and/or interpret an Advertisement that does not change over a time period shorter than the duration of the transmission of an Advertisement. Static Information may include demographic information about an user, personal information about an user, information about the Wireless Device, and/or information about the preferences of the user regarding Advertisements.

Static Information may include demographic information about an user. Demographic information may include, among other information, gender, age, income, education, occupation, marital status, children, home ownership, and/or other types of demographic characteristics. For example, if an Advertiser knew that an user is a female, the Advertiser might transmit an Advertisement promoting Products used by women. In another example, an Advertiser knew that an user owned a home, it might transmit an Advertisement promoting home improvement Products.

Static Information may also include personal information about an user provided by the user and/or obtained from third-party sources. The personal information may include, among other types of information, language (data which Advertiser System 0100 could use to determine which language an Advertisement to the user should utilize), height, weight, body measurements (which can be utilized by vendors, including, but not limited to, apparel vendors), hair color, and skin complexion, other personal characteristics, and/or psychographic characteristics (e.g., premium on convenience).

Personal information may also include Product preferences. The HUPP Database can include data on the Product preferences of the user. Advertiser System 0100, URMS 0350, or a Third Party Server 0150 can search through the database to determine what type of Products the user likes and/or does not like. HUPP Database can include data read and/or stored by Payment Code Module 0730 from payment systems, tickets, and content/applications utilized, purchased, downloaded, or accessed by Wireless Device 0120 user.

Personal information may also include dietary preferences. The HUPP Database can include data on the dietary preferences of the user. Advertiser System 0100, URMS 0350, or a Third Party Server 0150 can search through the database or other information provided by the user to determine what type of food the user likes and/or does not like. An Advertiser, including, but not limited to, vendors of food Products, retailers of food Products, and/or restaurants, would value such data, because it can help determine whether they transmit an Advertisement of a food Product to the user. For example, if an Advertiser knew that an user is a vegetarian, vendors of meat Products, retailers that sell meat Products, and/or restaurants that serve meat Products, can decide not to transmit an Advertisement promoting their meat Products.

Personal information may also include past user purchase of Product advertised. Advertiser System 0100, URMS 0350, or a Third Party Server 0150 can search through the HUPP database to determine whether the user had purchased the Product advertised. An Advertiser should value such information because it could produce one Advertisement to an user who has not tried its Product and another Advertisement to an user who is already a regular customer of its Product. For example, a new user might be more receptive to an Advertisement that focused on the benefits of the Product, while an existing user might already be convinced about the Product benefits and be more receptive to an Advertisement that focused on the price or location of where the user can buy the Product.

Static Information may include information about Wireless Device that could affect downloading and viewing of an Advertisement. This information may include the Wireless Device screen size, Wireless Device screen resolution (in dpi), Wireless Device sound capabilities (e.g., monophonic, polyphonic, and/or rich audio), and/or other information about Wireless Device that could affect downloading and viewing of an Advertisement.

Static Information may also include information about the preferences of user regarding Advertisements. This information reflects the historical responses of the user to prior Advertisements (“Historical User Ad Preferences”). In particular, this information reflects which Elements were most effective in generating a desired response by an Advertiser. The present application describes in a later section how any person skilled in the art can make and use a system or method of producing Historical User Ad Preferences.

### 4.1.2 DYNAMIC INFORMATION

Dynamic Information 5732 is the Dynamic Information associated with Wireless Device 5750. Dynamic Information can include any type of information related to an user's ability and willingness to receive, view, hear, and/or interpret an Advertisement that can change over a time period shorter than the duration of the transmission of an Advertisement. Each user with a Wireless Device has his/her unique Dynamic Information. Dynamic information can be information related to an user's ability to receive, view, hear, and/or interpret an Advertisement that can change over a time period shorter than the duration of the transmission of an Advertisement. Dynamic Information can include, but is not limited to information about an user, information about user activity on Wireless Device 0120 at any given time, and/or information about Wireless Device 0120 that could affect downloading and viewing and/or hearing and Advertisement.

Information about an user may include time of day, day of week, day of year, and/or velocity of vehicle in which an user is traveling. The information may also include the location of user. When user is at or near home. Advertiser System 0100 can transmit an Advertisement that promotes awareness, trial, and/or usage. When an user is traveling away from home, Advertiser System 0100 can transmit an Advertisement that promotes awareness, but not trial or usage if a Retailer is not present at visited location. For example, if an user lives in Los Angeles but is traveling to New York, an LA-based Retailer could send an awareness message, but not an offer message.

Information about an user may also include weather in immediate area. The DAPM can link information about user location to third-party database on local weather conditions. For example, rainy weather could make an user more receptive to an Advertisement for raincoats, while sunny and hot weather could make an user more receptive to an Advertisement for suntan lotion.

Information about an user may also include information about events in the immediate area. The DAPM can link information about user location to third-party database on local events. For example, an user at a baseball game could be more receptive to an Advertisement for baseball Products. An user at a concert could be more receptive to an Advertisement for music Products.

Information about an user may also include the distance traveled by user. If an user travels long distance and time is evening, the user could be more receptive to an Advertisement for hotel/motel services and the DAPM could link user to third-party database of local hotels and motels. The information may also include fuel tank inventory of vehicle. If gasoline level is low, an user could be more receptive to an Advertisement for gasoline service stations and the DAPM could link user to third-party database of local gasoline service stations.

Dynamic Information about user activity on Wireless Device 0120 may include content from third-party sources an user is viewing and/or hearing such as a video program, an audio program, a web page, and/or a game and/or content from sources generated by an user which an user is viewing and/or hearing including, but not limited to an email, music, and/or a photo.

User activity information may also include activity by an user including purchasing and/or financial activity at an ATM. If an user is buying a Product, Advertiser System 0100 can transmit a promotion of related Product. For example, if an user buys digital camera, Advertiser System 0100 can transmit a promotion for digital photo printer. If an user is withdrawing funds at ATM or transferring funds from ATM to Wireless Device 0120, Advertiser System 0100 can transmit a promotion for financial services.

Dynamic Information may also include information about Wireless Device 0120 that could affect downloading and viewing and/or hearing of Advertisement. The information may include the degree of light (sunlight or artificial) in the immediate area of Wireless Device 0120, which could be detected and measured by a sensor device sensitive to different intensities of light. In the preferred embodiment, the sensor would be incorporated in the display of Wireless Device 0120, which could measure approximately the intensity of light absorbed by the display. In another embodiment, the sensor would be placed in a position or on a device on Wireless Device 0120 other than the display. If the sensor detects a low light level, Advertiser System 0100 can transmit an Advertisement with more or less visually rich images and emphasis on rich audio content. If the sensor detects a high light level, Advertiser System 0100 can transmit an Advertisement with more or less visually rich images and emphasis on rich audio content.

Information about a Wireless Device 0120 may also include degree of noise level in the immediate area of Wireless Device 0120, which could be detected and measured by a sensor device sensitive to different intensities of noise. In the preferred embodiment, the sensor would be incorporated in Microphone 0328, which could measure approximately the intensity of noise absorbed by Microphone 0328. In another embodiment, the sensor would be placed in a position or on a device on Wireless Device 0120 other than Microphone 0328. If the sensor detects a low noise level, Advertiser System 0100 can transmit an Advertisement with high sound volume and emphasis on rich audio content. If the sensor detects a high noise level, Advertiser System 0100 can transmit an Advertisement with low sound volume and emphasis on rich visual content.

Information about Wireless Device may also include the amount of Wireless Device 0120 battery power remaining. If a low battery power level is detected, Advertiser System 0100 can transmit an Advertisement that would consume less battery power, e.g., a text message, than an Advertisement that would consume more battery power, e.g., a video file.

Information about a Wireless Device 0120 may also include the quality of connection between Wireless Base Station 0302 and Wireless Device 0120. Wireless Base Station 0302 and/or Wireless Device 0120 can measure the quality of the connection using any index, including, but not limited to: signal-to-noise ratio. If the index indicates a low-quality connection, Advertiser System 0100 can delay the transmission of the Advertisement to avoid the risk of a dropped call or interrupted transmission and thus avoid any retransmission charges.

### 4.1.3 FEEDBACK INFORMATION

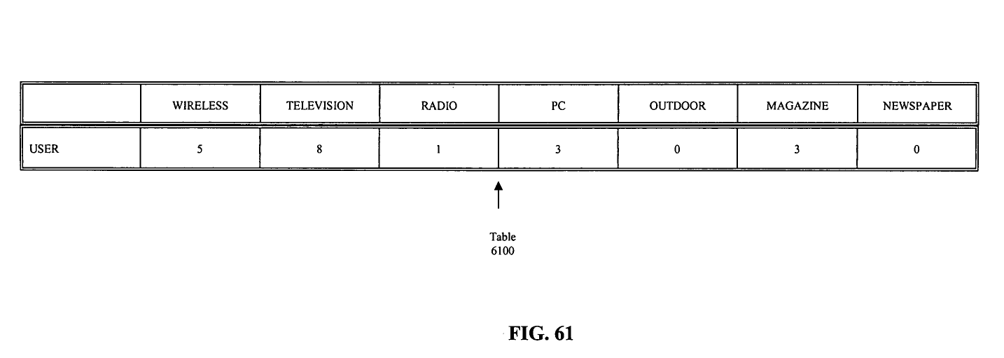

Feedback Information is information that reflects if, when, how, and/or to what degree an user responds to any kind of content, including an Advertisement, viewed by the user on Wireless Device 5750 in this example or on other Media Devices 0110 in other examples. Such responses can include, but are not limited to: the responses listed in Table 1200 in FIG. 12. Such responses can be measured by systems, methods, apparatuses, and/or computer program products including, but not limited to, the URMS 0350. Feedback Information 5760, Feedback Information 5790, Feedback Information 6960, and Feedback Information 6990 can include data, including, but not limited to: the number of Advertisements received listed in Table 6100 in FIG. 61, the responses listed in Table 1200 in FIG. 12, and/or the data in Ad Data File 0734, Ad Reception File 0736, Ad Response File 0738, Payment Data File 0740, and/or Matching Event File 0742.

The DAPM 5700 can use two types of feedback. The first, Feedback Information 5760, is communicated from the URMS 0350 of a Wireless Device to Ad Element Database 5720 via Wireless Base Station 0302 or any other wireless or wired network. The objective of obtaining the Feedback Information, in general, is to measure the behavior or reaction of an user to an Advertisement. Two different Advertisements promoting the same Product can produce two different reactions from any given user with Static Information and Dynamic Information. Obtaining Feedback Information can enable an Advertiser to determine: (a) which overall Advertisement is most effective in generating the desired user response; (b) which Elements are most effective in generating the desired user response; (c) which combination of Elements is most effective in generating the desired user response; and/or (d) which Version of any given Element is most effective in generating the desired user response. The objective of obtaining Feedback Information 5760, in particular, is to measure the behavior or reaction of an user to an Initial Advertisement and utilize the Feedback Information in order to produce a subsequent and/or final version of the Advertisement that is most likely to produce the behavior desired by an Advertiser.

The second, Feedback Information 5790, is communicated from the URMS of a Wireless Device to an Advertiser via Wireless Base Station 0302 or any other wireless or wired network. Feedback Information 5760 is Feedback Information generated from measuring the response to Initial Advertisement 1 5742 and Initial Advertisement n 5744 of users in a sample group, which in this example include: Wireless Device 5750, Wireless Device 5752, Wireless Device 5754, and Wireless Device 5756. The DAPM can select the sample group of users either by asking specific users to participate in a sample or transmitting Initial Advertisements to a group of users and utilizing their responses as the sample responses. In contrast, Feedback Information 5790 is Feedback Information generated from measuring the response to each Final Advertisement transmitted to each user, including in this example: Final Advertisement 1 5770, Final Advertisement 2 5772, Final Advertisement 3 5774, and Final Advertisement 4 5776 to Wireless Device 5780, Wireless Device 5782, Wireless Device 5784, and Wireless Device 5786, respectively. Each of the Final Advertisements is an unique Advertisement transmitted to each unique Wireless Device. That is, the DAPM can generate an unique combination of Advertisement Elements in a Final Advertisement that reflects: (a) the Static Information and Dynamic Information of a Wireless Device, whether or not the Wireless Device was a participant in the sample group of users receiving an Initial Advertisement; and/or (b) the Feedback Information 5760.

The objective of obtaining Feedback Information 5790 is not necessarily to measure the behavior or reaction of an user to an Initial Advertisement and utilize the Feedback Information in order to produce an improved version of an Initial Advertisement. The objective of obtaining Feedback Information 5790 is to measure the behavior or reaction of an user to a Final Advertisement to measure the overall effectiveness of the Final Advertisement. An Advertiser can utilize Feedback Information 5790 to help measure the ROI of the Final Advertisement along different dimensions, including, but not limited to: ROI of Advertisements promoting a unique Product, ROI of Advertisements promoting a unique brand, ROI of Advertisements distributed through a given Media Device 0110, ROI of Advertisements distributed through a given media channel, and/or ROI of all Advertisements by an Advertiser.

### 4.2 METHODS FOR DYNAMIC PRODUCTION OF ADVERTISEMENTS

### 4.2.1 OVERVIEW

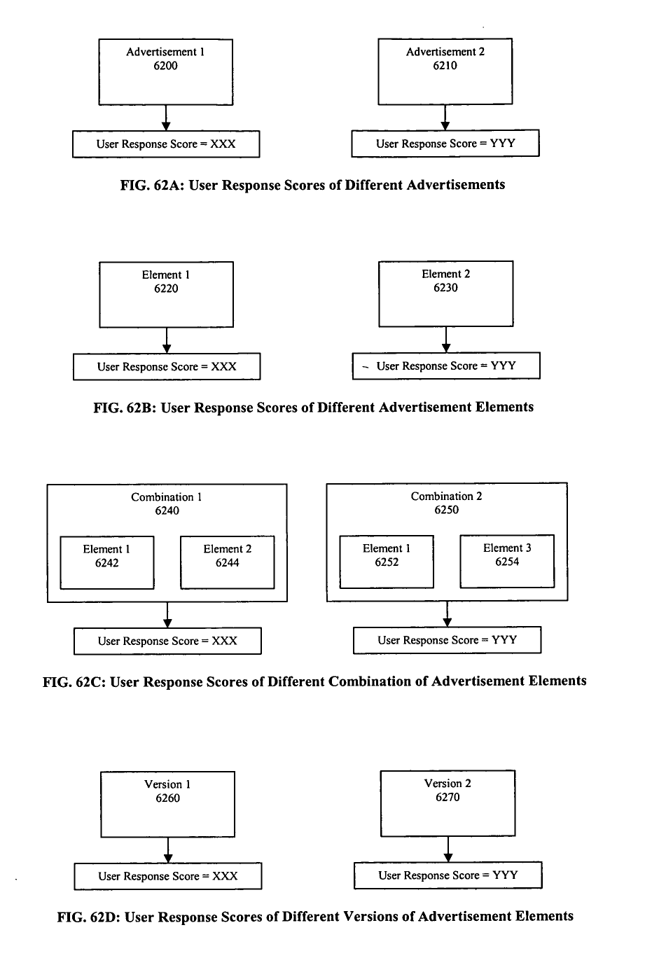

FIGS. 62A-D show examples of the generation of different User Response Scores based on characteristics of an Advertisement, according to embodiments of the present invention. FIG. 62A shows how two different overall Advertisements, Advertisement 1 6200 and Advertisement 2 6210, can generate two different User Response Scores in the preferred embodiment and alternative measures of user responses to Advertisements in alternative embodiments.

FIG. 62B shows how two different Elements in an Advertisement, Element 1 6220 and Element 2 6230, can generate two different User Response Scores in the preferred embodiment and alternative measures of user responses to Advertisements in alternative embodiments. For example, an Element focusing on describing Product benefits can generate a different User Response Score than an Element focusing on celebrity endorsements.

FIG. 62C shows how two different combinations of Elements, Combination 1 6240 and Combination 2 6250, can generate two different User Response Scores in the preferred embodiment and alternative measures of user responses to Advertisements in alternative embodiments. For example, Combination 1 6240 that contains Element 1 6242, which could focus on describing Product benefits, and Element 2 6244, which could focus on price, can generate a different User Response Score than Combination 2 6250 that contains Element 1 6252, which could focus on describing Product benefits, and Element 2 6254, which could focus on a celebrity endorsement.

FIG. 62D shows how two different Versions of an Element, Version 1 6260 and Version 2 6270, can generate two different User Response Scores in the preferred embodiment and alternative measures of user responses to Advertisements in alternative embodiments. For example, both Version 1 6260 and Version 2 6270 can focus on a celebrity endorsement, but Version 1 6260 could be an Advertisement with celebrity endorser 1 and Version 2 6270 could be the same Advertisement with celebrity endorser 2.

The DAPM can measure the effectiveness of different Elements by comparing the User Response Scores among the users in a sample group, which in FIG. 57 could include: Wireless Device 5750, Wireless Device 5752, Wireless Device 5754, Wireless Device 5756, and n number of Wireless Devices not pictured. In the DAPM, Advertiser System 0100 can transmit Initial Advertisement 5742 and Initial Advertisement 5744 that are similar in every respect except one: Initial Advertisement 5742 could include Element 1 5720 and Initial Advertisement 5744 could include Element 2 5730. If a sample group is large enough, a statistically significant difference in responsiveness among the group of Wireless Devices could enable an Advertiser to conclude that Advertisements featuring one Element are more effective than Advertisements featuring the other Element.

In another embodiment, the DAPM can measure the effectiveness of different Elements by comparing the User Response Scores of a given user over a large sample of Advertisements. Over time, a given user preferring Element 1 5720 over Element 2 5730 would probably respond to more Advertisements including Element 1 5720. For example, one user might be particularly swayed by Advertisements that focus on describing Product benefits and less persuaded by Advertisements utilizing celebrity endorsements. If a given user receives enough Advertisements that are similar in every respect except the different emphasis on Elements, a statistically significant difference in responsiveness between the Advertisements could enable an Advertiser to conclude that Advertisements featuring one Element are more effective than Advertisements featuring the other Element.

The present invention can generate more reliable data for Advertisers by enabling them to measure the preferences of users for different Elements passively, rather than actively. The DAPM does not require any explicit or overt action by the user to register the preference for any given Element. Requiring an user or group of users to select explicitly, overtly, or actively a given Element to determine user preference can introduce user bias into the measurement. In addition, by not requiring any overt action by the user to register the preference for any given Element, Advertisement, and Version of an Element, a system based on the DAPM can increase the size of the sample of users. A system that requires less effort of users to record preferences should attract more users to participate than a system requiring more effort of the users.

### 4.2.2 METHOD FOR PRODUCTION OF ADVERTISEMENT ELEMENTS

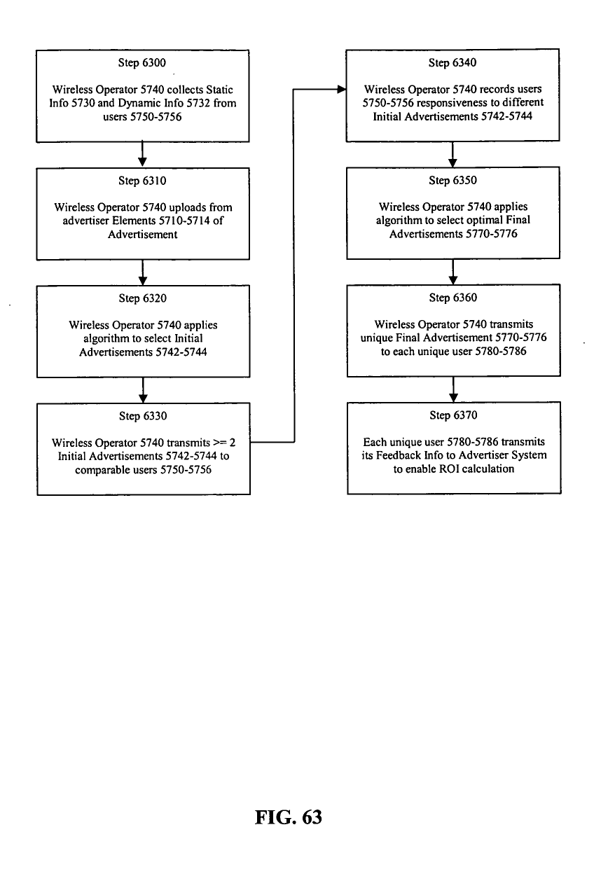

FIG. 63 depicts a flowchart 6300 of an exemplary method for the dynamic production of an Advertisement, according to embodiments of the present invention. Flowchart 6300 is described with continued reference to System 5700 of FIG. 57. However, flowchart 6300 is not limited to that embodiment. The present invention can implement flowchart 6300 by executing a subset of the steps, executing the steps in different order, and/or executing other or additional related or equivalent steps.

In step 6300, Advertiser System 0100 obtains Static Information 5730 and/or Dynamic Information 5732 for each Wireless Device in a sample group of users, which in this example are Wireless Device 5750, Wireless Device 5752, Wireless Device 5754, and/or Wireless Device 5756. The Static Information 5730 can be stored in Ad Element Database 5720, at each respective Wireless Device 5750-5756, and/or another location. The Dynamic Information 5732 can be transmitted by each respective Wireless Device 5750-5756 at or around the time Advertiser System 0100 transmits the Elements to Ad Element Database 5720.

In step 6310, Ad Element Database 5720 and/or Wireless Operator Server 5740 upload one or more elements of an Advertisement. As discussed above, an Advertiser System 0100 produces different Elements of an Advertisement, e.g., Element 1 5710, Element 2 5712, Element 3 5714, and Element n 5716, that it can incorporate into different Advertisements aimed at different users. Advertiser System 0100 transmits the Elements from Advertiser System 0100 to Ad Element Database 5720. In one embodiment, Ad Element Database 5720 transmits the Elements to Mobile Operator Server 5740. In another embodiment, Ad Element Database 5720 does not transmit the Elements to Wireless Operator Server 5740. For example, Ad Element Database 5720 can incorporate the Elements into different Advertisements and transmit such Advertisements directly to individual Wireless Devices, as discussed above in Section 4.1.

In step 6320, Wireless Operator Server 5740 selects or receives an Initial Advertisement. In an embodiment, Wireless Operator Server 5740 applies an algorithm to select two or more Initial Advertisements. In another embodiment, Wireless Operator Server 5740 receives two or more Initial Advertisements from Ad Element Database 5720.

In another embodiment, Ad Element Database 5720 applies an algorithm to select two or more Initial Advertisements. The algorithm may use as input the Static Information 5730 and/or Dynamic Information 5732 of one or more Wireless Devices in a sample group.

In step 6630, Wireless Operator Server 5740 transmits two or more Initial Advertisements, which comprise different combinations of Elements, to comparable user populations.

In step 6340, the Wireless Devices receiving one or more of the Initial Advertisements utilize their respective URMS 0350 to measure the responsiveness of each respective user to the Initial Advertisement it receives. Each respective Wireless Device transmits its Feedback Information 5760 to Ad Element Database 5720. Systems and methods for measuring the responsiveness of an user to an Advertisement are described above.

In step 6350, Wireless Operator Server 5740 selects or receives a Final Advertisement. In one embodiment, Wireless Operator Server 5740 applies an algorithm to select the Final Advertisement. In another embodiment, Wireless Operator Server 5740 receives a Final Advertisement from Ad Element Database 5720.

In another embodiment, Ad Element Database 5720 applies an algorithm to select the optimal Final Advertisement(s). Ad Element Database 5720 incorporates Static Information and/or Dynamic Information for each Wireless Device for an user and Feedback Information from a comparable user, i.e., a Wireless Device user with comparable Static Information and Dynamic Information, to select a Final Advertisement. For example, user of Wireless Device 5780, which was not a Wireless Device of sample group of users exposed to an Initial Advertisement, transmits its Static Information and Dynamic Information to Ad Element Database 5720. Ad Element Database 5720 searches its database for a Wireless Device in the sample group of users with comparable or similar Static Information and Dynamic Information. The DAPM assumes that two users with similar Static Information and Dynamic Information can have at least an approximately similar or comparable reaction to any given Advertisement.

The DAPM can apply an algorithm to select a combination of Elements constituting an Initial Advertisement or a Final Advertisement for a given user that increases the probability of generating a response from the user desired by an Advertiser. The algorithms selecting an Initial Advertisement and Final Advertisement can include, but are not limited to: a genetic algorithm, a simulated annealing algorithm, a particle swarm optimization algorithm, an ant colony optimization algorithm, a least squares optimization algorithm, any other algorithm, and/or algorithms operating in parallel.

In step 6360, Wireless Operator Server 5740 transmits the Final Advertisement to all Wireless Devices to which Advertiser System 0100 can transmit an Advertisement, including, but not limited to: Final Advertisement 1 5770, Final Advertisement 2 5772, Final Advertisement 3 5774, and Final Advertisement 4 5776 to Wireless Device 5780, Wireless Device 5782, Wireless Device 5784, and Wireless Device 5786, respectively.

In step 6370, the Wireless Devices receiving the Final Advertisements utilize their respective URMS 0350 to measure the responsiveness of each respective user to the Final Advertisement it receives. This measurement enables the Advertiser to measure the ROI of the Final Advertisement. Each respective Wireless Device can transmit its Feedback Information 5790 to Advertiser System 0100 through Wireless Base Station 0302 or any other wireless or wired network.

### 4.2.3 METHODS TESTING EFFECT OF INDEPENDENT VARIABLES

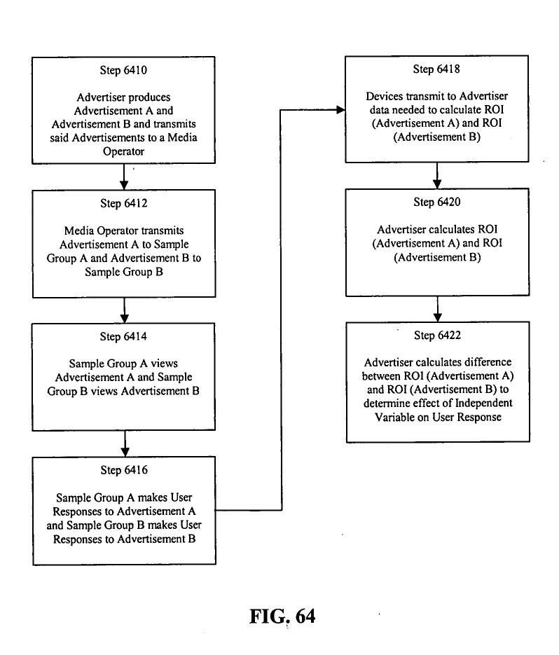

FIG. 64 is a flowchart 6400 illustrating an exemplary Method 6400 of enabling an Advertiser to measure the effect that one variable can have on the response of an user to an Advertisement, according to embodiments of the present invention. The present invention can implement flowchart 6400 by executing a subset of the steps, executing the steps in different order, and/or executing other or additional related or equivalent steps.

In step 6410, an Advertiser System 0100 produces two or more Advertisements which can include an Ad Data Code 0200 and transmits the Advertisements to a Media Operator 0104. In one embodiment, Advertiser System 0100 provides an economic incentive, e.g., a coupon, for the user to record the Code into his/her Wireless Device 0120 by including in the Code the basic UCC Coupon Code, the UCC/EAN 128 Coupon Extended Code, or the corresponding version for any given country/region. In another embodiment, Advertiser System 0100 produces Advertisements without any economic incentive for the user to record the Code into his/her Wireless Device 0120 and just transmits the Advertisements to a Media Operator 0104. In the preferred embodiment, Advertiser System 0100 produces two Advertisements—Advertisement A and Advertisement B—which have the same features in every respect except one feature, which is the variable whose effect on user response an Advertiser wants to measure (“Independent Variable”). The user response (“User Response”) can include any response by an user to viewing an Advertisement, including, but not limited to: any Intermediate Response, and/or a purchase of the Product promoted in the Advertisement. In another embodiment, Advertiser System 0100 can produce more than two Advertisements, which have the same features in every respect except the Independent Variable. The Independent Variable can be any feature whose effect on User Response an Advertiser wants to test.

For example, an independent variable may include different features of a given Advertisement, including, but not limited to: type of pricing promotions (e.g., Advertisement A offers a 25% discount and Advertisement B offers a “buy three, get one free” promotion), degree of Product benefit explanation (e.g., Advertisement A explains the Product benefits v. Advertisement B does not explain the Product benefits), Product endorsement (e.g., Advertisement A cites a scientific study v. Advertisement B cites a “man in the street” or a celebrity), degree of humor (e.g., Advertisement A is funny v. Advertisement B is serious), type of background music (e.g., Advertisement A uses popular background music v. Advertisement B uses classical background music), type of background color (e.g., Advertisement A uses a blue background v. Advertisement B uses a red background), degree of personalization (e.g., Advertisement A cites the name of the user v. Advertisement B does not cite the name of the user), or type of Product (e.g., Advertisement A promotes Product A v. Advertisement B promotes Product B).

In another example, an independent variable may include different versions of the same feature of a given Advertisement, i.e., for any given feature, the Independent Variable can be any version of the feature whose effect on User Response an Advertiser wants to test, which can include, but is not limited to: different versions of a given pricing promotion (e.g., Advertisement A offers a 10% price discount v. Advertisement B offers a 25% price discount), different versions of Product benefit explanation (e.g., Advertisement A cites the Product benefit of great taste v. Advertisement B cites the Product benefit of lower calories), different versions of a given Product endorsement feature (e.g., Advertisement A cites Celebrity A v. Advertisement B cites Celebrity B), different versions of humor (e.g., Advertisement A uses subtle humor v. Advertisement B uses overt humor), different versions of background music (e.g., Advertisement A uses classical background music written by composer A v. Advertisement B uses classical background music written by composer B), different versions of background color (e.g., Advertisement A uses a light blue background v. Advertisement B uses a dark blue background), or different versions of personalization (e.g., Advertisement A cites the name of the user v. Advertisement B uses a picture of the user).

In another example, an independent variable may be the focus of a given Advertisement on promoting the brand of a Product v. encouraging the immediate purchase of a Product. An Advertiser can test the effect on User Response of an Advertisement which focuses on promoting the Product brand v. an Advertisement which focuses on promoting the user purchase of the Product. For example, Advertisement A can include content explaining the Product benefit and exclude any content encouraging the immediate purchase of a Product, while Advertisement B can exclude content explaining the Product benefit and focus primarily on content encouraging the immediate purchase of a Product, e.g., a price discount if the user purchases the Product by a given deadline.

In another example, the independent variable may include different Media Device 0110, Media Program, or Media Location through which Advertiser System 0100 transmits an Advertisement. That is, an Advertiser can test the effect on User Response of an Advertisement transmitted to one Media Device 0110 v. another Media Device 0110, one Media Program v. another Media Program, or one Media Location v. another Media Location.

In step 6412, Media Operator 0104 transmits Advertisement A to a first group of users (“Sample Group A”) and Advertisement B to a second group of users (“Sample Group B”). To ensure that Sample Group A and Sample Group B are comparable, the present method can utilize statistical sampling methodology well known to those with ordinary skill in the art such that both sample groups are comparable and/or both sample groups represent the broader group of users targeted by an Advertiser within a level of statistical significance acceptable to the Advertiser. The users in Sample Group A and Sample Group B view Advertisement A and Advertisement B, respectively, at same or similar Media Location(s) at same or similar Media Program(s) on the same type of Media Device(s) 0110 during the same time period. That is, the users in Sample Group A and Sample Group B should view their respective Advertisements under conditions as similar as needed to ensure similar experiences.

In step 6414, the users in Sample Group A view Advertisement A and the users in Sample Group B view Advertisement B. The present method can measure if, when, and/or how users in Sample Group A and Sample Group B view Advertisement A and Advertisement B, respectively, with a computer program product on any device, including, but not limited to: URMS 0350 on Wireless Device 0120, URMS 0350 on Television 0304, or any other software with the capability to measure if, when, and/or how an user views an Advertisement similar to that of URMS 0350 on any other Media Device 0110 (collectively “User Ad Viewing Measurement Devices”). The present method can measure if, when, and/or how an user views an Advertisement utilizing any of the systems, methods, apparatuses, and/or computer program products described throughout the present invention and/or any other systems, methods, apparatuses, and/or computer program products not described in the present invention. Any of the devices can write data measuring user views of Advertisement A and Advertisement B to Ad Data File 0734.

In step 6416, the users in Sample Group A make User Responses to Advertisement A and the users in Sample Group B make User Responses to Advertisement B. The present method can passively measure if, when, and/or how users in Sample Group A and Sample Group B make User Responses to Advertisement A and Advertisement B, respectively, with a computer program product on any device, including, but not limited to: URMS 0350 on Wireless Device 0120, RURS 1460 on POS System 0130 and/or Retailer Server 0140, or any other software with the capability to measure if, when, and/or how an user makes User Responses to an Advertisement similar to that of URMS 0350 on any other device (collectively “User Response Measurement Devices”). That is, the Wireless Device does not ask an user to actively comment on his or her response to an Advertisement. The present invention passively measures responses to an Advertisement by observing the behavior of an user after the Advertisement is viewed. The method of FIG. 64 can measure User Response utilizing any of the systems, methods, apparatuses, and/or computer program products described throughout the present invention and/or any other systems, methods, apparatuses, and/or computer program products not described in the present invention. Any of the devices can write data measuring User Responses to Advertisement A and Advertisement B to Ad Response File 0738 and/or Payment Data File 0740.

In step 6418, any User Ad Viewing Measurement Devices transmit Ad Data File 0734 to Advertiser System 0100 and any User Response Measurement Devices transmit Ad Response File 0738 and/or Payment Data File 0740 to Advertiser System 0100. In another embodiment, any User Ad Viewing Measurement Devices transmit Ad Response File 0738 and/or Payment Data File 0740 to Advertiser System 0100. In another embodiment, any User Response Measurement Devices transmit Ad Data File 0734 to Advertiser System 0100. In another embodiment, any User Ad Viewing Measurement Devices and/or User Response Measurement Devices transmit Matching Event File 0742 to Advertiser System 0100. In another embodiment, any User Ad Viewing Measurement Devices and/or User Response Measurement Devices transmit Ad Data File 0734, Ad Response File 0738, Payment Data File 0740, and/or Matching Event File 0742 to Third Party Server 0150, which in turn transmits the files to Advertiser System 0100 or processes the data in the files for transmission to Advertiser System 0100. In another embodiment, User Ad Viewing Measurement Devices and/or User Response Measurement Devices can measure if an user views Advertisement A and/or Advertisement B and/or makes User Responses to Advertisement A and/or Advertisement B, respectively, through any other systems and/or methods, including, but not limited to: Method 4800, Method 5000, and/or Method 5200.

In step 6420, Advertiser System 0100 calculates the ROI of Advertisement A and the ROI of Advertisement B. In another embodiment, Third Party Server 0150 calculates ROI of Advertisement A and ROI of Advertisement B and transmits the ROI data to Advertiser System 0100. In another embodiment, User Ad Viewing Measurement Devices and/or User Response Measurement Devices calculate ROI of Advertisement A and ROI of Advertisement B and transmit the ROI data to Advertiser System 0100.

In step 6422, Advertiser System 0100 calculates the difference between ROI of Advertisement A and ROI of Advertisement B. In another embodiment, Third Party Server 0150 calculates the difference between ROI of Advertisement A and ROI of Advertisement B and transmits the data to Advertiser System 0100. Advertiser System 0100 can utilize statistical sampling methodology well known to those with ordinary skill in the art to determine if the difference in ROI due to the effect of the Independent Variable on User Response is statistically significant.

An Advertiser can apply Method 6400 to measure the effect of the Independent Variable on the User Response through a variety of methods. For example, an Advertiser may transmit Advertisement A to Sample Group A and Advertisement B to Sample Group B, where Advertisement A and Advertisement B were equal in every respect, Sample Group A and Sample Group B were statistically similar, and Advertisement A had a first value of the Independent Variable and Advertisement B had a second value of the Independent Variable. For example, if an Advertiser wanted to measure the effect that varying an Independent Variable, e.g., price discount, would have on the User Response, Advertisement Server 0100 could transmit Advertisement A, which offered a 10% price discount, to Sample Group A and Advertisement B, which offered a 20% price discount, to Sample Group B. Because Advertisement A and Advertisement B were equal in every respect except the Independent Variable and Sample Group A and Sample Group B were statistically similar, an Advertiser can attribute any difference in User Response to the difference in price discounts.

In another example, an Advertiser may transmit Advertisement A to Sample Group A and Advertisement A to Sample Group B, where Sample Group A and Sample Group B were statistically similar, and Sample Group A viewed Advertisement A on one set of Media Devices 0110, Media Programs, or Media Locations, and Sample Group B viewed Advertisement A on the same set of Media Devices 0110, Media Programs, or Media Locations, with the exception of one Media Device 0110, Media Program, or Media Location. For example, if an Advertiser wanted to measure the effect that varying an Independent Variable, e.g., Media Device 0110, would have on User Response, it could transmit Advertisement A to Sample Group A, which viewed Advertisement A on a Television and Wireless Device, and Advertisement A to Sample Group B, which viewed Advertisement A on a Television, Wireless Device, and Personal Computer. Because Sample Group A and Sample Group B viewed the same Advertisement A, Sample Group A and Sample Group B were statistically similar, and Sample Group A and Sample Group B viewed the Same Advertisement A on the same Media Devices 0110 except for the Personal Computer, an Advertiser can attribute any difference in User Response to Advertisement A viewed on a Personal Computer.

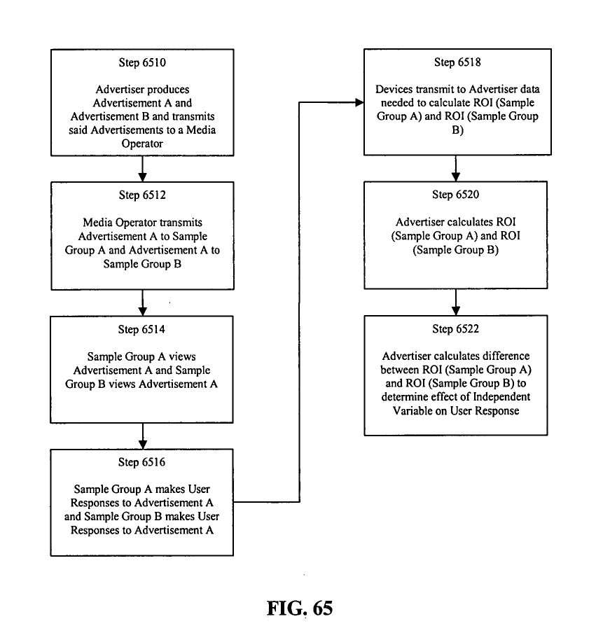

FIG. 65 depicts a flowchart of an exemplary Method 6500 for enabling an Advertiser System 0100 to measure the effect of viewing an Advertisement on different Media Devices 0110, Media Programs, or Media Locations, according to embodiments of present invention. The present invention can implement flowchart 6500 by executing a subset of the steps, executing the steps in different order, and/or executing other or additional related or equivalent steps.

In step 6510, Advertiser System 0100 produces one Advertisement A for transmission to a Media Operator 0104.

In step 6512, Media Operator 0104 transmits Advertisement A to Sample Group A and Advertisement A to Sample Group B. The users in Sample Group A and Sample Group B view Advertisement A on or at Media Location(s), Media Program(s), and Media Device(s) 0110, which are the same or similar in every respect except for the Independent Variable an Advertiser wants to measure. That is, if an Advertiser wants to measure the effect of viewing an Advertisement on a Personal Computer, the users in Sample Group A and Sample Group B would view Advertisement A on the same Media Location(s), Media Program(s), and the same set of Media Devices 0110, except Sample Group B would view Advertisement A on the Personal Computer, in addition to the same set of Media Devices 0110 viewed by Sample Group A.

In step 6514, the users in Sample Group A view Advertisement A and the users in Sample Group B view Advertisement A.

In step 6516, the users in Sample Group A make User Responses to Advertisement A and the users in Sample Group B make User Responses to Advertisement A.

In step 6518, any User Ad Viewing Measurement Devices transmit Ad Data File 0734 directly or indirectly to Advertiser System 0100 and any User Response Measurement Devices transmit Payment Data File 0740 directly or indirectly to Advertiser System 0100.

In step 6520, Advertiser System 0100 calculates the ROI of Advertisement A among Sample Group A and the ROI of Advertisement A among Sample Group B.

In step 6522, Advertiser System 0100 calculates the difference between the ROI of Advertisement A among Sample Group A and the ROI of Advertisement A among Sample Group B.

In another embodiment, an Advertiser can test the relative effect on user purchase of the Product from any marketing program, not just an Advertisement. That is, an Advertisement is just one means by which an Advertiser can influence an user to purchase a Product. An Advertiser can utilize a variety of means other than transmitting an Advertisement to user to encourage his/her purchase of a Product, including, but not limited to: public relations campaign, sales personnel actions, different pricing strategy, different Product Package, or different service offering. In the present embodiment, the Independent Variable can be one of the means, e.g., different Product Package. The present method can in Step 6412 transmit Advertisement A which has Product Package A to Sample Group A and Advertisement B which has Product Package B to Sample Group B. Advertisement A and Advertisement B have the same features in every respect, except for the different Product Package. At Step 6412, Advertiser System 0100 can utilize statistical sampling methodology well known to those with ordinary skill in the art to determine if the difference in ROI due to the different Product Package on User Response is statistically significant.

In another embodiment, an Advertiser can test the relative effect on ROI of any given Advertisement from any given Intermediate Response. That is, the present method can enable Advertiser System 0100 to estimate the relative contribution to the purchasing decision by an user of Wireless Device 0120 of one or more User Responses. Any purchasing decision of a given Product by an user is a result of a number of independent variables. For example, an Advertiser could value the contribution of any Independent Variable as follows:
Pᵢ=(w₁*Advertising Effectiveness)+(w₂*Product Benefit)+(w₃*Price)+(wᵢ* Other Independent Variable)+ . . . n

where Pᵢ=probability that users will purchase a given Product,
wᵢ=weight of any given Independent Variable, and
n=noise or random factors.

If the Advertiser concluded that Independent Variable (Advertising Effectiveness) contributes x% to Pᵢ, then the present method can enable the Advertiser to estimate the contribution of any Independent Variable, e.g., Independent Variable (Click-Through Advertisement) and Independent Variable (Sample Product), to Pᵢ (due to Advertising Effectiveness) as follows:
Pᵢ(Advertising Effectiveness)=(w₁*Click-Through Advertisement)+(w₂*Search for Product)+(w₃*Visit Retailer that Sells Product)+(w₄*Sample Product)+(wᵢ*Other Independent Variable)+ . . . n
where Pᵢ (Advertising Effectiveness)=probability that users will purchase a given Product due to Advertising Effectiveness,
wᵢ=weight of any given Independent Variable, and
n=noise or random factors.

The present invention can apply Method 6400 to test the relative effect of an Intermediate Response on the ROI of a given Advertisement.

In step 6410A, an Advertiser System 0100 produces one Advertisement which can include an Ad Data Code 0200 and transmits the Advertisement to a Media Operator 0104.

In step 6412A, Media Operator 0104 transmits the Advertisement to a Sample Group A.

In step 6414A, users in Sample Group A view the Advertisement. URMS 0350 on any User Ad Viewing Measurement Device measures if user views the Advertisement.

In step 6416A, users in Sample Group A make User Responses to Advertisement. URMS 0350 on any User Response Measurement Device measures if user responds to the Advertisement.

In step 6418A, any User Ad Viewing Measurement Devices transmit Ad Data File 0734 to Advertiser System 0100 and any User Response Measurement Devices transmit Payment Data File 0740 to Advertiser System 0100.

In step 6420A, Advertiser System 0100 calculates: (1) the number of users who responded to the Advertisement with a Click-Through Advertisement, e.g., an user who clicked an automobile Advertisement on a Personal Computer 0308 or Television 0304; and (2) of those users, the number of users who purchased the Product promoted in the Advertisement. The present method defines ROI (Click-Through)=(2)/(1).

In step 6422A, Advertiser System 0100 calculates: (1) the number of users who responded to the Advertisement with a Sample Product, e.g., an user who took a test drive of an automobile; and (2) of those users, the number of users who purchase the Product promoted in the Advertisement. The present method defines ROI (Sample)=(2)/(1).

In step 6424A, Advertiser System 0100 can compare ROI (Click-Through) against ROI (Sample). For example, if ROI (Click-Through) equals 10% and ROI (Sample) equals 40%, then Advertiser System 0100 can reasonably value an Advertisement that generates an User Response of a Click-Through of Advertisement as equal to 25% of the value of an Advertisement that generates an User Response of a Sample Product.

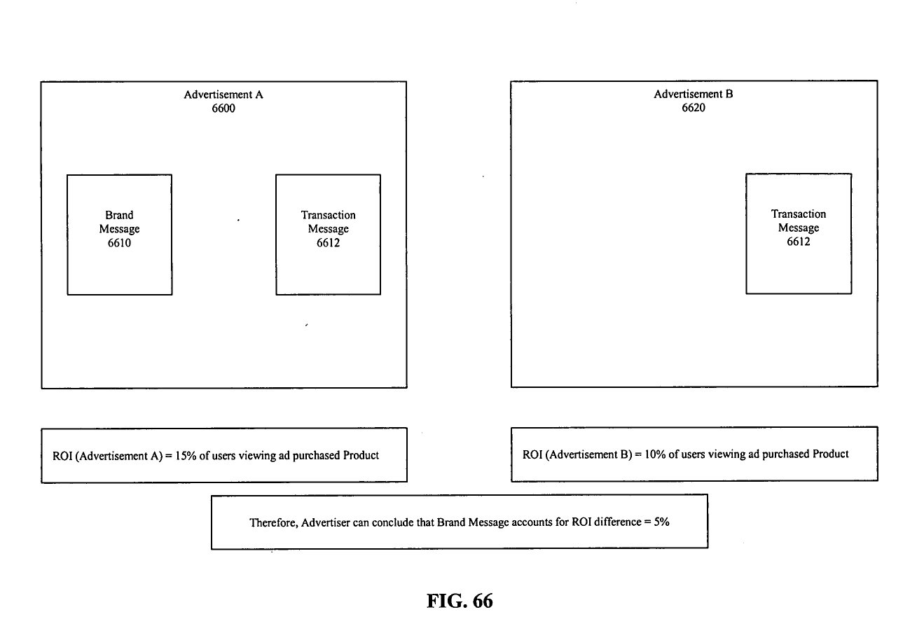

FIG. 66 shows a diagram comparing two Advertisements—Advertisement 6600 and Advertisement 6620—which have the same features in every respect except for the Independent Variable, which in the present example is Brand Message 6610, according to embodiments of the present invention. The present method can enable an Advertiser to measure the effect that Brand Message 6610 has on User Response by calculating the ROI of Advertisement 6600 transmitted to Sample Group A, calculating the ROI of Advertisement 6620 transmitted to Sample Group B, and measuring the difference in ROI. Because Advertisement 6600 and Advertisement 6620 have the same features in every respect except for the Independent Variable, Brand Message 6610, and assuming Advertiser System 0100 transmits Advertisement 6600 and Advertisement 6620 to two similar groups of users, an Advertiser can reasonably attribute the difference in ROI to Brand Message 6610. In Embodiment 6600:1, the present method can calculate the ROI of Advertisement 6600 among Sample Group A and Advertisement 6620 among Sample Group B at time t₁, which would enable an Advertiser to compare the effect of Brand Message 6610 on User Response at time t₁. However, an Advertiser might believe that an user must be exposed to Brand Message 6610 for some time period before the message can affect User Response. In another Embodiment 6600:2, the present method can calculate the ROI of Advertisement 6600 without Transaction Message 6612 at time t₁, among Sample Group A, calculate the ROI of Advertisement 6600 with Transaction Message 6612 at time t₂ among Sample Group A, calculate the ROI of Advertisement 6620 at time t₂ among Sample Group B, and measure the difference in ROI. In the present embodiment, Advertiser System 0100 can utilize statistical sampling methodology well known to those with ordinary skill in the art to determine if the difference in ROI due to the effect that Brand Message 6610 has on User Response over the period of time t₂−time t₁ is statistically significant. In another Embodiment 6600:3, the present method can calculate the ROI of Advertisement 6600 without Transaction Message 6612 among Sample Group A at time t₁, calculate the ROI of Advertisement 6620 among Sample Group B at time t₁, and measure the difference in ROI. While Embodiment 6600:3 would yield an ROI difference that is less reliable than Embodiment 6600:1 or Embodiment 6600:2, an Advertiser still might prefer Embodiment 6600:3 because it may cost less to test.

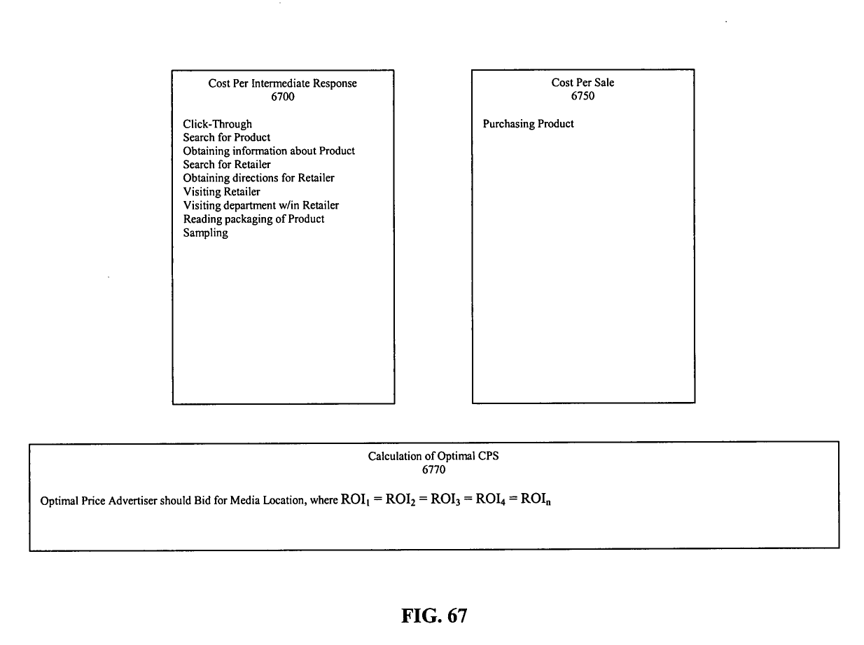

FIG. 67 depicts an exemplary method of calculating the optimal price an Advertiser should be willing to pay for a given Media Location, according to embodiments of the present invention.

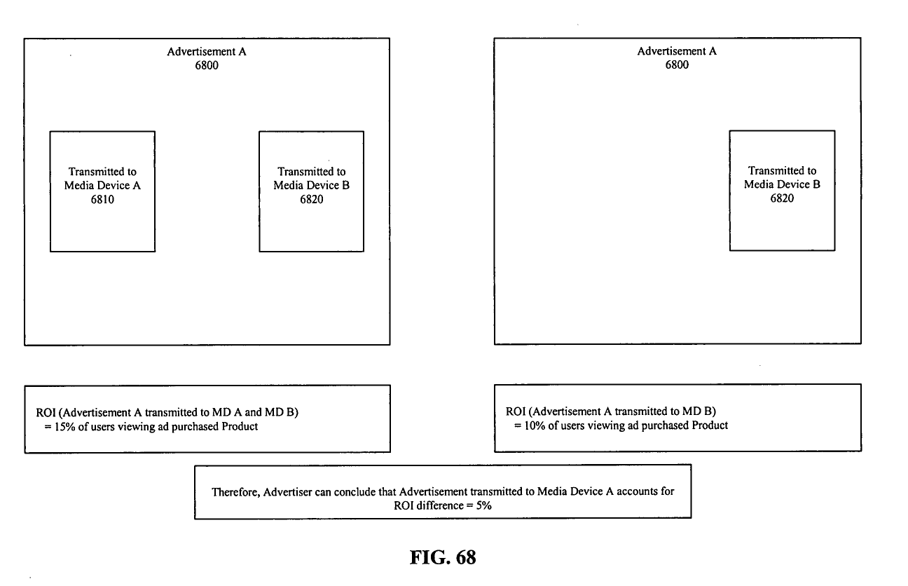

FIG. 68 shows a diagram comparing the transmission of the same Advertisement—Advertisement 6800—to Sample Group A and Sample Group B, each of which views the Advertisement through different Media Devices 0110, according to embodiment so the present invention. The present method can enable Advertiser System 0100 to measure the effect on User Response of transmitting Advertisement 6800 through Media Device A 6810 v. transmitting Advertisement 6800 through Media Device B 6820. In the preferred embodiment, the present method can calculate the ROI of Advertisement 6800 transmitted to Sample Group A viewing the Advertisement on both Media Device A 6810 and Media Device B 6820, calculate the ROI of Advertisement 6800 transmitted to Sample Group B viewing the Advertisement on Media Device B 6820, and measure the difference in ROI. Advertiser System 0100 can utilize statistical sampling methodology well known to those with ordinary skill in the art to determine if the difference in ROI due to Media Device A 6810 is statistically significant, because Sample Group A and Sample Group B view the same Advertisement 6800, Sample Group A and Sample Group B are statistically similar, and Sample Group A and Sample Group B view the same Advertisement 6800 on the same Media Devices except that Sample Group A viewed Advertisement 6800 on an additional Media Device A 6810. In another embodiment, the present method can calculate the ROI of Advertisement 6800 transmitted to Sample Group A viewing the Advertisement on Media Device A 6810, calculate the ROI of Advertisement 6800 transmitted to Sample Group B viewing the Advertisement on Media Device B 6820, and measure the difference in ROI.

### 4.2.4 EXAMPLE

FIG. 69 depicts an architecture of the DAPM in the case of producing one Advertisement for transmission to a Television 0304 or Personal Computer 0308, according to embodiments of the present invention. While FIG. 69 describes the DAPM in the case of producing an unique Advertisement for transmission to a Television 0304 or Personal Computer 0308, the present invention can apply the DAPM system, methods, apparatuses, and computer program products to any Media Device, including, but not limited to: Radio 0306, Outdoor Media Device 0310, Magazine or Newspaper 0312, Product Package 0314, and/or Other Wireless Device 0316. The DAPM for producing one Advertisement for transmission to Televisions or Personal Computers is similar to the DAPM for producing one Advertisement for transmission to Wireless Devices, except for the following key ways.

The DAPM can produce an unique Advertisement for transmission to a Television 0304, Personal Computer 0308, or any other Media Device 0110 viewed by a given user of Wireless Device 0120, as long as the user can transmit and/or receive Static Information, Dynamic Information, and/or Feedback Information with the Television 0304, Personal Computer 0308, or any other Media Device 0110. The user can transmit and/or receive such information through the MMCMS as illustrated in FIG. 4 and described in the specification associated with FIG. 4.

In the case of applying the DAPM to the transmission of an unique Advertisement to a Media Device 0110 rather than directly to a Wireless Device, Static Information 6930 can differ from Static Information 5730 and Dynamic Information 6932 can differ from Dynamic Information 5732. Static Information 6930 can incorporate Static Information about not only a Wireless Device 0120, but also the Media Device 0110 viewed by a given user of Wireless Device 0120. Dynamic Information 6932 can incorporate Dynamic Information about not only a Wireless Device 0120, but also the Media Device 0110 viewed by a given user of Wireless Device 0120. Feedback Information 6960 can incorporate Feedback Information from not only a Wireless Device 0120, but also the Media Device 0110 viewed by a given user of Wireless Device 0120.

For example, in FIG. 69, Advertiser System 0100 can retrieve Static Information 6930 and/or Dynamic Information 6932 from a given user of Wireless Device 5750, who is viewing Device 6950, which can be a Television 0304, Personal Computer 0308, or any other device. If the user can transmit and/or receive Static Information 6930 and/or Dynamic Information 6932 through any wired and/or wireless means, Advertiser System 0100 can retrieve the information to incorporate in the production of Initial Advertisement 1 6942 and Initial Advertisement n 6944 and then process the same steps as illustrated in FIG. 57 and described in the specification associated with FIG. 57.

Wireless Device 5750 can transmit Static Information 6930, Dynamic Information 6932, Feedback Information 6960, and/or any other communication to Device 6950 in a variety of ways, including, but not limited to, the following means: utilizing an Antenna utilizing Bluetooth or any other short-range wireless protocol; utilizing a Synchronization Device; utilizing an Infrared Device; and/or utilizing a RFID Device, including any RFID Device or other device that can support NFC or any comparable standard enabling short-range communication. All of these processes and devices for exchanging data between two devices are well known to those with ordinary skill in the art.

Wireless Device 5750 should establish a connection utilizing any of the above means with Device 6950 to exchange data between the devices. After establishing the connection, Wireless Device 5750 can transmit a message to Device 6950 indicating that Wireless Device 5750 user is viewing any content, e.g., an Advertisement, on Device 6950. Wireless Device 5750 can transmit Static Information 6930, Dynamic Information 6932, and/or Feedback Information 6960 to Device 6950 for storage and/or processing on a variety of devices, including, but not limited to: Device 6950, e.g., a STB of a Television 0304, Memory 0012 of a Personal Computer 0308, and/or Memory 0012 of any other device; TV Operator or Internet Server 6940; Ad Element Database 5720; Advertiser System 0100; and/or any Third-Party. Wireless Device 5750 user can terminate the connection with Device 6950 in a variety of ways, including, but not limited to: moving to a position out of range of Bluetooth or any other short-range wireless protocol; disconnecting the Synchronization Device; moving to a position out of range of the Infrared Device; and/or moving to a position out of range of the RFID Device, including any RFID Device or other device that can support NFC or any comparable standard enabling short-range communication. In addition, Wireless Device 5750 user can terminate the connection either permanently or temporarily by initiating or receiving a voice or data transmission on the Wireless Device that is unrelated to an Advertisement viewed on Device 6950. The purpose of terminating the connection in this case is to indicate to Advertiser System 0100 that the user is not viewing any Advertisement transmitted during such voice or data transmission.

During a typical connection, Wireless Device 5750 user can view an Advertisement and Wireless Device 5750 can receive the associated Ad Data Code 0200 while viewing Device 6950. In another embodiment, Wireless Device 5750 user can view an Advertisement on Device 6950 and Wireless Device 5750 can receive the associated Ad Data Code 0200 separately or subsequently. That is, Device 6950 can store in its Memory 0012 any or all of the Ad Data Code 0200 associated with any Advertisement transmitted after Wireless Device 5750 establishes a connection with Device 6950. The connection can mark the beginning of the period during which Advertiser System 0100 and/or Device 6950 can assume Wireless Device 5750 user is viewing any Advertisement on Device 6950. At a regular or other schedule and before Wireless Device 5750 user terminates the connection, Device 6950 can transmit any or all of the Ad Data Code 0200 associated with any Advertisement transmitted during the period.

### 4.2.5 BENEFITS

The DAPM can benefit an Advertiser in at least the following ways. First, the DAPM can produce a unique Advertisement for transmission to each unique user of Wireless Device 0120 that is more likely to generate an user response desired by an Advertiser than producing an Advertisement broadcast to all users. By taking into account Static Information, Dynamic Information, and/or Feedback Information, the DAPM can produce a unique Final Advertisement that is customized for an individual user. Any one Advertisement transmitted to multiple users is likely to generate a suboptimal average response, because most users react differently to the same Advertisement.

Second, the DAPM can produce a unique Advertisement for transmission to any Media Device 0110, including, but not limited to: Wireless Base Station 0302, Television 0304, Radio 0306, Personal Computer 0308, Outdoor Media Device 0310, Magazine or Newspaper 0312, Product Package 0314, or Other Wireless Device 0316. FIG. 57 describes how the DAPM can produce a unique Advertisement customized for a given user of Wireless Device 0120 and FIG. 69 describes how the DAPM can produce a unique Advertisement customized for a given user of Wireless Device 0120 viewing a Television 0304. However, the DAPM is not limited to producing unique Advertisements through these two devices. An Advertiser can apply the DAPM to produce a unique Advertisement customized for a given user of any device, as long as a given user of Wireless Device 0120 can transmit and receive Static Information, Dynamic Information, and/or Feedback Information with the device.

Third, the DAPM can generate data showing which Element, which Version of an Element, and/or which combination of Elements can generate the most effective response from a given user. Current approaches of testing an Advertisement among focus groups or in test markets can only measure what such audiences think of the Advertisement. These approaches typically do not measure actual behavior or response to an Advertisement. For example, asking an user whether he or she would buy a Product after viewing an Advertisement is generally less reliable than measuring whether the user actually buys a Product after viewing the Advertisement. Asking an user for an opinion about an Advertisement can introduce a variety of biases that do not reflect how an user will actually respond to the Advertisement.

There exists current means of measuring the response of a given user to a unique Advertisement transmitted to the user through a personal computer. However, these means can measure the user response only if the user visits an online site of an Advertiser transmitting the Advertisement. Although users are increasing their purchases of Products online, users buy the vast majority of Products at physical retailers. Because the DAPM takes advantage of the fact that a very high percentage of Wireless Devices users take the device wherever they go, the present invention can significantly improve the measurement of actual behavior or response to many type of Advertisements, including those transmitted to a personal computer.

Fourth, the DAPM can quantify the ROI for any given Version of an Element. FIG. 46 shows an embodiment of a table of how a given user responds to different Versions of a single Element, in this case, different celebrity endorsers. Table 5900 compares how a given user responds to Advertisements with Endorser A, Endorser B, and Endorser C. Table 5900 lists the number of Advertisements received by a given user that utilized an Element of celebrity endorsement and lists how the user responded along each of Variables 1-14. In this example, the data show that the user is more responsive to Advertisements featuring Endorser B than Endorser A or Endorser C. With such data, the DAPM can calculate the ROI of Advertisements featuring different Versions of Elements, in general, and different celebrity endorsers, in this example. The ROI calculation can enable an Advertiser to estimate more accurately how much additional revenue an Advertisement using a given celebrity can generate and thus how much an Advertiser should pay the celebrity.

Current approaches can enable an Advertiser to determine how much to pay celebrities for endorsements by considering factors like audience recognition or sales of other Products featuring the celebrity. The DAPM can generate data quantifying how users respond to an Advertisement featuring the celebrity.

Fifth, the DAPM can enable Advertiser System 0100 to produce a unique Final Advertisement that reflects the preferences of any given user for each Element and/or Version of Element. That is, the DAPM can enable the creation of a HUAP Database. The HUAP Database can be stored in a variety of locations, including, but not limited to: Wireless Device 0120, Wireless Operator Server 5740, Ad Element Database 5720, and/or Advertiser System 0100. The information in the HUAP Database can be distributed among the locations.

### 5. EXEMPLARY IMPLEMENTATIONS

### 5.1 COMBINATION POWER CHARGER AND AD MEASUREMENT APPARATUS

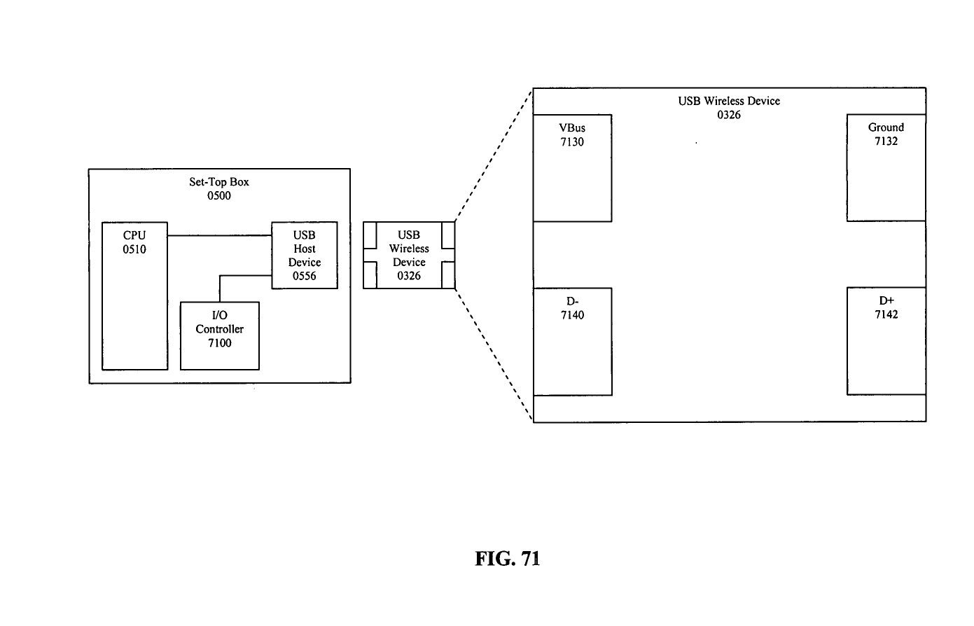

FIG. 71 shows a block diagram of an embodiment of a combination power charger and ad measurement apparatus for a Television STB 0500, according to embodiments of the present invention. The present invention includes the combination apparatus to enable simultaneously an user to charge his or her Wireless Device 0120 and Advertiser System 0100 to transmit Ad Data Code 0200 to Wireless Device 0120. Enabling an user to charge Wireless Device 0120 by connecting to STB 0500 enables the user to recharge the device, which many users do often because of the limited battery storage in most Wireless Devices. In addition, charging Wireless Device 0120 by connecting to STB 0500 and assuming that most users carry their Wireless Devices when they move around their home enables Advertisers to measure when an user is viewing or hearing Television Advertisements.

If an user charges Wireless Device 0120 through STB 0500 and Television 0304 is turned on, the present invention assumes that the user is viewing or hearing Television programming and/or Television Advertisements. If an user carries Wireless Device 0120 when he or she leaves the room and Television 0304 still turned on, the present invention assumes that the user is not viewing or hearing Television programming and/or Advertisements. If an user receives an incoming call on Wireless Device 0120, originates an outgoing call on Wireless Device 0120, or uses Wireless Device 0120 for a data transmission or reception, the user remains in the room with Television 0304, and Television 0304 is still turned on, the present invention assumes that the user is not viewing or hearing Television programming and/or Advertisements.

STB 0500 can support analog or digital Television. STB 0500 can support Television service distributed through cable, satellite, broadcast, or any other distribution technology.

In the preferred embodiment, STB 0500 can include a USB Host Device 0556 or a hub to provide additional attachment points to the USB Host Device 0556. In another embodiment, STB 0500 can include alternative connection interfaces that perform the same or equivalent functions as USB, including, but not limited to: UART, Small Computer System Interface (SCSI), IEEE 1394, or any future standard succeeding USB.

A USB Wireless Device 0326 can utilize a four-conductor cable: power like VBus 7130, ground like Ground 7132, and two signal wires for carrying data like D− 7140 and D+ 7142. For example, the Series B receptacles or Series mini-B receptacles in USB function as inputs into devices like Wireless Device 0120.

In the preferred embodiment, Wireless Device 0120 can charge its battery through VBus 7130 and Ground 7132 and receive an Ad Data Code 0200 through signal wires like D− 1740 and D+ 1742.

In the preferred embodiment, an user can charge Wireless Device 0120 by inserting USB Wireless Device 0326 directly into a docking station incorporated in STB 0500 that connects to USB Host Device 0556. In another embodiment, an user can charge Wireless Device 0120 by connecting a cable from USB Wireless Device 0326 to USB Host Device 0556.

To remind the user to reconnect Wireless Device 0120 to USB Host Device 0556, the present invention includes an alert system prompting user to reconnect. The alert can include, but is not limited to: a ringtone or other sound alert reminding user to reconnect, or a text message to reconnect.

The present invention can include more than one USB Host Device 0556 for any given STB 0500. Such capability can enable several users to charge simultaneously their respective Wireless Device 0120 and view programming and/or Advertisements on the same Television 0304. Such capability can enable Advertiser System 0100 to measure if more than one user is watching the same programming and/or Advertisements on the same Television 0304.

Attached hereto is an Appendix that describes additional embodiments of the invention.

### 6. CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

The present application includes headings herein for reference and to aid in locating certain sections. The present application does not intend these headings to limit the scope of the concepts described therein. The present application may apply the concepts in other sections throughout the entire specification.

While the present application describes how to format data, assign names to variables, and assign names to values that are written in the English language, the data, variables, and values can be written in alternative languages. The present invention can include modification of the systems, methods, apparatuses, and/or computer program products to operate with data, variables, and values in languages different from English.

The present application provides the previous description of the disclosed embodiments to enable any person skilled in the art to make and use the present invention. Various modifications to these embodiments will be readily apparent to those skilled in the art. The present invention may apply the generic principles defined herein to other embodiments without departing from the spirit or scope of the invention. Thus, the present application does not intend to limit the present invention to the embodiments shown herein, but accords the widest scope consistent with the principles and novel features disclosed herein.

Reference to “invention” herein refers to one or more embodiments. The phrase “present invention” is not intended to limit the scope of the claims to the description following the phrase.

### APPENDIX

Appendix A teaches one embodiment of the present invention, which can measure if an user of a Media Device 0110, e.g., Personal Computer 0308 or Television 0304, views an Advertisement and buys in any Retailer the Product promoted in such Advertisement and test the effect of any independent variable, e.g., an Element of the Advertisement, on ROI of the Advertisement.

A.1 Overview of Exemplary Implementation of Invention

The system can have four major sets of components:
1. Components that can measure if a panel member views an Advertisement on any Media Device 0110.
2. Components that can measure if a panel member buys a Product promoted in such Advertisement.
3. Components that can search for a match between the Advertisements viewed and the Products purchased.
4. Components that can test and analyze the data to generate information enabling an Advertiser to evaluate the effectiveness of an Advertisement.

While the system in the present embodiment can measure if an user of a Personal Computer 0308 or Television 0304 views an Advertisement and buys in any retail channel the Product promoted in such Advertisement, the present system can apply such measurement to any Media Device 0110.

The present system can utilize an Unique WD Code 4910 and/or Existing Unique ID Code 5110 to identify uniquely a panel member when he/she views an Advertisement and/or buys the Product promoted in such Advertisement. The present system can associate an Unique WD Code 4910 and/or Existing Unique ID Code 5110 with an Ad Data Code 0200 describing any Advertisement viewed by a user on a Personal Computer 0308 or Television 0304. The present system can search for an Unique WD Code 4910 and/or Existing Unique ID Code 5110 in any Transaction Database 1452, Customer Database 1454, and/or Other Database 4412, which contains records of transactions collected by the company transmitting such Advertisement or an affiliate of such company. While the present embodiment describes primarily the utilization of an Existing Unique ID Code 5110, the present invention can utilize an Unique WD Code 4910 or any other code where it can utilize an Existing Unique ID Code 5110.

A.2 Overall System of Exemplary Implementation

A.2.1 Architecture

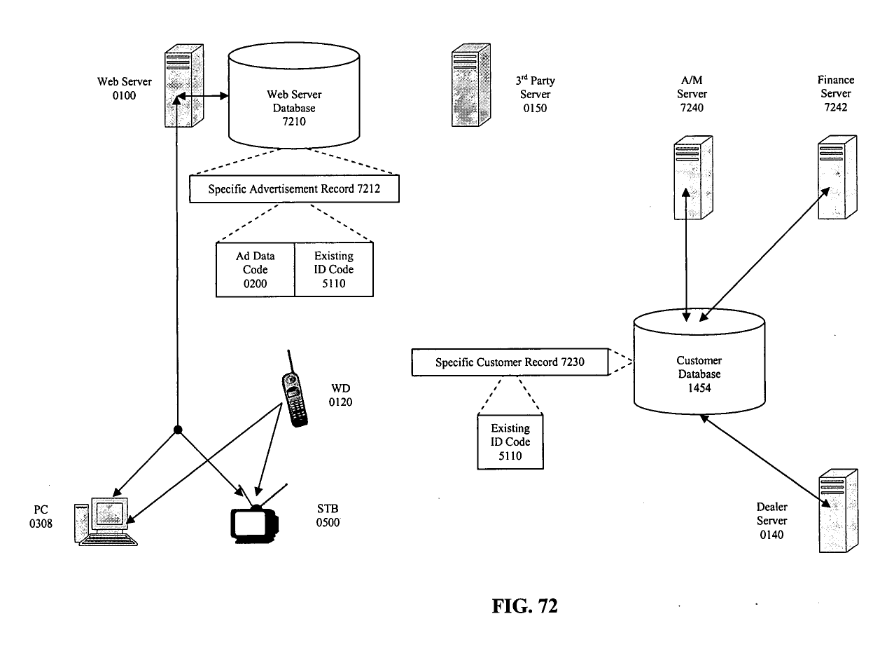

FIG. 72 depicts a functional block diagram of the components enabling an Advertiser to measure if an Internet Advertisement viewed by a user on a Personal Computer 0308 or Television 0304 leads to a sale in a Retailer. While the present invention describes a Television 0304, any Advertisement, Ad Data Code 0200, and/or computer program product transmitted to and/or received from a Television 0304 would actually be transmitted to and/or received from a STB 0500 through a wired (e.g., cable television system) or wireless (e.g., satellite broadcast system) operator.

A.2.2 Method

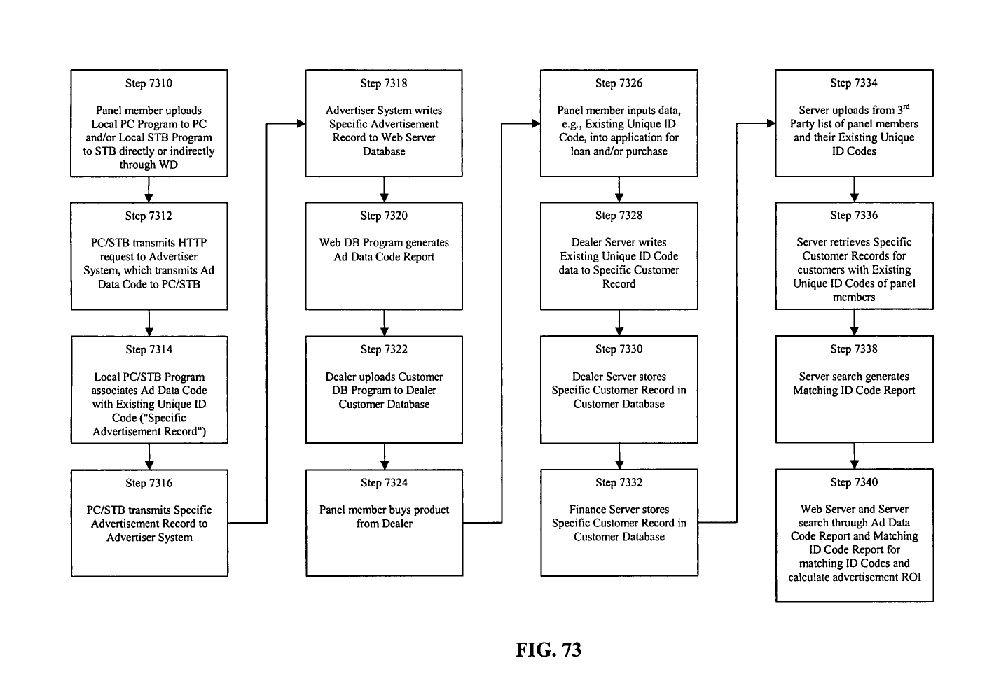

FIG. 73 depicts a flowchart of one or more steps that can implement an exemplary Method 7300 enabling such measurement. The present invention can implement the Method 7300 by executing a subset of the steps, executing the steps in different order, and/or executing other or additional related or equivalent steps.

The system can generate for any given Advertisement the following data: (1) the number of any given Advertisements transmitted to any given Media Device 0110 (“ROI Denominator”); and (2) the number of transactions involving the Product promoted in such Advertisement (“ROI Numerator”). The data can enable an Advertiser to:

1. ROI Calculation. Calculate the percent of Advertisements leading to the sale of the Product promoted in such Advertisement or ROI; and

2. Creative Effectiveness Measurement. Determine which elements of an Advertisement and/or which versions of an element can generate the highest ROI.

The system can enable an Advertiser to make the ROI Calculation as depicted in Method 7300.

The system can enable an Advertiser to measure Creative Effectiveness by comparing the ROI of two sample groups that are statistically similar, each of which view an Advertisement that is the same in every respect except the independent variable. The independent variable is anything of which an Advertiser wants to test the effectiveness. The independent variable can be any feature of an Advertisement, including, but not limited to: the text of the message, the voice communicating the message, the presence or absence of humor, the authority endorsing the product, branding or transaction, the images or videos of the Advertisement, the background music, color or black-and-white, and/or the pricing of the product.

For example, an Advertiser can test the effectiveness of different authorities endorsing the product. The Advertiser can send the same Advertisement to two sample groups, except the first Advertisement includes an endorsement by a scientific publication, e.g., a specific medical journal, while the second Advertisement includes an endorsement by a celebrity, e.g., a famous doctor.

In another example, an Advertiser can test the effectiveness of a branding versus a transaction message. A branding message aims to educate a consumer about the benefits of a product without attempting to motivate the consumer to buy the product immediately. A transaction message aims to motive the consumer to buy the product immediately, e.g., “Buy this product before midnight, tomorrow!” The system can enable an Advertiser to measure the effectiveness of the branding message by comparing the ROI over a long time period, e.g., 6 months or 1 year, of two sample groups where the first sample group views both a transaction message and a branding message while the second sample group views only the transaction message. An Advertiser can reasonably attribute any statistically significant difference in ROI between the two sample groups to the branding message.

The system can enable: (1) the distributed generation and collection of data necessary for ROI Calculation and Creative Effectiveness Measurement; and (2) the distributed and/or centralized analysis of such data. The generation and collection of data needed for ROI Calculation and Creative Effectiveness Measurement can occur at any Media Device 0110 and any Retailer Server 0140. The analysis of such data can occur at one or more devices to which an Advertiser can access, including servers transmitting over any network Advertisements from the Advertiser, e.g., an Advertiser System 0100, and/or servers to which an individual can input an Existing Unique ID Code 5110 of a panel member, e.g., a Customer Database 1454.

The system assumes that the party transmitting an Advertisement and manufacturing the product promoted in the Advertisement can be the same party (“Advertiser/Manufacturer”). The system assumes that the party transmitting an Advertisement and selling the product promoted in the Advertisement can be the same party (“Advertiser/Retailer”), e.g., an automobile dealer transmitting an Advertisement promoting automobiles at its dealership. The present invention assumes that any functional capabilities enabled for a system measuring Advertisement ROI for an Advertiser/Manufacturer are applicable to a system measuring Advertisement ROI for an Advertiser/Retailer.

The Advertiser/Manufacturer can distribute its product to any Retailer, which is an entity that can sell the product directly to the customer. A Retailer can include, but is not limited to: a party operated by the Advertiser/Manufacturer, e.g., a store operated by a vendor that sells its products; a party not operated by the Advertiser/Manufacturer but sells exclusively products of the Advertiser/Manufacturer, e.g., a franchisee like a restaurant chain store not owned and operated by such restaurant chain or a dealer like an automobile dealer not owned and operated by the automobile manufacturer; or a party not operated by the Advertiser/Manufacturer that sells a variety of products, including those of the Advertiser/Manufacturer, e.g., a supermarket, drugstore, or mass merchandiser (“Independent Retailer”). A Retailer can sell the product through any retail channel, including, but not limited to: a physical store, an online store, a phone order, and/or a mail order.

There are two classes of users of the system.
1. Panel Members. There are individuals who are members of a sample group panel who can download software, install software into any device that can receive and display an Advertisement, which can include, but is not limited to: their Wireless Devices 0120, Personal Computers 0308, STB 0500, and/or any other Media Device 0110. In addition, the panel members can input data, e.g., an Existing Unique ID Code 5110, into these Media Devices 0110. The panel members should be a representative sample of viewers and consumers targeted by one or more Advertisers.
2. Advertiser/Retailer Technical Personnel. There are individuals working at an Advertiser and/or Retailer who can produce an Ad Data Code 0200 (which can be in the form of a cookie), download software, install software into an Advertiser System 0100, Web database, customer database, and/or transaction database, and analyze data and reports generated by the system.
   A.2.3 Formats/Interfaces

Inputting Existing Unique ID Codes 5110 accurately into Media Devices 0110 can enable an Advertiser to match Advertisements viewed with products bought by the same individual. The system can enable a panel member to input an Existing Unique ID Code 5110 in a variety of ways, including, but not limited to: (a) typing an Existing Unique ID Code 5110 into a Media Device 0110 through its keyboard or keypad; (b) keying an Existing Unique ID Code 5110 into a Media Device 0110 through a wireless input device like a TV remote control device; (c) orally inputting an Existing Unique ID Code 5110 into a Media Device 0100 by speaking the data constituting such Existing Unique ID Code 5110 through a microphone, e.g., Microphone 0328; (d) orally inputting an Existing Unique ID Code 5110 into a wired or wireless phone transmitted to a third party, which can convert such voice signals to data constituting such Existing Unique ID Code 5110 and transmit such Existing Unique ID Code 5110 to a Media Device 0110; and (e) using a Camera 0332—either attached to, integrated with, or separate from a Wireless Device 0120—to take a picture of an image that includes an Existing Unique ID Code 5110, e.g., a barcode on a shopper loyalty member card, convert such image, e.g., barcode, into data constituting an Existing Unique ID Code 5110, and transmit such data to a Media Device 0110.

The system can support the inputting of Existing Unique ID Codes 5110 into any Media Device 0110, in particular, a Personal Computer 0308, STB 0500, or Wireless Device 0120. Therefore, the system can support the particular graphical user interface (GUI) and display size limitations for each corresponding Media Device 0110.

The system can support the data formats utilized by any Media Device 0110 or device at an Advertiser or Retailer.
Ad Data Code. An Advertiser can produce and transmit an Ad Data Code 0200 in any format. In the preferred embodiment, the Ad Data Code 0200 can have the same alphanumeric format as a regular cookie file. In another embodiment, the Ad Data Code 0200 can include one or more data in a non-text format. For example, an Advertiser/Manufacturer can identify a given product by a proprietary or standard code, e.g., the UPC, the EAN, and/or the GTIN. An Advertiser/Manufacturer can represent such code in formats other than alphanumeric, e.g., a barcode or other image. An Ad Data Code can include one or more data in such non-alphanumeric formats.
Local PC Program. The system can support a program written in any language that can be executed by a Personal Computer 0308.
Local STB Program. The system can support a program written in any language that can be executed by a STB 0500.
Local WD Program. The system can support a program written in any language that can be executed by a Wireless Device 0120.
Panel List Program. The system can support a program written in any language that can be executed by a Personal Computer 0308.
Web Server Program. The system can support a program written in any language that can be executed by an Advertiser System 0100.
Web DB Program. The system can support a program that can input, output, exchange, and process data with any database utilized by an Advertiser, in particular, a web server database.
Customer DB Program. The system can support a program that can input, output, exchange, and process data with any database utilized by an Advertiser, in particular, a customer/transaction database.
Match Program. The system can support a program written in any language that can be executed by one or more servers that can search any database utilized by an Advertiser, match data retrieved from such database, and analyze such data.
Analysis Program. The system can support a program written in any language that can be executed by one or more servers that can measure the ROI of different advertisements.
Existing Unique ID Code. The system can produce and exchange an Existing Unique ID Code 5110 in any format, but preferably the same text format as an Ad Data Code 0200. The computer program product with the functionality of Local PC Program and/or Local STB Program at any given Media Device 0110 can associate at such Media Device 0110 an Existing Unique ID Code 5110 with an Ad Data Code 0200. However, the system can support any other means of enabling an Advertiser to determine if a panel member with a given Existing Unique ID Code 5110 viewed an Advertisement with a given Ad Data Code 0200, including, but not limited to: inserting the data in an Existing Unique ID Code 5110 into any field of an Ad Data Code 0200; or transmitting an Existing Unique ID Code 5110 to an Advertiser separately from an Ad Data Code 0200 and associating the Existing Unique ID Code 5110 and Ad Data Code 0200 at the Advertiser System 0100.
Panel List. The system can support the production and transmission of a file including data describing panel members (“Panel List”) in a data format that can be parsed by any database, in particular, a web server database or a customer/transaction database.
   A.3 Measurement of Advertisement Viewed

The system can enable the generation and collection of data necessary for ROI Calculation and Creative Effectiveness Measurement at any Media Device 0110, e.g., a Personal Computer 0308 and/or STB 0500.

A.3.1 PC Advertisement Measurement

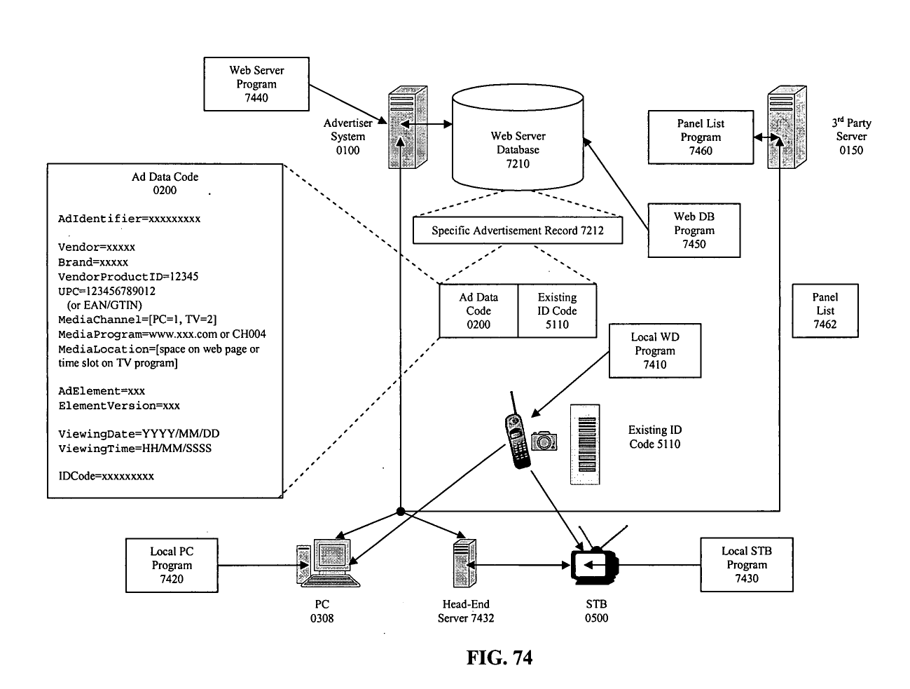

The system can include a PC Advertisement Measurement Module (PAMM), which can include any component needed to measure if a panel member views an Internet Advertisement on a Personal Computer 0308. See FIG. 74 for a diagram illustrating the different components and their location.

The PAMM can include the following components:

A.3.1.1 Local WD Program

A.3.1.1.1 Description

The Local WD Program 7410 is a computer program product comprising a Computer/Machine Readable/Accessible Medium having computer program logic recorded in such medium loaded into a Wireless Device 0120. The program can enable the inputting to a Wireless Device 0120 of data that can represent an Existing Unique ID Code 5110 for transfer to a Media Device 0110, where another computer program product with the functionality of Local PC Program and/or Local STB Program can associate such Existing Unique ID Code 5110 with an Ad Data Code 0200 received from an Advertiser. In another embodiment, the program can enable the inputting to a Wireless Device 0120 of data that can represent an Existing Unique IID Code 5110, which such program can associate such Existing Unique ID Code 5110 with an Ad Data Code 0200 received from an Advertiser. In another embodiment, the Local WD Program 7410 can enable the capturing by a component of such Wireless Device 0120, e.g., Camera 0332, of such data.

The program can enable a user of the Wireless Device 0120 in which the program is installed to input into the Wireless Device 0120 through the keypad or touch-sensitive display data that can represent an Existing Unique ID Code 5110. In another embodiment, the program can enable such user to input into the Wireless Device 0120 through any means, including, but not limited to, voice or handwriting, data that can represent an Existing Unique ID Code 5110. In another embodiment, the program can enable such user to take a picture using a camera—attached to, integrated with, or separate from a wireless phone—of any image containing data that can represent an Existing Unique ID Code 5110, e.g., a check or a shopper loyalty ID card. After receiving such data, the Local WD Program 7410 can convert such data to a standard format that can be processed by a computer program product located at the Advertiser System 0100 or Third Party Server 0150. Local WD Program 7410 can store such data in memory until the user of the Wireless Device 0120 moves such device within transmission range of a Media Device 0110 to which the program can transmit such data.

A.3.1.1.2 Inputs

The inputs into Local WD Program 7410 can include data representing an Existing Unique ID Code 5110 and/or an Ad Data Code 0200.
Data Source. The program can receive such data from a user of the Wireless Device 0120.
User Interface. The program can enable a user of the Wireless Device 0120 to input data by typing a keypad or using a finger or pointing device on a touch-sensitive display.
User Interface Elements. The program can include fields in which the user can input alphanumeric characters.
Allowable Data Types. The program can enable the input of alphanumeric characters or any other data representing an Existing Unique ID Code 5110 and/or an Ad Data Code 0200.
   A.3.1.1.3 Processing

The Local WD Program 7410 can process the inputs by converting the data to a standard format that can be processed by a computer program product located at the Advertiser System 0100 or Third Party Server 0150. In the preferred embodiment, the standard format can be the same format as that used by any Retailer database containing records of customers (“Retailer Customer Database”) 1454. Converting such data to the Retailer Customer Database 1454 format would simplify the searching, parsing, and matching of such data in other modules. In another embodiment, other computer program products, e.g., Local PC Program 7420, Local STB Program 7430, or Web DB Program 7450, can convert such data to the Retailer Customer Database 1454 format. After such conversion, the Local WD Program 7410 can then write the data into memory.

A.3.1.1.4 Outputs

The outputs from Local WD Program 7410 can include a file containing data representing an Existing Unique ID Code 5110.
Data Destination. The program can transmit over any network such file to any Media Device 0110. In the preferred embodiment in this section, the Local WD Program 7410 can transmit over any network such file to Local PC Program 7420. In another embodiment, the Local WD Program 7410 can associate such Existing Unique ID Code 5110 with an Ad Data Code 0200 received from an Advertiser and transmit over any network such associated Existing Unique ID Code 5110 and Ad Data Code 0200 to the Advertiser System 0100 which transmitted the Ad Data Code 0200.
   A.3.1.2 Local PC Program
   A.3.1.2.1 Description

The Local PC Program 7420 is a computer program product comprising a Computer/Machine Readable/Accessible Medium having computer program logic recorded in such medium loaded into a Personal Computer 0308. The program can execute a variety of functions, including, but not limited to: the inputting to a Personal Computer 0308 of data that can represent an Existing Unique ID Code 5110, the association of such Existing Unique ID Code 5110 with an Ad Data Code 0200 received from an Advertiser, and/or the transmission of the associated Existing Unique ID Code 5110 and Ad Data Code 0200 to an Advertiser System 0100.

A.3.1.2.2 Inputs

The inputs into Local PC Program 7420 can include data representing an Existing Unique ID Code 5110 and any Ad Data Code 0200.
Data Source: Existing Unique ID Code. The program can receive: (1) a file containing data representing an Existing Unique ID Code 5110 from a Wireless Device 0120; and/or (2) data representing an Existing Unique ID Code 5110 from a user of a Personal Computer 0308.
Data Source: Ad Data Code. The program can receive any Ad Data Code 0200 from an Advertiser System 0100. The program supports the reception of an Advertisement and/or Ad Data Code 0200 from an Advertiser System 0100 to a Personal Computer 0308 over any protocol, including, but not limited to: HTTP; or any proprietary protocol.
User Interface. The program can enable a user of the Personal Computer 0308 to input data through any means, including, but not limited to: typing a keyboard, touching a touch-sensitive display, speaking to a microphone, and/or writing by hand on a display.
User Interface Elements. The program can include fields in which the user can input alphanumeric characters.
Allowable Data Types. The program can enable the input of alphanumeric characters or any other data representing an Existing Unique ID Code 5110 and/or an Ad Data Code 0200.
   A.3.1.2.3 Processing

The Local PC Program 7420 can process the data representing an Existing Unique ID Code 5110 by converting the data to a standard format that can be processed by a computer program product located at the Advertiser System 0100 or Third Party Server 0150. In the preferred embodiment, the standard format can be the same format as that used by a Retailer Customer Database 1454. Converting such data to the Retailer Customer Database 1454 format would simplify the searching, parsing, and matching of such data in other modules. In another embodiment, other computer program products, e.g., Web DB Program 7450, can convert such data to the Retailer Customer Database 1454 format. After such conversion, the Local PC Program 7420 can then write the data into memory.

The Local PC Program 7420 can process any Ad Data Code 0200 by associating such Ad Data Code 0200 with the Existing Unique ID Code 5110 stored in memory. The program can make such association through any means, including, but not limited to: appending the file containing the Existing Unique ID Code 5110 to the file containing the Ad Data Code 0200, or writing the data representing the Existing Unique ID Code 5110 into a field of the Ad Data Code 0200.

The program can transmit over any network the associated Existing Unique ID Code 5110 and Ad Data Code 0200 to the Advertiser System 0100 which transmitted the Ad Data Code 0200. In another embodiment, the program can transmit over any network the associated Existing Unique ID Code 5110 and Ad Data Code 0200 to the Third Party Server 0150.

A.3.1.2.4 Outputs

The outputs from Local PC Program 7420 can include a file containing the associated Existing Unique ID Code 5110 and Ad Data Code 0200.
Data Destination. The program can transmit over any network such file to the Advertiser System 0100 which transmitted the Ad Data Code 0200. The program can determine the destination address through any means, including, but not limited to: searching the destination address in the Internet Protocol header of the Ad Data Code 0200, or searching the Ad Data Code 0200, in which the Advertiser System 0100 could include the destination address. In another embodiment, the program can transmit over any network such file to the Third Party Server 0150.
   A.3.2 Television Advertisement Measurement

The system can include a Television Advertisement Measurement Module (TAMM), which can include any component needed to measure if a panel member views an Advertisement on a Television 0304. See FIG. 74 for a diagram illustrating the different components and their location.

The TAMM can include the following components.

A.3.2.1 Local WD Program

The Local WD Program 7410 in this section can have the same functional capabilities as the Local WD Program 7410 described in the previous section except the following. In the preferred embodiment in this section, the Local WD Program 7410 can transmit over any network such file to Local STB Program 7430.

A.3.2.2 Local STB Program

A.3.2.2.1 Description

The Local STB Program 7430 is a computer program product comprising a Computer/Machine Readable/Accessible Medium having computer program logic recorded in such medium loaded into a STB 0500. The program can execute a variety of functions, including, but not limited to: the inputting to a STB 0500 of data that can represent an Existing Unique ID Code 5110, the association of such Existing Unique ID Code 5110 with an Ad Data Code 0200 received from an Advertiser, and/or the transmission of the associated Existing Unique ID Code 5110 and Ad Data Code 0200 to an Advertiser System 0100.

A.3.2.2.2 Inputs

The inputs into Local STB Program 7430 can include data representing an Existing Unique ID Code 5110 and any Ad Data Code 0200.
Data Source: Existing Unique ID Code. The program can receive: (1) a file containing data representing an Existing Unique ID Code 5110 from a Wireless Device 0120; and/or (2) data representing an Existing Unique ID Code 5110 from an user of a Television 0304 through any device that can control a STB 0500, e.g., a remote control device (“Remote Control”).
Data Source: Ad Data Code. The program can receive any Ad Data Code 0200: (1) directly from an Advertiser System 0100; (2) indirectly from an Advertiser System 0100 or any other type of server of any Advertiser through a server at a head-end of a cable TV system (“Head-End Server”) that can retrieve an Advertisement and/or Ad Data Code 0200 from an Advertiser System 0100 or any other type of server of any Advertiser; and/or (3) directly from a Head-End Server 7432 that can distribute an Advertisement and/or Ad Data Code 0200 to a STB 0500. An Advertiser can transmit an Advertisement and/or Ad Data Code 0200 to a Head-End Server 7432 in a variety of ways, including, but not limited to: transmission through a satellite network, transmission through another type of wireless network, or transmission through a wired network. The program supports the reception of an Advertisement and/or Ad Data Code 0200 from a Head-End Server 7432 to a STB 0500 over any protocol, including, but not limited to: Data Over Cable Service Interface Specification (DOCSIS) Set-Top Gateway (DSG); or any proprietary protocol.
User Interface. The program can enable an user of the Television 0304 to input data through any means, including, but not limited to: pressing keys on a Remote Control, typing a keyboard, touching a touch-sensitive display, speaking to a microphone, and/or writing by hand on a display.
User Interface Elements. The program can include fields in which the user can input alphanumeric characters.
Allowable Data Types. The program can enable the input of alphanumeric characters or any other data representing an Existing Unique ID Code 5110 and/or an Ad Data Code 0200.
   A.3.2.2.3 Processing

The Local STB Program 7430 can process the data representing an Existing Unique ID Code 5110 by converting the data to a standard format that can be processed by a computer program product located at the Advertiser System 0100 or Third Party Server 0150. In the preferred embodiment, the standard format can be the same format as that used by a Retailer Customer Database 1454. Converting such data to the Retailer Customer Database 1454 format would simplify the searching, parsing, and matching of such data in other modules. In another embodiment, other computer program products, e.g., Web DB Program 7450, can convert such data to the Retailer Customer Database 1454 format. After such conversion, the Local STB Program 7430 can then write the data into memory.

The Local STB Program 7430 can call a function in the STB 0500 OS that presents a screen on the Television 0304 display device to present a series of check boxes, drop down lists, and alphanumeric fields in which an user of the Television 0304 can input his/her Existing Unique ID Code 5110. A typical STB 0500 OS has a library of functions for displaying graphics on a Television 0304 screen. The program can call a function in such library to present on the Television 0304 screen a graphic designed to enable an user of the Television 0304 to input his/her Existing Unique ID Code 5110. The program can read any field identifying the particular STB 0500 within any given household, e.g., an IP address identifying such STB 0500. The program can associate such identifying address with the Existing Unique ID Code 5110 inputted by the user of such Television 0304. In the preferred embodiment, an user of a Television 0304 can input his/her Existing Unique ID Code 5110 through typing the keypad of a Remote Control. In another embodiment, a user of a Television 0304 can input his/her Existing Unique ID Code 5110 through any device that can control a STB 0500, including, but not limited to: a Wireless Device 0120 that contains the same function as a Remote Control.

The Local STB Program 7430 can process any Ad Data Code 0200 by associating such Ad Data Code 0200 with the Existing Unique ID Code 5110 stored in memory. The program can make such association through any means, including, but not limited to: appending the file containing the Existing Unique ID Code 5110 to the file containing the Ad Data Code 0200, or writing the data representing the Existing Unique ID Code 5110 into a field of the Ad Data Code 0200.

The program can transmit over any network the associated Existing Unique ID Code 5110 and Ad Data Code 0200 directly to the Advertiser System 0100 or indirectly to the Advertiser System 0100 through the Head-End Server 7432. In another embodiment, the program can transmit over any network the associated Existing Unique ID Code 5110 and Ad Data Code 0200 to the Third Party Server 0150.

A.3.3.2.4 Outputs

The outputs from Local STB Program 7430 can include a file containing the associated Existing Unique ID Code 5110 and Ad Data Code 0200.
Data Destination. The program can transmit over any network such file to the Advertiser System 0100 which transmitted the Ad Data Code 0200. The program can determine the destination address through any means, including, but not limited to: searching the destination address in the Internet Protocol header of the Ad Data Code 0200, or searching the Ad Data Code 0200, in which the Advertiser System 0100 could include the destination address. The program can transmit such file to a Head-End Server 7432 in a variety of ways, including, but not limited to: transmission through a satellite network, transmission through another type of wireless network, or transmission through a wired network. The program can support the transmission of such file from a STB 0500 to a Head-End Server 7432 over any protocol, including, but not limited to: DSG; or any proprietary protocol. In another embodiment, the program can transmit such file to the Third Party Server 0150.
Uplink Speed. Most existing cable TV systems limit the transmission of data from the STB 0500 to the Head-End Server 7432 to about 15 kbps. Because the transmission of the associated Existing Unique ID Code 5110 and Ad Data Code 0200 is not time-sensitive, the program can transmit over any network the associated Existing Unique ID Code 5110 and Ad Data Code 0200 whenever uplink capacity is available.
   A.3.3 Web Server Program
   A.3.3.1 Description

The Web Server Program 7440 is a computer program product comprising a Computer/Machine Readable/Accessible Medium having computer program logic recorded in such medium loaded into a server, e.g., an Advertiser System 0100. The program can execute a variety of functions, including, but not limited to: the generation of an Ad Data Code 0200, the reception of any file containing an associated Existing Unique ID Code 5110 and Ad Data Code 0200, the inputting of such file to the memory of the Advertiser System 0100, the transmission of such file to the Web Server Database 7210, and/or the reception of a Panel List 7462.

In another embodiment, the program can enable at the Advertiser System 0100 the association of an Existing Unique ID Code 5110 with an Ad Data Code 0200. The program can upload from the Third Party Server 0150 the Panel List 7462, which can include an unique address identifying any Media Device 0110 utilized by each panel member, e.g., an IP address. When the Advertiser System 0100 receives a HTTP request from a Media Device 0110, the Advertiser System 0100 can compare the IP address included in the header file of such HTTP request to determine if a Media Device 0110 utilized by a panel member transmitted the HTTP request. If so, then the Advertiser System 0100 can associate the Existing Unique ID Code 5110 associated with such IP address with the Ad Data Code 0200 associated with any Advertisement it transmits to such Media Device 0110. In this embodiment, the program performs the same association of an Existing Unique ID Code 5110 with an Ad Data Code 0200 as Local PC Program 7420 or Local STB Program 7430, but at the Advertiser System 0100 instead of at a Media Device 0110.

A.3.3.2 Inputs

The inputs into Web Server Program 7440 can include data constituting an Ad Data Code 0200 and any file containing an associated Existing Unique ID Code 5110 and Ad Data Code 0200.
Data Source: Ad Data Code. The program can receive any data constituting an Ad Data Code 0200 from a user of the Advertiser System 0100 on which the program is loaded and/or any other program containing data that can be inputted into the Ad Data Code 0200.
User Interface. The program can enable a user of the Advertiser System 0100 to input data by typing a keyboard.
Data Source: Existing Unique ID Code & Ad Data Code. The program can receive any file containing an associated Existing Unique ID Code 5110 and Ad Data Code 0200 from any Media Device 0110, including, but not limited to: (1) a Personal Computer 0308; and/or (2) a STB 0500.
Data Source: Panel List. The program can receive from the Third Party Server 0150 a file containing the list of Existing Unique ID Codes 5110 of panel members.
Allowable Data Types. The program can enable the reception of any file with alphanumeric data or any other data representing an Existing Unique ID Code 5110 and/or an Ad Data Code 0200.
   A.3.3.3 Processing

The Web Server Program 7440 can process any file containing an associated Existing Unique ID Code 5110 and Ad Data Code 0200 by: (1) writing such file to the memory of the Advertiser System 0100 and reading such file from memory for writing to the Web Server Database 7210; or (2) transferring such file from any type of memory directly to the Web Server Database 7210.

The program can process a file containing the list of Existing Unique ID Codes 5110 of panel members received from the Third Party Server 0150. The program can generate a list of panel members to which it can transmit an Advertisement and its associated Ad Data Code 0200 for the purpose of Creative Effectiveness Measurement, as described in a later section.

The program can generate an Ad Data Code 0200, which is any type of data that can be read by a machine, including, but not limited to, data: (1) uniquely identifies an Advertisement transmitted to and displayed on such machine; and/or (2) uniquely identifies the product promoted in such Advertisement. The data can include, but are not limited to, the name-value pairs listed in “Ad Data Code 0200” in FIG. 74.

A.3.3.4 Outputs

The outputs from Web Server Program 7440 can include a file containing the associated Existing Unique ID Code 5110 and Ad Data Code 0200.
Data Destination: Ad Data Code. The program can transmit over any network an Ad Data Code 0200 to any Media Device 0110.
Data Destination: Associated Existing Unique ID Code and Ad Data Code. The program can transmit over any network a file containing the associated Existing Unique ID Code 5110 and Ad Data Code 0200 to a Web Server Database 7210 residing on the Advertiser System 0100, a Database Server located at, co-located with, or connected to the Advertiser System 0100, or any other server.
   A.3.4 Web DB Program
   A.3.4.1 Description

The Web DB Program 7450 is a computer program product comprising a Computer/Machine Readable/Accessible Medium having computer program logic recorded in such medium loaded into a server, e.g., an Advertiser System 0100, and attached to, integrated with, or capable of making a call to a Web Server Database 7210. The program can execute a variety of functions, including, but not limited to: the reception from an Advertiser System 0100 of any file containing an associated Existing Unique ID Code 5110 and Ad Data Code 0200, the creation of a file structure for the Web Server Database 7210, the creation of the tables for the Web Server Database 7210, the population of the Web Server Database 7210, the writing of data in such file to a new or existing record for a panel member, the generation of a parse tree from the file, the updating and/or deletion of records or fields, the generation of a report containing the records of each panel member and the Advertisements he/she viewed, the transmission of such report to the Match Program 7610, the querying of the database for any Existing Unique ID Code(s) 5110 that match(es) any Existing Unique ID Code(s) 5110 in a Retailer Customer Database 1454, and/or the transmission of query results to the Match Program 7610.

A.3.4.2 Inputs

The inputs into Web DB Program 7450 can include any file containing an associated Existing Unique ID Code 5110 and Ad Data Code 0200.
Data Source. The program can receive any file containing an associated Existing Unique ID Code 5110 and Ad Data Code 0200 from any Advertiser System 0100.
Allowable Data Types. The program can enable the reception of any file with alphanumeric data or any other data representing an Existing Unique ID Code 5110 and/or an Ad Data Code 0200.
   A.3.4.3 Processing

The Web DB Program 7450 can create a file structure for the Web Server Database 7210, create the tables for the Web Server Database 7210, and populate the Web Server Database 7210 with data from any file containing an associated Existing Unique ID Code 5110 and Ad Data Code 0200.

The program can organize the Web Server Database 7210 in any format desired by the Advertiser. For example, the program can import the data from an associated Existing Unique ID Code 5110 and Ad Data Code 0200 to a Specific Advertisement Record 7212, which can include any and all panel members viewing such specific Advertisement as identified by their respective Existing Unique ID Codes 5110. In another embodiment, the program can import the data from an associated Existing Unique ID Code 5110 and Ad Data Code 0200 to a Specific Panel Member Record, which can include any and all Advertisements viewed by such specific panel member as identified by the value in the AdIdentifier field in the Ad Data Code 0200. The program can import the data from an associated Existing Unique ID Code 5110 and Ad Data Code 0200 to any other record format desired by the Advertiser.

The program can generate a parse tree or concrete syntax tree from any file containing an associated Existing Unique ID Code 5110 and Ad Data Code 0200. The Web Server Database 7210 can classify a product in terms of multiple layers, e.g., a product type, a brand, a specific product, or a specific model. For example, an automobile manufacturer can advertise different product types, e.g., an automobile, a truck, a motorcycle, a credit card, or a satellite broadcast service; different brands, e.g., within the automobile product type, brand A, brand B, brand C, or brand D; different products, e.g., within the brand A, product A, product B, product C, or product D; or different models, e.g., within the product A, a two-door sedan, a four-door sedan, or a station wagon. The program can generate a parse tree to classify any product for inputting into one or more fields in the Web Server Database 7210.

The program can update and/or delete any records or values of any fields. For example, an Advertiser can maintain data indicating the Advertisements viewed by a panel member for a certain time period t. After t, the program can delete any Ad Data Code(s) 0200 associated with such “expired” Advertisement(s).

The program can call a function in the Web Server Database 7210 to generate a report containing the records of each panel member and each Advertisement(s) he/she viewed as described by the associated Ad Data Code 0200 (“Ad Data Code Report”). The program can transmit such report to the Match Program 7610, which can search for matches in Existing Unique ID Codes 5110 in both the Ad Data Code Report 7620 and a report from a Retailer Customer Database 1454 identifying purchases by panel members. A sample Ad Data Code Report 7620 can have a format with one or more the following fields:

| | Vendor | | | | |
|---|---|---|---|---|---|
| Ad | Product | Media | First | Phone | Viewing |
| Identifier | ID | Channel | Name | Number | Date |
| 000000001 | 123456789012 | PC | John | 210-123- | 2006/06/01 |
| | | | | 4567 | |
| 000000001 | 123456789012 | PC | Mary | 310-123- | 2006/06/11 |
| | | | | 4567 | |
| 000000001 | 123456789012 | TV | Bill | 410-123- | 2006/06/21 |
| | | | | 4567 | |

This sample Ad Data Code Report 7620 includes records of three panel members, each with an Existing Unique ID Code 5110 comprising a FirstName and a PhoneNumber, who viewed an Advertisement identified by the AdIdentifier code “000000001” that promotes a product with a VendorProductID “123456789012”.

In another embodiment, the Web DB Program 7450 can enable Match Program 7610 to query the Web Server Database 7210 for any Existing Unique ID Code(s) 5110 that match(es) any Existing Unique ID Code(s) 5110 in a Retailer Customer Database 1454. If there is a match of such Existing Unique ID Code(s) 5110 where the associated product purchase occurs after the associated Advertisement viewing, an Advertiser can infer some type of relationship between the Advertisement viewing and the purchase of the product promoted in such Advertisement.

A.3.4.4 Outputs

The outputs from Web DB Program 7450 can include a file containing the results of any query of the Web Server Database 7210.
Data Destination. The program can transmit over any network such file to the Match Program 7610.
   A.3.5 Panel List Program
   A.3.5.1 Description

The Panel List Program 7460 is a computer program product comprising a Computer/Machine Readable/Accessible Medium having computer program logic recorded in such medium loaded into a server, e.g., an Third Party Server 0150. The program can execute a variety of functions, including, but not limited to: the collection of data over any network from any computer program product that can collect data about the Advertisements viewed on any Media Device 0110, including, but not limited to: Local WD Program 7410, Local PC Program 7420, and Local STB Program 7430; and/or the selection of one or more panel members representative of the population targeted by any given Advertiser. The system can utilize the data from Panel List Program 7460 to enable a Retailer Customer Database 1454 to filter customer records to import only those records of panel members. Such a filter can reduce the amount of data the Match Program 7610 must search.

A.3.5.2 Inputs

The inputs into Panel List Program 7460 can include data representing the Existing Unique ID Codes 5110 of panel members and/or any data describing the characteristics of panel members, which would enable the program to select one or more panel members representative of the population targeted by any given Advertiser (“Panel Member Descriptive Data”).
Data Source: Existing Unique ID Code. The program can receive: (1) a file containing data representing an Existing Unique ID Code 5110 from a Wireless Device 0120; (2) a file containing data representing an Existing Unique ID Code 5110 from a STB 0500; and/or (3) a file containing data representing an Existing Unique ID Code 5110 from a Personal Computer 0308.
Data Source: Local PC Program and/or Local STB Program. The program can receive from a computer program product like Local PC Program 7420 or Local STB Program 7430 loaded into any Media Device 0110, e.g., a Personal Computer 0308 or STB 0500, any Panel Member Descriptive Data.
Data Source: Web Server Program. The program can receive from an Web Server Program 7440 a request from an Advertiser for a list of panel members representative of the population targeted by such Advertiser.
Allowable Data Types. The program can enable the reception, processing, and transmission of alphanumeric data or any other data representing an Existing Unique ID Code 5110 and/or an Ad Data Code 0200.
   A.3.5.3 Processing

The Panel List Program 7460 can process the data representing the Existing Unique ID Codes 5110 of panel members by sorting the data to enable a Retailer Customer Database 1454 to use such data to filter customer records easily.

The program can receive from any Media Device 0110 any Panel Member Descriptive Data, receive from an Web Server Program 7440 a request from an Advertiser for a list of panel members representative of the population targeted by such Advertiser, search the Panel List 7462 for such representative panel members, and generate a list of such representative panel members.

A.3.5.4 Outputs

The outputs from Panel List Program 7460 can include a file containing corrected and refined data constituting the Existing Unique ID Codes 5110 of panel members.
Data Destination: Panel List. The Third Party Server 0150 can transmit the Panel List 7462 generated by Panel List Program 7460 to a Retailer Customer Database 1454. The Third Party Server 0150 can transmit a list of representative panel members to an Analysis Program 7710 to test the effect of any independent variable of interest to an Advertiser.
   A.4 Measurement of Product Purchase

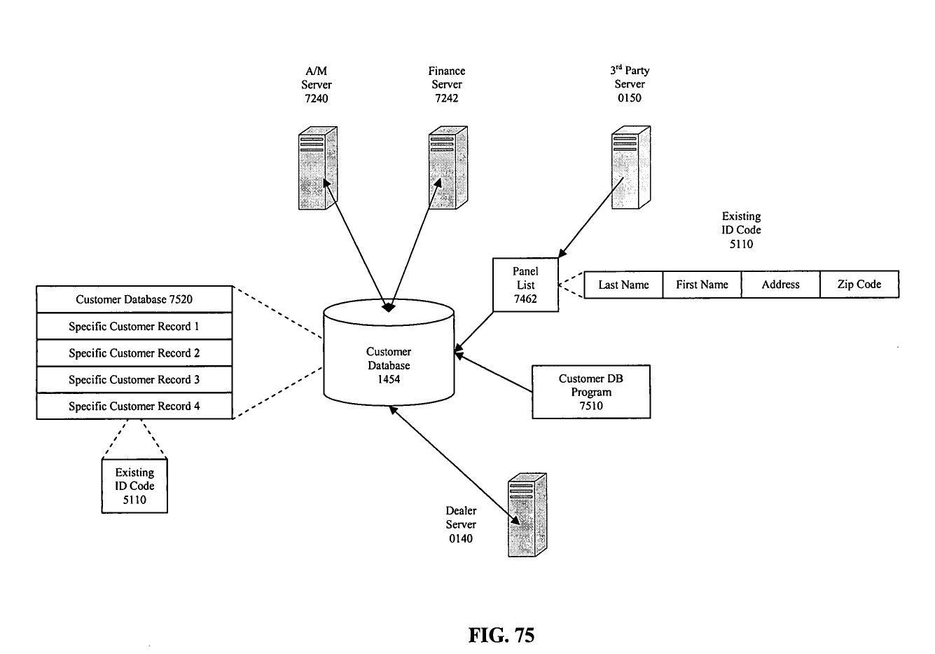

The system can enable the generation and collection of data necessary for ROI Calculation and Creative Effectiveness Measurement at any Media Device 0110. In the preferred embodiment, the system can enable the generation of ROI Numerator data at and collection of ROI Numerator data from devices at a Retailer Customer Database 1454. See FIG. 75 for a diagram illustrating the different components of the system components measuring the purchase of a product promoted in an Advertisement.

A.4.1 Customer DB Program

A.4.1.1 Description

The Customer DB Program 7510 is a computer program product comprising a Computer/Machine Readable/Accessible Medium having computer program logic recorded in such medium loaded into a server, e.g., a Retailer Server 0140, and attached to, integrated with, or capable of making a call to a Retailer Customer Database 1454. The program can execute a variety of functions, including, but not limited to: the reception from the Third Party Server 0150 a Panel List 7462, the querying of a Retailer Customer Database 1454 for any record of a customer with an Existing Unique ID Code 5110 matching an Existing Unique ID Code 5110 from the Panel List 7462, the generation of a report of records with such matching Existing Unique ID Codes 5110, and/or the transmission of such records to the Match Program 7610.

The program can be loaded into one or more Retailer Servers 0140, which can collectively store the records of any customer buying a product of the Advertiser/Manufacturer. There are a variety of ways of generating a report of records with matching Existing Unique ID Codes 5110, including, but not limited to:
Query the Retailer Customer Database of each Retailer Server. If an Advertiser/Manufacturer has a network of many Retailers, e.g., an automobile manufacturer with thousands of automobile dealers, one method of generating a report of records of matching Existing Unique ID Codes 5110 is to load the Customer DB Program 7510 into the Retailer Server 0140 of each of the Retailers, query the Retailer Customer Database 1454 of each of those Retailers, and then transmit a report of records with such matching Existing Unique ID Codes 5110 to the Match Program 7610.
Query the Retailer Customer Database of the Advertiser/Manufacturer. Another method of generating a report of records of matching Existing Unique ID Codes 5110 is to load the Customer DB Program 7510 into the Retailer Server 0140 of the Advertiser/Manufacturer, which can contain the data on customers and customer transactions from one or more, if not all, of its Retailers, query the Retailer Customer Database 1454 of the Advertiser/Manufacturer, and then transmit a report of records with such matching Existing Unique ID Codes 5110 to the Match Program 7610.

In another embodiment, the Customer DB Program 7510 can transmit a copy of the entire Retailer Customer Database 1454 to an Advertiser and/or Third Party Server 0150, either of which can query such database for any record of a customer with an Existing Unique ID Code 5110 matching an Existing Unique ID Code 5110 from the Panel List 7462, generate a report of records with such matching Existing Unique ID Codes 5110, and transmit such records to the Match Program 7610. In the preferred embodiment, the present invention can query the Retailer Customer Database 1454 at the Retailer Server 0140, because queries at the Retailer Server 0140 will: (1) consume less communication bandwidth; and (2) cause fewer customer privacy problems. In the present embodiment, a panel member can agree to participate in a sample group only after opting-in, i.e., giving permission for an Advertiser, a Retailer, and a third party to collect information about the Advertisements viewed by such panel member and/or the products purchased by such panel member. The other embodiment would result in the transmission to an Advertiser or a third party of records of customers who are not panel members who have opted-in and therefore could violate the privacy policies of a Retailer.

A typical Retailer Customer Database 1454 is the database operated by any business, including, but not limited to, a manufacturer, distributor, dealer, or Retailer, for the purpose of storing data about a customer. While different Retailers may use different names to identify the Retailer Customer Database 1454, e.g., Member Database, Transaction Database, or Inventory Database, the system defines any database operated by any business which stores data about a customer as a Retailer Customer Database 1454.

In the case of an Advertiser/Manufacturer which sells its products directly to a customer, e.g., through its own web site or physical store, it can record in a Retailer Customer Database 1454 any data on the transactions executed by its customers. In addition, such an Advertiser/Manufacturer can record in a Retailer Customer Database 1454 any data on the transactions executed by customers of a distributor, dealer, Retailer, or other third party whose customer database it can access. For example, an automobile manufacturer can operate a Retailer Customer Database 1454 that contains data on transactions executed through its own web site, the web site of its dealers, and/or the physical stores of its dealers.

Such a database can include one or more fields for each record that contain data about a given customer. There exist a minimum number of fields, whose values can collectively and uniquely identify a given customer. For example, there exists a low probability that there are two or more customers with the same last name, first name, street address, and zip code. In another example, there exist a low probability that there are two or more customers with the same first name and wired phone number. In another example, there exists an almost zero probability that there are two or more customers with the same wireless phone number. In another example, there exists a very low probability that there are two or more customers with the same email address. The system defines the Existing Unique ID Code 5110 to include at least the values in a minimum number of fields needed to identify uniquely a given customer. While Existing Unique ID Code 5110 can include more data than necessary to identify uniquely a given customer, it must include at least the minimum data needed to identify uniquely such customer.

The system does not require an Existing Unique ID Code 5110 to contain the full value of any given field in the Retailer Customer Database 1454. A collection of subsets of values of one or more fields can enable an Advertiser to identify uniquely a given customer. For example, the combination of the first name, the last four digits of a wired phone number, and a zip code can generate an Existing Unique ID Code 5110 that has a high probability of uniquely identifying a given customer.

A typical Retailer Customer Database 1454 includes one or more fields that contain data about a customer and any product(s) purchased by a given customer. The fields are typically indexed to enable a variety of functions, including, but not limited to, instant lookup, and sorting. The fields can vary depending on a variety of factors, including, but not limited to, the industry and the vendor of the database application. The fields can include, but are not limited to, the following variables:

| Field | Data Type | Data Format |
|---|---|---|
| Customer Number | Integer (assigned by | |
| | database) | |
| Customer identifying | | |
| data | | |
| Last Name | Alphabetical characters | |
| First Name | Alphabetical characters | |
| Street Address | Alphanumeric characters | |
| Zip Code | Alphanumeric characters | XXXXX-XXXX |
| Wired Number | Integer | XXX-XXX-XXXX |
| Wireless Number | Integer | XXX-XXX-XXXX |
| Email Address | Alphanumeric characters | XXX@XXX.XXX |
| IM Address | Alphanumeric characters | |
| Brand Name | Alphanumeric characters | |
| Product Name | Alphanumeric characters | |
| Product ID | | |
| Internal ID | Alphanumeric characters | |
| UPC/EAN/GTIN or | Integer/Barcode/Other | XXXXXXXXXXXX |
| other standard ID | | |
| Product Description | | |
| Weight | Integer | |
| Dimension | Integer | HH × LL × WW |
| Color | Alphabetical characters | |
| Other variables | | |
| Unit Price | Integer | $XXXXX.XX |
| Transaction Amount | Integer | $XXXXX.XX |
| Retail Channel | | |
| Physical Store | | |
| Online Store | | |
| Manufacturer | | |
| Retailer | | |
| Third party | | |
| Phone | | |
| Mail Order | | |
| Related Product | | |
| Purchase | | |
| Payment Method | Alphabetical characters | |
| Cash | | |
| Credit Card | Integer | xxxx-xxxx-xxxx-xxxx |
| Debit Card | Integer | xxxx-xxxx-xxxx-xxxx |
| Check | Integer | |
| Purchase Date | Integer | YYYY/DD/MM |
| Purchase Time | Integer | HH/SS/SS |

In a typical Retailer Customer Database 1454, the application can record a purchase by an existing customer in a variety of ways, including, but not limited to: creating a new record for such transaction, or creating a field for additional products purchased by an existing customer.

In a typical Retailer Customer Database 1454, the application can record a purchase by a customer of products related to the product sold by an Advertiser/Manufacturer. These related products can include, but are not limited to: any goods bought by the customer after buying the original product, e.g., parts or accessories, or any services bought by the customer after buying the original product, e.g., warranties, insurance, or repair. In the case of an automobile Advertiser/Manufacturer, a Retailer Customer Database 1454 can record purchases by a customer of an automobile of related products, e.g., auto parts, auto accessories, or service contracts.

In a typical Retailer Customer Database 1454, the application can include additional fields that contain data about actions by customers short of or related to buying a product. For example, a customer can: (1) purchase a product but return it; (2) apply for financing to purchase a product, but not purchase the product; (3) fill out an application to purchase a product, but not purchase the product, e.g., such an incomplete application can include, but is not limited to, an application to purchase the product online, in a physical store, or on the phone; (4) request and receive information about a product without purchasing the product; and/or (5) call, email, mail, visit the web site of, visit a physical store of, or otherwise contact the Advertiser/Manufacturer without purchasing the product. The application can include fields that contain data about such actions.

In a typical Retailer Customer Database 1454, the application can record the type of retail channel through which a customer bought any given product. These retail channels can include, but are not limited to: a physical store, an online store (either that of an Advertiser/Manufacturer, a Retailer, or a third-party), a phone order, and/or a mail order.

The system can enable an Advertiser to access the Retailer Customer Database 1454 in a variety of ways, including, but not limited to:
1. In the preferred embodiment, the Advertiser/Manufacturer and Retailer can share direct access to the Retailer Customer Database 1454. The database can be located on a server operated by the Advertiser/Manufacturer, the Retailer, or a third party.
2. In another embodiment, the Advertiser/Manufacturer can access the Retailer Customer Database 1454 by having a program in such database automatically transmit a report over a network.
3. In another embodiment, the Advertiser/Manufacturer can access the data in the Retailer Customer Database 1454 by having a user of such database manually transmit a report through devices like a fax machine.

The Retailer Customer Database 1454 can be centralized at one server or distributed among multiple servers. For example, the Retailer Customer Database 1454 can be distributed among one or more servers operated by the Advertiser/Manufacturer, one or more servers operated by the Retailer, and/or one or more servers operated by a party financing the purchase of the product, e.g., a Finance Server 7242. The servers can handle a variety of functions related to the database, including, but not limited to: client requests, report generation, and/or applications processing.

Where an Independent Retailer operates the Retailer Customer Database 1454, many Independent Retailers allow their suppliers, in this case, an Advertiser/Manufacturer, to access directly certain data in such database to enable them to replenish inventory at such Retailer. An user at its suppliers can utilize any web-based client to access such data in real-time.

A.4.1.2 Inputs

The inputs into Customer DB Program 7510 can include any of the following.
Data Source: Retailer Customer Database. The program can receive from a Retailer Customer Database 1454 a report containing the records of those customers with an Existing Unique ID Code 5110 that matches an Existing Unique ID Code 5110 of any panel member (“Matching ID Code Report”).
Data Source: Panel List. The program can receive from an Third Party Server 0150 a file containing the list of Existing Unique ID Codes 5110 of panel members.
Allowable Data Types. The program can enable the reception of any file with alphanumeric data or any other data representing an Existing Unique ID Code 5110, an Ad Data Code 0200, and/or a product ID.
   A.4.1.3 Processing

The Customer DB Program 7510 can call a function in the Retailer Customer Database 1454 to search one or more fields that include values which collectively constitute the Existing Unique ID Code 5110 of any panel member, which the program can call from the Panel List 7462. The program can search for one or more Existing Unique ID Code 5110 types. For example, the Panel List 7462 can include some panel members with an Existing Unique ID Code 5110 of the last name, first name, street address, and zip code and other panel members with a wireless phone number. The Panel List 7462 may have such different Existing Unique ID Codes 5110 because panel members can supply an Advertiser or Third Party different or incomplete information. In this case, the Customer DB Program 7510 can search the Retailer Customer Database 1454 for Existing Unique ID Codes 5110 that match different Existing Unique ID Codes 5110 in the Panel List 7462. For example, the program can search the Retailer Customer Database 1454 a first time for any Existing Unique ID Code 5110 that matches an Existing Unique ID Code 5110 in the Panel List 7462 in the format of last name, first name, street address, and zip code and a second time for any Existing Unique ID Code 5110 that matches an Existing Unique ID Code 5110 in the Panel List 7462 in the format of a wireless phone number.

The program can call a function in the Retailer Customer Database 1454 to generate a Matching ID Code Report 7630. A typical database application includes one or more functions enabling a user to generate a report in any format desired by the user of such database.

The report requested by the Customer DB Program 7510 can include fields whose values collectively constitute the Existing Unique ID Code 5110 of any panel member. For example, if the Existing Unique ID Code 5110 is a wireless phone number, the report can include the field for wireless phone numbers or if the Existing Unique ID Code 5110 is the last name, first name, street address, and zip code, the report can include the fields for such data. The report can include the values for the fields specified by the Customer DB Program 7510. The report requested by the program can include data for any given time period an Advertiser wishes to evaluate.

In addition to the fields whose values collectively constitute the Existing Unique ID Code 5110 of any panel member, the report can include the fields and their respective values for any data reflecting a purchase by a panel member of the product promoted in such Advertisement. These additional fields can include, but are not limited to: the brand name, the product name, the product ID (whether internally generated or a standardized product ID code, e.g., the UPC, the EAN, and/or the GTIN), unit price, transaction size, retail channel, payment method, the date purchased, and/or the time purchased. In addition, the report can include the fields and their respective values for any data reflecting a response by a panel member short of or related to a purchase. These additional fields can include, but are not limited to, any return of a product, application of financing to purchase a product, request for information about a product, and/or contact with the Advertiser/Manufacturer and the type of contact, e.g., call, email, mail, web site visit, physical store visit, or any other contact.

A record with values for one or more fields whose values collectively constitute the Existing Unique ID Code 5110 of any panel member and one or more fields whose values reflect a purchase by such panel member is a Panel Customer Record.

By importing data on the retail channel in which a customer bought a product, the report can enable an Advertiser/Manufacturer to measure the ROI of an Advertisement viewed through any Media Device 0110, regardless of the retail channel. For example, because a Retailer Customer Database 1454 can include data on purchases in physical stores, purchases in online stores, and purchases through the phone, an Advertiser/Manufacturer can measure the ROI of an online Advertisement leading to a sale in a physical store, in an online store, and through the phone, as well as the ROI of an Television Advertisement leading to a sale in a physical store, in an online store, and through the phone.

The Customer DB Program 7510 can support the queries of and generation of a Matching ID Code Report 7630 from a Retailer Customer Database 1454 that is centralized at one server or distributed among multiple servers. Some Retailers operate a single Retailer Customer Database 1454 that includes data on purchases in any retail channel. Other Retailers operate a separate Retailer Customer Database 1454 for each retail channel. Other Retailers operate separate, but integrated or networked, Retailer Customer Databases 1454 for each retail channel. The Customer DB Program 7510 can support the queries of Existing Unique ID Codes 5110 across multiple Retailer Customer Databases 1454 and the generation of a Matching ID Code Report 7630 from multiple Retailer Customer Databases 1454.

The Customer DB Program 7510 can format the Matching ID Code Report 7630 into a data structure that the Match Program 7610 can read when searching for Existing Unique ID Codes 5110 that match the Existing Unique ID Codes 5110 associated with Ad Data Codes 0200. The Customer DB Program 7510 can encrypt the Matching ID Code Report 7630, transmit over a network such encrypted report to the Match Program 7610, and receive an acknowledgement from the Match Program 7610 that it received and decrypted the report.

A sample Matching ID Code Report 7630 can have a format with one or more the following fields:

| | | Vendor | | | |
|---|---|---|---|---|---|
| First | Phone | Product | Product | Retail | |
| Name | Number | ID | Name | Channel | PurchaseDate |
| John | 210-123- | 123456789012 | XXXXXX | Physical | 2006/07/01 |
| | 4567 | | | | |
| Dave | 510-123- | xxxxxxxxxxxx | YYYYYY | Online | 2006/07/11 |
| | 4567 | | | | |
| Jill | 610-123- | xxxxxxxxxxxx | ZZZZZZ | Phone | 2006/07/21 |
| | 4567 | | | | |

This sample Matching ID Code Report 7630 includes records of three customers with a FirstName and PhoneNumber matching those of panel members, one of whom bought a product with a VendorProductID code “123456789012” in a physical retail channel on the date, YYYY/MM/DD.

Where an Independent Retailer operates the Retailer Customer Database 1454 and allows its suppliers to access directly certain data in such database, the Customer DB Program 7510 can add the number and type of fields to which an Advertiser/Manufacturer can access and/or generate a report which can include data from such additional fields. If an Independent Retailer currently enables an Advertiser/Manufacturer to access only fields describing the products and/or inventory of the products of such Advertiser/Manufacturer and/or access reports providing only aggregate data on such products and/or inventory, the Customer DB Program 7510 can—with the permission of the Independent Retailer and/or the individual customer (e.g., through receiving permission from customers on the Panel List 7462)—enable the Advertiser/Manufacturer to access additional fields describing the customer associated with any given transaction involving its products and/or access reports including data from such additional fields. In the preferred embodiment, the program can enable the Advertiser/Manufacturer to access additional fields describing only those customers with Existing Unique ID Codes 5110 matching the Existing Unique ID Codes 5110 from the Panel List 7462. An Independent Retailer would not violate any privacy policy with respect to such data if customers on the Panel List 7462 provide an Advertiser or Third Party permission to access such data. In another embodiment, the program can enable the Advertiser/Manufacturer to access additional fields describing any customer in the Retailer Customer Database 1454.

A.4.1.4 Outputs

The outputs from Customer DB Program 7510 can include a file containing a Matching ID Code Report 7630.
Data Destination: Match Program. The Retailer Server 0140 can transmit a Matching ID Code Report 7630 to the Match Program 7610 located at a server operated by an Advertiser or Manufacturer (“Advertiser/Manufacturer Server”), an Third Party Server 0150, or a server at a third party. In another embodiment, the Match Program 7610 can poll the Customer DB Program 7510 to retrieve the Matching ID Code Report 7630. In another embodiment, a user of the Match Program 7610 can directly access the Matching ID Code Report 7630 on the Retailer Server 0140. In the case where an Advertiser/Manufacturer and Retailer can share access to the Retailer Customer Database 1454, such database can have any interface through which a user can access, including, but not limited to, a HTML-based interface through which a user can access via a web browser.
Communications Protocol. The Retailer Server 0140 can transmit a Matching ID Code Report 7630 to the Match Program 7610 located at another server over any communications protocol, including, but not limited to: IP, electronic data interchange (EDI), or any proprietary protocol.
   A.5 Matching of Data

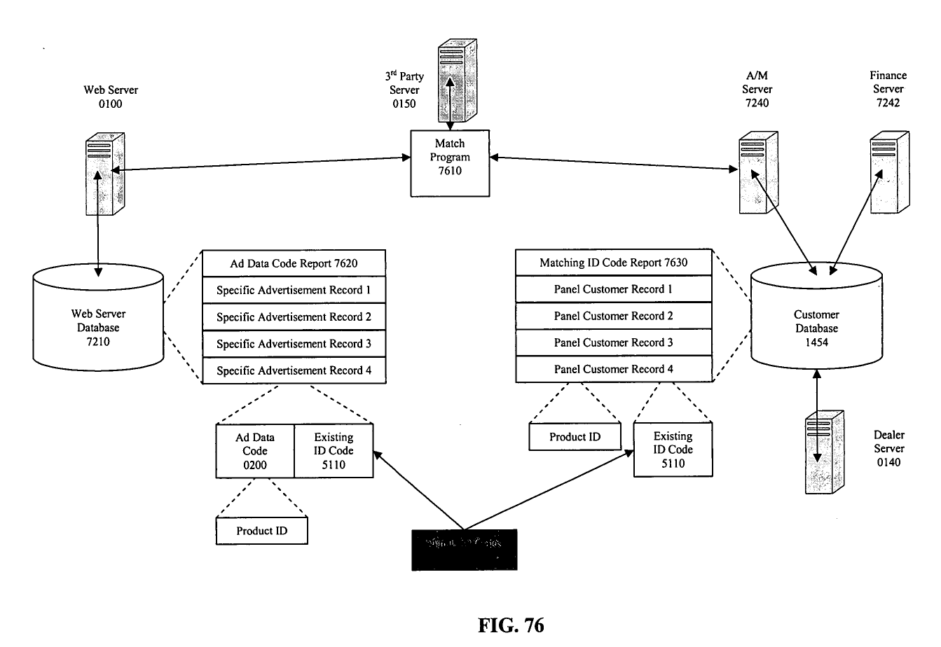

The system can search the Ad Data Code Report 7620 and the Matching ID Code Report 7630 for any matches in Existing Unique ID Codes 5110. If there is a match of such Existing Unique ID Code(s) 5110 where the associated product purchase occurs after the associated Advertisement viewing, an Advertiser can infer some type of relationship between the Advertisement viewing and the purchase of the product promoted in such Advertisement. See FIG. 76 for a diagram illustrating the different components of the system components enabling the matching of such Existing Unique ID Code(s) 5110.

A.5.1 Match Program

A.5.1.1 Description

The Match Program 7610 is a computer program product comprising a Computer/Machine Readable/Accessible Medium having computer program logic recorded in such medium loaded into one or more servers, which can include, but are not limited to: an Advertiser System 0100, a Retailer Server 0140, an Advertiser/Manufacturer Server 7240, and/or the Third Party Server 0150. The program can execute a variety of functions, including functions that can be executed by URMA Module 0744, but not limited to: the reception from the Web DB Program 7450 one or more Ad Data Code Reports 7620, the reception from the Customer DB Program 7510 one or more Matching ID Code Reports 7630, the searching of the Ad Data Code Report 7620 and Matching ID Code Report 7630 for any matches in Existing Unique ID Codes 5110, the summing of the number of transactions by customers with the same Existing Unique ID Codes 5110 in both the Ad Data Code Report 7620 and Matching ID Code Report 7630 which also have a Product ID in the Matching ID Code Report 7630 matching the Product ID in the Specific Advertisement Records 7212 (which can be the ROI Numerator), the summing of the number of Advertisements promoting a product with such Product ID (which can be the ROI Denominator), and/or the division of the ROI Numerator by the ROI Denominator to yield the ROI of a given Advertisement.

A.5.1.2 Inputs

The inputs into Match Program 7610 can include any of the following reports:
Data Source: Web Server. The program can receive one or more Ad Data Code Reports 7620 from the Web DB Program 7450 at an Advertiser System 0100.
Data Source: Retailer Server. The program can receive one or more Matching ID Code Reports 7630 from the Customer DB Program 7510 at one or more Retailer Servers 0140.
Allowable Data Types. The program can enable the reception of any file with alphanumeric data or any other data representing an Existing Unique ID Code 5110, an Ad Data Code 0200, and/or a product ID.
   A.5.1.3 Processing
   A.5.1.3.1 Algorithm

For a given time period t, the Match Program 7610 can calculate the ROI of a given Advertisement by executing one or more of the following steps. The present invention can implement the following algorithm by executing a subset of the steps, executing the steps in different order, and/or executing other or additional related or equivalent steps.
1. Search an Ad Data Code Report 7620 and sum the number of records of Ad Data Codes 0200 for a given Advertisement Ax. For example, there can be x number of panel members, on whose Personal Computers 0308 and STBs 0500 the Local PC Program 7420 and the Local STB Program 7430, respectively, can transmit Specific Advertisement Records 7212 containing the records of each Advertisement as described by its associated Ad Data Code 0200 viewed by each panel member. The Web DB Program 7450 can generate an Ad Data Code Report 7620 that contains records of one or more Specific Advertisement Records 7212 for one or more panel members. The Match Program 7610 can sum the number of records of Ad Data Codes 0200 for a given Advertisement A,, which can equal (x number of panel members)*(an average of y number of times each panel member viewed Advertisement Aₓ). This product constitutes the ROI Denominator.
2. Search one or more Matching ID Code Reports 7630 and filter those records of customers or customer transactions with an Existing Unique ID Code 5110 which matches the Existing Unique ID Code 5110 in a record for a given Advertisement Ax in the Ad Data Code Report 7620. For example, an Advertiser/Manufacturer can store at its Advertiser System 0100 an Ad Data Code Report 7620 containing the records of one or more Specific Advertisement Records 7212 for one or more panel members. In addition, an Advertiser/Manufacturer can store at its Advertiser System 0100 or another server it operates one or more Matching ID Code Reports 7630 received from one or more of its Retailers. The Match Program 7610 can search both the Ad Data Code Report 7620 and one or more Matching ID Code Reports 7630 for any Specific Advertisement Record 7212 for a given Advertisement A, with an Existing Unique ID Code 5110 matching an Existing Unique ID Code 5110 in any Panel Customer Record (“Matching ID Code Record”).
3. For those Matching ID Code Records, filter those Panel Customer Records whose values for the PurchaseDate field occur after the values of the ViewingDate field in the Ad Data Code 0200 for a given Advertisement Aₓ (“Post Matching ID Code Records”).
4. For those Post Matching ID Code Records, sum the number of records of customers or customer transactions with a Product ID which matches the Product ID in the Ad Data Code 0200 for Advertisement Aₓ. This sum constitutes the ROI Numerator.
5. Divide ROI Numerator by ROI Denominator to generate ROI for Advertisement Aₓ.

The following example shows the application of the above steps to generate a ROI calculation for Advertisement 000000001.

Ad Data Code Report:

| | Vendor | | | | |
|---|---|---|---|---|---|
| Ad | Product | Media | First | Phone | Viewing |
| Identifier | ID | Channel | Name | Number | Date |
| 000000001 | 123456789012 | PC | John | 210-123- | 2006/06/01 |
| | | | | 4567 | |
| 000000001 | 123456789012 | PC | Mary | 310-123- | 2006/06/11 |
| | | | | 4567 | |
| 000000001 | 123456789012 | TV | Bill | 410-123- | 2006/06/21 |
| | | | | 4567 | |

One Matching ID Code Report:

| | | Vendor | | | |
|---|---|---|---|---|---|
| First | Phone | Product | Product | Retail | |
| Name | Number | ID | Name | Channel | PurchaseDate |
| John | 210-123- | 123456789012 | XXXXXX | Physical | 2006/07/01 |
| | 4567 | | | | |
| Dave | 510-123- | xxxxxxxxxxxx | YYYYYY | Online | 2006/07/11 |
| | 4567 | | | | |
| Jill | 610-123- | xxxxxxxxxxxx | ZZZZZZ | Phone | 2006/07/21 |
| | 4567 | | | | |

1. Search the Ad Data Code Report 7620 and sum the number of records of Ad Data Codes 0200 for Advertisement 000000001. Step 1 generates a value of 3, which equals the ROI Denominator.
2. Search one or more Matching ID Code Reports 7630 and filter those records of customers or customer transactions with an Existing Unique ID Code 5110 which matches the Existing Unique ID Code 5110 in a record for Advertisement 000000001 in the Ad Data Code Report 7620. Step 2 finds that only one Panel Customer Record (FirstName=John and PhoneNumber=210-123-4567) has an Existing Unique ID Code 5110 which matches the Existing Unique ID Code 5110 in a record for Advertisement 000000001. Step 2 defines such Panel Customer Record as a Matching ID Code Record.
3. For those Matching ID Code Records, filter those Panel Customer Records whose values for the PurchaseDate field occur after the values of the ViewingDate field in the Ad Data Code 0200 for Advertisement 000000001. The value of 2006/06/01 in PurchaseDate for the Matching ID Code Record occurs after the value of 2006/07/01 in ViewingDate. Step 3 defines such Panel Customer Record as a Post Matching ID Code Record.
4. For those Post Matching ID Code Records, sum the number of records of customers or customer transactions with a Product ID which matches the Product ID in the Ad Data Code 0200 for Advertisement 000000001. Step 4 finds that the VendorProductID for the Post Matching ID Code Record matches the VendorProductID for the Ad Data Code Record. Step 4 generates a value of 1, which equals the ROI Numerator.
5. Divide ROI Numerator by ROI Denominator to generate ROI for Advertisement 000000001. Step 5 generates a value of ⅓.
   A.5.1.3.2 Related Product Purchases

In calculating the ROI Numerator, the Match Program 7610 can sum not only: (1) the number of customer transactions in the Matching ID Code Report 7630 with a Product ID matching the Product ID in the Specific Advertisement Records 7212; but also (2) the number of records of customer transactions in the Matching ID Code Report 7630 with a Product ID that is related to the Product ID in the Specific Advertisement Records 7212.

That is, a customer can buy one or more related products in response to viewing an Advertisement promoting a single product:

1. There can be a family relationship between the products. An Advertisement promoting a brand X can lead to a customer buying a model XY that is part of brand X. For example, an Advertisement promoting brand X can lead to a customer buying model XY that is part of brand X. If the Advertiser/Manufacturer uses a proprietary Product ID to identify uniquely a first product, there is typically one or more lookup tables including the values of any other products related to the first product. For example, an Advertiser/Manufacturer brand database can include the following table identifying the brands in the Advertiser/Manufacturer's portfolio:

| | | | |
|---|---|---|---|
| | | | Other |
| Brand ID | Brand Name | Other field | field |

| | |
|---|---|
| 00000 | XXX |
| 00100 | YYY |
| 00200 | ZZZ |

A brand XXX database can include the following table identifying the products under the brand XXX:

| Product | Product | Brand | Brand |
|---|---|---|---|
| ID | Name | Name | ID |
| 00001 | xxx | XXX | 00000 |
| 00002 | yyy | XXX | 00000 |
| 00003 | zzz | XXX | 00000 |

A product xxx database can include the following table identifying the specific models under product xxx:

| Product | Product | | |
|---|---|---|---|
| ID | Name | Model | Model ID |
| 00001 | xxx | 2-door | 000011 |
| 00001 | xxx | 4-door | 000012 |

For an Advertisement promoting the brand XXX, the Match Program 7610 can sum the number of customer records with not only the Brand ID equaling 00000, but also the number of any customer records with a Product ID equaling 00001, 00002, and 00003, and the number of any customer records with a Model ID of 000011 and 000012. The program can execute the above sum in a variety of ways, including, but not limited to: the program calling a function in the Advertiser/Manufacturer product database that can automatically lookup the values of other products related to the primary product. For example, if the program is summing the number of customer records with the Brand ID equaling 00000, the program can automatically call a function in the Advertiser/Manufacturer brand database that looks up the foreign key's table, “Brand XXX” and sums any customer records with a Product ID whose Brand ID also equals 00000, and any customer records with a Model ID whose Product ID also equals 00001.
2. There can be other relationships between the products. An Advertisement promoting an automobile brand X can lead to a customer buying an automobile service XX1 that is related to the sale of brand X. For example, an Advertisement by an automobile dealer promoting the brand XXX can lead to a customer buying not only a brand XXX automobile from the dealer, but also an annual service contract maintaining the automobile from such dealer instead of a third party.

The Match Program 7610 can sum the number of customer records with not only the Brand ID equaling the brand of the product purchased, but also the number of any customer records with a Product ID equaling the related products purchased, e.g., the annual service contract. To enable the program to sum the customer records of related products purchased, the Advertiser/Manufacturer can create and provide the program access to lookup tables that relate additional products to the primary product purchased.

In another embodiment, the Advertiser/Manufacturer can use a standardized Product ID to identify uniquely a product, e.g., an UPC, EAN, and/or GTIN. To enable the Match Program 7610 to match not only exactly matching Product IDs, but also any related Product IDs, the Advertiser/Manufacturer can create and provide the program access to lookup tables that relate additional products to the primary product purchased which identify such products with standardized Product IDs.

A.5.1.4 Outputs

The outputs from Match Program 7610 can include a report containing data on the ROI of any Advertisement.
Data Destination: PC of Decision Maker. The Match Program 7610 can transmit to the Personal Computer 0308 of a decision maker at the Advertiser a report containing data on the ROI of any Advertisement. The report can include summary data and data constituting the ROI Numerator and ROI Denominator. The report can include data in the form of tables and/or graphics.
Data Destination: ERP Program. The Match Program 7610 can transmit data on the ROI of any Advertisement to another program, including, but not limited to, an enterprise resource planning (ERP) program, a financial planning program, and/or a marketing analysis program, which can import, process, and/or export data enabling an Advertiser to calculate additional measures related to such Advertisement. For example, another program can include or access data on the gross margin or contribution of the product promoted in an Advertisement, the cost of producing such Advertisement, and the cost of placing such Advertisement. Such additional data can enable an Advertiser to calculate the ROI and determine if the sales from such Advertisement exceed the expenses.
Data Destination: Analysis Program. The Match Program 7610 can transmit aggregate and/or specific panel member data on the ROI of any Advertisement to the Analysis Program 7710.
   A.6 Analysis of Data

The system can calculate a given Advertisement ROI, i.e., the ratio of the number of purchases by one or more panel members of a product promoted in a given Advertisement to the number of Ad Data Codes 0200 describing such Advertisement viewed by one or more such panel members. However, an Advertiser would typically value additional analysis of such data for a variety of reasons, including, but not limited to, the following.
1. A given panel member could have bought such product even if they had not viewed such Advertisement. An Advertiser would like to know the difference between the ROI of one sample group of panel members who viewed an Advertisement for a given product and the ROI of another sample group of panel members who did not view such Advertisement.
2. A given panel member can view the same Advertisement for a given product on one or more Media Devices 0110. An Advertiser would like to know the difference between the ROI of one sample group of panel members who viewed the same Advertisement on one Media Device 0110, e.g., a Personal Computer 0308, and the ROI of another sample group of panel members who viewed the same Advertisement on another Media Device 0110, e.g., a Television 0304.
3. A given panel member could have bought such product, because he/she was influenced by prior Advertisements improving the image of the brand (“Branding Advertisement”) as well as a current Advertisement encouraging the immediate purchase of the product (“Transaction Advertisement”). An Advertiser would like to know the difference between the ROI of one sample group of panel members who viewed the Branding Advertisement and Transaction Advertisement and the ROI of another sample group of panel members who viewed only the Transaction Advertisement.

The system can enable an Advertiser to determine with a high confidence level the effect of any independent variable on the ROI of a given Advertisement. The system can test the effect of any independent variable of interest to an Advertiser, including, but not limited to: the viewing of an Advertisement promoting a given product; the viewing of a given Advertisement on a given Media Device 0110; the viewing of a Branding Advertisement; any given element of an Advertisement, including, but not limited to, the content of an Advertisement, e.g., a slogan, the degree of product benefit explanation, the type of product endorsement, e.g., a scientific study v. a celebrity, the type of background music, or the type of background color; the type of product promoted; the pricing of the product; and/or the type of retail channel for the product.

A.6.1 Analysis Program

A.6.1.1 Description

The Analysis Program 7710 is a computer program product comprising a Computer/Machine Readable/Accessible Medium (as defined in Section 7.0) having computer program logic recorded in such medium loaded into one or more servers, which can include, but are not limited to: an Advertiser System 0100, a Retailer Server 0140, an Advertiser/Manufacturer Server 7240, and/or the Third Party Server 0150. The program can execute a variety of functions, including functions that can be executed by URMA Module 0744, but not limited to: the selection of one or more sample groups of panel members representative of the population targeted by such Advertiser; the selection of one or more Advertisements of which at least one is an Advertisement that includes the independent variable and another is an Advertisement that represents the control; the transmission of such Advertisements to the plurality of sample groups; the reception from the Match Program 7610 data on an average, e.g., mean, ROI of the Advertisement transmitted to each sample group; the reception from the Match Program 7610 data on the values of ROI for any given panel member; and/or the calculation of the mean, standard deviation, standard error, confidence interval, and test statistic of the sample group estimate of ROI and/or the difference in sample group mean ROI.

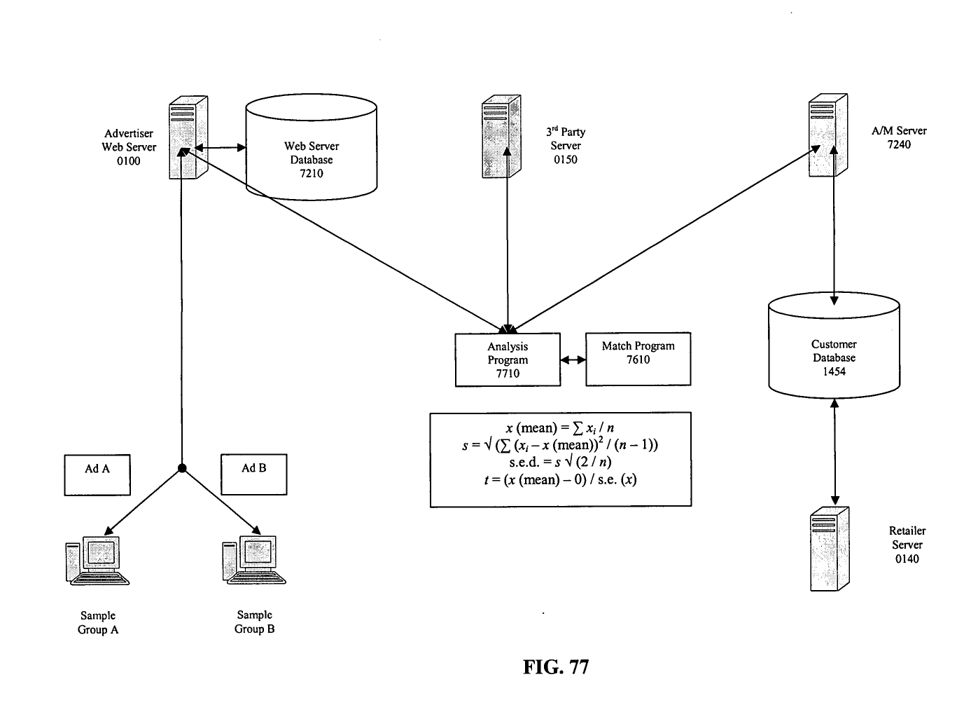

See FIG. 77 for a diagram illustrating the different components of the system components enabling the testing the effect of an independent variable on the ROI of a given Advertisement.

A.6.1.2 Inputs

The inputs into Analysis Program 7710 can include any of the following data:
Data Source: Panel List Program. The program can receive from an Panel List Program 7460 a list of panel members representative of the population targeted by a given Advertiser.
Data Source: Match Program. The program can receive from an Match Program 7610 any data on the ROI of the Advertisement transmitted to each sample group. Such data can include, without limitation, the mean ROI of each sample group, and/or the ROI of any given panel member of each sample group.
Allowable Data Types. The program can enable the reception of any file with alphanumeric data or any other data representing an Existing Unique ID Code 5110, an Ad Data Code 0200, and/or a product ID.
   A.6.1.3 Processing
   A.6.1.3.1 Algorithm

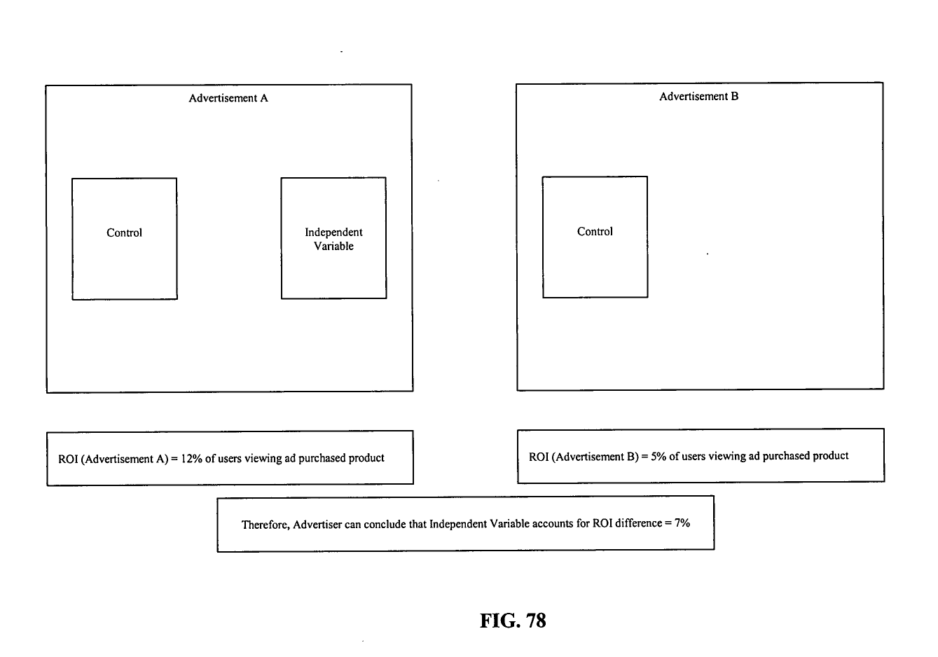

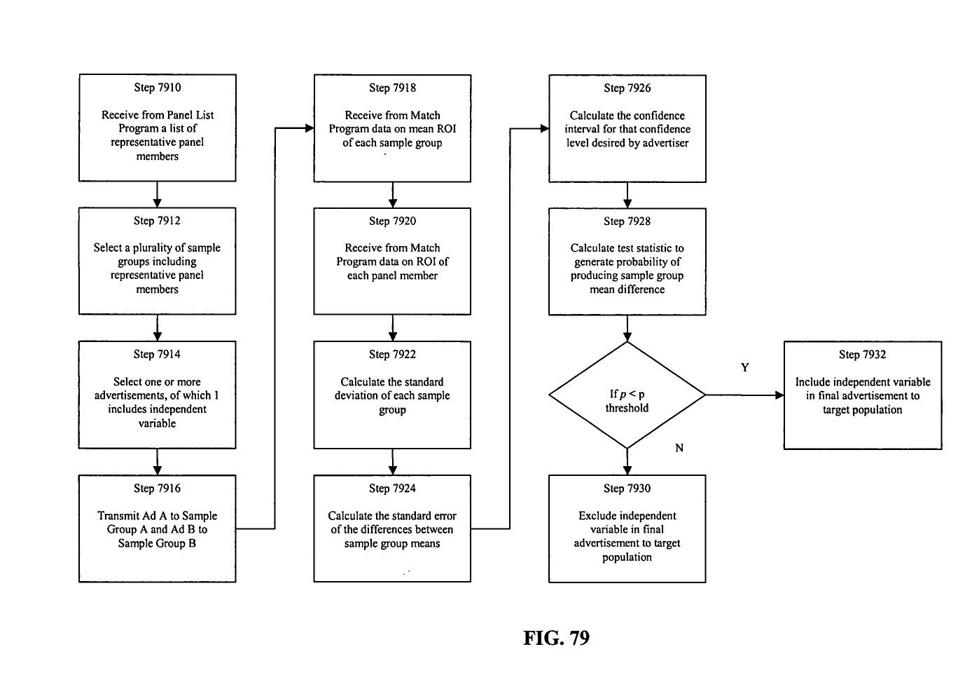

The Analysis Program 7710 can test the effect of an independent variable on the ROI of a given Advertisement by executing one or more of the following steps. The present invention can implement flowchart 7900 by executing a subset of the steps, executing the steps in different order, and/or executing other or additional related or equivalent steps. See FIG. 77 for a diagram showing the following steps:
1. Retrieve from a Panel List Program 7460 a list of panel members representative of the population targeted by a given Advertiser for a given product.
2. Assign randomly panel members into one or more sample groups. In the preferred embodiment, the Analysis Program 7710 generates two sample groups, Sample Group A and Sample Group B. In another embodiment, the program generates more than two sample groups.
3. Select one or more Advertisements, of which one includes the independent variable whose effect on ROI an Advertiser wishes to test. The Advertiser can store in the memory of one or more servers, e.g., its Advertiser System 0100, one or more Advertisements, of which one includes the independent variable. The program retrieves each Advertisement and assigns such Advertisement to one or more sample groups. In the preferred embodiment, the program assigns Advertisement A, which includes the independent variable, to Sample Group A and Advertisement B, which excludes the independent variable, to Sample Group B. See FIG. 78 for a diagram illustrating the differences between an Advertisement including an independent variable and an Advertisement excluding an independent variable.
4. Transmit Advertisement A to the Media Device 0110 being tested of Sample Group A and Advertisement B to the Media Device 0110 being tested of Sample Group B. If the independent variable is the Media Device 0110, e.g., an Advertiser wishes to test the difference between an Advertisement viewed on a Personal Computer 0308 and the same Advertisement viewed on a Television 0304, then the program can either: (a) transmit an Advertisement to a first Media Device 0110 and a second Media Device 0110 to Sample Group A and the same Advertisement to a second Media Device 0110 to Sample Group B; or (b) transmit an Advertisement to a first Media Device 0110 to Sample Group A and not transmit such Advertisement a second Media Device 0110 for both Sample Group A and Sample Group B.
5. Retrieve from Match Program 7610 data on the mean ROI of each sample group. The Analysis Program 7710 can calculate an average ROI (sample group x), which can be any average, including, but not limited to: a mean, weighted mean, or any other average. In the preferred embodiment, the program defines and calculates the mean ROI (sample group x) as follows:

$$Let {x}_{i} = ROI of panel {member}_{i}$$

$$Let x ( mean ) = {\sum }_{i}^{n} ( {x}_{i} / n )$$

After calculating such mean, the program writes the value of x (mean) in memory and/or permanent storage.
6. Retrieve from Match Program 7610 data on the ROI of each panel member of each sample group. The Analysis Program 7710 writes the values of xi and the number n of panel members of each sample group to the memory of the server on which it is loaded.
7. Calculate the standard deviation of each sample group. In the preferred embodiment, the Analysis Program 7710 defines and calculates the standard deviation (sample group x) as follows:

$$Let {SD}_{x} = √ ( {\sum }_{i}^{n} {( {x}_{i} - x ( mean ) )}^{2} / ( n - 1 ) )$$

The program can calculate the standard deviation of each sample group by reading from memory and/or permanent storage, in which Match Program 7610 stores the values of xᵢ and n, calculating the difference between the ROI for each panel member and the mean ROI for his/her sample group, squaring such difference, summing such squares, dividing such sum by the difference of (n−1), and taking the square root of such division. After calculating such standard deviation, the program writes the value of SD₁, SD₂ . . . SDₓ in memory and/or permanent storage.
8. Calculate the standard error of the difference between the sample group means. The Analysis Program 7710 can calculate the standard error of sample group mean, the standard error of the difference between the sample group means, and/or the standard error of any other measure related to sample group mean, e.g., a proportion or a ratio, an Advertiser wishes to test. In the preferred embodiment, the program can test the difference in mean ROI among one or more sample groups. The program can make different calculations of the standard error of the difference between the sample group means, depending on the sample size.

The program includes a step which compares n against any given threshold defining a sample as large or small. The program can enable a user to input any n threshold above which it defines as a large sample and below which it defines as a small sample. If a user of the program does not input an n threshold, the program assigns a value of n threshold equal to 30 observations.

a. For a large sample size, the program can calculate the standard error of the difference between two sample group means using any widely accepted formula. One widely accepted formula is as follows:
Let s.e. (difference, large)=√((SD₁²/n₁)+(SD₂²/n₂))
The program can calculate the s.e. (difference, large) by reading the values SD₁, SD₂, n₁, n₂ from memory and/or permanent storage, squaring SD₁, squaring SD₂, dividing SD₁ by n₁, dividing SD₂ by n₂, summing the previous two ratios, and taking the square root of such sum. After calculating such s.e. (difference, large), the program writes such value in memory and/or permanent storage.

b. For a small sample size, the program can calculate the standard error of the difference between two sample group means using any widely accepted formula. One widely accepted formula is as follows:
Let sₚ²=(((n₁−1)*SD₁²)+((n₂−1)*SD₂²))/(n₁+n₂−2)
Let s.e.(difference, small)=sₚ*(√((1/n₁)+(1/n₂)))
The program can calculate the s.e. (difference, small) by reading the values SD₁, SD₂, n₁, n₂ from memory and/or permanent storage, calculating sₚ² in accordance with the above formula, calculating the inverse of n₁, calculating the inverse of n₂, summing the previous two terms, taking the square root of such sum, and multiplying such square root by the sₚ². After calculating such s.e. (difference, small), the program writes such value in memory and/or permanent storage.

The standard error formula implies that the precision of the sample group mean is related to the variability of the ROI of panel members and the number of panel members sampled. The smaller the variability or the larger the number of samples, the more precise the sample group mean.
9. Calculate the confidence interval providing the range within which the true mean ROI for the population lies for each sample group. The Analysis Program 7710 can calculate any confidence interval. A common confidence interval used in statistical testing is 95 percent. In the preferred embodiment, the program can define and calculate a 95 percent confidence interval for the sample group mean as approximately:
   x(mean)±2*s.e.(x(mean))

The program can calculate a 95 percent confidence interval by multiplying the standard error of the sample group mean by two, a product which when added or subtracted from the sample group mean represents the range within which the true mean ROI for the population lies. After calculating such confidence level, the program writes such value in memory and/or permanent storage.
10. Calculate using standard statistical tests the probability of generating the observed difference between sample group means. In standard statistical analysis, if there is a very small probability of generating a difference as large as the difference observed, then it is reasonable to reject the hypothesis that there is no difference between the sample group means and to conclude that the difference is statistically significant. A general formula for calculating the test statistic for the observed difference between sample group means is:
   t=(x₁(mean)−x₂(mean))/s.e.(difference)

In the preferred embodiment, the program can calculate a t-value in accordance with the above formula, compare such t-value with standard distribution tables stored locally or remotely, and/or lookup the p-value associated with any given t-value, i.e., the probability of generating the observed difference between sample group means. After calculating such t-value and p-value, the program writes such values in memory and/or permanent storage.
11. If the p-value exceeds a given p-threshold, then standard statistical analysis suggests that the independent variable did not generate a statistically significant observed difference between sample group means. If the p-value falls below a given p-threshold, then standard statistical analysis suggests that the independent variable did generate a statistically significant observed difference between sample group means.

If the Advertiser specifies a given p-threshold, e.g., 1 percent, then the program compares the p-value against such p-threshold. If the Advertiser does not specify a given p-threshold, then the program compares the p-value against a 5 percent p-threshold.
12. If the p-value exceeds a given p-threshold, then the program excludes the independent variable when producing a final Advertisement for transmission to the target population.
13. If the p-value falls below a given p-threshold, then the program includes the independent variable when producing a final Advertisement for transmission to the target population.

In another embodiment, the program can add additional steps to control for other factors that could affect the observed difference between sample group means. For example, a panel member can view an Advertisement by a competing vendor B, which could increase the probability of buying the product promoted by vendor A. The program can add a step to control for viewings of such competing product Advertisements.

### A.6.1.3.2 EXAMPLE

The following example shows how the Analysis Program 7710 can test the effect of an independent variable—specifically the Media Device 0110, i.e., Personal Computer 0308, on which a panel member views an Advertisement—on the ROI of a given Advertisement by executing the following steps:

1. Retrieve a list of panel members (PM) representative of the population targeted by a given Advertiser for a given product.

| Panel Member | PM Descriptive | | |
|---|---|---|---|
| Record ID | Data | PM ID Code | Field xx |
| 0001 | Male, 35 years old | 210-123-4567 | |
| 0002 | Male, 31 years old | 915-123-4567 | |
| 0003 | Male, 39 years old | 353-123-4567 | |
| 0004 | Male, 45 years old | 256-123-4567 | |
| 0005 | Male, 28 years old | 367-123-4567 | |
| 0006 | Male, 33 years old | 758-123-4567 | |
| 0007 | Male, 28 years old | 410-123-4567 | |
| 0008 | Male, 41 years old | 844-123-4567 | |
| 0009 | Male, 37 years old | 990-123-4567 | |
| 0010 | Male, 39 years old | 445-123-4567 | |

2. Assign randomly panel members into Sample Group A and Sample Group B.

| | | | |
|---|---|---|---|
| Panel Member | PM Descriptive | | |
| Record ID | Data | PM ID Code | Field xx |

Sample Group A:

| | | |
|---|---|---|
| 0001 | Male, 35 years old | 210-123-4567 |
| 0002 | Male, 31 years old | 915-123-4567 |
| 0004 | Male, 45 years old | 256-123-4567 |
| 0006 | Male, 33 years old | 758-123-4567 |
| 0009 | Male, 37 years old | 990-123-4567 |

Sample Group B:

| | | |
|---|---|---|
| 0003 | Male, 39 years old | 353-123-4567 |
| 0005 | Male, 28 years old | 367-123-4567 |
| 0007 | Male, 28 years old | 410-123-4567 |
| 0008 | Male, 41 years old | 844-123-4567 |
| 0010 | Male, 39 years old | 445-123-4567 |

3. Select the Advertisement which Analysis Program 7710 can transmit to Sample Group A and Sample Group B. Because this example is testing the independent variable, Personal Computer Media Device 0308, the program transmits the same Advertisement to both Sample Groups.
4. Transmit Advertisement A to the Personal Computer 0308 and Television 0304 of Sample Group A and Advertisement A to the Television 0304 of Sample Group B.
5. Retrieve from Match Program 7610 data on the mean ROI of each sample group.

Sample Group A ROI (mean)=4.4%

Sample Group B ROI (mean)=1.9%

6. Retrieve from Match Program 7610 data on the ROI of each panel member of each sample group.

| | | | |
|---|---|---|---|
| Panel Member | PM Descriptive | | |
| Record ID | Data | PM ID Code | ROI |

Sample Group A:

| | | | |
|---|---|---|---|
| 0001 | Male, 35 years old | 210-123-4567 | 3.1% |
| 0002 | Male, 31 years old | 915-123-4567 | 4.6% |
| 0004 | Male, 45 years old | 256-123-4567 | 4.2% |
| 0006 | Male, 33 years old | 758-123-4567 | 2.6% |
| 0009 | Male, 37 years old | 990-123-4567 | 7.4% |

Sample Group B:

| | | | |
|---|---|---|---|
| 0003 | Male, 39 years old | 353-123-4567 | 2.1% |
| 0005 | Male, 28 years old | 367-123-4567 | 1.3% |
| 0007 | Male, 28 years old | 410-123-4567 | 1.5% |
| 0008 | Male, 41 years old | 844-123-4567 | 4.5% |
| 0010 | Male, 39 years old | 445-123-4567 | 0.0% |

7. Calculate the standard deviation of each sample group.

SD_{A}=1.87

SD_{B}=1.65
8. Calculate the standard error of the difference between the sample group means. The program compares n₁ and n₂ against the threshold defining a sample as large or small. Because n₁ and n₂ are each less than 30, the program calculates the standard error of the difference between the sample group means in accordance with step 8.b.
   sₚ²=(((n₁−1)*SD₁²)+(n₂−1)*SD₂²))/(n₁+n₂−2)
   sₚ²=3.11
   s.e.(difference, small)=sₚ*(√((1/n₁)+(1/n₂)))
   s.e.(difference, small)=1.97
9. Calculate the 95% confidence interval providing the range within which the true mean ROI for the population lies for each sample group.
   CI(Sample Group A)=4.4%±1.68%
   CI(Sample Group B)=1.9%±1.48%
10. Calculate the test statistic for the observed difference between the sample group means.
   t=(x₁(mean)−x₂(mean))/s.e.(difference)
   t=(4.4%−1.9%)/(1.97)
   t=1.27

The associated p-value is between 0.50 and 0.10.
11. Because the p-value exceeds the 5 percent p-threshold, the program decides that the independent variable—showing the Advertisement on a Personal Computer 0308—did not generate a statistically significant observed difference between the two sample group means.

Given the small sample size of 5 observations for each sample group, the difference between the two sample group means would have to be large in order to generate a high t-value and low associated p-value. Alternatively, the program can generate a high t-value and low associated p-value for the observed difference between the two sample group means if the sample size is sufficiently large.

A.6.1.4 Outputs

The outputs from Analysis Program 7710 can include data showing the statistical significance of the observed difference between sample group means and/or a decision metric for including or excluding an independent variable in a final Advertisement for transmission to the target population.

What is claimed is:

1. A method for determining the effectiveness of an advertisement, comprising:
(a) receiving, in a computer, one or more advertisement viewing records including data related to the advertisement and data related to an individual viewing the advertisement from one or more devices, wherein at least one advertisement viewing record is associated with a first type of media device and at least one advertisement viewing record is associated with a second type of media device;
(b) receiving, in the computer, one or more product purchase records including data related to a product purchased and data related to an individual purchasing the product from one or more devices, wherein the product purchase records are electronically transmitted to the computer;
(c) analyzing, in the computer, the received advertisement viewing records and the received product purchase records; and
(d) for each advertisement viewing record having a predefined set of data in common with a product purchase record, generating a matching record, whereby the matching record indicates a likelihood that the viewing of an advertisement associated with the advertisement viewing record generated a subsequent purchase of a product associated with the advertisement.

2. The method of claim 1 wherein step (a) comprises:
receiving, in the computer, one or more advertisement viewing records from one or more wireless devices.

3. The method of claim 2, wherein the one or more advertisement viewing records are collected by a user response measurement system in one of the one or more wireless devices.

4. The method of claim 3, wherein the one or more advertisement viewing records are collected by the user response measurement system from a media device.

5. The method of claim 1 wherein an advertisement viewing record includes one or more ad data codes.

6. The method of claim 2, wherein the one or more product purchase records are collected by a user response measurement system in one of the one or more wireless devices.

7. The method of claim 6, wherein the one or more product purchase records are collected by the user response measurement system from a point of sale system.

8. The method of claim 1 wherein a product purchase record includes one or more payment receipts.

9. The method of claim 1 wherein step (a) comprises:
receiving, in the computer, one or more advertisement viewing records from a media device.

10. The method of claim 9, wherein the media device is a personal computer.

11. The method of claim 9, wherein the media device is a set-top box.

12. The method of claim 1 wherein step (b) comprises:
receiving, in the computer, one or more product purchase records from a point of sale device.

13. The method of claim 1 wherein step (b) comprises:
receiving, in the computer, one or more product purchase records from a media device.

14. The method of claim 1 wherein step (b) comprises:
receiving, in the computer, one or more product purchase records from a retailer server.

15. The method of claim 14, wherein the one or more product purchase records are collected by the retailer server from one or more point of sale devices.

16. The method of claim 1, wherein the advertisement viewing record includes a unique code field and the product purchase record includes the unique code field.

17. The method of claim 16, wherein the predefined set of data includes the unique code field.

18. The method of claim 17, wherein the unique code is an existing identification code.

19. The method of claim 18, the existing identification code includes a membership identification code.

20. The method of claim 1, further comprising:
(e) generating a plurality of advertisements.

21. The method of claim 20, wherein one or more of the generated advertisements include a plurality of independent variables from a set of independent variables.

22. The method of claim 21, wherein step (e) comprises generating a first advertisement for a first sample group and a second advertisement for a second sample group.

23. The method of claim 22, wherein one or more advertisement viewing records includes an identification of the first advertisement and an identification of an individual in the first sample group and one or more advertisement viewing records includes an identification of the second advertisement and an identification of an individual in the second sample group.

24. The method of claim 23, wherein one or more product purchase records includes the identification of the individual in the first sample group and one or more product purchase records includes the identification of the individual in the second sample group.

25. The method of claim 24, further comprising:
(f) generating a first set of data indicative of the return on investment for the first advertisement; and
(g) generating a second set of data indicative of the return on investment for the second advertisement.

26. The method of claim 25, further comprising:
(h) analyzing the first set of data and the second set of data to identify the impact of one or more of the independent variables.

27. A computer program product comprising a computer useable medium including control logic stored therein, the control logic enabling the determination of the effectiveness of an advertisement, the control logic comprising:
means for enabling a processor to receive one or more advertisement viewing records including data related to the advertisement and data related to an individual viewing the advertisement from one or more devices, wherein at least one advertisement viewing record is associated with a first type of media device and at least one advertisement viewing record is associated with a second type of media device;
means for enabling the processor to receive one or more product purchase records including data related to a product purchased and data related to an individual purchasing the product from one or more devices, wherein the product purchase records are electronically transmitted to the computer;
means for enabling the processor to analyze received advertisement viewing records and the received product purchase records; and
means for enabling the processor to generate a matching record for each advertisement viewing record having a predefined set of data in common with a product purchase record.

28. The computer program product of claim 27, wherein the means for enabling the processor to receive one or more advertisement viewing records comprises:
means for enabling the processor to receive one or more advertisement viewing records from one or more wireless devices.

29. The computer program product of claim 28, wherein the one or more advertisement viewing records are collected by a user response measurement system in one of one or more wireless devices.

30. The computer program product of claim 29, wherein the one or more advertisement viewing records are collected by the user response measurement system from a media device.

31. The computer program product of claim 27 wherein an advertisement viewing record includes one or more ad data codes.

32. The computer program product of claim 28, wherein the one or more product purchase records are collected by a user response measurement system in one of one or more wireless devices.

33. The computer program product of claim 32, wherein the one or more product purchase records are collected by the user response measurement system from a point of sale system.

34. The computer program product of claim 27 wherein a product purchase record includes one or more payment receipts.

35. The computer program product of claim 27 wherein the means for enabling the processor to receive one or more advertisement viewing records comprises:
means for enabling the processor to receive one or more advertisement viewing records from a media device.

36. The computer program product of claim 35, wherein the media device is a personal computer.

37. The computer program product of claim 35, wherein the media device is a set-top box.

38. The computer program product of claim 27 wherein the means for enabling the processor to receive one or more purchase records comprises:
means for enabling the processor to receive one or more product purchase records from a point of sale device.

39. The computer program product of claim 27 wherein the means for enabling the processor to receive one or more purchase records comprises:
means for enabling the processor to receive one or more product purchase records from a media device.

40. The computer program product of claim 27 wherein the means for enabling the processor to receive one or more purchase records comprises:
means for enabling the processor to receive one or more product purchase records from a retailer server.

41. The computer program product of claim 40, wherein the one or more product purchase records are collected by the retailer server from one or more point of sale devices.

42. The computer program product of claim 27, wherein the advertisement viewing record includes a unique code field and the product purchase record includes the unique code field.

43. The computer program product of claim 42, wherein the predefined set of data includes the unique code field.

44. The computer program product of claim 43, wherein the unique code is an existing identification code.

45. The computer program product of claim 44, wherein the existing identification code includes a membership identification code.

46. The computer program product of claim 27, wherein the control logic includes:
means for enabling the processor to generate a plurality of advertisements.

47. The computer program product of claim 46, wherein one or more of the generated advertisements include a plurality of independent variables from a set of independent variables.

48. The computer program product of claim 47, wherein the means for enabling the processor to generate a plurality of advertisement comprises means for enabling the processor to generate a first advertisement for a first sample group and a second advertisement for a second sample group.

49. The computer program product of claim 48, wherein one or more advertisement viewing records includes an identification of the first advertisement and an identification of an individual in the first sample group and one or more advertisement viewing records includes an identification of the second advertisement and an identification of an individual in the second sample group.

50. The computer program product of claim 49, wherein one or more product purchase records includes the identification of the individual in the first sample group and one or more product purchase records includes the identification of the individual in the second sample group.

51. The computer program product of claim 50, wherein the control logic further comprises:
means for enabling the processor to generate a first set of data indicative of the return on investment for the first advertisement; and
means for enabling the processor to generate a second set of data indicative of the return on investment for the second advertisement.

52. The computer program product of claim 25, wherein the control logic further comprises:
means for enabling the processor to analyze the first set of data and the second set of data to identify the impact of one or more of the independent variables.

53. A system for determining the effectiveness of an advertisement, comprising:
receiver configured to receive one or more advertisement viewing records including data related to the advertisement and data related to an individual viewing the advertisement from one or more devices, wherein at least one advertisement viewing record is associated with a first type of media device and at least one advertisement viewing record is associated with a second type of media device and to receive one or more product purchase records including data related to a product purchased and data related to an individual purchasing the product from one or more devices, wherein the product purchase records are electronically transmitted to the computer; and
an analysis module configured to analyze the received advertisement viewing records and the received product purchase records to generate a matching record for each advertisement viewing record having a predefined set of data in common with a product purchase record,
whereby the matching record indicates a likelihood that the viewing of an advertisement associated with the advertisement viewing record generated a subsequent purchase of a product associated with the advertisement.

54. The system of claim 53 wherein the one or more advertisement viewing records are received from one or more wireless devices.

55. The system of claim 54, wherein the one or more advertisement viewing records are collected by a user response measurement system in one of the one or more wireless devices.

56. The system of claim 55, wherein the one or more advertisement viewing records are collected by the user response measurement system from a media device.

57. The system of claim 53 wherein an advertisement viewing record includes one or more ad data codes.

58. The system of claim 54, wherein the one or more product purchase records are collected by a user response measurement system in one of the one or more wireless devices.

59. The system of claim 58, wherein the one or more product purchase records are collected by the user response measurement system from a point of sale system.

60. The system of claim 53 wherein a product purchase record includes one or more payment receipts.

61. The system of claim 53 wherein the one or more advertisement viewing records are received from a media device.

62. The system of claim 61, wherein the media device is a personal computer.

63. The system of claim 61, wherein the media device is a set-top box.

64. The system of claim 53 wherein the one or more product purchase records are received from a point of sale device.

65. The system of claim 53 the one or more product purchase records from a media device.

66. The system of claim 53 wherein the one or more product purchase records from a retailer server.

67. The system of claim 66, wherein the one or more product purchase records are collected by the retailer server from one or more point of sale devices.

68. The system of claim 53, wherein the advertisement viewing record includes a unique code field and the product purchase record includes the unique code field.

69. The system of claim 68, wherein the predefined set of data includes the unique code field.

70. The system of claim 69, wherein the unique code is an existing identification code.

71. The system of claim 70, the existing identification code includes a membership identification code.

72. The system of claim 53, further comprising:
advertisement generation module configured to generate a plurality of advertisements.

73. The system of claim 72, wherein one or more of the generated advertisements include a plurality of independent variables from a set of independent variables.

74. The system of claim 73, wherein the advertisement generation module is further configured to generate a first advertisement for a first sample group and a second advertisement for a second sample group.

75. The system of claim 74, wherein one or more advertisement viewing records includes an identification of the first advertisement and an identification of an individual in the first sample group and one or more advertisement viewing records includes an identification of the second advertisement and an identification of an individual in the second sample group.

76. The system of claim 75, wherein one or more product purchase records includes the identification of the individual in the first sample group and one or more product purchase records includes the identification of the individual in the second sample group.

77. The system of claim 76, wherein the analysis module is further configured to:
generate a first set of data indicative of the return on investment for the first advertisement; and
generate a second set of data indicative of the return on investment for the second advertisement.

78. The system of claim 77, wherein the analysis module is further configured to analyze the first set of data and the second set of data to identify the impact of one or more of the independent variables.
